(19) United States
(12) Patent Application Publication
(10) Pub. No.: US 2025/0148487 A1
(43) Pub. Date: May 8, 2025

(54) METHODS, PROCESSES, AND SYSTEMS TO DEPLOY ARTIFICIAL INTELLIGENCE (AI)-BASED CUSTOMER RELATIONSHIP MANAGEMENT (CRM) SYSTEM USING MODEL-DRIVEN SOFTWARE ARCHITECTURE

(71) Applicant: C3.ai, Inc., Redwood City, CA (US)

(72) Inventors: Thomas M. Siebel, Woodside, CA (US); Houman Behzadi, San Francisco, CA (US); Nikhil Krishnan, San Carlos, CA (US); Varun Badrinath Krishna, Mountain View, CA (US); Anna L. Ershova, Redwood City, CA (US); Mark Woollen, San Mateo, CA (US); Ruiwen An, Jersey City, NJ (US); Gabriele Boncoraglio, Redwood City, CA (US); Aaron James Christensen, Redwood City, CA (US); Kush Khosla, Redwood City, CA (US); Hoda Razavi, San Jose, CA (US); Ryan Compton, San Francisco, CA (US)

(21) Appl. No.: 19/015,232

(22) Filed: Jan. 9, 2025

Related U.S. Application Data
(62) Division of application No. 17/807,937, filed on Jun. 21, 2022.
(60) Provisional application No. 63/213,313, filed on Jun. 22, 2021.

(51) Int. Cl. G06Q 30/0201; G06Q 30/01; G06Q 30/0202

(52) U.S. Cl. CPC G06Q 30/0201; G06Q 30/01; G06Q 30/0202

(57) ABSTRACT

A method includes curating CRM data by employing a type system of a model-driven architecture and selecting an AI CRM application from a group of applications. Each CRM application may generate one or more use case insights with one or more objectives. The method also includes obtaining one or more data models including an industry-specific data model from the curated CRM data and orchestrating a plurality of machine learning models for the selected CRM application with the obtained data model(s) to determine one or more machine learning models effective for at least one objective of the selected CRM application. The method further includes applying the determined machine learning model(s) and the obtained data model(s) to predict probabilities that optimize the at least one objective and using the predicted probabilities to apply at least one of the one or more use case insights that optimizes the at least one objective.

### CROSS-REFERENCE TO RELATED APPLICATIONS AND PRIORITY CLAIM

This application claims priority under 35 U.S.C. § 120 as a divisional of U.S. patent application Ser. No. 17/807,937 filed on Jun. 21, 2022, which claims priority under 35 U.S.C. § 119 (e) to U.S. Provisional Patent Application No. 63/213,313 filed on Jun. 22, 2021. Both of these applications are hereby incorporated by reference in their entirety.

### TECHNICAL FIELD

This disclosure is generally directed to machine learning and other artificial intelligence (AI) systems. More specifically, this disclosure describes methods, processes, and systems to deploy an AI-based customer relationship management (CRM) system using a model-driven software architecture, such as one that uses internal data sources and/or exogenous data sources.

### BACKGROUND

Customer relationship management (CRM) systems are used as a system of record for sales and other revenue-related opportunities, sales and other forecasts, and marketing, product, customer service, customer relationship history, and other information within and across organizations and markets. Sales, service, and marketing teams and other personnel use CRM systems to keep track of contacts, secure revenue, ensure progress against sales targets, service customers, manage marketing programs, deploy customer self-service systems, and perform other functions. Ideally, CRM systems can be used to help decision-makers increase revenue, maximize profits, increase customer satisfaction, increase customer retention, increase market share, and increase sales and service effectiveness within an organization.

### SUMMARY

This disclosure describes methods, processes, and systems to deploy an artificial intelligence (AI)-based customer relationship management (CRM) system using a model-driven software architecture.

In a first embodiment, a method of AI-based CRM using a model-driven architecture includes curating CRM data by employing a type system of the model-driven architecture. The method also includes selecting an AI CRM application from a group of AI CRM applications, where each AI CRM application is configured to generate one or more use case insights with one or more objectives. The method further includes obtaining one or more data models including an industry-specific data model from the curated CRM data. The method also includes orchestrating a plurality of machine learning models for the selected AI CRM application with the one or more obtained data models to determine one or more machine learning models effective for at least one of the one or more objectives of the selected AI CRM application. The method further includes applying the one or more determined machine learning models and the one or more obtained data models to predict probabilities that optimize the at least one of the one or more objectives of the selected AI CRM application. In addition, the method includes using the predicted probabilities to apply at least one of the one or more use case insights that optimizes the at least one of the one or more objectives of the selected AI CRM application.

Any single one or any suitable combination of the following features may be used with the first embodiment.

The type system of the model-driven architecture may include types as data objects and at least one of: associated methods, associated logic, and associated machine learning classifiers. One or more of the data objects may be associated with at least one of: one or more customers, one or more companies, one or more accounts, one or more products, one or more employees, one or more suppliers, one or more opportunities, one or more contracts, one or more locations, and one or more digital portals.

Type definitions may include properties or characteristics of an implemented software construct.

Applying the one or more determined machine learning models and the one or more obtained data models may include calculating a CRM metric associated with at least one of: customer satisfaction, customer churn, customer retention, demand forecasting, and product forecasting. The one or more objectives of the selected AI CRM application may be targeted at scoring the CRM metric for at least one of: one or more customers, an aggregation of multiple customers, one or more products, an aggregation of multiple products, one or more opportunities, an aggregation of multiple opportunities, one or more sales representatives, an aggregation of multiple sales representatives, one or more employees, and an aggregation of multiple employees.

Using the predicted probabilities to apply the at least one of the one or more use case insights may include developing an electronic communication campaign that optimizes a customer engagement score based on one or more relationship intelligence data models. The selected AI CRM application may include an AI customer satisfaction application that scores features of the one or more data models, and the features may be associated with at least one of: marketing data, account data, stakeholder data, competitor data, and contextual data.

A plurality of types of the type system may be based on a variety of data sources. In response to a request for data, a type of the plurality of types including information in accordance with a definition corresponding to the type may be provided.

Applying the one or more determined machine learning models and the one or more obtained data models may include scoring features of CRM metrics associated with the at least one of the one or more objectives of the selected AI CRM application.

The selected AI CRM application may include an AI customer satisfaction application that scores features of the one or more data models, and the features may be associated with a likelihood of one or more existing customers or groups of customers ceasing to be customers completely or partially within a given timeframe.

Orchestrating the plurality of machine learning models may include at least one of: calibrating, inferencing, labeling, merging, normalizing, snapshotting, refactoring, training, updating, and validating the one or more of the plurality of machine learning models with the one or more obtained data models.

Orchestrating the plurality of machine learning models may include determining one or more machine learning models effective for the one or more objectives of the selected AI CRM application based on one or more model templates. Each model template may include specifications defining one or more specified machine learning models to be used, one or more inputs to be provided to the one or more specified machine learning models, at least one algorithm to be performed, and a scope of data to be processed using the one or more specified machine learning models.

The group of AI CRM applications may include an AI revenue forecasting application, an AI pricing optimization application, an AI next best application, an AI customer segmentation application, an AI CRM services application, an AI marketing application, and an AI customer satisfaction application.

Applying the one or more determined machine learning models and the one or more obtained data models may include packaging a set of features of model outputs that contribute to the predicted probabilities and transmitting the packaged set of features to a remote distributed system that applies the at least one of the one or more use case insights that optimizes the at least one of the one or more objectives of the selected AI CRM application.

Applying the one or more determined machine learning models and the one or

more obtained data models may include performing opportunity scoring. Performing the opportunity scoring may include, for each of a plurality of transaction opportunities, (i) using a first trained machine learning model to predict a probability that the transaction opportunity will be successfully completed; (ii) using a second trained machine learning model to predict a probable closing date for the transaction opportunity; and (iii) determining a probability that the transaction opportunity will be successfully completed by the closing date.

The type system of the model-driven architecture may include a metadata-based mapping framework over a plurality of data formats associated with a plurality of data sources.

Applying the one or more determined machine learning models and the one or more obtained data models may include calculating a lead score for a probability of each prospective customer to buy one or more products or services associated with the at least one of the one or more objectives of the selected AI CRM application.

Orchestrating the plurality of machine learning models may include proactively updating and maintaining the plurality of machine learning models with the curated CRM data independent of applying the one or more determined machine learning models.

Orchestrating the plurality of machine learning models may include updating at least one of the plurality of machine learning models or the curated CRM data based on output from applying the one or more machine learning models.

Using the predicted probabilities to apply the at least one of the one or more use case insights may include initiating one or more automated electronic communication actions including at least one of: scheduling a calendar event or virtual meeting with a customer; generating an electronic communication or social media posting; triggering an online digital marketing campaign; instructing a message for an automated chatbot; and pushing a digital alert message to a mobile device.

Using the predicted probabilities to apply the at least one of the one or more use case insights may include initiating one or more automated sales operation actions including at least one of: calculating one or more sales forecast metrices; customizing a product bundle or offering; autonomously generating one or more sales quotes; prioritizing one or more customers for service actions or sales efforts; performing a warranty or upgrade replacement; performing one or more recommendation functions based on predicting a customer satisfaction level; and providing one or more actionable recommendations for representatives to improve a likelihood that the representatives achieve the at least one of the one or more objectives of the selected AI CRM application.

Using the predicted probabilities to apply the at least one of the one or more use case insights may include initiating one or more automated data transmission operation actions including at least one of: transmitting a stream of optimized data to a remote data store or display; dynamically reconfiguring a website based on a specified use case insight; automatically executing a keyword purchase on a digital ad exchange; and adjusting one or more of the machine learning models or one or more of the data models.

Using the predicted probabilities to apply the at least one of the one or more use case insights may include initiating one or more automated reporting actions including at least one of: a recommendation, a score, a pricing, a prediction, a report, a real-time stream, and/or a dynamic graphical reporting interface.

Using the predicted probabilities to apply the at least one of the one or more use case insights may include recommending one or more preemptive actions to reduce customer churn based on the predicted probabilities.

The type system of the model-driven architecture may abstract domain-specific language (DSL) in order to access data from one or more exogenous data sources.

Employing the type system of the model-driven architecture may include performing data modeling to translate raw source data formats into target types. Sources of data may be associated with at least one of: accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance 30 logs, and service logs.

In a second embodiment, a method includes executing at least one of multiple CRM functions using one or more processors. Each CRM function is associated with and configured to use one or more trained machine learning models and one or more data models. The method also includes administering, using a model orchestrator, usage of the machine learning models and the data models based on (i) the at least one CRM function of the multiple CRM functions being executed and (ii) a specified use case associated with the at least one CRM function being executed. The method further includes generating evidence packages associated with predictions produced by the machine learning models, where each evidence package identifies features that contribute to the associated prediction generated by the associated machine learning model. In addition, the method includes providing one or more of the evidence packages as one or more inputs to at least one of the machine learning models.

Any single one or any suitable combination of the following features may be used with the second embodiment.

The method may further include generating a graphical user interface containing at least one of the evidence packages.

Each of one or more of the CRM functions may be associated with (i) a core machine learning model and one or more additional machine learning models and (ii) a core data model and one or more additional data models. The one or more additional machine learning models and the one or more additional data models may extend the core machine learning model and the core data model to one or more industry-specific functionalities. The model orchestrator may administer usage of the core machine learning model, the one or more additional machine learning models, the core data model, and the one or more additional data models for each of the one or more CRM functions.

One or more of the machine learning models may be configured to generate the predictions using (i) internal information of a company seeking to provide one or more products or services to customers and (ii) external information from outside the company. The method may further include using the one or more processors to provide a data handling function, where the data handling function obtains and curates the external information. The data handling function may receive and curate at least one of: streaming data, time-series data, batch data, social media data, financial data, relationship data, demographics data, news data, and customer data.

The method may further include using the one or more processors to perform a CRM engine function, where the CRM engine function performs inferencing using the machine learning models in order to perform the CRM functions.

The method may further include using the one or more processors to perform a command/output module function, where the command/output module function provides outputs based on the predictions. One or more outputs associated with a specified one of the CRM functions may be based on one or more objectives of the specified CRM function. The one or more outputs associated with the specified CRM function may include the evidence package associated with the prediction generated using the one or more machine learning models for the specified CRM function. The one or more outputs associated with the specified CRM function may include at least one of: a recommendation, a score, a pricing, a prediction, a report, a real-time stream, a dynamic graphical reporting interface, a marketing campaign, an adjusted model, and updated data.

Administering the usage of the machine learning models and the data models may include at least one of: identifying machine learning model templates for different use cases; training and retraining at least some of the machine learning models associated with the CRM functions; performing inferencing on data using the machine learning models; triggering computations of feature contributions and aggregate feature contributions into virtual-features; and creating actionable recommendations for representatives to achieve specified objectives.

Administering the usage of the machine learning models and the data models may include identifying machine learning model templates for different use cases and applying the one or more machine learning models associated with at least one of the CRM functions based on one of the model templates. Each model template may include a specification defining one or more specified machine learning models to be used, one or more inputs to be provided to the one or more specified machine learning models, at least one algorithm to be performed, and a scope of data to be processed using the one or more specified machine learning models.

Executing the at least one CRM function may include performing an opportunity scoring function by (i) using a first machine learning model to predict a probability that a transaction opportunity involving a customer will be successfully completed; (ii) using a second machine learning model to predict a probable closing date for the transaction opportunity; and (iii) determining a probability that the transaction opportunity will be successfully completed by the closing date. The closing date may be an arbitrary date or date range selected by a user.

Executing the at least one CRM function may include performing a precision revenue forecasting function by using a machine learning model to (i) predict a probability that each of multiple transaction opportunities involving customers will be successfully completed within a given timeframe (the probabilities predicted using information associated with individual transaction opportunities) and using the probabilities and deal sizes to generate a revenue forecast.

Executing the at least one CRM function may include performing a precision revenue forecasting function by generating at least one of: an aggregate revenue and a bookings prediction.

Executing the at least one CRM function may include (i) identifying a gap in a representative's revenue target for a given timeframe and (ii) identifying actionable opportunities to close the gap. The actionable opportunities may include transaction opportunities at risk, transaction opportunities able to be escalated from future timeframes, and new recommended transaction opportunities.

Executing the at least one CRM function may include performing a precision product/service forecasting function by at least one of (i) using a machine learning model to predict transaction volumes for specified products or services within a given timeframe and (ii) providing a demand forecast for likely products that are to be sold to customers in order to optimize product inventory to produce and deliver the products within the given timeframe.

Executing the at least one CRM function may include performing a next best offer or next best product determination function by using a machine learning model to predict one or more additional products or services that a particular customer is likely to obtain if offered.

Executing the at least one CRM function may include performing a churn management function by using a machine learning model to predict whether an existing customer is likely to cease being a customer completely or partially within a given timeframe.

Executing the at least one CRM function may include performing a churn management function by using a machine learning model to predict an aggregate likelihood of a group of existing customers ceasing to be customers completely or partially within a given timeframe.

Executing the at least one CRM function may include performing a relationship intelligence function by using a machine learning model to identify one or more direct or indirect relationships between a company and its customers and to evaluate connection strengths.

Executing the at least one CRM function may include performing a lead scoring function by using a machine learning model to identify a probability of a prospective customer purchasing at least one product or service if offered.

Executing the at least one CRM function may include performing a price optimization function by using a machine learning model to predict a price range that is acceptable to at least one customer and identify a most likely price point in the price range that the at least one customer will accept.

Executing the at least one CRM function may include performing a warranty or upgrade replacement function by using a machine learning model to predict whether one or more customers are likely to upgrade a product or service and prioritize the one or more customers for service actions or sales efforts.

Executing the at least one CRM function may include performing a marketing optimization function by using one or more machine learning models to predict which marketing activities are likely to increase revenue, analyze drivers of previous successful and unsuccessful marketing campaigns, and recommend marketing investments across potential campaigns.

Executing the at least one CRM function may include performing a customer satisfaction analysis function by using a machine learning model to analyze customers' sentiments about at least one of: a company, one or more products or services of the company, transaction opportunities involving the customers, and the customers' relationships with the company.

Executing the at least one CRM function may include performing a customer segmentation analysis function by using a machine learning model to segment or divide customers into groups with shared characteristics.

Executing the at least one CRM function may include performing a recommendation function by identifying sales or service actions in order to achieve one or more specified objectives.

Executing the at least one CRM function may include performing a recommendation function by predicting at least one of: a customer satisfaction level for each of multiple customers and customer satisfaction levels in aggregate.

Executing the at least one CRM function may include utilizing one or more of the machine learning models associated with one or more of the CRM functions to provide actionable recommendations for representatives to improve a likelihood that the representatives achieve specified objectives.

Executing the at least one CRM function may include utilizing inputs created through natural language processing.

Executing the at least one CRM function may include utilizing time-series data that includes internal and external information as time-aligned, normalized, and interpolated.

Executing the at least one CRM function may include using one or more of the machine learning models associated with one or more of the CRM functions to optimize pricing discounts for different products in different geographic areas or stores.

Executing the at least one CRM function may include using one or more of the machine learning models associated with one or more of the CRM functions to predict changes in customer loyalty.

Executing the at least one CRM function may include using one or more of the machine learning models associated with one or more of the CRM functions to optimize product configurations or product bundles based on predicted customer preferences associated with the product.

Executing the at least one CRM function may include using one or more of the machine learning models associated with one or more of the CRM functions to provide information to website clients regarding an Internet self-service navigation of a website.

Executing the at least one CRM function may include performing predictive relationship modeling by using a machine learning model to identify at least one of: (i) a best connecting path between a company and a customer, (ii) a recommendation regarding interaction with the customer using the best connecting path, and (iii) an estimated strength of a relationship between the company and the customer based on the best connecting path.

Executing the at least one CRM function may include performing predictive relationship modeling by using a machine learning model to identify and provide an interactive graphical representation of at least one of: (i) a hierarchy and structure of relationships between customers, representatives of a company, and external agents; (ii) a best connecting path between the company and one of the customers, (iii) a recommendation regarding interaction with the customer using the best connecting path, and (iv) an estimated strength of a relationship between the company and the customer based on the best connecting path.

Each method of the first and second embodiments may be implemented using at least one processor configured to perform the method, including any individual feature or any combination of features described above. Also, each method of the first and second embodiments may be implemented via a non-transitory computer readable medium storing computer readable program code that, when executed by one or more processors, causes the one or more processors to perform the method, including any individual feature or any combination of features described above.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting a model-driven software architecture providing an artificial intelligence (AI)-based customer relationship management (CRM) system according to this disclosure;

FIGS. 2A through 2D illustrate an example device, an example architecture, an example modular services component, and an example machine learning platform system supporting a model-driven software architecture providing an AI-based CRM system according to this disclosure;

FIG. 3 illustrates an example architecture supporting opportunity scoring, precision revenue forecasting, and precision product forecasting according to this disclosure;

FIG. 4 illustrates a more specific example architecture supporting opportunity scoring and precision revenue forecasting according to this disclosure;

FIG. 5 illustrates an example approach for implementing an opportunity-level machine learning model for use in an architecture supporting opportunity scoring and precision revenue forecasting according to this disclosure;

FIG. 6 illustrates an example conditional probability calculation by an opportunity-level machine learning model according to this disclosure;

FIGS. 7A through 7G illustrate example approaches for implementing an aggregate-level machine learning model for use in an architecture supporting opportunity scoring and precision revenue forecasting and example approaches for performing aggregations according to this disclosure;

FIG. 8 illustrates an example architecture supporting next best offer/product/action functionality and customer segmentation according to this disclosure;

FIG. 9 illustrates an example architecture supporting customer segmentation according to this disclosure;

FIG. 10 illustrates an example architecture supporting churn management, relationship intelligence, and AI customer satisfaction estimation according to this disclosure;

FIG. 11 illustrates an example architecture supporting relationship intelligence according to this disclosure;

FIG. 12 illustrates an example architecture supporting AI customer satisfaction estimation according to this disclosure;

FIG. 13 illustrates an example architecture supporting lead scoring according to this disclosure;

FIG. 14 illustrates an example architecture supporting opportunity/pricing optimization according to this disclosure;

FIG. 15 illustrates an example architecture supporting warranty and product upgrade replacement according to this disclosure;

FIG. 16 illustrates an example architecture supporting marketing optimization and trade promotion optimization according to this disclosure;

FIGS. 17A through 27 illustrate example user interfaces supporting AI-based CRM according to this disclosure;

FIG. 28 illustrates an example approach for extending AI-based CRM to a specific industry or other use case according to this disclosure; and

FIGS. 29 through 39 illustrate example use cases for AI-based CRM according to this disclosure.

### DETAILED DESCRIPTION

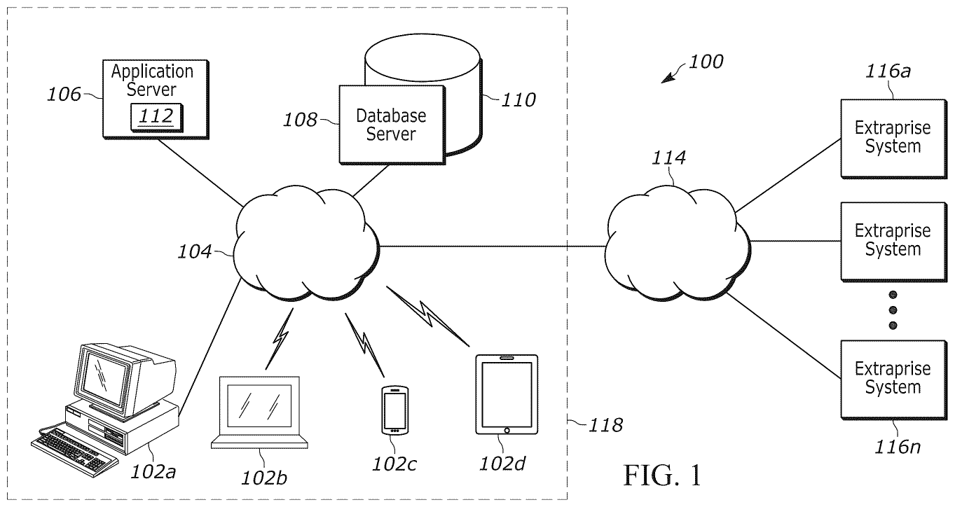

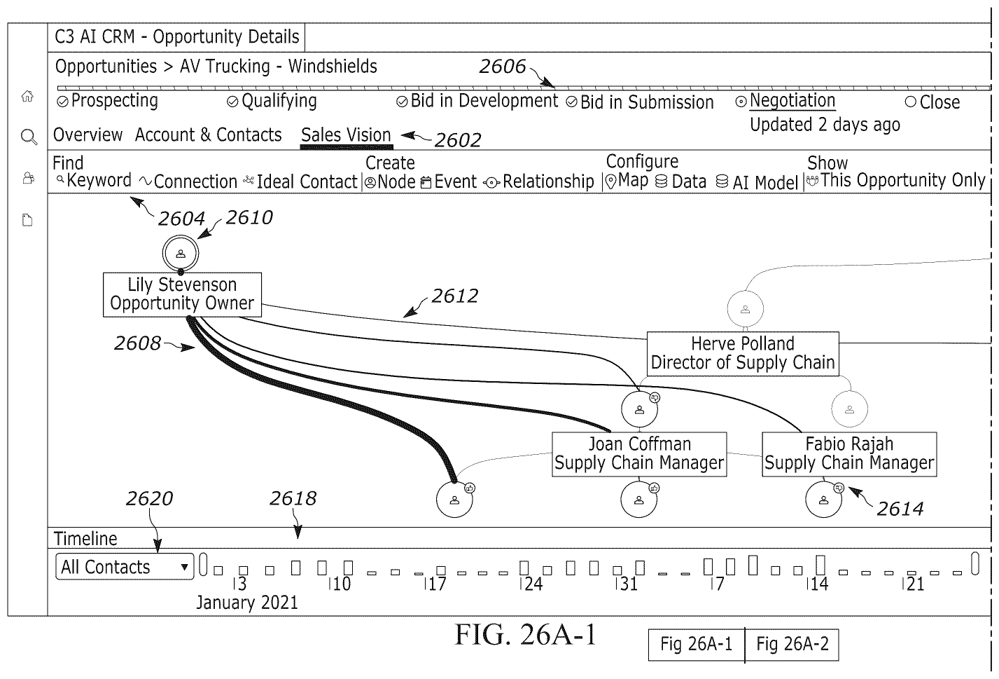

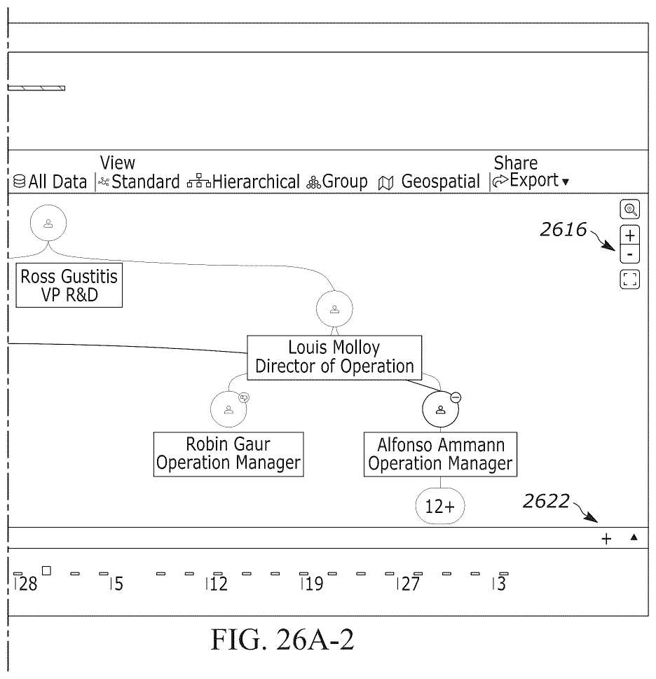

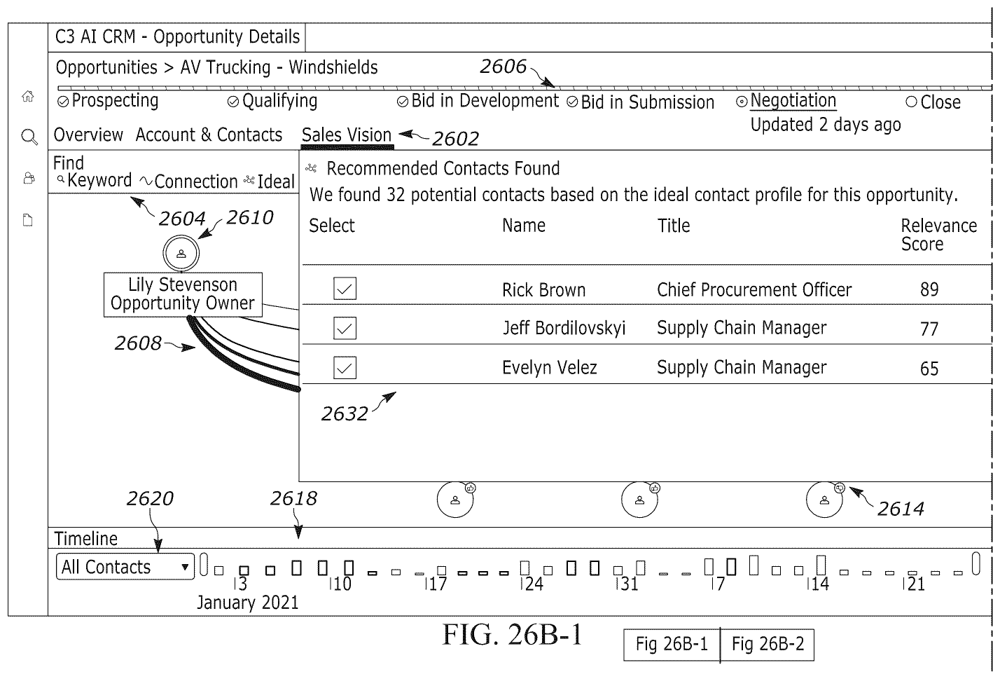

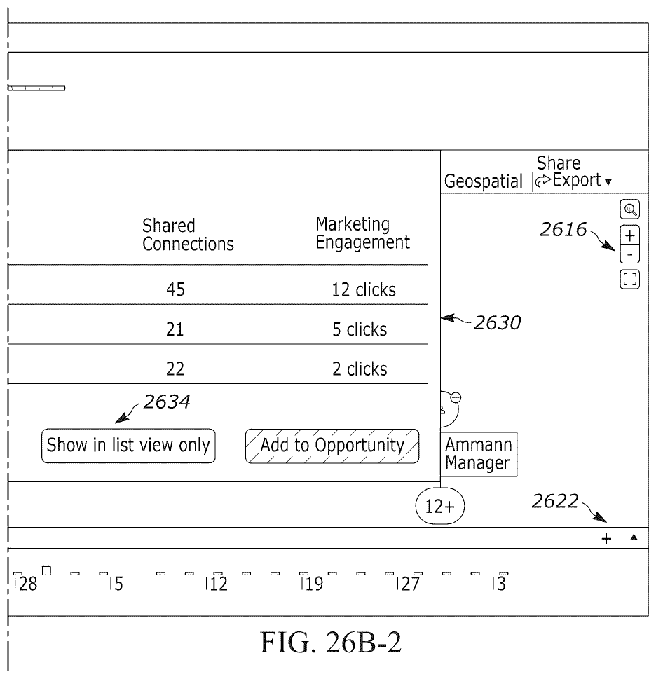

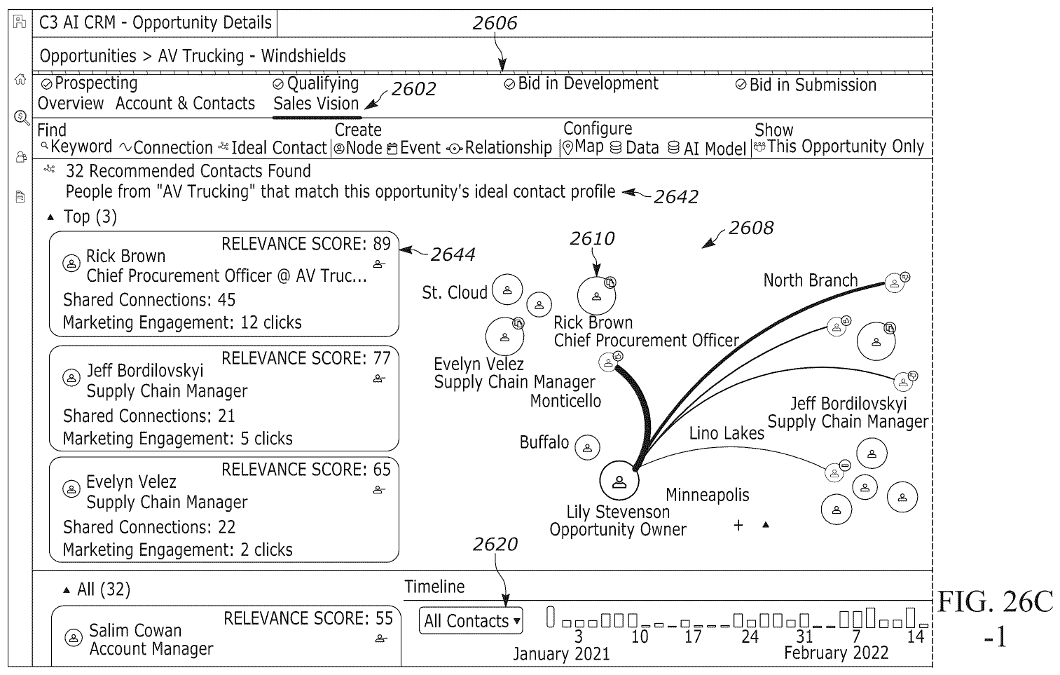

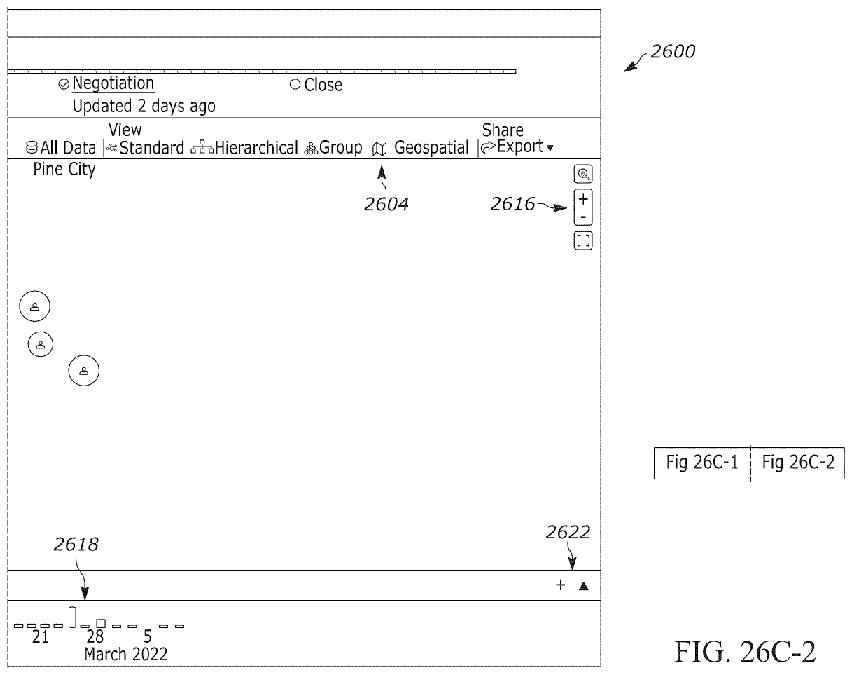

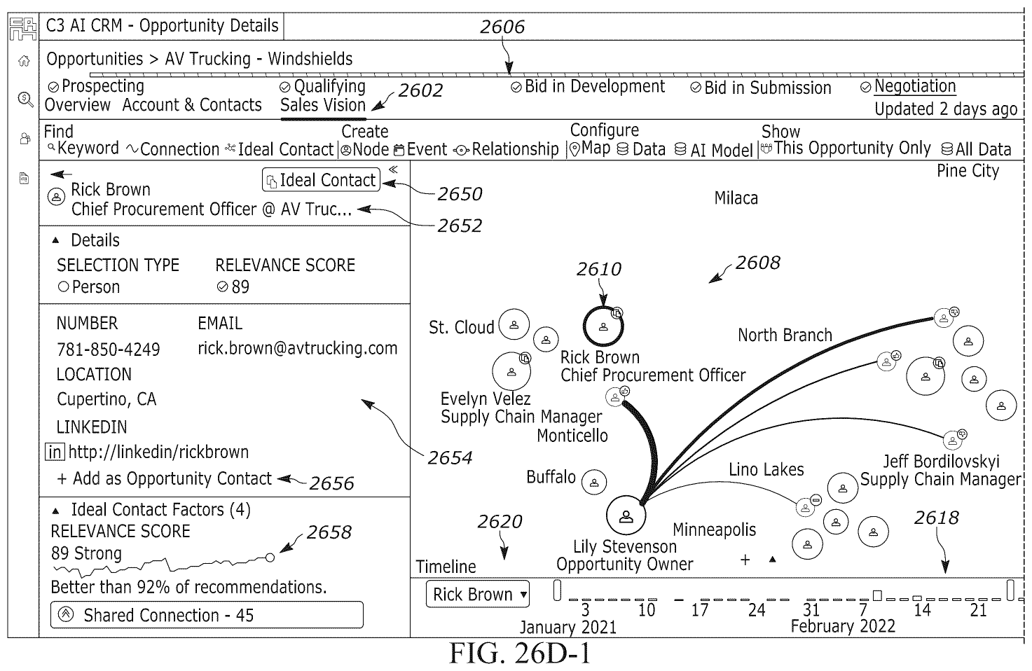

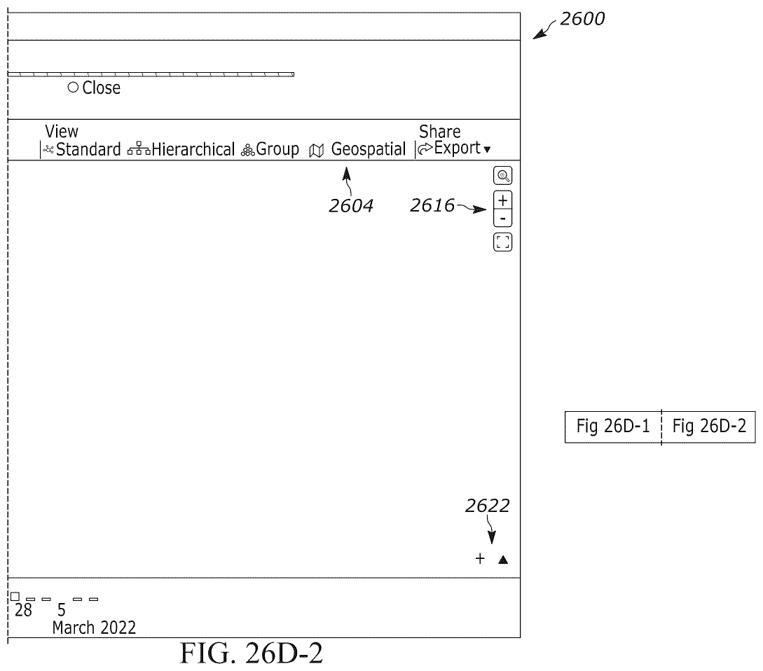

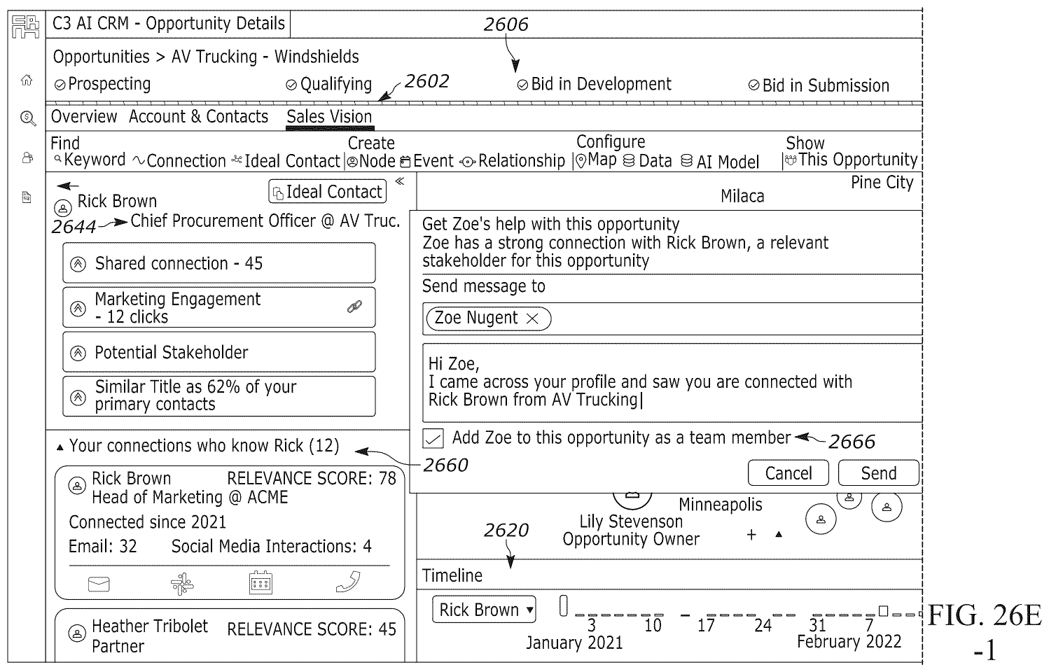

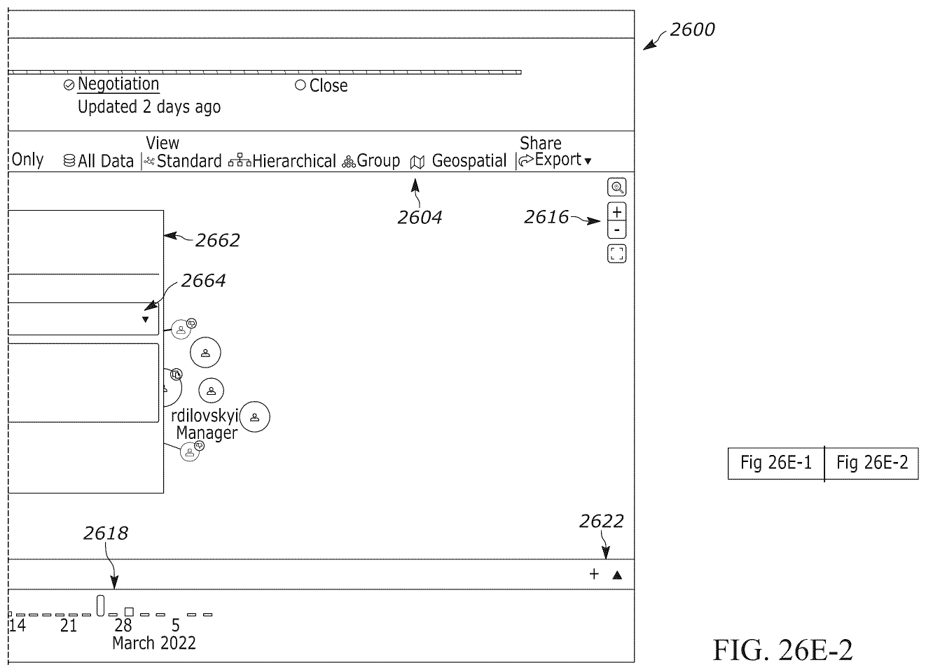

FIGS. 1 through 39, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

As noted above, customer relationship management (CRM) systems are used as a system of record for sales and other revenue-related opportunities, sales and other forecasts, and marketing, product, customer service, customer relationship history, and other information within and across organizations and markets. Sales, service, and marketing teams and other personnel use CRM systems to keep track of contacts, secure revenue, ensure progress against sales targets, service customers, manage marketing programs, deploy customer self-service systems, and perform other functions. Ideally, CRM systems can be used to help decision-makers increase revenue, maximize profits, increase customer satisfaction, increase customer retention, increase market share, and increase sales and service effectiveness within an organization.

Unfortunately, traditional CRM systems often rely primarily on erroneous human-entered predictions of outcomes (such as manually-entered estimated probabilities of winning sales opportunities), timing (such as estimates of close dates for transactions), or commitments (such as estimates of prospect engagements or customer satisfaction). As a result, traditional CRM systems often provide aggregations of the inaccuracies, biases, and deficiencies of judgments made by the humans providing the data, do not provide accurate estimates, and do not base predictions on other significant factors from enterprise and extraprise data sources. Enterprise and extraprise data sources may include or be associated with macroeconomic and microeconomic trends (such as equity prices, commodity prices, debt prices, unemployment rates, labor prices, news, social media trends, and gross domestic product (GDP) growth rates), the impacts of global events (such as pandemics, military conflicts, and government regulations), or recent customer-specific events (such as changes in customer management, poor quarterly earnings, or significant layoffs). These types of information may, for example, dynamically impact a prospect or customer's ability or intention to obtain one or more products/services or to continue as a customer of an organization.

This disclosure describes systems and methods that support the use of machine learning (ML) or other AI-based techniques to perform one or more CRM-related functions. The AI-based techniques can use various machine learning approaches to supplement manually-input traditional CRM data with a wide variety of additional enterprise data sources (such as Enterprise Resource Planning systems, Human Resource systems, and other enterprise software systems) and/or extraprise data sources (such as financial indices, commodity prices, equity prices, credit ratings, news, social media platforms, and business performance indicators like stock prices and analyst ratings) to generate more accurate CRM-related predictions. For example, an AI-based CRM system may use machine learning to predict (for each opportunity in a sales pipeline or other pipeline) the probability that the opportunity will close by a specified close date and revise that prediction dynamically as new information is collected or as previously-collected data changes or is updated, whether manually by a representative or dynamically from one or more enterprise and/or extraprise data sources. The AI-based system's machine learning approaches are also able to “self-learn” as the system recognizes patterns in the data (such as which factors are common in deals that close, the amount of a given transaction, or which customers churn) to update its own machine learning model(s) and use these machine learning insights as an additional exogenous factor (typically with some significance) in making future predictions. In this way, the described techniques allow for more accurate probabilities, forecasts, and other valuable AI CRM-related outputs to be produced.

In addition, rather than simply aggregating manual predictions and presenting them in aggregate like a traditional CRM system, an AI-based CRM system can use machine learning to identify the most important contributing factor or factors (such as positive and/or negative factors) to predicted probabilities, forecasts, and other CRM-related outputs, along with indications on magnitude and directionality of impact of each contributing factor. This functionality allows the AI-based CRM system to help users identify and understand its predictions at a more granular scale, enabling them to be more precise in their predictions (such as when providing quarterly revenue guidance to analysts or other constituencies, allocating resources to sales more efficiently, or providing more accurate product production scheduling), to be more nimble and accurate in their decision-making (such as when identifying key prospects, customers, or markets), or to focus their efforts on specific factors to influence desired outcomes in the CRM process (such as when choosing among options to increase revenue, profitability, or customer engagement/satisfaction or reduce customer churn), for example.

The following terminology is used in this disclosure. A person or an organization that implements or uses at least one device or system supporting AI-based CRM functionality may be referred to as a “company.” A company-affiliated end user of a device or system supporting AI-based CRM functionality may be referred to as a “sales representative,” “representative,” “customer service rep,” “rep,” “sales manager,” etc. Another person or organization that may buy, lease, or otherwise obtain one or more products or services from a company may be referred to as a “customer.” “Sales opportunities,” “opportunities,” “prospects,” or “leads” may be said to represent or be associated with possible, completed, or lost sales or other transactions between a company and its customers. More specifically, a “lead” may refer to a contact who has typically expressed some level of interest in at least one product or service being offered but who has not yet been qualified to determine if the contact fits an ideal customer persona or would benefit from using or otherwise obtaining the at least one product or service. A “prospect” may refer to a contact who has been qualified as an ideal customer and who would consider buying or otherwise obtaining at least one product or service. A “sales opportunity” or “opportunity” may refer to a qualified prospect with a high chance of closing a purchase, lease, or other transaction for at least one product or service.

A potential sale or other transaction between a company and a customer that has not been completed (as either a win or a loss) may be referred to as an “open” opportunity. A successfully-completed sale or other successfully-completed opportunity between a company and a customer may be referred to as being “sold,” being “successfully closed,” being a “win,” or having been “won.” An unsuccessful sale or other unsuccessful opportunity between a company and a customer may be referred to as having been “lost” or “cancelled.” Won and lost opportunities may be collectively referred to as “closed” opportunities. Opportunities can include “customer service cases” (“cases”) or “customer service tickets” (“ticket”), which describe instances where customers contact and interact with the company. In some instances, an opportunity can be “cancelled” or “withdrawn” in a way that is not treated as a closed and lost opportunity. Such opportunities can be filtered out (not used by machine learning models), such as when they represent accidental or duplicate entries not used for reporting or other purposes.

A “quota” may refer to a time-bound transaction target set by management for a particular region, team of representatives, or individual representative (quotas are often attached to a daily, monthly, quarterly, or other time period). Quotas can be measured in a number of different ways, including by profits, sales, or representative activity. The progress of an opportunity may be tracked over time, and an indicator that summarizes the progress of an opportunity may be referred to as a “sales stage,” “transaction stage,” or “stage.” There may be any number of stages depending on the company, and these stages are typically recorded and tracked in a CRM system. All prospects/opportunities that representatives are working on within a company may be referred to collectively as a “sales pipeline” or “pipeline.” In some cases, one or more pipelines can provide an overview of a representative's account forecast and how close the representative is to making quota, as well as how close a team as a whole is to reaching quota. “Forecast categories” may refer to different categories of information related to revenue forecasts or other forecasts being generated. Example categories may include pipeline (information is included in or associated with a pipeline), best case (information is included in or associated with “best case” opportunities or estimates), commit (information is included in or associated with opportunities in the process of being closed), omitted (information is not included in or associated with forecasts), and closed (information is included in or associated with closed opportunities). “Activities” in a CRM system may refer to actions that have happened and that have been identified by the system, such as new deals, contacts, opportunities, or messages from colleagues. A “snapshot” can capture how a pipeline or any individual opportunity looks at a particular point in time. “Churn” may refer to customers who stop acquiring, using, or otherwise obtaining a particular product/service or who stop acquiring, using, or otherwise obtaining all products/services. In some cases, churn can be expressed as a percentage of service subscribers who discontinue their subscriptions within a given time period (although other measures of churn are also possible and described below). “Sandbagging” may refer to the actions of a representative who holds back deals in order to undermine an associated forecast and lower management's expectations. A representative who engages in sandbagging typically closes or reports deals later to give the impression of overperformance, and a manager's job typically includes discovering and preventing sandbagging.

FIG. 1 illustrates an example system 100 supporting a model-driven software architecture providing an AI-based CRM system according to this disclosure. For example, the system 100 shown here can be used to support one or more CRM-related functions for at least one company, such as a sales organization, or a division or other portion of at least one company. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, a tablet computer, a wearable computer, etc. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other data processing or communication system or systems at one or more locations. In some cases, the network 104 may represent an internal or private network used by a sales company or other company. In other cases, the network 104 may represent or form a part of a cloud-based application platform, such as an AMAZON WEB SERVICES (AWS) platform, a MICROSOFT AZURE platform, or a GOOGLE CLOUD platform.

The application server 106 is coupled to the network 104 and is coupled to or otherwise communicates with the database server 108. The application server 106 supports one or more AI-based CRM functions, such as one or more of the AI-based CRM functions described below. For example, the application server 106 may execute one or more applications 112 that use data from the database 110 to perform one or more AI-based CRM functions. Note that the database server 108 may also be used within the application server 106 to store information, in which case the application server 106 may store the information itself used to perform one or more AI-based CRM functions. Also note that the functionality of the application server 106 may be physically distributed across multiple servers for various reasons, such as redundancy and parallel processing.

The database server 108 operates to store and facilitate retrieval of various information used, generated, or collected by the application server 106 and the user devices 102a-102d in the database 110. For example, the database server 108 may store various information related to sales opportunities and other sales- or transaction-related information that may be used during performance of one or more CRM functions. Note that the functionality of the database server 108 and the database 110 may be physically distributed across multiple database servers and multiple databases for various reasons, such as redundancy and parallel processing.

In this example, at least some of the information used by the application server 106 and/or stored in the database 110 may be received over at least one additional network 114 from one or more extraprise systems 116a-116n. For example, the network 114 may represent a public data network (such as the Internet) or other network that allows the one or more extraprise systems 116a-116n to provide information to and receive information from a company. As a particular example, the one or more extraprise systems 116a-116n may be used by the application server 106 or the database server 108 to obtain information such as financial indices, commodity prices, equity prices, credit ratings, news volumes and sentiments, social media content, and business performance indicators like stock prices and analyst ratings. At least some of this information may be stored in the database 110 and used by the application server 106 to perform one or more CRM functions. Thus, as described in more detail below, the database 110 may be used to store a wide range of enterprise data, such as histories, sales orders or other transactions, and inventory information. The database 110 may also be used to store a wide range of extraprise data. The extraprise systems 116a-116n here can therefore be distinguished from an enterprise system 118, which may include the various components and information used by the company. Information from outside of the organization associated with the enterprise system 118 may generally be referred to as “exogenous” data.

The application server 106 may perform any number of AI-based CRM functions. In the discussion below, specific examples of AI-based CRM functions are provided, and the application server 106 may support one, some, or all of the described functions. If some (but not all) of these AI-based CRM functions are supported by the application server 106, the application server 106 may support any desired combination of these AI-based CRM functions. The example AI-based CRM functions described below include opportunity scoring, precision revenue (or booking) forecasting, precision product forecasting, next best offer/product/action, churn management, relationship intelligence, lead scoring, opportunity/pricing optimization, warranty and product upgrade replacement, marketing optimization, trade promotion optimization, AI customer satisfaction, AI customer segmentation, AI recommendation, and AI evidence package functionality.

Opportunity scoring generally involves evaluating individual opportunities and determining a probability that a representative will win an opportunity within a given timeframe. Precision revenue forecasting generally involves estimating total revenue or bookings for an entity (such as an individual, a team of individuals, an entire company, or a portion thereof) within a given timeframe, which can be calculated as a standalone forecast or be based on aggregated probabilities that various individual opportunities will be won within the given timeframe. Precision product forecasting generally involves predicting sales volumes or other transaction volumes for one or more specific products or services within a given timeframe. Precision product forecasting may also provide a demand forecast for one or more products that are to be sold to customers, which can be used to help ensure that product inventory is prepared for delivery of a product after the conclusion of a transaction.

Next best offer/product/action generally involves estimating a propensity or likelihood of a new or existing customer to purchase or otherwise obtain one or more specific products or services, which can be used to make a first or subsequent offer to the customer or otherwise identify at least one action that be taken with respect to the customer. Churn management generally involves predicting whether particular customers of the company will remain customers of the company (either entirely or for one or more specific products/services) and generating recommendations for ensuring customer retention. Churn management can also or alternatively be used to predict whether particular employees or other personnel of the company will remain employed by or otherwise associated with the company. Relationship intelligence generally involves identifying personnel associated with existing or prospective customers and potential contacts or communication pathways for reaching or interacting with those personnel.

Lead scoring generally involves estimating a probability of closing any opportunity with a specific prospective customer. Opportunity/pricing optimization generally involves identifying prices or other offerings for one or more products or services that are likely to be accepted by specific customers, which can be used to increase or optimize revenue within a given timeframe. Warranty and product upgrade replacement generally involves estimating a likelihood of a customer upgrading or replacing at least one product or service within a given timeframe. Marketing optimization generally involves estimating characteristics of marketing activities (such as amounts of money to spend on marketing campaigns) and likely returns for those promotion activities, and trade promotion optimization refers to a specific type of marketing optimization.

AI customer satisfaction generally involves estimating customer sentiment regarding a company in general or regarding a current or prospective opportunity with the customer. AI customer segmentation generally involves segmenting or dividing customers into groups, such as to allow other functions to be performed for groups of customers. AI recommendation generally involves using machine learning to identify what action or actions users can take to achieve desired outcomes (in some cases, this functionality may also be referred to as or performed as a part of next best action). AI evidence package functionality generally involves identifying top contributing factors to CRM-related outputs generated using a machine learning algorithm, meaning the identification of reasons why a machine learning model makes a particular prediction and the impact of individual reasons on that particular prediction. As described below, it is also possible to provide AI model extensibility, which generally involves using industry-specific or other customized machine learning and data models to extend various functions described here with industry-specific or other customized functionalities.

The predictions produced by the application server 106 may be used in any suitable manner. For example, the predictions may be presented to one or more users, such as via one or more of the user devices 102a-102d. The one or more users may review the predictions, obtain and review explanations for the predictions, or perform other actions using the predictions. The predictions may also be used by the application server 106 or other device to automatically make recommendations to personnel about how to improve their individual performances or perform other remediating or other actions. In general, one or more AI-based CRM-related predictions produced by the application server 106 may be used in any suitable manner.

Although FIG. 1 illustrates one example of a system 100 supporting a model-driven software architecture providing an AI-based CRM system, various changes may be made to FIG. 1. For example, the system 100 may include any number of user devices 102a-102d, networks 104, 114, application servers 106, database servers 108, databases 110, and extraprise systems 116a-116n. Also, these components may be located in any suitable locations and might be distributed over a large area. Further, while the application server 106 is described above as executing one or more applications 112 to perform one or more CRM-related functions for a specific company, the application(s) 112 may be executed by a remote cloud computing system, server(s), or other device(s) and may or may not be used to make predictions for multiple companies. In some cases, for instance, different CRM-related functions described above as being performed by the application server 106 may be executed or otherwise performed using different servers or other distinct devices. In addition, while FIG. 1 illustrates one example operational environment in which one or more CRM-related functions may be used, this functionality may be used in any other suitable system.

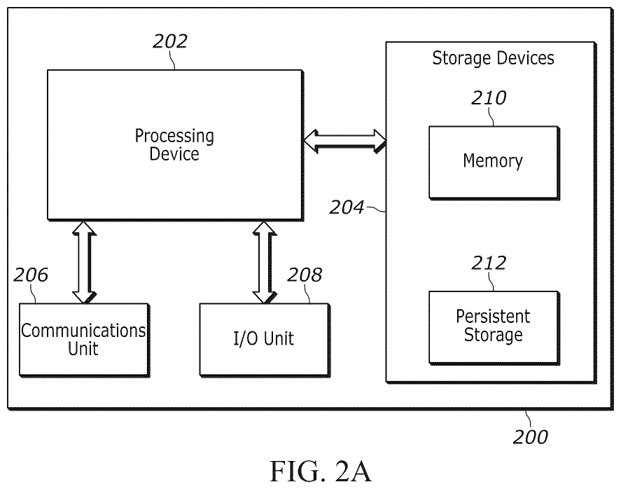

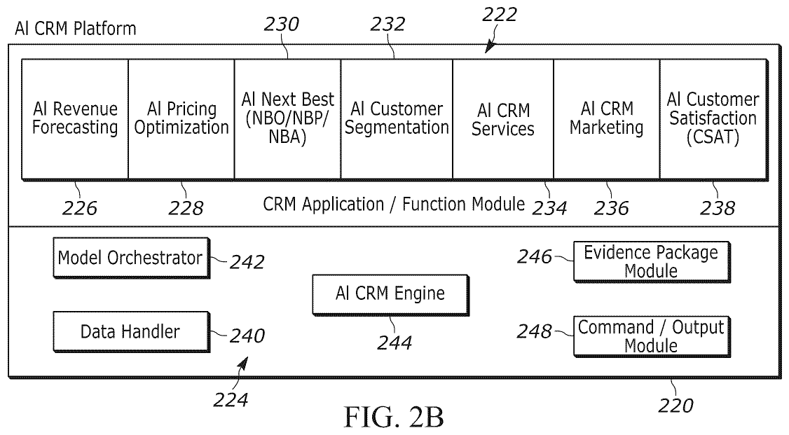

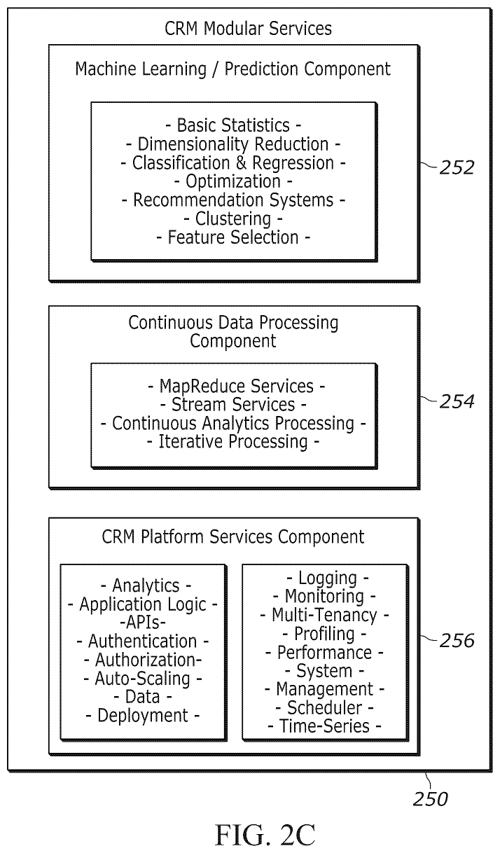

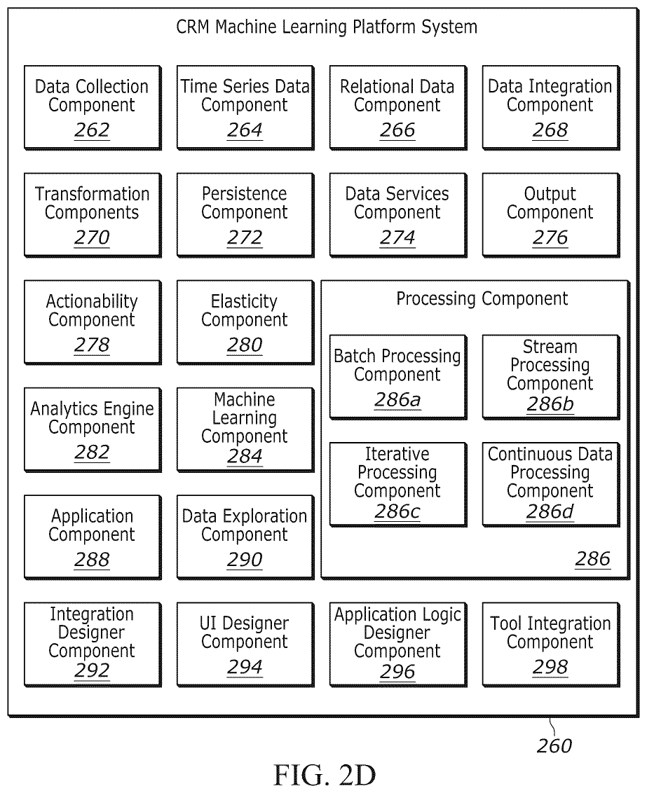

FIGS. 2A through 2D illustrate an example device 200, an example architecture 220, an example modular services component 250, and an example machine learning platform system 260 supporting a model-driven software architecture providing an AI-based CRM system according to this disclosure. One or more instances of the device 200 may, for example, be used to at least partially implement the functionality of the application server 106 of FIG. 1, such as by executing the various functions associated with one or more applications 112. Also, the architecture 220, modular services component 250, and machine learning platform system 260 may be supported by the device(s) 200 implementing the functionality of the application server 106. However, the functionality of the application server 106 may be implemented in any other suitable manner. In some embodiments, the device 200 shown in FIG. 2A may form at least part of a user device 102a-102d, application server 106, database server 108, or extraprise system 116a-116n in FIG. 1. However, each of these components may be implemented in any other suitable manner.

As shown in FIG. 2A, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104 or 114. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

As shown in FIG. 2B, the architecture 220 includes a number of functions supporting AI-based CRM. In this example, these functions are divided roughly into two groups of functions, namely AI-based CRM functions 222 and supporting or management functions 224. The AI-based CRM functions 222 represent or involve the use of trained machine learning models and other AI-based functionality to implement AI-based CRM. For example, the AI-based CRM functions 222 here include an AI-based revenue forecasting function 226, an AI-based pricing optimization function 228, an AI-based next best offer/product/action (NBO/NBP/NBA) function 230, an AI-based customer segmentation function 232, an AI-based CRM services function 234, an AI-based CRM marketing function 236, and an AI-based customer satisfaction (CSAT) function 238. Operations that may be performed as part of each of these functions 226-238 are described below in more detail. Overall, each of these functions 226-238 can use one or more trained machine learning models to generate insights with respect to one or more specified objectives (which can vary depending on the use case and the specific function 226-238 being performed). Note that while a specific collection of functions 226-238 is shown in FIG. 2B, other implementations of the architecture 220 may include one or more additional functions and/or omit one or more of the functions 226-238 shown in FIG. 2B.

The supporting or management functions 224 generally represent functions that can be used by or with multiple ones of the functions 226-238, so these functions 224 are generally viewed as being used to support or manage the functions 226-238. In this example, the supporting or management functions 224 include a data handler function 240, a model orchestrator function 242, an AI-based CRM engine function 244, an AI-based evidence package module function 246, and a command/output module function 248. The data handler function 240 generally operates to curate CRM-related information that is used, generated, or collected by the architecture 220. For example, the data handler function 240 can curate CRM-related information that is mined or otherwise obtained from one or more enterprise data sources and/or one or more extraprise data sources for use with one or more of the functions 226-238. In general, the types of data sources from which information is obtained and how the obtained information is processed, stored, and curated can vary widely depending on the data source(s) and the information being used (such as which function or functions 226-238 are being performed).

The model orchestrator function 242 generally operates to administer usage of a number of machine learning models (possibly including a very large number of machine learning models) in order to implement the specific AI-based function or functions 226-238 to be performed. For example, the model orchestrator function 242 may receive information that identifies the type of machine learning model to be run in the architecture 220. The model orchestrator function 242 may also evaluate specified metrics over a specified timeframe, load one or more appropriate machine learning models, make predictions for appropriate source objects (such as opportunities or business units depending on the use case), run the model or models' interpretation technique(s), convert SHapley Additive explanations (SHAP), geo-visualize, or other feature contributions into human-readable interpretations, and generate suitable information for users. As a particular example of this, as described in more detail below, it is possible to use core and/or industry-specific machine learning models when performing one or more AI-based CRM functions 222, and the model orchestrator function 242 can be configured to select the appropriate machine learning model(s) according to the AI-based function(s) 226-238 to be performed and the entity for which the AI-based function(s) 226-238 will be performed.

In some cases, the model orchestrator function 242 may also be used to train or retrain (if needed) one or more machine learning models used by one or more of the functions 226-238, such as through the use of historical data. The training or retraining of one or more machine learning models may occur asynchronously (such as when needed) or on a schedule (such as every month or at another specified interval). The model orchestrator function 242 may further be used to perform inferencing using live data with one or more trained machine learning models (either asynchronously or on a schedule, such as every day or at another specified interval). In some cases, the machine learning models can be proactively updated and maintained using curated CRM data, which may occur independent of applying the machine learning models during inferencing. Also, in some cases, at least one of the machine learning models or the curated CRM data may be updated based on output from applying the machine learning models. Moreover, the model orchestrator function 242 may compute feature contributions and aggregate them into virtual-features for presentation to users. In addition, the model orchestrator function 242 may create actionable recommendations for representatives to improve their machine learning scores to thereby improve their chances of achieving specified objectives (such as closing an opportunity or mitigating churn risk). Overall, the model orchestrator function 242 may perform a wide variety of functions related to machine learning models. These functions may broadly include operations such as labeling of training data, feature extraction using machine learning models, scoring of machine learning model outputs, training/retraining of machine learning models, validation of trained machine learning models, inferencing using trained machine learning models, normalization or merging of machine learning model outputs, snapshotting of machine learning models, optimization of machine learning models, and refactoring of machine learning models. In some cases, these functions can be based on one or more data models associated with the AI function(s) to be performed.

In addition, in some cases, the model orchestrator function 242 may be responsible for identifying at least one machine learning model template to be used for each CRM use case (such as templates for opportunity scoring, precision revenue forecasting, next best offer/product/action identification, and churn prediction). A machine learning model template that is selected by the model orchestrator function 242 may include one or more features, one or more algorithms, one or more scoring metrics, or one or more other characteristics. As a particular example of this, a template associated with a particular use case can identify one or more inputs to be provided to one or more machine learning models. In some embodiments, the one or more inputs may include one or more required inputs and one or more optional inputs. The one or more optional inputs may represent one or more inputs that can potentially be filtered during operation of a machine learning model, such as through feature selection. The one or more required inputs may represent one or more inputs that are not filterable. At least one algorithm for the particular use case can also be defined in the template, where at least one algorithm can define logic to be executed (such as logic for using one or more machine learning models). The template can further identify which machine learning model or models are to be used for the particular use case and the scope of the data to be processed using the machine learning model(s), such as by defining which opportunities and/or user accounts will be considered by a machine learning model. Overall, the model orchestrator function 242 may treat each template as a specification defining how a use case can be implemented, and the model orchestrator function 242 can use one or more appropriate machine learning models to process data and generate one or more scores, probabilities, forecasts, pricing optimizations, next best identifications, or other type(s) of AI-based result(s).

Note that it is possible to define and use multiple templates (even ones that process the same opportunities or other common input data) to obtain different AI-based CRM-related insights, such as when different templates involve the performance of different AI-based CRM functions 226-238 or when different templates involve defining how often machine learning models are subjected to retraining or used for inferencing purposes (like when retraining is defined to occur less frequently and inferencing is defined to occur more frequently). In addition, different templates may be used here to define which historical data is used during training/retraining of different machine learning models and to (optionally) define how different versions of a single machine learning model may be created and managed. In some cases (such as when the architecture 220 is used by a company that has data science expertise), experts or other users can create their own templates, such as by modifying pre-built templates that already exist or by creating new templates. This extensible nature of the framework allows different users or companies to tune templates to their own unique needs.

The AI-based CRM engine function 244 generally operates to receive one or more machine learning models associated with each function 226-238 and to perform inferencing using the various machine learning models in order to support the function 226-238. For example, the CRM engine function 244 may process information obtained by the data handler function 240 using one or more machine learning models to generate probabilities for insights with respect to one or more specified objectives associated with an AI-based function 226-238. This may occur for each of the AI-based functions 226-238 being executed. As particular examples, the CRM engine function 244 may be used to generate scheduled, triggered, or real-time predictions using one or more machine learning models to optimize the objective or objectives of one, some, or all of the AI-based functions 226-238.

The AI-based evidence package module function 246 generally operates to capture features (such as model input variables) that contribute to predicted probabilities or other outputs produced by the AI-based CRM engine function 244. That is, the AI-based CRM engine function 244 may operate by using one or more machine learning models to generate probabilities of certain results or other outputs, and these outputs are typically based on features extracted from input data by the machine learning pipeline. Feature importance refers to techniques that calculate a score for all or a subset of the input features for a given model, and the scores may represent the “importance” or contribution of each feature in predicting model outputs. A high feature importance score can indicate that the specific feature or model input has a larger or greater effect on the model that is being used to predict a certain calculated output value, and a low feature importance score can indicate that the specific feature or model input has a smaller or lesser effect on the model that is being used to predict a certain calculated output value. Additionally, an AI evidence package can include identified input variables (such as features), an importance score associated with each identified input variable, and one or more metrics (such as historical versions, time-series data, etc.) for at least one of the identified input variables. For example, GDP of the current year may be an input variable to a model of logistic regression, an importance score associated with the GDP of this year can be a numerical value (such as a ranking, weighting, etc.), and metrics can include other versions of the input variable such as the average GDP for a prior year. Based on a set of importance scores for a specific model, the features, and the relevant statics, an AI evidence package for a specific model can be generated. In some embodiments, multiple AI evidence packages for different models (or approaches to models) can be combined on a dashboard. Also, in some implementations, importance scores can be used to display the highest-ranked subset of features that contribute to model results in view of dashboard configurations.

The AI-based evidence package module function 246 can identify the primary feature or features that cause a specific probability or other output to obtain its current value, such as by identifying one or more features that positively or negatively affect the output value and to what extent. The AI-based evidence package module function 246 can provide the identified feature(s) as an explanation of the calculated output value. From most interpretable machine learning models, an AI evidence package can include an extracted explanation that implicitly contrasts a prediction of an instance with a prediction of an artificial data instance or an average of instances. For example, if an output value is 90% and a baseline is 50% with a primary feature contributing 30% to the output value, the AI evidence package may indicate the contribution distribution. In other examples, a tree model may identify which feature makes a primary contribution to a model. Identified features can be used as part of complete, partial, contrastive, or other explanations. In other embodiments, importance scores can represent the extent to which features caused a model to either increase or decrease its output by a specific amount. For instance, the GDP of the current year may cause the model to increase a bookings forecast made today by $15.6 million. In that situation, the importance score of the GDP feature could be $15.6 million, or it could represent the percent increase from a baseline prediction. In such an example, features can be presented in a user interface along with numbers that represent the extent to which each feature increases or decreases the model prediction. Other graphics-based techniques may replace numbers to indicate a large increase (such as two up arrows) or small decrease (such as one down arrow) along with the feature.

The identified feature(s) affecting a calculated output value can be said to represent an “evidence package,” and an evidence package can be generated for any number of calculated probability values or other output values. One or more evidence packages may be presented to at least one user, presented in association with one or more related outputs generated by at least one machine learning model, used as one or more inputs to one or more machine learning models or other CRM-related application(s)/logic (including one or more machine learning models used for other CRM or non-CRM purposes), or used in any other suitable manner.

AI evidence packages can be output based on configurable settings associated with a particular use case, dashboard, actionability, etc. In some examples, certain input variables may be prioritized or de-prioritized based on the configuration settings. In other examples, particular input variables can be selected based on actionability logic. For example, a feature related to GDP growth with a high importance score but no recommendation may be deprioritized for a feature related to a customer recommendation. As a particular example, the customer recommendation may be prioritized for display on a dashboard, report, action plan, etc. to aid a specified outcome over the GDP growth feature with a higher importance score. In some implementations, action logic can be triggered by an AI evidence package to automate using the predicted probability in order to apply a use case insight that optimizes one or more specific objectives. For instance, the prioritized customer recommendation can be used to trigger actionability logic that causes an automated electronic communication to optimize customer loyalty or achieve some other result.

The command/output module function 248 generally operates to provide one or more outputs associated with performance of one or more AI-based CRM functions 222, such as one or more outputs from the AI-based CRM engine function 244 and/or from the AI-based evidence package module function 246. For example, the command/output module function 248 can generate outputs that are associated with the specified objectives of various AI-based CRM functions 226-238 being executed, and the outputs may include information based on the AI evidence packages generated for those specified objectives. The outputs that are generated by the command/output module function 248 can have various forms depending on the AI-based CRM functions 226-238 being performed and the use case. For instance, example types of outputs may include predictions of future events, recommendations for actions to be performed or pricing to be used, probabilities or other scores associated with predictions or recommendations, or updated/retrained/adjusted machine learning models or updated data. The outputs can also be presented in various ways depending on the AI-based CRM functions 226-238 being performed and the use case, such as when the outputs are used in graphical user interfaces, reports, or marketing campaigns. The outputs can further be provided in any suitable manner, such as via electronic communications/transmissions like via an application program interface (API), a real-time stream, or a dynamic graphical reporting interface.

As a particular example, one or more automated electronic communication actions may be triggered. Examples of automated electronic communication actions may include scheduling a calendar event or virtual meeting with a customer, generating an electronic communication or social media posting, triggering an online digital marketing campaign, instructing a message for an automated chatbot, or pushing a digital alert message to a mobile device. As another particular example, one or more automated sales operation actions may be triggered. Examples of automated sales operation actions may include calculating one or more sales forecast metrices, customizing a product bundle or offering, autonomously generating one or more sales quotes, prioritizing one or more customers for service actions or sales efforts, performing a warranty or upgrade replacement, performing one or more recommendation functions based on predicting a customer satisfaction level, or providing one or more actionable recommendations for representatives to improve a likelihood that the representatives achieve the at least one specified objective. As yet another particular example, one or more automated data transmission operation actions may be triggered. Examples of automated data transmission operation actions may include transmitting a stream of optimized data to a remote data store or display, dynamically reconfiguring a website based on a specified use case insight, automatically executing a keyword purchase on a digital ad exchange, or adjusting one or more of the machine learning models or one or more of the data models.

As shown in FIG. 2C, the modular services component 250 represents a design that can be used to support the use of modular services or other components to implement the architecture 220 or other model-driven software architecture for CRM. As shown in FIG. 2C, the modular services component 250 includes a machine learning/prediction component 252, a continuous data processing component 254, and a CRM platform services component 256. The modular services component 250 generally provides native predictive capabilities through the power of machine learning. As described throughout this disclosure, a large amount of information can be obtained and made available to machine learning models for use in performing various CRM-related functions. Hidden in the interrelationships of these big data sets are insights that can improve understandings of customer behaviors, customer interactions, and ways to optimize company operations. Identifying these insights may involve the use of advanced machine learning data processing tools to help companies and representatives discover, analyze, and understand the relationships that exist in the large amounts of available data. The components 252-256 support the use of machine learning, which enables the development of self-learning algorithms and analytics. For example, the components 252-256 may leverage cloud technologies or other technologies to aggregate and process all of the enterprise, extraprise, and other data into a unified, federated cloud image for analysis. Advanced machine learning techniques can be employed to continuously improve analytic algorithms and generate increasingly-accurate results.

The machine learning/prediction component 252 is configured to provide multiple prediction and machine learning processing algorithms, such as the various AI-based CRM functions 222 described above. These prediction and machine learning processing algorithms can involve various types of operations or functions, such as one or more of basic statistics, dimensionality reduction, classification and regression, optimization, recommendations, clustering, and feature selection. The machine learning/prediction component 252 integrates state-of-the-art machine learning techniques to allow the architecture 220 to learn directly from massive data sets. Machine learning broadly refers to a class of algorithms that make inferences and build prediction mechanisms directly from data. While traditional analytics typically focus on hand-coded program logic, machine learning takes a different, data-driven approach. Rather than manually specify analytics, machine learning algorithms look at a large amount of “raw” data signals and automatically learn how to combine these signals in the appropriate manner that captures this predictive ability in a much more direct and scalable manner.

In some embodiments, the machine learning/prediction component 252 enables close integration of machine learning algorithms in several ways. For example, the machine learning/prediction component 252 may closely integrate with industry-standard or other interactive data exploration environments, such as C3 AI EX MACHINA, IPYTHON, RSTUDIO, or other suitable platforms. This allows users to explore and understand their data directly inside the platform without the need to export data from a separate system or operate only on a small subset of available data. As another example, the machine learning/prediction component 252 may contain a suite of state-of-the-art machine learning libraries, such as public libraries like those built upon APACHE SPARK, R, PYTHON, or other systems. The machine learning/prediction component 252 may also include custom-built, highly-optimized, and parallelized implementations of many standard machine learning algorithms, such as generalized linear models, orthogonal matching pursuit, and latent variable clustering models. Together, these tools allow developers to use tools that they are familiar with in data science and to use and deploy large-scale machine learning applications directly inside a platform.

Using these tools, companies, developers, or users can quickly apply machine learning algorithms to any data source contained within a platform. By providing a single platform for data storage, processing, and machine learning, the platform enables users to easily deploy industry-leading predictive modeling applications. In some embodiments, the machine learning/prediction component 252 may be configured to perform at least some machine learning algorithms against data via types or an abstraction layer (which may be provided by the data handler function 240). In particular embodiments, machine learning algorithms may be performed using any processing paradigm provided by the continuous data processing component 254, which is discussed in more detail below. For example, performing machine learning using the different available processing paradigms can lead to great flexibility based on the needs of a particular platform and may even improve machine learning speed and accuracy. Companies or developers may not need to get an understanding of the low-level details of machine learning and can leverage these built-in tools for powerful and efficient tools.

The continuous data processing component 254 is configured to provide processing services and algorithms to perform calculations and analytics against persisted or received data. For example, the continuous data processing component 254 may analyze large data sets including current and historical data to create reports and new insights. In some embodiments, the continuous data processing component 254 provides different processing services to process stored or streaming data according to different processing paradigms. These processing and analysis algorithms can involve various types of operations or functions, such as one or more of map reduce services, stream services, continuous analytics processing, and iterative processing. Also, the data that is processed here may be processed in any suitable forms, such as by performing batch processing or streaming data processing.

In some embodiments, batch or other analytics processing performed by the continuous data processing component 254 can utilize map reduce, which is a best-practice programming model for improving the performance and reliability of processing-intensive tasks through parallelization, fault-tolerance, and load balancing. A map reduce processing job splits a large data set into independent chunks and organizes them into key-value pairs for parallel processing. This parallel processing improves the speed and reliability of the cluster, returning solutions more quickly and with greater reliability. Map reduce processing utilizes a map function that divides input based on the specified batch size and creates a map task for each batch. An input reader distributes those tasks to worker nodes to perform reduce functions. The output of each map task is partitioned into a group of key-value pairs for each reduce. The reduce function collects various results and combines them to answer the larger problem that the job needs to solve. Map output results are “shuffled,” which means that the data set is rearranged so that the reduce workers can efficiently complete the calculation and quickly write results to storage. Batch processing services, such as map reduce, may be used on top of the types of a data abstraction layer.

Also, in some embodiments, the continuous data processing component 254 may stream process data, such as by processing a stream of data from one or more data sources. The continuous data processing component 254 may provide stream processing services for large volumes of high-velocity data in real-time. Stream processing may be beneficial for scenarios requiring real-time analytics, machine learning, and continuous monitoring. For example, stream processing may be used for real-time customer service management and operational dashboard generation. In some cases, stream processing may occur after data has been received and before or after it has been loaded into a data store and/or abstracted by an abstraction layer. For example, stream processing may be performed at or within a head-end system that processes incoming messages from data sources. Initial processing, such as detecting whether a value is within a desired window, may be performed and warnings, notifications, or flags may be created based on whether the value is within the window. Thus, stream processing may provide extremely fast real-time processing of data as it is received, which may be helpful for certain deployments where it may be undesirable or detrimental to wait until data has been fully integrated. Also, in some cases, at least a portion of stream processing may be performed at or near an edge of a network. For instance, devices or systems that include an edge analytics component may perform some analytical operations or calculations to reduce a processing load on workers or servers of the system. In addition, in some cases, a concentrator, sensor, or smart device may detect whether a value is within a desired value window (such as a range of values) and create warnings, notifications, or flags based on whether the value is within the window.

In some embodiments, the continuous data processing component 254 may provide multiple features that are beneficial for real-time data processing workloads, such as scalability, fault-tolerance, and reliability. For example, the continuous data processing component 254 may provide scalable stream processing by performing parallel calculations that run across a cluster of machines. The continuous data processing component 254 may provide fault-tolerant operation by automatically restarting workers or worker nodes when they fail or die. The continuous data processing component 254 may provide reliability by guaranteeing that each unit of data will be processed at least once or exactly once. In some cases, the continuous data processing component 254 only replays messages when a failure occurs.

In some cases, the continuous data processing component 254 may use stream services that provide for development and run-time environment of evaluating analytic functions in real-time. In some embodiments, these analytics can be expressed as functions with a loophole for accessing small amounts of data from a data services layer (such as account status). In many instances, a stream service may take one data stream as input and may produce another data stream as output for downstream consumption. Thus, multiple processing layers for the input stream may enable sophisticated real-time analytics on streaming data.

In some embodiments, the continuous data processing component 254 is configured to perform continuous analytics processing. Stream processing may have some limitations because not all data, or only limited data, may be available for stream processing. For example, during stream processing, the streaming data may not yet have been stored by the data handler function 240 and thus may not be in a correct format, may not be accessible via types in an abstraction layer provided by the data handler function 240, and/or may not be associated with relational data or other data that has been stored in one or more data stores. For these reasons, stream processing may be limited to certain processing operations that do not require the abstraction layer, relational data, or data that has already been placed in a data store.

Continuous analytics processing allows for real-time or near real-time processing based on all data and/or based on types abstracted by the data handler function 240. In some embodiments, the continuous data processing component 254 is configured to detect changes, additions, or deletions of data in one or more data sources. For example, the continuous data processing component 254 may monitor data corresponding to analytics for which continuous analytics processing should be performed and initiate processing of a corresponding analytic when that data changes. In some embodiments, the continuous analytics processing may recalculate a metric or analytic based on the changed data. The results of the recalculation may be stored in a data store, provided to a dashboard, included in a report, or sent to a user or an administrator as part of a notification. Also, in some embodiments, the continuous analytics processing may use map reduce, iterative processing, or any other processing paradigm to process the data when a change in data is detected. In addition, in some embodiments, continuous analytics processing may perform processing for only a sub-portion of an analytic. For instance, some calculations may be updated based only on a changed or new value and, thus, not all calculations that go into an analytic may need to be recalculated. Only those that are impacted by the change may be recalculated to save resources and time.

In some embodiments, the continuous data processing component 254 is configured to perform iterative processing. Iterative processing can be used to perform processing or analytics that are not well addressed by either batch (such as map reduce) or stream models. This class of workflows is referenced as iterative because the processing may involve visiting data multiple times, frequently across a wide range of data types. As an example, the continuous data processing component 254 may use a simple technique, such as clustering and iterating repeatedly through data, to predictively identify opportunities within at least one business unit with high likelihoods of closing successfully. Batch processing does not provide a solution to this type of problem because the task cannot be easily broken down into sub-tasks and then merged together for map reduce.

Rather than horizontally scale the processing (matching it to the data), iterative processing both horizontally scales the processing and keeps the data in memory (or provides the appearance of keeping the data in memory) across a cluster. This makes techniques that involve repeatedly iterating through vast amounts of data possible. The APACHE SPARK project is one example of an implementation of an iterative processing model and provides for abstraction of an unlimited amount of memory over which processing can iterate. In some embodiments, APACHE SPARK is implemented by the continuous data processing component 254 on a service platform to allow ad-hoc processing and machine learning algorithms to run in a natural way. Also, in some embodiments, the iterative processing services, such as an adapted APACHE SPARK implementation, are adapted to run on top of abstracted models defined by the data handler function 240. Iterative processing on top of an abstraction layer provides a very powerful and easy to use tool for companies and/or developers.

Each of the different processing paradigms (batch, stream, continuous analytics, and/or iterative processing) may be implemented on top of the types or abstraction layer provided by the data handler function 240. Use of the abstraction layer removes the need of a developer to understand specific data formats, storage details, or the like while still obtaining results of processing according to time demands or other processing or business needs.

The CRM platform services component 256 provides a plurality of services built-in to a CRM application development platform, such as the machine learning platform system 260 of FIG. 2D. The services provided by the platform services component 256 may include one or more of analytics, application logic, APIs, authentication, authorization, auto-scaling, data, deployment, logging, monitoring, multi-tenancy applications, profiling, performance, system, management, scheduler, and/or other services. These services may be used or accessed by other components of a system and/or applications built on top of the system. For example, applications may be developed and deployed more quickly and efficiently using services provided by the platform services component 256 and other components of the system.

In some embodiments, developing application logic or using already-available logic enables the development of complex applications and application logic that leverages other portions or services, such as map reduce, stream processing, batch updates, machine learning, or the like. Also, in some embodiments, an application layer of the system leverages various libraries (such as open libraries) as well as type models in a type layer or data abstraction layer. These built-in features enable development using fewer lines of code, less debugging, and better performance so that companies and developers can make better applications in less time, leading to significantly reduced costs. In some embodiments, REST bindings provided by the platform services component 256 enable the use of HTTP verbs (such as POST, GET, PUT, and DELETE), extends a set of resources that may be targeted by a URL, and allows header-based selection of multiple representations of content, all of which serve to phrase the API in a more REST-friendly way. This is because the API calls often require a URL to specify the location from which the data will be accessed.

In some embodiments, the platform services component 256 may enable developing applications that have a tiered application architecture. For example, some application functionality, analytics, and data structures may be implemented through type definitions. These types may work in unison across multiple layers of a tiered application architecture to process data in response to requests and to process analytic calculations triggered by batch and real-time data flowing into the system. These types may function as a superstructure over physical data stores. Applications that utilize the platform services component 256 or other components of the modular services component 250 may have an application architecture including a user interface layer, an analytics layer, and a type layer.

As shown in FIG. 2D, the machine learning platform system 260 represents an application development platform system that can be used to provide the various CRM-related functions described in this disclosure. In some embodiments, the machine learning platform system 260 may implement a model-driven architecture for a distributed system. The machine learning platform system 260 may perform any of the functionality discussed in this patent disclosure. In some cases, the machine learning platform system 260 may be viewed as a specific implementation of the architecture 220 shown in FIG. 2B and described above.

As shown here, the machine learning platform system 260 includes a data collection component 262, a time-series data component 264, a relational data component 266, a data integration component 268, transformation components 270, a persistence component 272, a data services component 274, an output component 276, an actionability component 278, an elasticity component 280, an analytics engine component 282, a machine learning component 284, a processing component 286 (which includes a batch processing component 286a, a stream processing component 286b, an iterative processing component 286c, and a continuous data processing component 286d), an application component 288, a data exploration component 290, an integration designer component 292, a user interface (UI) designer component 294, an application logic component 296, and a tool integration component 298. These components 262-298 are given by way of illustration only and may not all be included in all embodiments. In fact, some embodiments may include only one or any combination of two or more of the components 262-298. Furthermore, some of the components 262-298 may be located outside the machine learning platform system 260, such as in other servers or devices in communication with the machine learning platform system 260. Various examples of ways in which these components 262-298 may be implemented and/or used are provided in U.S. Pat. No. 10,817,530 (which is hereby incorporated by reference in its entirety).

A platform having a model-driven architecture, rather than a structured programming architecture, may be useful or necessary to address both big data needs and provide powerful and complete platform as a service (PaaS) solutions that include application development tools, user interface (UI) tools, data analysis tools, and/or complex data models that can deal with large amounts of CRM data. A model-driven architecture is a term for a software design approach that provides models as a set of guidelines for structuring specifications. An example model-driven architecture may include a type system that may be used as a domain-specific language (DSL) within a platform used to access data, interact with data, and/or perform processing or analytics based on one or more type or function definitions within the type system. By using an abstraction layer provided by a type system, the complexity of the CRM application problem can be reduced by orders of magnitude, such as to the order of a few thousand types, for any given CRM application that a programmer manipulates using JAVASCRIPT or other language to achieve a desired result. Thus, all of the complexity of the underlying foundation (with an order of M×S×T×A×U using structured programming paradigms) is abstracted and simplified for the programmer. Here, M represents the number of process modules (APACHE Open Source modules are examples of process modules), S represents the number of disparate enterprise and extraprise data sources, T represents the number of unique sensored devices, A represents the number of programmatic APIs, and U represents the number of user presentations or interfaces. Example technologies that can be included in one or more embodiments may include nearly-free and unlimited compute capacity and storage in scale-out cloud environments, such as AWS; big data and real-time streaming; smart connected devices; mobile computing; and data science including big-data analytics and machine learning to process the volume, velocity, and variety of big-data streams. Among other things, the type system can be employed to perform data modeling in order to translate raw source data formats into target types. Sources of data for which data modeling and translation can be performed may include accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, or service logs.

The model-driven architecture enables capabilities and applications including precise predictive analytics, massively parallel computing at the edge of a network, and fully-connected sensor networks at the core of a business value chain. The model-driven architecture and CRM infrastructure software stack serves as the nerve center that connects and enables collaboration among previously-separate business functions, including product development, marketing, sales, service support, manufacturing, finance, and human capital management. Some embodiments may include a product cloud that includes software running on a hosted elastic cloud technology infrastructure that stores or processes product data, customer data, enterprise data, and Internet data. The product cloud may provide one or more of: a platform for building and processing software applications; massive data storage capacity; a data abstraction layer that implements a type system; a rules engine and analytics platform; a machine learning engine; smart product applications; and social human-computer interaction models. One or more of the layers or services may depend on the data abstraction layer for accessing stored or managed data, communicating data between layers or applications, or otherwise storing, accessing, or communicating data.

An example model-driven architecture for integrating, processing, and abstracting data related to an enterprise CRM application development platform includes tools for machine learning, application development and deployment, data visualization, and/or other tools (such as an integration component, a data services component, a modular services component, and an application that may be located on or behind an application layer). The model-driven architecture may operate as a comprehensive design, development, provisioning, and operating platform for industrial-scale applications in various industries, such as energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

An integration component, data services component, and modular services component may store, transform, communicate, and process data based on the type system. In some embodiments, the data sources and/or the applications may also operate based on the type system. In an example embodiment, the applications may be configured to operate or interface with the components based on the type system. For example, the applications may include business logic written in code and/or accessing types defined by a type system to leverage services provided by the system.

In some embodiments, the model-driven architecture uses a type system that provides type-relational mapping based on a plurality of defined types. For example, the type system may define types for use in the applications, such as a type for a customer, organization, device, or the like. During development of an application, an application developer may write code that accesses the type system to read or write data to the system, perform processing or business logic using defined functions, or otherwise access data or functions within defined types. In some embodiments, the model-driven architecture enforces validation of data or type structure using annotations/keywords. A UI framework may also interact with the type system to obtain and display data. The types in the type system may include defined view configuration types used for rendering type data on a screen in a graphical, text, or other format. In some embodiments, a server, such as a server that implements at least a portion of the system, may implement mapping between data stored in one or more databases and a type in the type system, such as data that corresponds to a specific customer type or other type.

### Type System

One example of a type system is given by way of the following non-limiting example, which may be used in various embodiments and in combination with any other teachings of this disclosure. In some embodiments, the fundamental concept in the type system is a “type,” which is similar to a “class” in object-oriented programming languages. At least one difference between “class” in some languages and “type” in some embodiments of the type system disclosed here is that the type system is not tied to any particular programming language. As discussed here, at least some embodiments disclosed here include a model-driven architecture, where types are the models. Not only are types interfaces across different underlying technologies, they are also interfaces across different programming languages. In fact, the type system can be considered self-describing, so below is presented an overview of the types that may define the type system itself.

### Types

A type is the definition of a potentially-complex object that the system understands. Types may be the primary interface for all platform services and the primary way that application logic is organized. Some types are defined by and built into the platform itself. These types provide a uniform model across a variety of underlying technologies. Platform types also provide convenient functionality and build up higher-level services on top of low-level technologies. Other types are defined by the developers using the platform. Once installed in the environment, they can be used in the same ways as the platform types. There is no sharp distinction between types provided by the platform and types developed using the platform.

### Fields and Functions

Types may define data fields, each of which has a value type (see below). Types may also define methods, which provide static functions that can be called on the type and member functions that can be called on instances, such as:

```
type Point {
  x : !double
  y : !double
  magnitude : member function( ): double
}
```

In this example, there are two data fields (“x” and “y”), both of which are declared as primitive “double” (numeric) values. Note that an exclamation point before the type may indicate that the values are required for these fields. There is also one member method (function) that calculates the point's magnitude and returns it as a double value.

### Mix-Ins

Types can “mix in” other types. This is like sub-classing in the JAVA or C++ languages. However, unlike JAVA, multiple types may be mixed in some embodiments. Mix-ins may be parametric, which means they have unbound variables that are defined by types that mix them in (at any depth). For example, the actual coordinate values in the example above might be parametric as follows:

```
type Point<V> {
  x : V
  y : V
}
type RealPoint mixes Point<double>
type IntPoint mixes Point<int>
```

In this example, “Point” is now a parametric type because it has the unbound parametric variable “V.” The RealPoint and IntPoint types mix in Point and bind the variable in different ways. For instances of RealPoint, the fields are bound to “double” values, which has the same effect as the explicit declaration in the first example. However, either type can be passed to a function that declares an argument of type Point.

### Value Types

A ValueType (itself a Type) is the metadata for any individual piece of data that the system understands. Value types can represent instances of specific Types but can also represent primitive values, collections, and functions. When talking about modeling, the number of “meta levels” may need to be clarified. Data values are meta level 0 (zero); the value 11 (eleven) is just a data value. Value types are the possible types of data values and thus are meta level 1 (one). The “double primitive” value type defines one category of values, where real numbers are representable by a double-precision floating-point format. So, the value “11” might be stored in a field declared as a “double” value type and then naturally displayed as “11.0” (or maybe 1.1×10¹). It might also be stored in a field declared as an “int” or even a “string.” This is discussing meta level two, which involves the metadata of metadata. Stated another way, this is discussing the shape of the data that describes the shape of actual data values, or that “ValueType” is the model used to define models.

### Primitive Types

In some embodiments, the simplest value types are primitives. The values of primitives are generally simple values that have no further sub-structure exposed. Note that they may still have sub-structure, but it is not exposed through the type system itself. For example, a “datetime” value can be thought of as having a set of rules for valid values and interpretation of values as calendar units, but the internal structure of datetime is not documented as a value type. These primitive types may be arranged into a natural hierarchy. Note that for storage purposes, there are variants of these basic types, but from a coding and display perspective this may be the complete set of primitive value types. Since primitive types have no sub-structure, the value types are simply themselves (such as singletons or an enumeration).

### Collection Types

The next group of value types to consider is “collections.” There are various shapes of collections for different purposes, but collections may share some common properties. For example, they may contain zero or more elements; the elements may have an ordering; and/or the elements may have a value type for their elements. Note that collections are strongly typed, so they have sub-structure that is exposed in their value types. The collection types may include an array (an ordered collection of values); a set (a unique ordered collection); a map (a labelled collection of values); and/or a stream (a read-once sequence of values). Collection types may always declare their element types, and map types may also declare their key type. The parametric type notation may be used in a domain specific language (DSL) to represent this, such as in the following manner:

```
type Example {
  array : [boolean]
  set : set<string>
  map : map<string,double>
produce : function( ) : stream<int>
}
```

Note that map keys can be any primitive type (not just strings), although strings are the most common case. Sets behave nearly identically to arrays but ignore insertion of duplicate elements.

### Reference Types

Fields can also be instances of types (see above). These may be called “reference types” because they appear as “pointers” to instances of other objects. An example of this is:

```
type Cluster {
  centroid : Point
  inputs : [Point]
  boundary : member function( ): [Point]
}
```

Point can be a reference to a Point type (or any type that mixes it in). References can appear directly or be used in collections or as function arguments or return values. Functions are declared on types in the same way as data fields. Methods can be “static” or “member” functions. Static functions are called on the type itself, while member functions are called on instances of the type. An example of this is:

type KMeans {
cluster : function(points : ![Point], n : !int) : ![Cluster]
}

In this example, “cluster” is a static function on a “KMeans” type that takes two arguments and returns an array. Like everything else in this embodiment, the function argument declaration is strongly typed and so “points: ![Point]” declares that the argument name is “points” and that its type is an array (collection) of Point instances, and the exclamation point indicates that the argument is required. The return value may also be strongly typed, so the function returns an array of Cluster instances and the exclamation point indicates that a value is always returned.

### Lambdas

Functions above may be called “methods” because they are defined on a per-type basis. The KMeans type above has exactly one implementation of cluster. This is true for both static and member methods. Sometimes a user may want the function implementation to be dynamic, in which case a “lambda” may be used. For example, a user may have multiple populations, each of which comes with a clustering algorithm. For some populations, one clustering technique might be more appropriate than another, or perhaps the parameters to the clustering technique might differ. Instead of hard-coding the clustering algorithm, for example, a “lambda” may be used as follows.

```
type Population {
  points : [Point]
  cluster : lambda(points : [Point]) : [Cluster]
}
```

The declaration of the cluster variable looks somewhat like a method, but the “lambda” keyword indicates that it is a data field. Data fields typically have different values for each instance of the type, and lambda fields are no exception. Lambda values may also be passed to functions. Lambdas may be thought of as anonymous JAVASCRIPT functions but with strongly typed argument and return values.

In some embodiments, the type system abstracts underlying storage details, including database type, database language, or storage format, from the applications or other services. Abstraction of storage details can reduce the amount of code or knowledge required by a developer to develop powerful applications. Furthermore, with the abstraction of storage, type models, functions, or other details by the type system, customers or developers for a client of a PaaS system are insulated from any changes that are to be made over time. Rather, these changes may be made in the type system without any need for customers or developers to be made aware or any updates to be made to applications or associated business logic. In some embodiments, the type system, or types or functions defined by the type system, performs data manipulation language (DML) operations, such as structured query language (SQL) CREATE/UPDATE operations, for persisting types to a database in structured tables. The type system may also generate SQL for reading data from the database and materializing/returning results as types.

The type system may also be configured with defined functions for abstracting data conversion, calculating values or attributes, or performing any other function. For example, a type defined by the type system may include one or more defined methods or functions for that type. These methods or functions may be explicitly called within business logic or may be automatically triggered based on other requests or functions made by business logic via the type system. In some embodiments, types may depend on and include each other to implement a full type system that abstracts details above the abstraction layer but also abstracts details between types. The specification of types, models, data reads and writes, functions, and modules within the type system may increase robustness of the system because changes may only need to be made in a single (or very small number of locations) and then are available to all other types, applications, or other components of a system.

A model-driven architecture for distributed systems may provide significant benefits and utility to a cyber-physical system. For example, the type system may provide types, functions, and other services that are optimized for cyber-physical applications, such as analytics, machine learning algorithms, data ingestion, or the like. Additionally, as the model-driven architecture for distributed systems is used and extended over time, continual support for new patterns/optimizations or other features useful for big data, CRM, and/or cyber-physical systems can be implemented to benefit a large number of types and/or applications. For example, if improvements to a machine learning algorithm have been made, these improvements will be immediately available to any other types or applications that utilize that algorithm, potentially without any changes needed to the other types or business logic for applications. An additional benefit that may result from the model-driven architecture includes abstraction of the platform that hides the details of the underlying operations. This improves not only the experience of customers or their application developers but also maintenance of the system itself. For instance, even developers of the type system or cyber-physical system may benefit from abstraction between types, functions, or modules within the type system. The type system may be defined by metadata or circuitry within the model-driven architecture for distributed systems. The type system may include a collection of modules and types. The modules may include a collection of types that are grouped based on related types or functionality. The types may include definitions for types, data, data shapes, application logic functions, validation constraints, machine learning classifiers and/or UI layouts.

Entity type definitions may include a variety of information, structures, or code. For example, entity type definitions may include fields to track named values such as customer name or address. Fields may include a data type, array, reference, or function. Entity type definitions may include a data shape to track whether the data type for a field is a string, integer, float, double, decimal, date-time, or Boolean value. Entity type definitions may include a schema to dictate a related table in a physical database schema where the data resides. Entity type definitions may include application logic to declare functions that can be called when executing business rules to process data. Entity type definitions may include data validation constraints to declare which fields are required, define a permissible list of values, and/or implement indexing to improve performance. Entity type definitions may include a user interface layout to define one or more user interface layouts that the type should be rendered in when displayed.

Type definitions may include or consist of properties or characteristics of the implemented software construct. For example, the properties of a type that is persisted in a database table, such as a billing account, may include its column name, data type, length, and so on. Similarly, the properties of a logical function that performs a calculated expression may include the input and output parameters of the expected result.

The type system may provide a logical structure for data, processes, and/or services of a PaaS solution. The type system may provide a consistent and unified programming model to facilitate case in development and maintenance of the platform. In some embodiments, the type system may be used to represent applications, procedures, or the like as interactions of types. The types are extensible and may define relationships between types or types, services or analytics to be performed in relation to a type or types, and/or an interface declaration for a type or types. The type system may provide a framework and an implementation-independent runtime engine for constructing types, performing functions or analytics, and/or providing access to the type system by services or business logic.

In some embodiments, a data flow event is a combination of an analytic defining what is being measured, a period defining the period of a time-series to be analyzed, and an interval that defines a granular for aggregation. In addition, analytics may specify a completeness threshold for a data flow event that defines how much of the potential data for a period has been collected so far.

A type layer may persist and manage all platform types built on top of a data model. The types may contain definitions that describe fields, data formats, and/or functions for an entity in the system. The types defined by the platform types may create a layer of abstraction over various data stores, such as relational database management systems, key/value stores, and multi-dimensional stores, and provide a consistent set of APIs for a metadata-driven development environment. The type layer may be optimized to meet the unique requirements imposed on how an application interacts with data of differing shapes, speeds, and purposes.

In some implementations, a data integrator module can provide a set of standardized canonical type definitions (standardized interface definitions) that can be used to load data into applications of the application server. The canonical types of the data integrator module may be based on current or emerging industry standards, such as the Common Information Model (CIM), industry focused standards (like with respect to the energy industry and the utility sector, Green Button and Open Automatic Data Exchange), or on the specifications of the application server. The application server may support these and other standards to ensure that a broad range of data sources will be able to connect easily to the enterprise CRM application development platform.

Note that the various functions shown in each of FIGS. 2B through 2D may be implemented using any suitable hardware or any suitable combination of hardware and software/firmware instructions. In some embodiments, for instance, at least some of the functions shown in FIG. 2B, 2C, or 2D can be implemented or supported using software or firmware instructions that are executed by one or more processing devices, such as by one or more processing devices 202 in one or more devices 200. In other embodiments, at least some of the functions shown in FIG. 2B, 2C, or 2D can be implemented or supported using dedicated hardware components. In general, the functions of one or more devices can be implemented using any suitable hardware or any suitable combination of hardware and software/firmware instructions.

Although FIGS. 2A through 2D illustrate examples of a device 200, architecture 220, modular services component 250, and machine learning platform system 260 supporting a model-driven software architecture providing an AI-based CRM system, various changes may be made to FIGS. 2A through 2D. For example, computing and communication devices and systems come in a wide variety of configurations, and FIG. 2A does not limit this disclosure to any particular computing or communication device or system. Also, functions can be added, omitted, combined, further subdivided, replicated, or placed in any other suitable configuration in the architecture 220, modular services component 250, and machine learning platform system 260 of FIGS. 2B through 2D according to particular needs.

### Opportunity Scoring & Precision Revenue Forecasting

Opportunity scoring generally involves evaluating opportunities and determining a probability that a representative will win a specific opportunity within a given timeframe (such as a given month or a given quarter). A related function is precision sales forecasting (PSF), which models the possible total sales, revenue, or bookings that might be generated from the pipeline for the company in the given timeframe.

Precision revenue forecasting generally involves estimating total revenue or bookings (such as for an individual, a team of individuals, an entire company, or a portion thereof) within a given timeframe. In some cases, precision revenue forecasting can be based on aggregated probabilities that various individual opportunities will be won within the given timeframe, so opportunity scoring may be used to support precision revenue forecasting with forecasts for individual opportunities (both accounted for and unaccounted for at the time of forecast) being aggregated into an overall forecast. Additionally, precision revenue forecasting may involve calculating gap-to-plan, which refers to a gap between the estimated total revenue or bookings and a sales plan or other quota for an individual, a team of individuals, an organization, or a portion thereof. A related function is precision product forecasting, which generally involves predicting sales volumes or other transaction volumes for one or more specific products or services within a given timeframe. Overall, these functions support the ability to track opportunities within an organization, which can be used to help predict revenue, increase or maximize profits and efficiencies, generate new insights for sales or other transactions, and manage workflows associated with sales or other transactions.

Note that, in the following discussion, various specific details and implementations may be described for implementing groups of functions, such as opportunity scoring and precision revenue forecasting. Since opportunity scoring may be used without also performing precision revenue forecasting, the details provided below for the opportunity scoring techniques may be used without also implementing the precision revenue forecasting techniques (or vice versa). Similarly, functions such as precision product forecasting and AI evidence package functionality are described below as being used with the precision revenue forecasting, but each of these functions may be used separately or in any desired combination. As a result, the functions for opportunity scoring, precision revenue forecasting, precision product forecasting, and AI evidence package generation may be used separately or in any suitable combination.

Various shortcomings exist in prior attempts to provide opportunity scoring and related functions. For example, other approaches for opportunity scoring often cannot capture the probability of closing an opportunity within a user-specified time period, and expected outcomes from opportunities do not necessarily sum up to an accurate bookings forecast for a given time period. Moreover, the probabilities that are generated for opportunity scoring may not be human-relatable because they are not calibrated to a human-understood scale. Other approaches for bookings and revenue forecasting again typically cannot capture the probability of closing an opportunity within a user-specified time period and do not account for opportunities that have not been entered into a CRM system for a current time period (which misses opportunities that may be created between the current date and a future date). In addition, other approaches are typically hierarchy-dependent, which means that aggregates or roll-ups of opportunity scores are tied to the manner in which specific hierarchies are constructed and cannot handle situations where opportunities may not be tied to an overall business unit through a hierarchical relation.

The opportunity scoring and precision revenue forecasting functions (among other functions) described in this disclosure can help to resolve these or other problems associated with prior approaches. This is accomplished by generating AI-driven opportunity scores, each of which captures the probability that an open opportunity will close in any future time period as defined by a user or other source that defines the future time period. As described in more detail below, for instance, one or more AI-based machine learning models can be used to determine the probability of closing an opportunity before a user-provided date or within a user-provided date range. As one example, the probability of closing an opportunity by a specified date can be determined using that date. As another example, the probability of closing an opportunity within a specified date range can be determined by identifying probabilities of closing before the start and end dates of the defined date range and determining the difference between those two probabilities. Each determined probability of closing an opportunity can also be scaled or otherwise calibrated so that it is human-relatable on a human-relatable or human-understood scale, such as when an 80% probability score generated using a machine learning model actually means an 80% chance of closing (rather than when an arbitrary score is generated without a real probabilistic meaning, which is common with machine learning models).

The opportunity scores can also be reconciled into various aggregate-level forecasts. For example, opportunity scores and bookings forecasts can be adjusted (such as in the smallest ways possible) so that expected values of opportunities roll-up into broader aggregate-level forecasts properly. As a particular example, an optimization formulation that is used to adjust the opportunity scores can also account for ranges within which the probabilities can be adjusted, and the opportunity scores can be scaled or otherwise formulated to fall within a specified range (such as a range of [0, 1]) when explicit ranges are not specified. This supports the roll-up of the opportunity scores into any suitable hierarchy-agnostic aggregation or into any of numerous types of opportunity hierarchies that support any manner of opportunity aggregation. Example types of aggregation hierarchies that may be supported include representative hierarchies (such as hierarchies based on aggregations of opportunity scores for different representatives), account hierarchies (such as hierarchies based on aggregations of opportunity scores for different customer accounts), geographical region/territory hierarchies (such as hierarchies based on aggregations of opportunity scores for different geographic areas), industry hierarchies (such as hierarchies based on aggregations of opportunity scores for different industries), and product/service hierarchies (such as hierarchies based on aggregations of opportunity scores for different products or services). In addition, opportunity scoring, precision revenue forecasting, and/or precision product forecasting can be performed for each product/service or for groups of products/services offered by a company, for each representative or for groups of representatives in the company, or for any other individual or group characteristic(s) associated with the company.

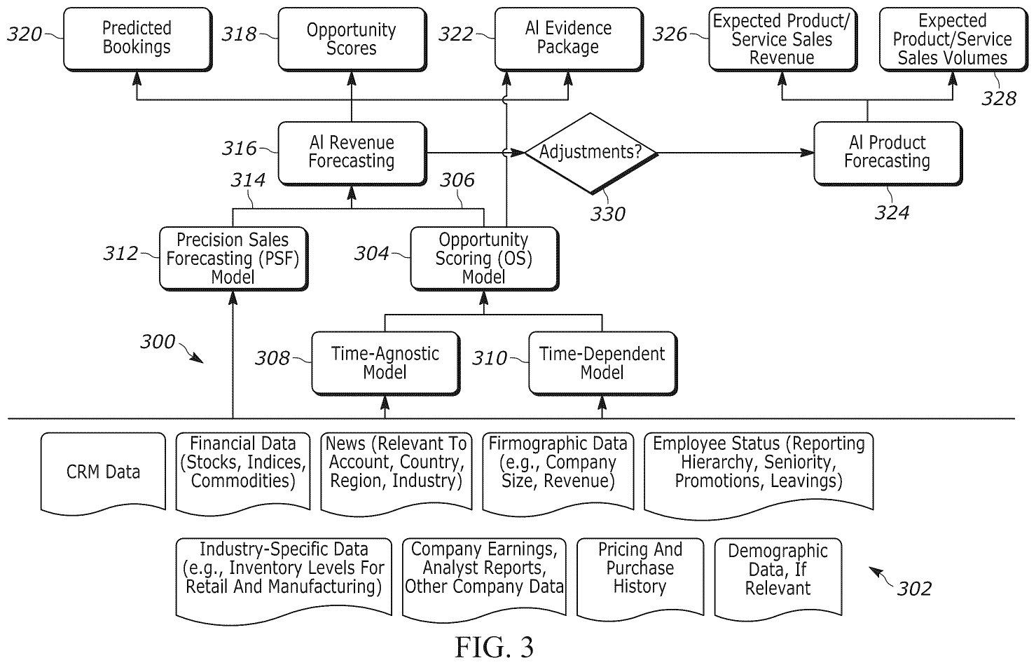

FIG. 3 illustrates an example architecture 300 supporting opportunity scoring, precision revenue forecasting, and precision product forecasting according to this disclosure. The architecture 300 may, for example, be implemented by the application server 106 shown in the system 100 of FIG. 1 using one or more instances of the device 200 shown in FIG. 2A. The architecture 300 may also form part of or be used within the architecture 220, modular services component 250, and/or machine learning platform system 260 shown in FIGS. 2B through 2D, such as when the architecture 300 is used (among other things) to implement at least part of the AI-based revenue forecasting function 226. However, the architecture 300 may be implemented using any other suitable device(s) and architecture(s) and in any other suitable system(s).

As shown in FIG. 3, data from a wide variety of data sources 302 may be obtained and used by the architecture 300, such as when the data is obtained and curated using the data handler function 240. In this example, the data sources 302 include one or more enterprise CRM data sources (such as a history of opportunities and a history of sales or other transactions recorded in a company's internal system or systems) and one or more extraprise data sources providing macroeconomic financial data (such as stock prices, stock indices, and commodity prices). The data sources 302 also include one or more extraprise news sources, such as news related to a specific customer or more generally to a relevant country, region, or industry. The data sources 302 further include one or more firmographic sources providing data related to specific customers, such as each customer's size and revenue. The data sources 302 also include one or more sources of employee information related to specific customers, such as information about reporting hierarchies within customers' organizations, seniorities of different employees of customers, and promotions or employee exits (like resignations or firings) of different employees of customers. The data sources 302 further include one or more sources of industry-specific data, such as information related to inventory levels of retail or manufacturing operations in a specific industry. The data sources 302 also include one or more sources of other customer-related data, such as information about customers' earnings, analyst reports about customers, social media information regarding customers, information describing relationships within or between customers or other parties, and other information about customers. The data sources 302 further include one or more sources of pricing and purchase history data, which may identify prior sales/other transactions or offers made involving particular customers. In addition, the data sources 302 include one or more sources of demographic data related to particular customers. Note that this information may be obtained in any suitable form and may include streaming data, data collected or obtained in batches, or data obtained in any other appropriate form.

This information is processed using an opportunity scoring (OS) machine learning model 304. The OS machine learning model 304 uses this information to evaluate individual opportunities and to provide, for each opportunity, a probability that a representative can win the opportunity within a given timeframe. In some embodiments, the OS machine learning model 304 uses snapshots of opportunities during both training and inferencing phases to generate the probabilities. For example, during the training phase, the OS machine learning model 304 can be trained (such as by modifying its weights or other parameters) using snapshots of opportunities having known won or lost outcomes (which are known as ground truths). During the inferencing phase, the OS machine learning model 304 can receive additional snapshots of current opportunities, and the OS machine learning model 304 can generate predictions 306 of the probabilities of winning or losing various opportunities. In some embodiments, the OS machine learning model 304 may receive a snapshot of the opportunities in a pipeline and generate the predictions 306 daily, although other time intervals may also be used.

In this way, each opportunity has an associated opportunity score, such as a probability of winning the opportunity within a designated timeframe. The designated timeframe may be defined by start and end dates or by an end date (in which case the current date may represent the start date). The opportunity score for an opportunity can vary over time, and the changes over time can both quantitatively and qualitatively indicate how the opportunity is progressing. For example, if an opportunity has not seen much activity over the past few weeks (such as due to little communication with a customer) or no progression has occurred through specified sales or other transaction stages as would normally be expected, the opportunity score for this opportunity can decrease over time. Conversely, if an opportunity is moving through the transaction stages very quickly, the opportunity score for this opportunity can trend upward. Among other things, the OS machine learning model 304 allows representatives to prioritize their opportunities. If an opportunity has a very high score and is in a later transaction stage, a representative may not need to focus much effort on that opportunity. If an opportunity has a very high score and is in an earlier transaction stage, a representative may prioritize the opportunity to ensure winning the opportunity (which may help close his or her gap-to-plan in a given fiscal period). If an opportunity has a very low score and is in an earlier transaction stage, a representative may wish to de-prioritize the opportunity in favor of other opportunities that he or she is more likely to win within a given timeframe.

In addition to generating opportunity scores, the OS machine learning model 304 can explain each of its predictions 306 using the AI evidence package functionality, such as by invoking or otherwise being used in conjunction with the AI-based evidence package module function 246. This allows for the identification of the features that are contributors (positive and negative) to the predicted probabilities, optionally along with the identification of an extent that each identified feature contributes to an associated predicted probability. These contributing features can be ranked, such as with top features identified for both positive and negative probabilities, and exposed to the representative to aid in decision-making. Among other things, this information can help a representative understand the reasons for a specific prediction 306 and support further actions based on the prediction 306.

If the only goal of the OS machine learning model 304 was to estimate the probability of winning an opportunity, a classifier model might be sufficient for this use case. However, there is an additional temporal component that can be considered by the OS machine learning model 304. That is, the OS machine learning model 304 estimates the probability of winning an opportunity within a given timeframe. This can be expressed in various ways, such as by estimating the probability of winning the opportunity by a specified end date (in which case the current date is treated as the start date) or by estimating the probability of winning the opportunity within specified start and end dates. However, there may not necessarily be a set timeframe for which the OS machine learning model 304 is trained to predict outcomes. This may occur, for instance, when a representative is given the ability to set any desired close date (the date by which an opportunity should be won) when using the architecture 300. As a result, given any date in the future, the OS machine learning model 304 may be configured to predict the probability of winning an opportunity by that date.

Various approaches may be used to support this functionality. One approach may involve training different machine learning models, where each machine learning model is trained to predict the probability of winning an opportunity over a specific time horizon and where different machine learning models are trained to predict the probability of winning an opportunity over different time horizons. However, if the user is able to input a close date of his or her choosing, this may involve the use of an unsustainably large number of machine learning models. Thus, this approach might be limited to permitting queries over predefined time horizons, such as one week, one month, one quarter, or one year.

Another approach may involve training one or more machine learning models that can handle any user-specified close date(s). In some embodiments, this may be handled as follows. Let Y represent an outcome of an opportunity, where Y equals one if the opportunity is won and Y equals zero otherwise. Let X represent the number of days until the opportunity concludes (as either a win or a loss). Let q represent the query date given by a user or the number of days until the end of a quarter or other time period. For any value of q, the OS machine learning model 304 can output the joint probability p(X<q,Y=1). To model this, the joint probability can be broken out using the rules of conditional probability, which can be expressed as p(X<q,Y=1)=p(X<q|Y=1)×p(Y=1). In some cases, this can be expressed as p(X<q,Y=1|θ)=p(X<q|θ,Y=1)×p(Y=1|θ), where θ represents one or more features that capture the current state of an opportunity, such as stage age (the length of time that the opportunity has been in its current transaction stage), number of positive-sentiment emails or other communications obtained during a time period (such as within the past month), and champion clout (the amount of clout that a particular contact associated with an opportunity has). The second probability can be given by a time-agnostic model 308, and the first probability can be given by a time-dependent model 310. As a result, in some cases, outputs from two AI-based models are multiplied to produce the probability of closing before a user-provided date (such as by plugging in a date q into one of the equations above). In other cases, multiple probabilities of closing can be determined for two user-provided dates (such as by plugging in two dates q into one of the equations above), and the difference between the probabilities can represent the probability of closing within a user-provided date range. In other embodiments, a single machine learning model can be trained to take time as an input along with one or more other features in order to estimate the probability of closing before a specified date or within a specified date range. Note that any desired user-defined or other date range may be used here, such as monthly, quarterly, half-yearly, or yearly.

In some embodiments, the time-agnostic model 308 that is used to identify the second probability (p(Y=1) or p(Y=1|θ)) may represent a classifier model. In some embodiments, the classifier model can be trained using snapshots of opportunities with known outcomes, and the classifier model can be used during inferencing to process additional snapshots of current opportunities. Each opportunity typically undergoes one or more changes, such as one or more changes in deal size, sales stage, forecast category, sales rep, sales rep probability, estimated close date, etc. Each of these changes can be recorded (possibly with the date and time of the change and the field or fields that changed) as a snapshot of the opportunity in time. These snapshots represent a way of reconstructing the history of a closed opportunity, and they allow machine learning algorithms to go back to a specific snapshot of the opportunity in time and evaluate the correlation between whether or not the opportunity will be won or lost versus what the opportunity's state was at that time. Thus, during inferencing, one or more machine learning models can map states of live opportunities to snapshots of historical opportunities that have been seen in the past and make predictions of the likelihood of the live opportunity closing successfully (because it is known from the historical snapshots whether the live opportunity's state is more similar to historically won/lost opportunities).

During training, for a set of snapshots of completed opportunities, snapshots that belong to opportunities that were won can be given a label of one (1), and snapshots from opportunities that were lost can be given a label of zero (0). The classifier model can be trained on these snapshots so that, when a new snapshot is received, the classifier model can give the probability that an opportunity represented by the new snapshot will be won. Note that this training procedure does not have any dependence on time (except in the features). This classifier model is used to determine whether, given an infinite amount of time, an opportunity is predicted to be won.

The time-dependent model 310 that is used to identify the first probability (p(X<q|Y=1) or p(X<q|θ,Y=1)) may represent a conditional probability model, so the time-dependent model 310 changes the training regimen. First, the time-dependent model 310 may be trained only on snapshots from won opportunities. Second, the labels of these snapshots can be changed to be the number of days or other length of time until each opportunity was won. This changes the problem from a classification problem to a regression problem, so the time-dependent model 310 may be implemented using a regressor model in some cases. In order to obtain a probability, the time-dependent model 310 may be implemented in several ways.

In some cases, the time-dependent model 310 may be implemented using a generalized linear model (GLM) with a gamma distribution. After training, the time-dependent model 310 can predict the number of days or other length of time until an opportunity is won by giving the mean of the distribution. To turn this into a probability, the entire gamma distribution can be modeled. In specific cases, this may be accomplished using a method of moments estimate of the dispersion parameter for the gamma distribution since, in using a GLM, it is assumed that the target variables are all pulled from gamma distributions sharing a dispersion parameter. After training and using the time-dependent model 310 to compute the dispersion parameter estimate, the time-dependent model 310 can give a probability of winning an opportunity at any point in time for any new inference point. To do so, the time-dependent model 310 gives the mean of the gamma distribution by evaluating the snapshot. By combining that output with the dispersion parameter estimate, the time-dependent model 310 constructs a gamma distribution, which has a cumulative distribution function (CDF) that can be evaluated at any query date given by the user.

In other cases, the time-dependent model 310 may be implemented using a survival model. A survival model is typically used to estimate the time to an event (such as the death of a patient), and some methods construct entire CDF estimates for the event. Here, a survival model can be used to estimate the time by which an opportunity is expected to be won, which can be adjusted to identify a probability of winning the opportunity by any point in the future.

Various types of information can be used to train the OS machine learning model 304 or to train the individual models 308 and 310 that form the OS machine learning model 304. As described above, the application server 106 is able to obtain and ingest data from a wide variety of data sources 302 (such as via the data handler function 240) to make informed decisions about a sales process or other process, and the model orchestrator function 242 can be used to train or retrain the OS machine learning model 304 or the individual models 308 and 310. Thus, various categories of features may be fed into the OS machine learning model 304 or into the individual models 308 and 310.

Historical CRM data is one possible type of input data for the OS machine learning model 304 or for the machine learning models 308 and 310 that form the OS machine learning model 304, and various opportunity-level features can be constructed from this type of data. For example, stage duration features encode how many days (or other length of time) each opportunity has spent in each transaction stage at any point in time. As an example of this feature's influence on at least one machine learning model's outcome, if an opportunity moves through multiple transaction stages very quickly, this may increase the probability score for that opportunity. The features may also include customer communication-based features associated with an opportunity. For instance, if a representative has sent many emails or other communications about an opportunity and received many replies, that may indicate a strong interest in moving the opportunity forward and thereby indicate that the opportunity will likely close successfully (and likely in the near future).

Other types of features that may be fed into the OS machine learning model 304 or into the machine learning models 308 and 310 that form the OS machine learning model 304 may include financial and corporate information about a customer. This information itself is typically not contained within a traditional CRM system, but these features can be directly received or generated from datasets received from one or more third-party data providers such as QUANDL, INSIDEVIEW, or other provider(s). These sources give insight as to how the customer is performing financially, identify if the customer is expanding or shrinking its labor force, indicate any ongoing leadership changes, and provide other useful or important news or other information about the customer. In addition, the features may include news sentiment or social media sentiment, which evaluates positive and negative sentiment on the body or title of new articles or in social media posts or other content. In some cases, application program interfaces (APIs) are used to evaluate the overall sentiment about a customer in order to help determine if an opportunity is likely to come to fruition based on the reported opinions of customer. Features based on news or social media content may look at both sentiment and volume/frequency of newsworthy information about a customer.

The following table identifies example features that may be used in particular embodiments of the OS machine learning model 304 or the machine learning models 308 and 310 that form the OS machine learning model 304, although this list is for illustration only and does not limit the scope of this disclosure to this particular collection of features.

TABLE 1

| Category | Feature | Description |
|---|---|---|
| Opportunity | Deal size | Representative-provided estimate of the |
| | | value of the opportunity |
| | Owner | Representative in charge of the |
| | | opportunity |
| | Current estimated close | Current human-provided estimate of the |
| | date | deal's close date |
| | Current sales or other | Current stage of the opportunity in the |
| | transaction stage | sales or other transaction process |
| | Opportunity age | Number of days (or other temporal units) |
| | | since the opportunity was created in the |
| | | CRM system |
| | Deal type | Type of deal that an opportunity |
| | | represents, such as “renewal,” “new |
| | | opportunity,” or “trial follow on” |
| | Product/service | Type(s) of product(s)/service(s) being |
| | | provided for a given opportunity, such as |
| | | a description and/or a stock-keeping unit |
| | | (SKU) |
| | Number of submitted | Number of submitted documents, such as |
| | documents | non-disclosure agreements (NDAs), |
| | | proposals, or requests for proposals |
| | | (RFPs) |
| | Forecast category | Current forecast category, such as |
| | | “committed,” “best case,” or “pipeline” |
| | Currency | Type of currency for the deal, such as |
| | | USD, AUD, CAD, CHF, CNY, EUR, |
| | | GBP, JPY, or other |
| | Currency exchange rate | Latest foreign exchange rate, which may |
| | | be provided on a daily basis |
| Opportunity | Stage duration | Amount of time an opportunity has spent |
| History | | in each sales or other transaction stage |
| | Push count | Number of times the estimated close date |
| | | has changed since the opportunity |
| | | creation date |
| | Stage regression count | Number of times an opportunity has |
| | | moved backwards instead of forward (as |
| | | changed by a representative) |
| Owner | Number of open | Total number of open opportunities |
| | opportunities | owned by a given representative |
| | Total number of won | Total number of opportunities a |
| | opportunities | representative has won during his or her |
| | | tenure |
| | Tenure | Number of months (or other temporal |
| | | units) of the representative's tenure at |
| | | company |
| Account | Days until the end of the | Depending on the fiscal period of the |
| | fiscal period | customer, a counter-metric keeping track |
| | | of the number of days left until the end of |
| | | the fiscal period, such as a quarter |
| | Prior engagement | Binary value indicating whether an |
| | | account is for a new or existing customer |
| | Annual revenue | Latest reporting of annual revenue |
| | | reported by the customer |
| | Quarterly revenue | Latest reporting of quarterly revenue |
| | | reported by the customer |
| | Employees | Current number of employees at the |
| | | customer |
| | Industry | Primary industry in which the customer |
| | | operates (such as manufacturing) |
| | Sub-industry | Primary sub-industry in which the |
| | | customer operates (such as automotive |
| | | manufacturing) |
| | Ownership status | Customer's status as publicly or privately |
| | | owned |
| | Headquarter region | Geographical region of the customer's |
| | | headquarters, such as North America, |
| | | EMEA, Europe, etc. |
| | Stock price | Latest stock prices reported (for public |
| | | companies) |
| | Earnings per share | Latest earnings per share defined as net |
| | | income divided by outstanding shares |
| | | (for public companies) |
| | Price to earnings ratio | Latest price-to-earnings ratio defined as a |
| | | ratio of current share price relative to |
| | | earnings per share (for public companies) |
| | Price to book ratio | Latest price-to-book ratio defined as a |
| | | ratio of the customer's market price to its |
| | | book price |
| | Analyst rating | Latest analyst rating (multiple, if |
| | | available) (for public companies) |
| | Total corporate actions | Total number of recorded corporate |
| | | action events since the opportunity |
| | | creation date (for public companies) |
| | | (corporate actions are defined as events |
| | | relevant to a customer that are either |
| | | publicly reported or that can affect the |
| | | stock price) |
| | Corporate actions last week | Count of corporate action events in the |
| | | last week |
| | Region GDP change | Local gross domestic product (GDP) |
| | | percentage change, such as annually |
| | Region equities index | Regional exchange index (such as FTSE |
| | | for the United Kingdom) |
| | Region futures | Regional futures prices |
| | Industry commodity prices | Commodity prices of interest for the |
| | | customer's industry, such as gold, oil, |
| | | copper, or silver |
| | Industry commodity | Commodity inventories of interest for the |
| | inventories | customer's industry, such as crude oil, |
| | | natural gas, metals, or grains |
| Account History | Annual revenue history | Time series of annual revenues reported |
| | Quarterly revenue history | Time series of quarterly revenue reported |
| | Employee history | Time series of quarterly reported number |
| | | of employees |
| | Stock price history | Time series history of the customer's |
| | | stock price (for public companies) |
| | Customer news history | Percent change in the number of relevant |
| | week | news articles this week relative to last |
| | | week |
| | Customer news history | Percent change in the number of relevant |
| | month | news articles this month relative to last |
| | | month |
| | Customer news history 90 | Percent change in the number of relevant |
| | days | news articles this week relative to the |
| | | average for the last 90 days |
| | Customer news last week | Number of relevant news articles in the |
| | | last week |
| | Customer news last month | Number of relevant news articles in the |
| | | last month |
| | Customer news last quarter | Number of relevant news articles in the |
| | | last 90 days |
| | Customer average news | Average sentiment of relevant news in |
| | sentiment last week | the last week |
| | Customer average news | Average sentiment of relevant news in |
| | sentiment last month | the last month |
| | Customer average news | Average sentiment of relevant news in |
| | sentiment last 90 days | the last 90 days |
| | Customer news sentiment | Percent change in the average sentiment |
| | change | score last week relative to last 90 days |
| Stakeholders | Has champion | Binary metric indicating the presence of |
| | | a deal champion |
| | Has economic buyer | Binary metric indicating the presence of |
| | | an economic buyer |
| | Stakeholder count | Number of stakeholders engaged in an |
| | | opportunity |
| | Stakeholder seniority | Count of stakeholders engaged in an |
| | | opportunity, weighted by their seniority |
| | | levels |
| | Champion title | Organizational title of the champion |
| | Champion region | Geographic region of the champion |
| | Has legal stakeholder | Binary metric indicating the involvement |
| | | of at least one stakeholder from the legal |
| | | department |
| | Has procurement | Binary metric indicating the involvement |
| | stakeholder | of at least one stakeholder from the |
| | | procurement department |
| Activities | Total touchpoints | Number of contacts with an |
| | | opportunity's stakeholders since the |
| | | opportunity creation date (emails, |
| | | appointments, phone calls, etc.) |
| | Touchpoints in last week | Number of contacts made with an |
| | | opportunity's stakeholders in the last |
| | | week (emails, appointments, phone calls, |
| | | etc.) |
| | Touchpoints in last month | Number of contacts made with an |
| | | opportunity's stakeholders in the last |
| | | month (emails, appointments, phone |
| | | calls, etc.) |
| | Total emails | Number of emails received from all |
| | | opportunity stakeholders since the |
| | | opportunity creation date |
| | Emails last week | Number of emails received from all |
| | | opportunity stakeholders in the last week |
| | Emails last month | Number of emails received from all |
| | | opportunity stakeholders in the last |
| | | month |
| | Emails change | Percent change in the number of emails |
| | | received from all opportunity |
| | | stakeholders in the last week relative to |
| | | the last 90 days |
| | Cc'ed contacts | Average number of contacts cc'ed in |
| | | emails received since the opportunity |
| | | creation date |
| | Average email sentiment | Average sentiment of all emails received |
| | | from all opportunity stakeholders since |
| | | the opportunity creation date |
| | Email sentiment last week | Average sentiment of emails received |
| | | from all opportunity stakeholders in the |
| | | last week |
| | Email sentiment last month | Average sentiment of emails received |
| | | from all opportunity stakeholders in the |
| | | last month |
| | Entail sentiment change | Percent change in the average sentiment |
| | | of emails received from all opportunity |
| | | stakeholders in the last week relative to |
| | | the last 90 days |
| | Email frequency | Average time between subsequent |
| | | received emails from any opportunity |
| | | stakeholders since the opportunity |
| | | creation date |
| | Email frequency last week | Average time between subsequent |
| | | received emails from any opportunity |
| | | stakeholders in the last week |
| | Email frequency last month | Average time between subsequent |
| | | received emails from any opportunity |
| | | stakeholders in the last month |
| | Email frequency change | Percent change in the average time |
| | | between subsequent received emails |
| | | from any opportunity stakeholders in the |
| | | last week relative to the last 90 days |
| | Stakeholder emails count | Percent change in the number of emails |
| | change | received from all opportunity |
| | | stakeholders in the last week relative to |
| | | the last 90 days |
| | Total appointments | Number of appointments with any of |
| | | opportunity stakeholders since the |
| | | opportunity creation date |
| | Appointments last week | Number of appointments with any of the |
| | | opportunity stakeholders in the last week |
| | Appointments last month | Number of appointments with any of the |
| | | opportunity stakeholders in the last |
| | | month |
| | Appointments change | Percent change in the number of |
| | | appointments with any of the opportunity |
| | | stakeholders in the last week relative to |
| | | the last 90 days |
| | Website visits | Total number of website visits from the |
| | | customer's IP address since the |
| | | opportunity creation date |
| Relevant news | Region news history week | Percent change in the number of relevant |
| | | news articles this week relative to last |
| | | week |
| | Region news history month | Percent change in the number of relevant |
| | | news articles this month relative to last |
| | | month |
| | Customer news history 90 | Percent change in the number of relevant |
| | days | news articles this week relative to |
| | | average for the last 90 days |
| | Region news last week | Number of relevant news articles in the |
| | | last week |
| | Region news last month | Number of relevant news articles in the |
| | | last month |
| | Region news last quarter | Number of relevant news articles in the |
| | | last 90 days |
| | Region average news | Average sentiment of relevant news in |
| | sentiment last week | the last week |
| | Region average news | Average sentiment of relevant news in |
| | sentiment last month | the last month |
| | Region average news | Average sentiment of relevant news in |
| | sentiment last 90 days | the last 90 days |
| | Region news sentiment | Percent change in the average sentiment |
| | change | score last week relative to last 90 days |
| | Industry news history week | Percent change in the number of relevant |
| | | news articles this week relative to last |
| | | week |
| | Industry news history | Percent change in the number of relevant |
| | month | news articles this month relative to last |
| | | month |
| | Industry news history 90 | Percent change in the number of relevant |
| | days | news articles this week relative to |
| | | average for the last 90 days |
| | Industry news last week | Number of relevant news articles in the |
| | | last week |
| | Industry news last month | Number of relevant news articles in the |
| | | last month |
| | Industry news last quarter | Number of relevant news articles in the |
| | | last 90 days |
| | Industry average news | Average sentiment of the relevant news |
| | sentiment last week | in the last week |
| | Industry average news | Average sentiment of the relevant news |
| | sentiment last month | in the last month |
| | Industry average news | Average sentiment of the relevant news |
| | sentiment last 90 days | in the last 90 days |
| | Industry news sentiment | Percent change in the average sentiment |
| | change | score last week relative to last 90 days |

As noted above, the ability to explain each prediction 306 through the use of the AI evidence package functionality is one additional feature of the OS machine learning model 304 (or the AI-based evidence package module function 246 as included in, invoked by, or otherwise used by the OS machine learning model 304). For example, it may be desirable to provide explanations in an easy-to-understand manner so that non-technical users (such as sales representatives or other representatives) can identify the reasoning of each AI-based prediction 306 and decide whether such reasoning appears trustworthy. Simply providing feature contributions, such as through the use of approaches like SHAP, to a representative may not improve trust in the OS machine learning model 304. As an example, when some features are not understood intuitively, such as rolling variances of time-series data, non-technical users are likely to lose trust in the entire model 304 and its outcome.

To improve interpretability, various features used by the model 304 may be combined or categorized into one or more “virtual-features.” Each virtual-feature may represent an aggregation of similar, related, or nearly-identical features with each individual feature given a weight or with the individual weights being manipulated by a mathematical formula. For example, one virtual-feature called “CRM Data” might contain features that document how many emails or other communications have been sent to a customer, how long an opportunity has been in a current stage, the tone of the customer emails (as determined by natural language processing), and how many calls have been scheduled with the customer (among many others). Each virtual-feature may have a contribution score, such as a score generated by combining the feature contributions (like SHAP values) for the features within that virtual-feature. In some cases, instead of displaying the combined contributions, the contributions can be categorized into “low,” “medium,” or “high” contributions. In a user interface, virtual-features may be displayed in groups that abstract the interpretability to an even higher level. As a particular example, “CRM Data” and “Internal Call Centers Records” virtual-features may be grouped together as a “Customer-Originated Data” virtual-feature group.

As noted above, precision revenue forecasting can be used to model the sales, revenue, or bookings that might be generated from the pipeline for a company (or for a more-granular entity, such as a business unit or department) over a given timeframe (such as a quarter). Among other things, this capability allows company leadership to adjust budgets and plan other parts of the company accordingly. As shown in FIG. 3, a precision sales forecasting (PSF) machine learning model 312 is used to generate predictions 314 about the amount of sales, revenue, or bookings generated for the company in a given timeframe. Typically, these metrics are forecasted for a fiscal quarter, but the time period can be adjusted as needed or desired.

In some embodiments, the PSF machine learning model 312 represents a regression model. To train the PSF machine learning model 312, each of multiple training labels may represent the amount of revenue or bookings to be realized between a specific day and the end of a timeframe (such as the end of a fiscal quarter). The training data may include features describing the pipeline, other CRM-derived features, external features, and the labels. After the PSF machine learning model 312 is trained, in order to predict the total revenue or bookings for the fiscal quarter or other timeframe, realized revenue or bookings can be added to the output of the PSF machine learning model 312 to obtain the estimated total revenue or bookings.

As with the OS machine learning model 304, the features used by the PSF machine learning model 312 may come from a variety of data sources 302. However, the exact formulation of the features may be somewhat different since the PSF machine learning model 312 aims to look at the entire pipeline, so the features used by the OS machine learning model 304 may be aggregated for use with the PSF machine learning model 312. In some cases, this is performed using a summation of feature values across opportunities. As an example, one feature used by the OS machine learning model 304 may document how many emails or other communications have been sent for an opportunity by the day of a snapshot. The corresponding feature for the PSF machine learning model 312 may be the sum of this feature across all currently-open opportunities, meaning the total number of emails or other communications that have been sent for all opportunities that are currently in the pipeline. When the PSF machine learning model 312 is implemented using regression, classic time-based features can also be used, such as the number of days (or other length of time) until the end of a timeframe (such as until the end of the quarter). Autoregressive features may also be used. The PSF machine learning model 312 may also consider financial information at the macroeconomic scale. In some cases, this type of information may include exchange rates, financial indices, and a world peace index.

Since one goal of precision sales forecasting may be to estimate the amount of revenue a company will book in a fiscal quarter or other timeframe, the PSF machine learning model 312 discussed above may be a regression model that estimates revenue directly. Another approach can involve using the OS machine learning model 304 to estimate revenue as an expected value calculation. By multiplying each estimated deal size by the probability of winning that deal and summing the results, the OS machine learning model 304 can estimate (or can be used to estimate) revenue using what is known as a “bottom-up” estimate. An example of this is described below in relation to the precision revenue forecasting function. However, this approach may also be used in FIG. 3.

In this example, the combination of opportunity scoring and precision sales forecasting supports an AI-based precision revenue forecasting function 316. The AI-based precision revenue forecasting function 316 may, for example, use the predicted revenue or bookings and opportunity probabilities to generate a graphical user interface (GUI) that identifies the predicted revenue or bookings and that provides the opportunity probabilities as an explanation for the predicted revenue or bookings. However, the predicted revenue or bookings and opportunity probabilities may be used in any other suitable manner.

As shown in this example, the AI-based precision revenue forecasting function 316 can output opportunity scores 318, which represent scores for the various opportunities in the pipeline of a company. For example, each opportunity score 318 may represent a numerical value, such as a value between 0 and 100 (or an equivalent value between 0.0 and 1.0), that identifies the probability of winning an associated opportunity within the given timeframe. The AI-based precision revenue forecasting function 316 can also output predicted bookings 320, which represent the opportunities that the application server 106 predicts are likely to be won within the given timeframe (such as opportunities having opportunity scores 318 above a specified threshold). The AI-based precision revenue forecasting function 316 can further output AI evidence packages 322, which can provide explanations for the opportunity scores 318 and the predicted bookings 320. For instance, each AI evidence package 322 may identify the largest contributors to an opportunity score 318 or predicted booking 320 (both positive and negative), such as when the AI evidence package 322 identifies which features have the largest impact on that opportunity score 318 or predicted booking 320. In some cases, the AI evidence packages 322 may provide explanations on multiple levels, such as when the AI evidence packages 322 provide explanations for individual opportunities, groups of opportunities, and all opportunities.

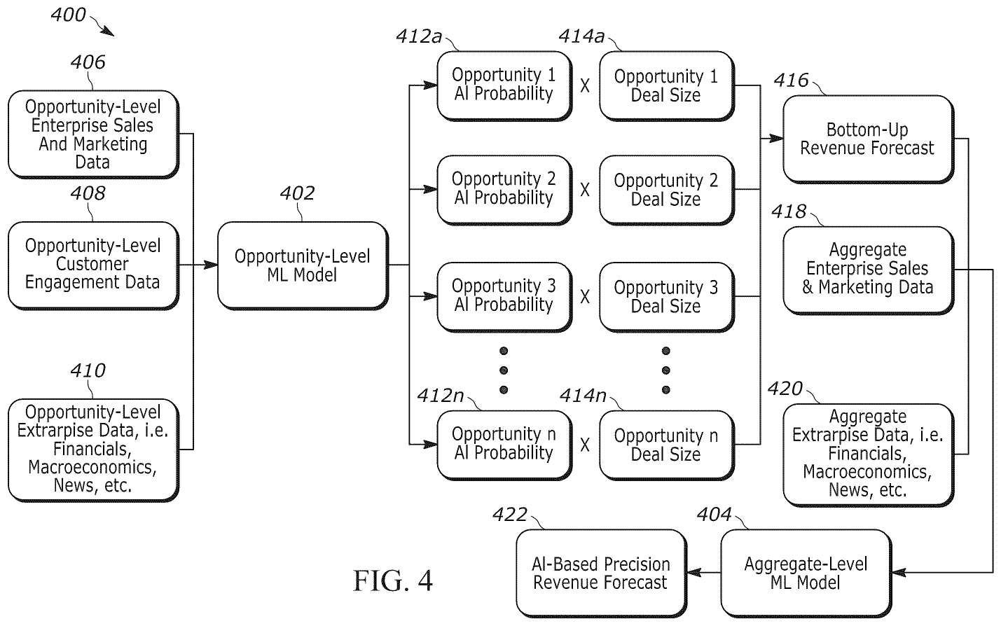

FIG. 4 illustrates a more specific example architecture 400 supporting opportunity scoring and precision revenue forecasting according to this disclosure. The architecture 400 may, for example, be implemented by the application server 106 shown in the system 100 of FIG. 1 using one or more instances of the device 200 shown in FIG. 2A. The architecture 400 may also form part of or be used within the architecture 220, modular services component 250, and/or machine learning platform system 260 shown in FIGS. 2B through 2D, such as when the architecture 400 is used (among other things) to implement at least part of the AI-based revenue forecasting function 226. However, the architecture 400 may be implemented using any other suitable device(s) and architecture(s) and in any other suitable system(s).

As shown in FIG. 4, the architecture 400 includes an opportunity-level machine learning model 402 and an aggregate-level machine learning model 404. In some cases, the opportunity-level machine learning model 402 may represent or include the OS machine learning model 304, and the aggregate-level machine learning model 404 may represent or include the PSF machine learning model 312.

The opportunity-level machine learning model 402 processes data related to individual opportunities in order to identify probabilities that the individual opportunities will be won within a given timeframe. In this example, the opportunity-level machine learning model 402 processes sales and marketing data 406 of a company regarding individual opportunities. This data 406 may include, for example, information identifying the various individual opportunities being pursued by the company, such as the specific customers and the specific products/services being offered to the specific customers. The opportunity-level machine learning model 402 also processes customer engagement data 408 defining interactions of the company with actual or potential customers for individual opportunities. This data 408 may include, for example, information related to emails, text messages, voice calls, video conferences, calendar appointments, and other interactions of representatives or other personnel with the actual or potential customers. The opportunity-level machine learning model 402 further processes extraprise data 410 related to various external aspects of individual opportunities. This data 410 may include, for example, financials of the actual or potential customers, macroeconomic conditions related to the actual or potential customers, and news or social media content related to the actual or potential customers for the individual opportunities.

The opportunity-level machine learning model 402 can process this information (possibly along with other information) to identify a probability 412a-412n for each individual opportunity. The probabilities 412a-412n identify the likelihood of each individual opportunity being won by its specified close date. The opportunity-level machine learning model 402 can also identify (or invoke the AI-based evidence package module function 246 to identify) top features or factors that contribute to each of the probabilities 412a-412n. In this example, the probabilities 412a-412n can be respectively multiplied by deal sizes 414a-414n, which represent the monetary sizes of the individual opportunities. The results can be summed to produce a bottom-up revenue forecast 416. As noted above, the probabilities 412a-412n can be scaled, expressed, or otherwise calibrated so that the probabilities 412a-412n are human-relatable, such as when an 80% score actually means an 80% chance of closing (rather than an arbitrary score generated without a real probabilistic meaning). Any suitable approach may be used to calibrate the probabilities 412a-412n (opportunity scores), such as Platt scaling or isotonic regression.

The aggregate-level machine learning model 404 processes the bottom-up revenue forecast 416 and data related to aggregate-level enterprise and extraprise data, meaning data that can span or affect multiple opportunities. In this example, the aggregate-level machine learning model 404 processes aggregate sales and marketing data 418 of a company regarding multiple (possibly all) opportunities. The aggregate-level machine learning model 404 also processes aggregate extraprise data 420 related to various aspects of multiple (possibly all) opportunities, such as financials of multiple actual or potential customers, overall macroeconomic conditions, and news or social media content related to multiple actual or potential customers across a number of opportunities.

The aggregate-level machine learning model 404 can process this information (possibly along with other information) to identify AI-based precision revenue forecasts 422. Each precision revenue forecast 422 represents an AI-based estimate of the opportunities that are likely to be won in a specified timeframe, such as a given fiscal period (like a quarter or a year). In some cases, a precision revenue forecast 422 can provide breakdowns by representatives or other personnel or can provide information at other levels of granularity. The aggregate-level machine learning model 404 can also identify (or invoke the AI-based evidence package module function 246 to identify) top features or factors that contribute to each of the precision revenue forecasts 422.

In this way, the architecture 400 supports opportunity scoring and precision revenue forecasting using a combination of machine learning models 402, 404 at both opportunity and aggregate levels. Features based on various enterprise and extraprise data relevant to given opportunities are defined for the opportunity-level machine learning model 402, which outputs the probabilities 412a-412n of winning opportunities by their specified close dates. The opportunity-level machine learning model 402 can also output significant drivers of the AI-based probabilities 412a-412n and their positive/negative polarities, meaning the opportunity-level machine learning model 402 can provide explanations for the computed probabilities 412a-412n. Each bottom-up revenue forecast 416 represents an AI probability-adjusted sum of deal sizes that, along with other aggregate-level enterprise and extraprise data, can be used to define features for the aggregate-level machine learning model 404. The aggregate-level machine learning model 404 outputs the AI-based precision revenue forecasts 422, and the aggregate-level machine learning model 404 can also output a list of significant drivers of each forecast 422 along with their positive/negative polarities, meaning the aggregate-level machine learning model 404 can provide explanations for the precision revenue forecasts 422.

In particular embodiments, the opportunity-level machine learning model 402 represents a compound model that includes a classifier machine learning model and a regressor machine learning model. In the same manner as described above with respect to the architecture 300, the classifier machine learning model can be used to determine probabilities of winning or losing open opportunities with no time considerations in mind. In some cases, the classifier machine learning model can be trained on previously-won and previously-lost opportunities, possibly using both static and time series features. The regressor machine learning model can be used to determine expected close dates for open opportunities. In some cases, the regressor machine learning model can be trained only on previously-won opportunities, possibly using both static and time series features. Combinations of the outputs from the classifier and regressor machine learning models can therefore be used to identify the probabilities of open opportunities being won within certain timeframes, such as before specified closing dates or within specified date ranges for the opportunities.

Also, in particular embodiments, the aggregate-level machine learning model 404 represents a regressor machine learning model, such as an elastic net or random forest model, that predicts additional bookings (successfully-won opportunities) between a current time and the end of a fiscal period or other timeframe. The regressor machine learning model may make these predictions at a specified interval, such as on a daily basis. In some cases, the regressor machine learning model can be trained on the value of bookings in previous fiscal periods or other timeframes with available data, and the baseline for training the regressor machine learning model on any given day may be equal to the fiscal period or other timeframe's total bookings minus realized bookings since the start of the fiscal period or other timeframe.

In addition, in particular embodiments, both the opportunity-level machine learning model 402 and the aggregate-level machine learning model 404 use machine learning model interpretability frameworks, such as SHAP or counterfactual explanations, to provide explanations for their outputs. In the case of SHAP explanations, a list of significant drivers for the machine learning model 402, 404 may be generated (such as by using the AI-based evidence package module function 246) and include positive or negative polarities to explain an output of the machine learning model 402, 404. In the case of counterfactual explanations, the machine learning model 402, 404 may identify (such invoke the AI-based evidence package module function 246 to identify) the most similar input to the original input such that the machine learning model 402, 404 would have predicted a different outcome.

Although FIG. 4 illustrates one more specific example of an architecture 400 supporting opportunity scoring and precision revenue forecasting, various changes may be made to FIG. 4. For example, each machine learning model 402, 404 may receive and process any other or additional data as needed or desired. Also, functions can be added, omitted, combined, further subdivided, replicated, or placed in any other suitable configuration in the architecture 400 of FIG. 4 according to particular needs.

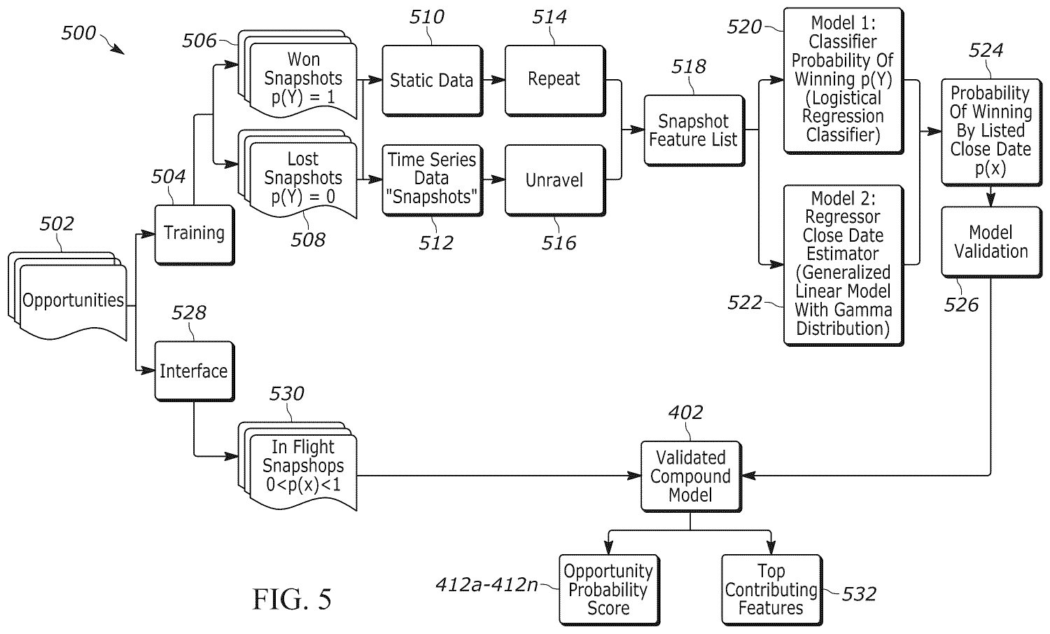

FIG. 5 illustrates an example approach 500 for implementing an opportunity-level machine learning model for use in an architecture supporting opportunity scoring and precision revenue forecasting according to this disclosure. The approach 500 may, for example, be used to implement the opportunity-level machine learning model 402 in the architecture 400 of FIG. 4. However, the opportunity-level machine learning model 402 may be implemented in any other suitable manner. Also, the approach 500 may be implemented by the application server 106 shown in the system 100 of FIG. 1 using one or more instances of the device 200 shown in FIG. 2A. The approach 500 may also be performed within or be used within the architecture 220, modular services component 250, and/or machine learning platform system 260 shown in FIGS. 2B through 2D, such as when the approach 500 is used (among other things) by the AI-based revenue forecasting function 226. However, the approach 500 may be implemented using any other suitable device(s) and architecture(s) and in any other suitable system(s).

As shown in FIG. 5, information 502 defining opportunities is obtained from any suitable source(s). Some of the information 502 is used during a training phase 504, where that information 502 is divided into two subsets 506 and 508. The subset 506 relates to opportunities that were successfully won, meaning they have a known probability of success equal to one. In contrast, the subset 508 relates to opportunities that were lost, meaning they have a known probability of success equal to zero.

The subsets 506 and 508 can be divided into static data 510 and time series data 512. The static data 510 generally represents individual data values, and the time series data 512 generally represents data over one or more specified periods of time. The static data 510 can be pre-processed by a removal operation 514 to remove duplicative data, and the time series data 512 can be pre-processed by an unravel operation 516 to remove time dependencies associated with the data. The results are combined to produce a snapshot feature list 518, which generally represents the features to be used by a trained opportunity-level machine learning model 402. One example of the snapshot feature list 518 that may be used in particular embodiments is shown in Table 1 above, although this list is for illustration only and does not limit the scope of this disclosure to this particular collection of features.

The snapshot feature list 518 is used to train a classifier model 520 and a regressor model 522. As noted above, the classifier model 520 is trained to estimate the probability of successfully winning an opportunity without regard to timing, and the regressor model 522 is trained to estimate the closing date for the opportunity. Outputs of the models 520, 522 can therefore be used to generate a probability 524 of successfully winning an opportunity within a specified timeframe. In some embodiments, the classifier model 520 represents a logistic regression classifier model, and the regressor model 522 represents a generalized linear model with a gamma distribution. The models 520, 522 can undergo model validation 526 to ensure that they appear to be operating accurately based on the generated probabilities 524, such as by comparing the generated probabilities 524 to the known outcomes from the subsets 506 and 508. If validated, the models 520, 522 can be used as a validated compound model representing the opportunity-level machine learning model 402.

Once trained, other information 502 is used during an inference phase 528, where that information 502 represents a snapshot 530 of current opportunities. The snapshot 530 is provided to the opportunity-level machine learning model 402, which generates the probability 412a-412n for each current opportunity and generates or obtains (such as via the AI-based evidence package module function 246) an identification of the top features 532 contributing to each of the probabilities 412a-412n.

In particular embodiments, the outputs from the opportunity-level machine learning model 402 for each opportunity may include the following: a date and time of the prediction, a probability score between 0 and 100 or some other range, a list of the top ten or some other number of contributing features to the model outputs with contributions defined and ranked based on SHAP or other feature contributions (in cases of categorical features such as industry or region, a summed SHAP or other feature contribution may be calculated for all features in that category), and the polarity of the top contributing features as positive or negative. For each contributing feature, the outputs from the opportunity-level machine learning model 402 may further include the following: a current value of the feature, a change in the value of the feature since the last output of the model 402 was generated, and a polarity of the change in the value of the feature (positive or negative) since the last output of model 402 was generated. Of course, these outputs of the model 402 are for illustration only and can vary as needed or desired.

Although FIG. 5 illustrates one example of an approach 500 for implementing an opportunity-level machine learning model 402 for use in an architecture 400 supporting opportunity scoring and precision revenue forecasting, various changes may be made to FIG. 5. For example, the opportunity-level machine learning model 402 may be trained in any other suitable manner. Also, functions can be added, omitted, combined, further subdivided, replicated, or placed in any other suitable configuration in the approach 500 of FIG. 5 according to particular needs.

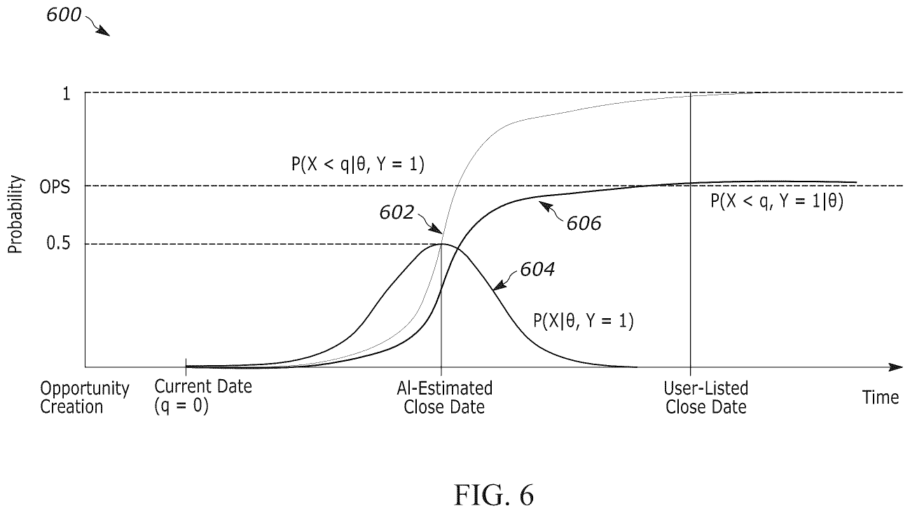

FIG. 6 illustrates an example conditional probability calculation 600 by an opportunity-level machine learning model according to this disclosure. The conditional probability calculation 600 may, for example, be used by the opportunity-level machine learning model 402 to generate each of the probabilities 412a-412n. However, the opportunity-level machine learning model 402 may generate probabilities in any other suitable manner. Also, the same type of calculation may be performed by other machine learning models described in this patent document.

As shown in FIG. 6, the conditional probability calculation 600 is based on values for X, q, and Y. Here, X represents the number of days between a current date and the disposition date of the opportunity (such as a losing or winning event). Also, q represents the number of days between the current date and a query date (such as the end of a fiscal period or a representative-estimated disposition date for an opportunity). Further, Y represents whether or not an opportunity will be won eventually (successfully completed with a sale), and 0 represents the current state of the opportunity (as captured by the values of the features at the time of computing the probabilities). Probabilities in FIG. 6 can be expressed using the same notations described above, namely:

P(Opportunity will be won before query date|current state of opportunity)=

$$P ( X < q , Y = 1 \vert θ )$$

In FIG. 6, a line 602 represents the output of the time-dependent (regressor) model 522 in the opportunity-level machine learning model 402 as a cumulative distribution function. A line 604 represents the same regressor model 522 in the opportunity-level machine learning model 402 as a probability density function. The outputs of the models 520, 522 can be fused to generate a probability 524, 412a-412n, which is represented by a line 606. In some cases, the outputs of the models 520, 522 can be multiplied to generate the probability 524, 412a-412n.

Although FIG. 6 illustrates one example of a conditional probability calculation 600 in an opportunity-level machine learning model 402, various changes may be made to FIG. 6. For example, the specific lines 602-606 in FIG. 6 relate to a specific situation and can vary widely based on the particular circumstances. Also, probabilities for opportunity scores or other probabilities may be determined in any other suitable manner.

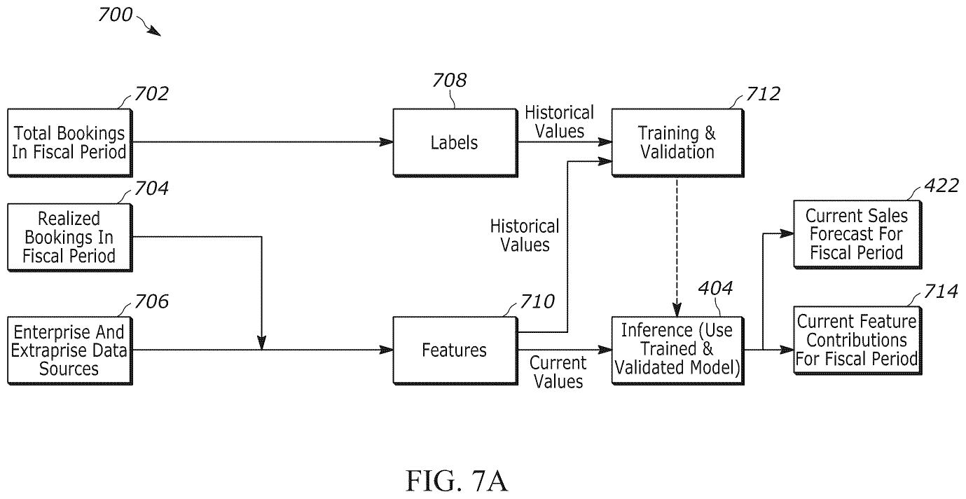

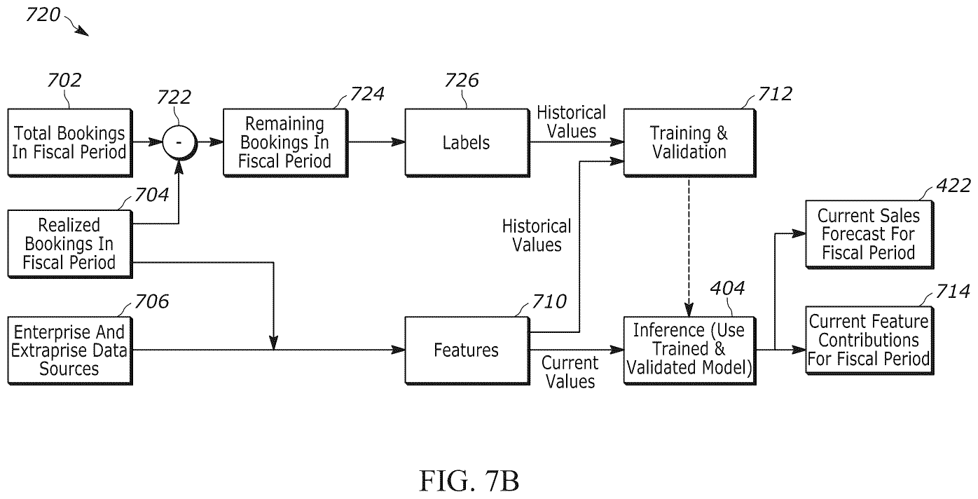

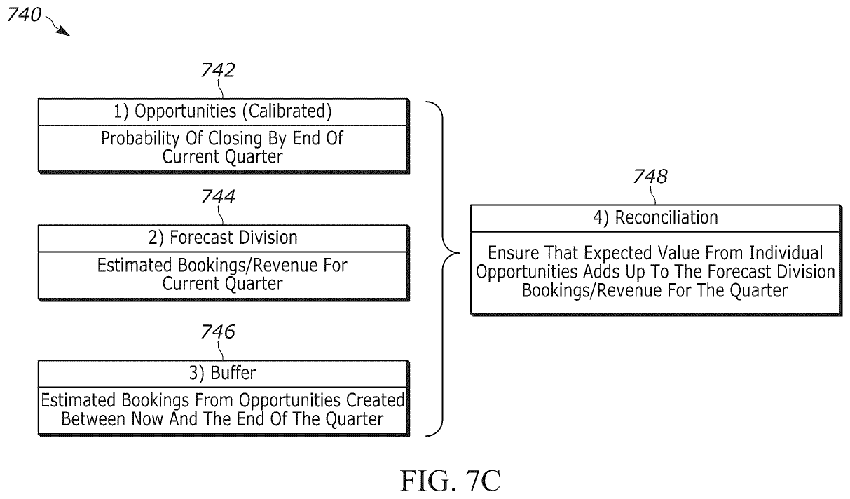

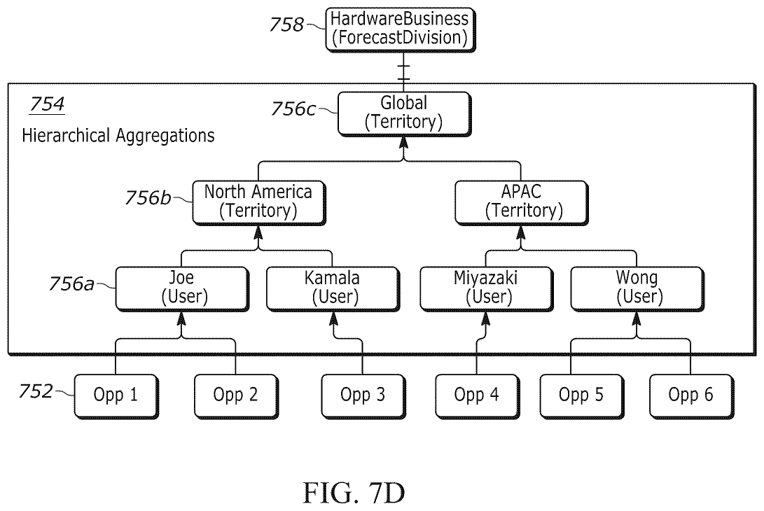

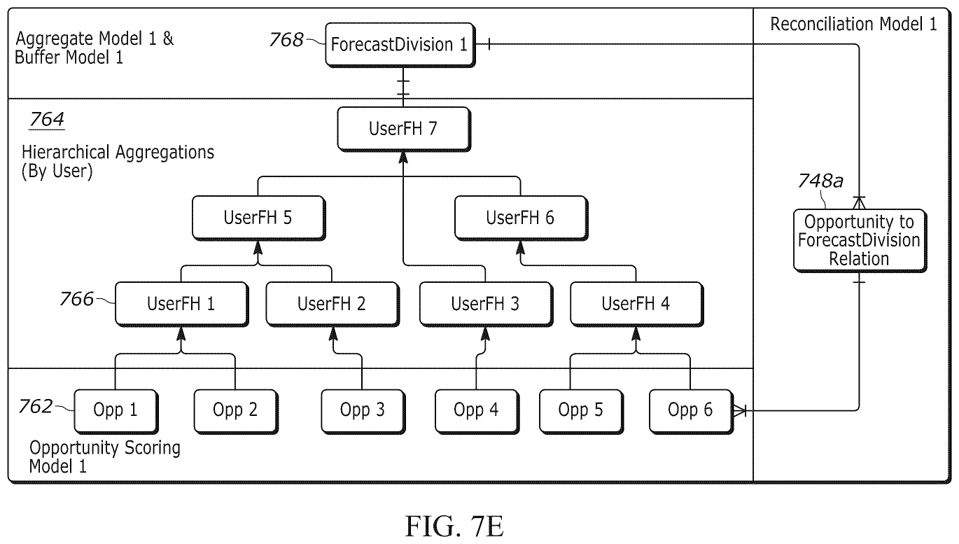

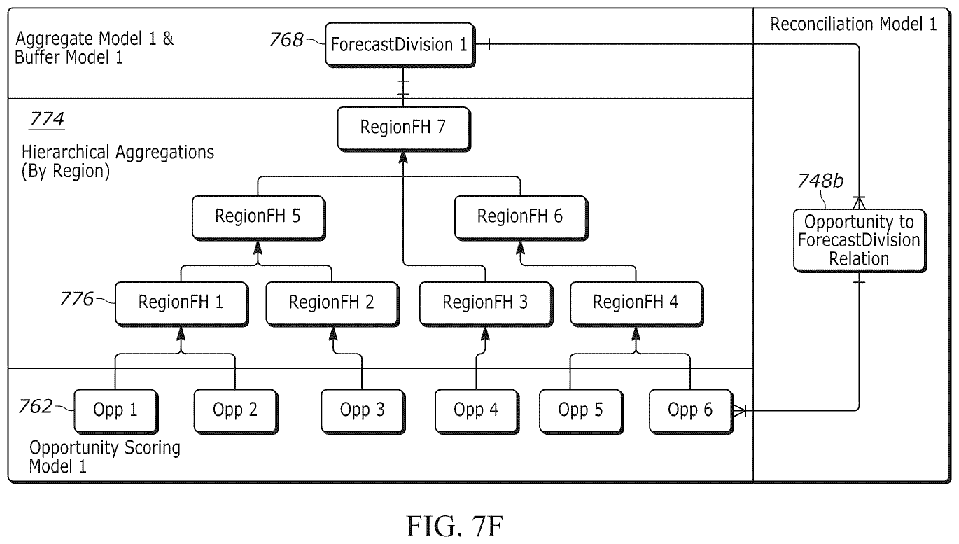

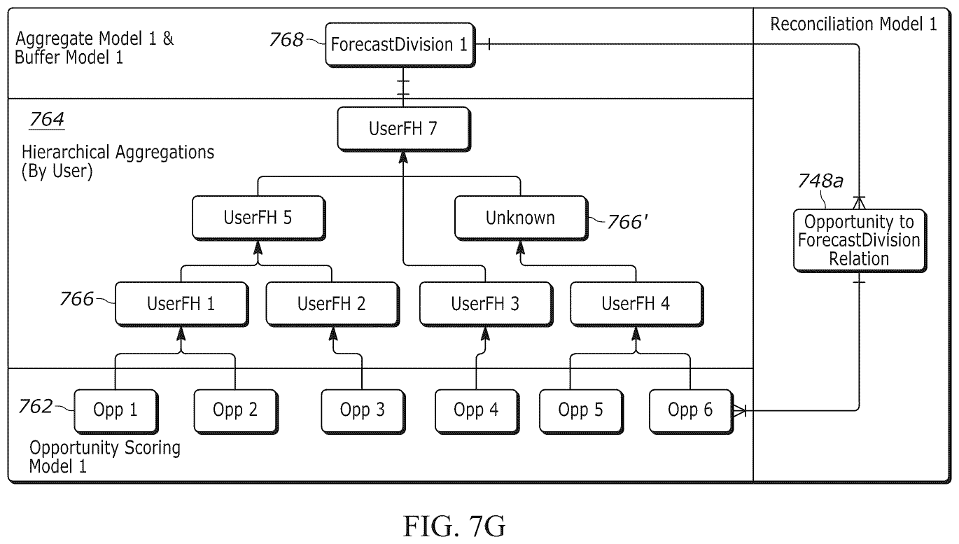

FIGS. 7A through 7G illustrate example approaches 700 and 720 for implementing an aggregate-level machine learning model for use in an architecture supporting opportunity scoring and precision revenue forecasting and example approaches for performing aggregations according to this disclosure. The approaches 700 and 720 may, for example, be used to implement the aggregate-level machine learning model 404 in the architecture 400 of FIG. 4. However, the aggregate-level machine learning model 404 may be implemented in any other suitable manner. Also, the approaches 700 and 720 may be implemented by the application server 106 shown in the system 100 of FIG. 1 using one or more instances of the device 200 shown in FIG. 2A. The approaches 700 and 720 may also be performed within or be used within the architecture 220, modular services component 250, and/or machine learning platform system 260 shown in FIGS. 2B through 2D, such as when the approach 500 is used (among other things) by the AI-based revenue forecasting function 226. However, the approaches 700 and 720 may be implemented using any other suitable device(s) and architecture(s) and in any other suitable system(s).

As shown in FIG. 7A, information defining opportunities that are successfully won is obtained from any suitable source(s). In this example, the information includes information 702 identifying total bookings, which identifies the opportunities successfully won for a given fiscal period (such as a quarter). The information also includes information 704 identifying realized bookings, which identifies the won opportunities that have been successfully finalized for the given fiscal period. Any other desired information 706, internal or external, may also be obtained here.

The information 702 is used to generate labels 708, and the information 704 and 706 is used to generate features 710. The labels 708 and some of the features 710 (historical features) are used during a training and validation phase 712, where that information is used to train an aggregate-level machine learning model 404. The following table represents one example of the labels 708 and features 710 that may be used in particular embodiments of the aggregate-level machine learning model 404, although this list is for illustration only and does not limit the scope of this disclosure to this particular collection of labels and features.

TABLE 2

| Category | Feature | Description |
|---|---|---|
| Pipeline | Total deal size | Total sum of deal sizes for all open |
| | | opportunities |
| | Deal size this quarter | Total sum of deal sizes for all open |
| | | opportunities with an expected close date |
| | | within this quarter |
| | Deal size this year | Total sum of deal sizes for all open |
| | | opportunities with an expected close date |
| | | within this year |
| | Open opportunities | Total number of open opportunities in |
| | | the pipeline |
| | Open opportunities this | Percent of open opportunities with an |
| | quarter | estimated close date within this quarter |
| | Committed distribution | Percent of open opportunities with a |
| | | forecast category as “committed” or |
| | | equivalent |
| | Best case distribution | Percent of open opportunities with a |
| | | forecast category as “best case” or |
| | | equivalent |
| | Pipeline distribution | Percent of open opportunities with a |
| | | forecast category as “pipeline” or |
| | | equivalent |
| | Stage X distribution | Percent of open opportunities in each |
| | | sales or other transaction stage |
| | Deal type X distribution | Percent of open opportunities in each |
| | | deal type defined |
| | Days until the end of the | Number of days until the end of the |
| | quarter | quarter |
| | Average residence time | Average number of days spent in each |
| | | sales or other transaction stage defined |
| | | for open opportunities |
| | Average opportunity age | Average age of open opportunities |
| | Number of industries | Total number of industries represented |
| | | by open opportunities |
| | Total annual revenue | Sum of reported annual revenues for all |
| | | open opportunities (for public |
| | | companies) |
| | Average number of | Average of the reported number of |
| | employees | employees for all open opportunities (for |
| | | public companies) |
| | Total news | Sum of relevant news articles for all open |
| | | opportunities |
| | Currency distribution | Percent of open opportunities in different |
| | | currencies, such as USD, AUD, CAD, |
| | | CHF, CNY, EUR, GBP, JPY, or other |
| | Percent public | Percent of open opportunities with public |
| | | companies |
| | Average Opportunity | Average AI-based opportunity |
| | Probability Score | probability score across all open |
| | | opportunities |
| | Positive AI flag distribution | Percent of open opportunities flagged by |
| | | AI as optimistic |
| | Negative AI flag | Percent of open opportunities flagged by |
| | distribution | AI as pessimistic |
| Team | Representative count | Total number of active representatives |
| | Territories | Total number of active territories/regions |
| | Average tenure | Average tenure for active representatives |
| | | (such as in months or other temporal |
| | | units) |
| | Total emails sent | Total number of emails sent |
| | Total quota | Sum of quotas for all representatives |
| Aggregate | Total emails received | Total number of emails received across |
| Customer | | all open opportunities |
| Engagement | Total appointments | Total number of appointments made |
| | | across all open opportunities |
| | Average email frequency | Average number of days between |
| | | subsequent received emails across all |
| | | open opportunities |
| | Average email sentiment | Average sentiment of received emails |
| | | across all open opportunities |
| | Total website visits | Total number of visits to the company's |
| | | website by IP addresses associated with |
| | | all open opportunities |
| Products/ | Product type X distribution | Percent of open opportunities with each |
| Services | | product/service type defined |
| | Average price | Average price for each product/service |
| | | type defined |
| | Number of product/service | Total number of unique products/services |
| | types | offered across all open opportunities |
| Marketing | Past marketing spent | Total amount spent on marketing X days |
| | | ago, where X is the average sales or other |
| | | transaction cycle in days (or other |
| | | temporal units) |
| | Past paid advertising spent | Total amount spent on paid advertising X |
| | | days ago, where X is the average sales or |
| | | other transaction cycle in days (or other |
| | | temporal units) |
| | Past organic impressions | Total number of organic search |
| | | impressions X days ago, where X is the |
| | | average sales or other transaction cycle |
| | | in days (or other temporal units) |
| | Past marketing campaigns | Total number of active marketing |
| | | campaigns X days ago, where X is the |
| | | average sales or other transaction cycle |
| | | in days (or other temporal units) |
| | Past leads count | Total number of leads X days ago, where |
| | | X is the average sales or other transaction |
| | | cycle in days (or other temporal units) |
| | Lead conversion | Percent of leads that convert to |
| | | opportunities |
| Macroeconomics | Global index prices | Daily index price for each of 70 or other |
| | | number of global indexes |
| | Continuous features | Daily price of 78 or other number of |
| | | futures contracts in the U.S. and |
| | | internationally |
| | Trading economics | |
| | Global commodity prices | Commodity prices globally, such as gold, |
| | | oil, copper, or silver |
| | Global commodity | Commodity inventories globally, such as |
| | inventories | crude oil, natural gas, metals, or grains |

The labels 708 and features 710 are used here to train the aggregate-level machine learning model 404, which may represent a regressor model. The model 404 can be trained here to predict the total bookings of a fiscal period directly. Once trained, the aggregate-level machine learning model 404 is used during an inference phase, where features 710 related to current data are provided to the model 404. The model 404 can then generate a precision revenue forecast 422 and generate or obtain (such as via the AI-based evidence package module function 246) an identification of the top feature contributors 714 (both positive and negative) contributing to the precision revenue forecast 422.

In particular embodiments, the outputs from the aggregate-level machine learning model 404 may include the following: a date and time of the prediction, a predicted amount of additional bookings between now and the end of a fiscal period (such as in a default currency or other currency), a list of the top ten or some other number of contributing features to the model prediction with contributions defined and ranked based on their SHAP or other feature contributions (in cases of categorical features such as industry or region, a summed SHAP or other feature contribution may be calculated for all features in that category), and the polarity of the top contributing features as positive or negative. For each contributing feature, the outputs from the aggregate-level machine learning model 404 may further include the following: a current value of the feature, a change in the value of the feature since the last output of the model 404 was generated, and a polarity of the change in the value of the feature (positive or negative) since the last output of model 404 was generated.

As shown in FIG. 7B, the information 702-706 is used somewhat differently. In this example, a processing operation 722 subtracts the realized bookings from the total bookings in order to estimate the remaining bookings 724 in a fiscal period. The remaining bookings 724 may then be used as labels 726 for the training and validation phase 712. This approach may train the aggregate-level machine learning model 404 to predict future bookings, which can be added to the realized bookings in order to generate the forecast 422.

As noted above, multiple opportunity scores can be reconciled into various aggregate-level forecasts, which (among other things) allows probabilistic forecasts that are generated as expectations of future values to be combined at multiple hierarchical levels. An optimization formulation can be used to adjust opportunity scores for aggregation at multiple hierarchical levels, and the optimization formulation can account for ranges within which the probabilities can be adjusted. Moreover, opportunity scores can be scaled or otherwise formulated to fall within a specified range (such as a range of [0, 1]) when explicit ranges are not specified. Here, opportunity probabilities (opportunity scores) and bookings forecasts can be adjusted, such as in the smallest ways possible, so that expected values of opportunities roll-up into broader aggregate-level forecasts. In some embodiments, the optimization formulation used for aggregating opportunity scores into various aggregate-level forecasts at multiple hierarchical levels can be expressed using the following optimization problem:

$${min}_{adjustedP ( {Oppty}_{i} ) ∀ i , adjustedBuffer} ( {‖ [ \begin{matrix}F \\ λ FP ( {Oppty}_{1} ) \\ λ FP ( {Oppty}_{2} ) \\ λ FP ( {Oppty}_{3} ) \\ ⋮ \\ ForecastBuffer\end{matrix} ] - [ \begin{matrix}{v}_{1} & {v}_{2} & {v}_{3} & ⋯ & 1 \\ λ F & 0 & 0 & ⋯ & 0 \\ 0 & λ F & 0 & ⋯ & 0 \\ 0 & 0 & λ F & ⋯ & 0 \\ ⋮ & ⋮ & ⋮ & ⋱ & ⋮ \\ 0 & 0 & 0 & ⋯ & 1\end{matrix} ] [ \begin{matrix}adjustedP ( {Oppty}_{1} ) \\ adjustedP ( {Oppty}_{2} ) \\ adjustedP ( {Oppty}_{3} ) \\ ⋮ \\ adjustedBuffer\end{matrix} ] ‖}^{2} )$$

$$subject to :$$

$${\sum }_{i} adjustedP ( {Oppty}_{i} ) \cdot {v}_{i} + adjustedBuffer \leq F$$

$$P ( {Oppty}_{i} ) - ϵ \leq adjustedP ( {Oppty}_{i} ) \leq P ( {Oppty}_{i} ) + ϵ , ∀ i ∈ I$$

Here, F represents the remaining bookings or revenue for the fiscal period of interest, which can be determined as a difference between (i) the bookings or revenue forecast for a fiscal period of interest and (ii) the bookings or revenue realized so far in the fiscal period of interest. Also, the expression {P(Opptyᵢ), ∀i∈I} represents the probability of winning an opportunity i that is generated during opportunity probability prediction as described above. In addition, ForecastBuffer is used to estimate how many opportunities will be created and closed between the current date and an end of the fiscal period of interest. Such opportunities do not already exist in a pipeline and may frequently appear because sales reps or other personnel may enter deals that have been won into a system on the days that they are won (without logging any opportunity snapshots through time). This can be thought of as capturing unseen opportunities that add to bookings for the fiscal period of interest. The total forecast can then be determined as the sum of products of opportunities in the system and their deal sizes, plus the forecast buffer (opportunities not in the system).

Aggregate-level forecasts that are based on opportunity scores (such as those determined as described above) may be defined using their own models. For example, an aggregate-level forecast may include a “forecast division,” which represents a collection of opportunities. Multiple types of forecast divisions may be defined and used in the system 100. In some embodiments, a forecast division may be used in an arrangement of models, such as an arrangement 740 of models as shown in FIG. 7C. In this example, the arrangement 740 includes a collection of opportunities 742, which are defined by or associated with the probabilities that specified opportunities will close within a specified time period (a quarter in this example, although other specified time periods may be used). These opportunities 742 can be calibrated to a human-understood scale as noted above. The arrangement 740 also includes a forecast division 744, which identifies the estimated bookings or revenue for the specified time period. The arrangement 740 further includes a buffer model 746, which is used to estimate the bookings from opportunities that might be created between the current time and the end of the specified time period. The buffer model 746 helps to ensure that aggregate-level forecasts capture opportunities that do not exist as of the current time but can be created later in the current fiscal period and closed in the same fiscal period as explained above. Finally, the arrangement 740 includes a reconciliation model 748, which can help to ensure that the expected revenue or other value from the individual opportunities 742 sum to the estimated bookings or revenue as identified by the forecast division 744.

These approaches support the roll-up of opportunity scores into any suitably-defined aggregation. Different aggregations can define different ways in which opportunity scores can be rolled-up to produce aggregated values. As noted above, example ways in which opportunity scores can be rolled-up to produce aggregated values can be based on representative hierarchies, account hierarchies, geographical region/territory hierarchies, industry hierarchies, and product/service hierarchies. Heterogenous hierarchies (such as a combination of two or more of these types of hierarchies) may also be supported.

Overall, forecasts can be generated for each level of a hierarchy by rolling-up the opportunity scores (optionally after reconciling them) to produce a top-level forecast. FIGS. 7D through 7G illustrate example ways in which aggregations may occur in order to produce forecasts based on opportunity scores. As shown in FIG. 7D, opportunity scores 752 can be subjected to various hierarchical aggregations 754, which in this example include user aggregations 756a, smaller territory aggregations 756b, and a larger territory aggregation 756c. Each user aggregation 756a can combine opportunity scores 752 for the same individual representative, each smaller territory aggregation 756b can combine the cumulative opportunity scores 752 for multiple representatives associated with the same smaller geographic region, and the larger territory aggregation 756c can combine the cumulative opportunity scores 752 for multiple smaller geographic regions associated with the larger geographic region. These hierarchical aggregations 754 therefore represent a heterogenous hierarchy since it involves different types of aggregations (in this case, representation and region). The cumulative value generated using the larger territory aggregation 756c can represent an aggregate score 758, which in this example represents a forecast division aggregation.

This type of approach can support various hierarchy-agnostic roll-ups of opportunity scores in different ways. As a result, when a change to a hierarchy occurs, the final rolled-up value can remain unaffected. An example of this is shown in FIGS. 7E and 7F. In FIG. 7E, opportunity scores 762 are subjected to various hierarchical aggregations 764, which in this example include various user aggregations 766. The user aggregations 766 are used here to produce an aggregate score 768, which in this example represents a forecast division aggregation. The forecast division aggregation is defined based on an opportunity-to-forecast division relation 748a, which is defined by the reconciliation model 748. In FIG. 7F, the same opportunity scores 762 are subjected to various hierarchical aggregations 774, which in this example include various region aggregations 776. The region aggregations 776 are used here to produce the same aggregate score 768, which in this example represents a forecast division aggregation. The forecast division aggregation is defined based on an opportunity-to-forecast division relation 748b, which is defined by the reconciliation model 748. As can be seen here, it is possible to swap out a representative- or user-based hierarchy with a region-based hierarchy (or vice versa) and, as long as the same opportunity scores belong to a forecast division, the top-level aggregate value does not change. The same type of result may be obtained using any other suitable hierarchy.

One example benefit of using a hierarchy-agnostic design is that the approach tends to be robust to gaps in the hierarchy. For example, as shown in FIG. 7G, if “UserFH 6” in the hierarchy of FIG. 7E leaves an organization, all opportunity scores under that user would not automatically be excluded from the roll-up. Rather, a catch-all node 766′ in the hierarchy (labeled “Unknown” in this example) can be used to account for opportunity scores that still belong to the forecast division but that are now missing an intermediate user within the hierarchy.

Although FIGS. 7A through 7G illustrate examples of approaches for implementing an aggregate-level machine learning model 404 for use in an architecture 400 supporting opportunity scoring and precision revenue forecasting and examples of approaches for performing aggregations, various changes may be made to FIGS. 7A through 7G. For example, the aggregate-level machine learning model 404 may be trained in any other suitable manner. Also, any other suitable hierarchical aggregations or other aggregations may be supported.

### Precision Product Forecasting

Returning to FIG. 3, opportunity scoring can also be used to support an AI-based product forecasting function 324. For example, the AI-based product forecasting function 324 can receive information identifying the likelihood of each opportunity being won within a given timeframe and generate predictions 326 and 328. The predictions 326 may represent predictions of likely revenue from sales (or other transactions) for individual products or services during the given timeframe, such as revenue for individual products or services in a specified currency. The predictions 328 may represent predictions of likely volumes of sales (or other transactions) for individual products or services during the given timeframe, such as specified quantities for individual products or services.

The predictions 326 and 328 can be generated by estimating the revenues and volumes associated with the opportunities that are likely to be won within the given timeframe, which can be determined as discussed above. In some cases, the AI-based product forecasting function 324 can generate the predictions 326 and 328 based on adjustments 330 by price per SKU number. This can help to convert overall revenue or sales/transaction estimates into values associated with specific SKU numbers (and therefore specific products or services). Additional product, pricing, packaging, and supply chain information may be leveraged by machine learning models to increase the accuracy of the forecast.

As described above, some features used by the PSF machine learning model 312 may be calculated by summing the corresponding features at the opportunity-level across all opportunities. Metrics evaluated at the business-level (or other higher level above the opportunity-level) that involve summations or other operations across all opportunities may be slow, particularly given the number of features and opportunities that might exist within each business. In some cases, the model orchestrator function 242 may evaluate the OS metrics on an individual level using the OS machine learning model 304 and store those results. When the model orchestrator function 242 needs to generate predictions using the PSF machine learning model 312, the model orchestrator function 242 may retrieve the relevant stored results and sum the retrieved values to provide features to the PSF machine learning model 312. Although this uses memory to store the results, it can significantly speed up model evaluation. Note, however, that other approaches that do not store results ahead of time may also be used.

Although FIG. 3 illustrates one example of an architecture 300 supporting opportunity scoring, precision revenue forecasting, and precision product forecasting, various changes may be made to FIG. 3. For example, while the architecture 300 here is described as supporting opportunity scoring, precision revenue forecasting, and precision product forecasting, the architecture 300 may support only one or two of these functions. For instance, the OS machine learning model 304 may be used separate and apart from the PSF machine learning model 312.

### Next Best Offer/Product/Action

Companies routinely attempt to identify which products or services to offer to new or existing customers. Typically, representatives use human intuition or simple analytical methods, such as rule-based engines, that use human inputs. However, these approaches fall short because they tend to be uncertain, are time consuming, include human biases, and are not able to incorporate all relevant data. This can result in customers being offered the wrong products or services or not being offered products or services that would have been purchased, and both scenarios lead to a lower revenue growth for the company.

AI-based next best offer/product/action functionality generally applies machine learning techniques to generate propensity scores associated with customers' likelihoods of purchasing additional products or services. Representatives can use those propensity scores to prioritize customers for selling, cross-selling, or up-selling products or services. For example, this functionality can predict, for each customer and for each available product or service, the probability that the customer will purchase or otherwise enter into a transaction for the product or service (if the product or service is offered to that customer). AI evidence package functionality may be used to identify explanations for the predictions, such as to identify the top probability contributors with indications on magnitude and directionality of impact. Customer segmentation may also be used here, which generally involves segmenting or dividing customers into groups to allow other functions (such as the next best offer/product/action) to be performed for groups of customers.

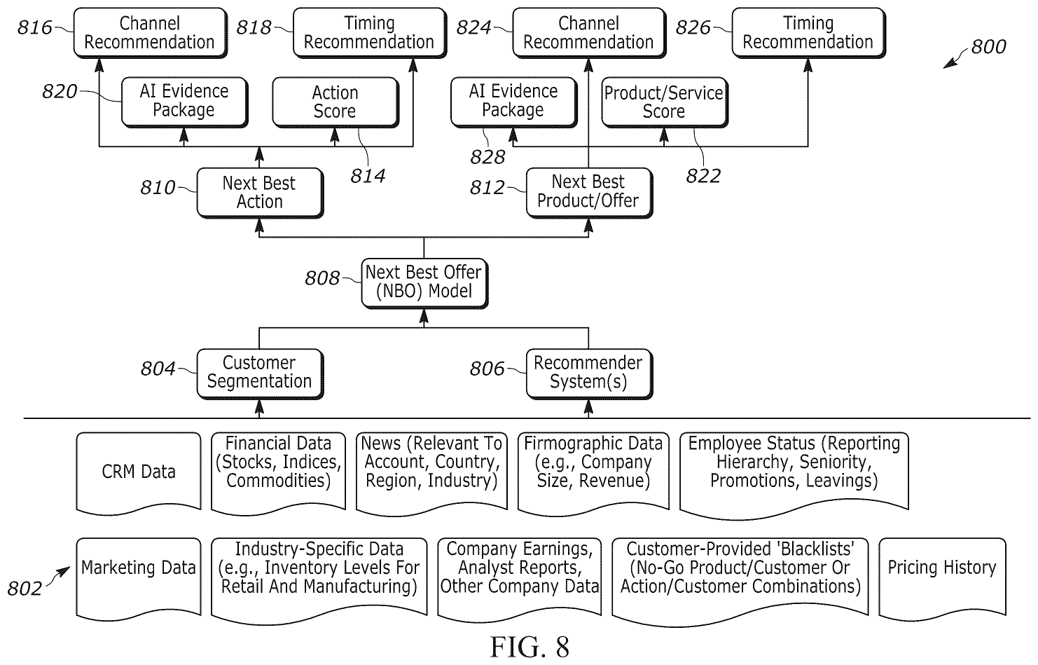

FIG. 8 illustrates an example architecture 800 supporting next best offer/product/action functionality and customer segmentation according to this disclosure. The architecture 800 may, for example, be implemented by the application server 106 shown in the system 100 of FIG. 1 using one or more instances of the device 200 shown in FIG. 2A. The architecture 800 may also form part of or be used within the architecture 220, modular services component 250, and/or machine learning platform system 260 shown in FIGS. 2B through 2D, such as when the architecture 800 is used (among other things) to implement at least part of the NBO/NBP/NBA function 230. However, the architecture 800 may be implemented using any other suitable device(s) and architecture(s) and in any other suitable system(s).

As shown in FIG. 8, data from a wide variety of data sources 802 may be obtained and used by the architecture 800. In this particular example, the data sources 802 include many of the same data sources 302 described above. In addition, the data sources 802 may include one or more sources of marketing data and blacklists. The marketing data may identify marketing efforts that have been made targeting one or more industries or markets generally or one or more actual or potential customers specifically. The blacklists may identify products or services that should not be offered to particular customers or activities that should not occur involving particular customers.

This information is processed using an AI-based customer segmentation function 804, which is described in more detail below. This information is also processed using at least one recommender system 806, which may represent a conventional, existing, or other system in a company that identifies potential recommendations of products or services for customers. The recommender system 806 may, for instance, use collaborative filtering or content-based filtering to make recommendations for customers.

At least some of the information from the data sources 802 and the outputs from the AI-based customer segmentation function 804 and the recommender system 806 are provided to a next best offer/product/action (referred to collectively as “NBO”) machine learning model 808, which processes the information to generate a next best action 810 and a next best product/offer 812. The next best action 810 generally identifies at least one proposed action to be taken by the company for a specific customer that is most likely to lead to a positive outcome for an opportunity. Note that the proposed action may be used as an input to other CRM-related functions, such as marketing optimization, as described below. The next best product/offer 812 generally identifies at least one proposed product or service that is most likely to be purchased or otherwise obtained by the specific customer. The next best product/offer 812 can also be used to identify which customers are most likely to purchase or obtain one or more specific products.

The NBO machine learning model 808 here is therefore used to identify and prioritize the best new opportunities that should be pursued by representatives. In some embodiments, depending on the data available, the NBO machine learning model 808 may use supervised, unsupervised, semi-supervised, deep learning, or positive-unlabeled (PU) learning to generate a probability that a given customer will purchase or otherwise obtain a given product or service. The NBO machine learning model 808 may consider various factors when generating recommendations, such as which other customers obtained a product or service, what other products or services the given customer has obtained, when these products or services were obtained, external data (such as news, financial, and social media information), and metadata about both products/services and the given customer. Using this type of information, the NBO machine learning model 808 can generate propensity scores, each of which identifies a probability that a specific customer will obtain a specific product or service. The NBO machine learning model 808 can also rank the propensity scores, which allows representatives to focus on the opportunities that have better likelihoods of being won.

In some cases, the NBO machine learning model 808 can be trained based on historical sales records or other historical information to identify customers' characteristics and features that indicate whether the customers are likely to purchase or otherwise obtain specific products or services. Historical records that indicate customers have obtained specific products or services may be labeled as positive, and historical records that indicate customers were offered specific products or services but chose not to obtain them may be labeled as negative. If there is no information on whether a customer has been offered a specific product or service or if no decision has been made by the customer, the corresponding record may be unlabeled. The actual type of NBO machine learning model 808 to be applied can vary based on the types of labels (or lack thereof) available during training. For instance, in the presence of completely labeled records, a supervised learning algorithm may be used to train the NBO machine learning model 808, such as when a gradient boost, random forest, neural network, or logistic regression technique is used. In the absence of labels, an unsupervised learning algorithm may be used to train the NBO machine learning model 808, such as when a one-class support vector machine, Gaussian mixture model, isolation forest, clustering, or auto-encoding technique is used. When few positive and negative labels are present, a semi-supervised learning algorithm may be used to train the NBO machine learning model 808, such as when a transductive support vector machine or Tikhonov-regularized graph technique is used. When few positive labels and no negative labels are present, a positive-unlabeled learning algorithm may be used to train the NBO machine learning model 808, such as when a bagged support vector machine or bagged logistic regression technique is used.

The following table represents one example of the feature list that may be used in particular embodiments of the NBO machine learning model 808, although this list is for illustration only and does not limit the scope of this disclosure to this particular collection of features.

TABLE 3

| | | |
|---|---|---|
| Category | Feature | Description |

Demographies/firmographics

| | | |
|---|---|---|
| Customer | Industry | Information about a customer's business |
| description - | Annual revenue | |
| firmographic | # of employees | |
| | Market cap | |
| | Locations | |
| | Products | |
| Customer | For publicly-traded | Price time series for stocks, sectors, and |
| description - | companies: | commodities (both for customers and the |
| financials and | Equity price volatility | company using CRM) |
| market conditions | Directional price changes | |
| | over time | |
| | Total volume of shares | |
| | being traded | |
| | Performance relative to | |
| | sector | |
| | Financials (revenue, | |
| | profit trends) | |
| Customer - | Directional price changes | Economic factors that can affect the |
| market conditions | of related commodities | customer's performance |
| | Economic conditions | |
| Customer - org | Employee names | Information about a customer's hierarchy |
| charts | Employee titles | |
| | Employee reporting | |
| | relationships | |
| Customer's | Employee names | Information about the degree of closeness |
| degree of | Employee titles | between the company and the customer, |
| closeness to | Employee reporting | such as seats on the same board for |
| company's org | relationships | executives or shared experiences (like same |
| chart | Employee connections | business school) |
| News | Frequency of n-grams | Top N most significant online news articles |
| | over time | over a specified time period |
| | Sentiment analysis and | |
| | scores | |
| | Frequency of news | |
| | articles from various | |
| | sources | |
| | Classifications of various | |
| | corporate events over | |
| | time | |
| Information about | Title | Basic professional information (such as |
| customer - | Function | previous roles and title) |
| professional | Seniority | |
| details | Professional experience | |
| | Education | |
| Information about | Address, location | Basic demographic information |
| customer - | Income bracket | Financial information (such as income and |
| financial and | Financial history (credit | red flags) |
| demographic | history, delinquencies, | |
| | homeownership status, | |
| | presence of mortgage) | |
| | Household size, | |
| | household members | |
| | information (such as | |
| | marital status and number | |
| | of children) | |
| Information about | Interests/hobbies | Information about a customer's interests that |
| customer - | Political views | cannot be gleaned from other data sources |
| hobbies and | Sentiment towards the | (Ethical/legal considerations may be present |
| interests | brand | here) |
| | Sentiment towards | |
| | competitors | |

Buying Patterns

| | | |
|---|---|---|
| Buying patterns | Quantity | Transaction history with the company |
| | Price | Historical deal closures and associated |
| | SKU | information for all customers |
| | Shopping basket | |
| | information (items sold | |
| | together) | |
| | Discount status | |
| | Timestamp | |
| | Representative | |
| | Sequence of events | |
| | Terms of sale (duration of | |
| | contract) | |
| | (For B2C) online cart | |
| | activity information, such | |
| | as how long the item was | |
| | in the cart, etc. | |
| | (For B2C) Payment | |
| | methods used | |
| Customer | Quantity of activities for | Activities involving a given contact or |
| accounts and | each customer | customer |
| coverage | Activity frequency per | |
| | customer | |
| | Representative involved | |
| | N-grams in activity | |
| | descriptions | |
| | Contacts involved from | |
| | customer | |
| Customer (current | Sentiment score | All emails and other interaction records |
| and potential) | Frequency of | associated with a given customer |
| interaction | communication | |
| records | Sequence of interactions | |
| | Engagement from | |
| | decision-makers | |
| | Presence of meetings | |
| | Character length | |
| | Actions (open/not open | |
| | email, email sent to | |
| | inbox/spam, duration of | |
| | reading email) | |
| Customer service | Transcripts, interaction | All activities associated with customer |
| records | notes | service activities |
| | Timestamps | |
| | Products/services about | |
| | which a customer service | |
| | touchpoint was initiated | |
| | Customer's sentiment | |
| | towards the company | |
| Promo history | Promo category (such as | Information about what promos went to |
| | discount, pure up-sell, | what customers, when, and via what |
| | etc.) | channels |
| | Promotional channel | |
| | Promo sequence | |
| | Link to promo content | |
| | (such as email text, or | |
| | postcard image) | |
| | Targeted customers - list, | |
| | addresses | |
| | Campaign affiliation | |
| Response-to- | Customers who actioned | Information about customers who actioned |
| promos history | a promo within X, Y, Z | the promo, how they actioned it, and when |
| | days of receiving it | they did so |
| | Dates of responses | |
| | Nature of actioning the | |
| | promo (such as bought a | |
| | higher-tier software | |
| | offering on sale + bought | |
| | an additional software | |
| | product) | |
| | Bounce rates (such as | |
| | returned mail or bounced | |
| | emails) | |

Other

| | | |
|---|---|---|
| General | Quantity | Description of available products/services |
| product/service/ | Price | |
| SKU records | SKU | |
| | Availability dates | |
| | Price/discount history | |
| User-provided | Recommendation on | Data that retrains the model based on the |
| feedback on next | which the feedback was | recommendations that customers did not |
| best offer | provided | find suitable |
| recommendations | User-provided | |
| | information/data (such as | |
| | usability score or text) | |
| Stage | Pipeline stage | Field indicating a deal stage |
| Time | Timing for deal creation, | Opportunity timing information |
| | stage movement, and | |
| | closure | |
| Representative/ | Representative assigned | Name and history of the representative |
| Deal | to the deal | assigned to the deal |
| Profit/revenue | Price | Information to calculate profit/revenue from |
| data | Fixed costs | the sale or other transaction of each |
| | Variable costs | product/service |
| History of | Generated | Generated NBO recommendations are |
| generated NBO | recommendations | tracked and used to backtest the model and |
| recommendations | (customer, channel, | calculate its performance |
| | timing, product, content, | |
| | affiliated marketing | |
| | campaign) | |

Note that after one or more NBO recommendations are made here, one or more representatives may provide feedback accepting, rejecting, or modifying the recommendations. Feedback rejecting or modifying a recommendation may be needed for various reasons. For instance, the NBO machine learning model 808 may provide an unreasonable or unrealistic recommendation, such as a recommendation to sell a customer an excessive amount of a product or a recommendation that a representative otherwise feels is invalid. The NBO machine learning model 808 may also lack certain information, such as knowledge that a particular officer or employee has left a customer (which may negatively impact an opportunity but which may not yet be manually entered into a traditional CRM database or other database). In some cases, a representative may be able to select a particular reason for rejecting or modifying a recommendation, such as from a drop-down menu, or the representative may be able to enter free-form text describing the reason. However the feedback is provided, the feedback itself may represent additional knowledge that can be used by the NBO machine learning model 808 in making future recommendations or in retraining the NBO machine learning model 808.

In this example, each next best action 810 is associated with an action score 814, a channel recommendation 816, a timing recommendation 818, and an AI evidence package 820. The action score 814 may represent a numerical value (such as a value from 0 to 100) that identifies how strongly the recommended action might result in a won opportunity. The channel recommendation 816 identifies a proposed communication channel for taking the action, such as via email, telephone call, video conference, or in-person meeting. The timing recommendation 818 identifies a proposed time for taking the action, such as a local time of day or day of the week. The AI evidence package 820 can provide explanation(s) for the action score 814, channel recommendation 816, or timing recommendation 818. For instance, the AI evidence package 820 may identify the largest contributors to the action score 814, channel recommendation 816, or timing recommendation 818 (both positive and negative), such as when the AI evidence package 820 identifies which features have the largest impact on that action score 814, channel recommendation 816, or timing recommendation 818. In some cases, the AI evidence package 820 can be obtained using the AI-based evidence package module function 246.

Similarly, each next best product/offer 812 is associated with a product/service score 822, a channel recommendation 824, a timing recommendation 826, and an AI evidence package 828. The product/service score 822 may represent a numerical value (such as a value from 0 to 100) that identifies how likely a customer is to obtain a specific product or service if the specific product or service was offered to the customer. The channel recommendation 824 identifies a proposed communication channel for making an offer for the product or service, such as via email, telephone call, video conference, or in-person meeting. The timing recommendation 826 identifies a proposed time for making an offer for the product or service, such as a local time of day or day of the week. The AI evidence package 828 can provide explanation(s) for the product/service score 822, channel recommendation 824, or timing recommendation 826. For instance, the AI evidence package 828 may identify the largest contributors to the product/service score 822, channel recommendation 824, or timing recommendation 826 (both positive and negative), such as when the AI evidence package 828 identifies which features have the largest impact on that product/service score 822, channel recommendation 824, or timing recommendation 826. In some cases, the AI evidence package 828 can be obtained using the AI-based evidence package module function 246.

In some embodiments, a library of AI evidence packages can be used for further processing, analysis, use, re-use, etc. The ability to use AI evidence packages as machine learning model inputs and to collect AI evidence packages into libraries for further processing, analysis, or use can provide various technical advantages, such as reduced processing or networking resources used. In some embodiments, AI evidence packages can be used as inputs to other machine learning models to derive merged or layered insights. Also, in some embodiments, AI evidence packages can be used independent of other elements of an AI CRM platform, such as by without rerunning the associated machine learning model(s) in order to regenerate the same outputs. For example, the AI-based evidence package module function 246 can run independent of the data handler 240, model orchestrator 242, AI CRM engine 244, etc. In some cases, a library of AI evidence packages can be used as part of a distributed AI CRM platform. For instance, a library of AI evidence packages can be used in a virtual computing environment separate from the data handler 240, model orchestrator 242, AI CRM engine 244, etc.

Although FIG. 8 illustrates one example of an architecture 800 supporting next best offer/product/action functionality and customer segmentation, various changes may be made to FIG. 8. For example, any other or additional data may be used as needed or desired. Also, next best offer/product/action functionality may or may not be used with customer segmentation.

### Customer Segmentation

Customer segmentation generally involves segmenting or dividing customers into groups, such as to allow targeted actions to be performed for groups of customers. Customer segmentation processes information to segment customers across various criteria. For example, different customers can be segmented into groups, such as based on their respective industries, regions, and sizes. These types of groups tend to be more homogeneous within and more heterogeneous between each other.

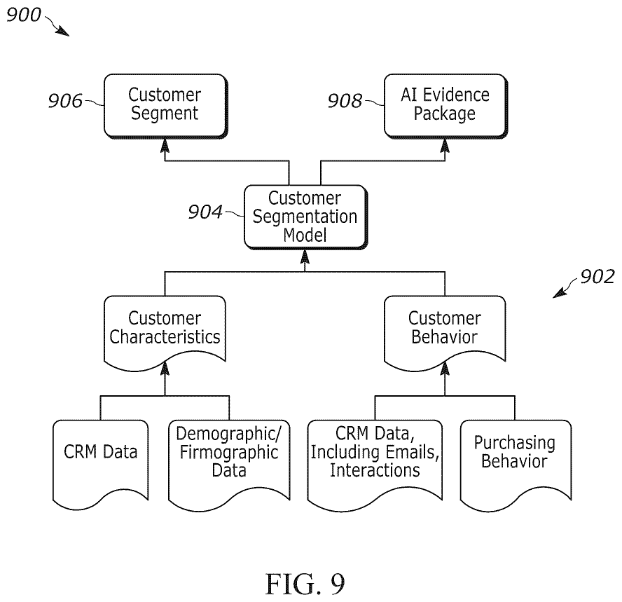

FIG. 9 illustrates an example architecture 900 supporting customer segmentation according to this disclosure. The architecture 900 may, for example, be implemented by the application server 106 shown in the system 100 of FIG. 1 using one or more instances of the device 200 shown in FIG. 2A. The architecture 900 may also form part of or be used within the architecture 220, modular services component 250, and/or machine learning platform system 260 shown in FIGS. 2B through 2D, such as when the architecture 900 is used (among other things) to implement at least part of the customer segmentation function 232. However, the architecture 900 may be implemented using any other suitable device(s) and architecture(s) and in any other suitable system(s).

As shown in FIG. 9, data from a wide variety of data sources 902 may be obtained and used by the architecture 900. In this particular example, the data sources 902 include various data sources described above. Here, the information from the data sources 902 may be generally combined into two sets of data, namely information identifying customer characteristics and information identifying customer behaviors.

This information is processed using a customer segmentation machine learning model 904, which processes the information to generate one or more customer segments 906 and an AI evidence package 908 for each customer. The one or more customer segments 906 identify one or more specified groups of customers to which a specific customer belongs. The AI evidence package 908 can provide explanation(s) for the customer segment(s) 906. For instance, the AI evidence package 908 may identify the largest contributors to each customer segment 906 (both positive and negative), such as when the AI evidence package 908 identifies which features have the largest impact on that customer segment 906. In some cases, the AI evidence package 908 can be obtained using the AI-based evidence package module function 246.

The customer segmentation model 904 here is therefore used to segment customers into groups. The customer segmentation model 904 may consider various factors when generating its predictions, such as known characteristics and known behaviors of the customers. In some cases, the customer segmentation model 904 can be trained based on information about known characteristics and behaviors of customers and known classifications of those customers. Suitable training of the customer segmentation model 904 may then occur to train the customer segmentation model 904 to predict acceptable groupings for the customers.

Depending on the usage of the customer segmentations, segmentation can be performed to understand a recommendation landscape and to target multiple customers in each segment in bulk, such as for next best offer/product/action as described above or for price optimization or other use cases described below. Customers can be segmented into groups based on any desired shared characteristics of the customers, such as demographic/firmographic data or purchasing history. In some cases, the customer segmentation model 904 may be implemented using an unsupervised machine learning model, such as a clustering model or other classification model that has been trained to group customers having similar characteristics. Customer segmentation can be carried out to provide predictive functionality, assuming the customers behave similarly within their designated segments.

Although FIG. 9 illustrates one example of an architecture 900 supporting customer segmentation, various changes may be made to FIG. 9. For example, any other or additional data may be used as needed or desired.

### Churn Management (Churn Prediction and Customer Retention)

Companies routinely attempt to identify which of its existing customers are likely to churn or to cease having relationships (partially or completely) with the companies within a given timeframe. Early identification of such risks can allow the companies to attempt to remediate potential issues and maintain revenue flows. Churn can be classified as complete or partial. Complete churn (also called customer churn) refers to an entire customer churning, meaning the customer ceases its entire relationship with a company. Partial churn (also called product or service churn) refers to a customer that remains a customer of at least one product or service but breaks a relationship for one or more different products or services or that reduces the quantity of product purchases or service consumption.

Churn management generally applies machine learning techniques to generate likelihood scores of existing customers completely or partially changing their customer relationships (such as changing suppliers or adding competitive suppliers) within a given timeframe. The machine learning techniques may also identify one or more possible ways to overcome the potential loss of each customer in order to maintain the company's relationships with those customers. Again, AI evidence package functionality may be used to identify explanations for the predictions, such as to identify the top probability contributors with indications on magnitude and directionality of impact. Again, a recommendation system can be used to identify potential courses of actions to take to retain at-risk customers. Thus, representatives can identify customers at risk of churning and see clear explanations about key risk factors and access recommendations to retain them so that preventative actions may be taken. Depending on the implementation, churn management can be used to determine the likelihood of individual customers churning (either partially or fully) or an aggregated likelihood of multiple customers churning (either partially or fully). Similarly, churn management can be used to determine the likelihood of one or more customers churning (either partially or fully) for each product/service or for groups of products/services, for each representative or for groups of representatives, or for any other individual or group characteristic(s).

Relationship intelligence and/or AI customer satisfaction functionality may also be used here. Relationship intelligence can be used to map relationships between organizations and/or individuals and to explore those relationships to understand the strength of each connection, including how the strength changes over time (as negative changes may indicate a higher risk of churn). Additionally, this can be used to identify ways to leverage existing relationships to retain customers. Analysis of customers, such as relationship intelligence and AI customer satisfaction, can be conducted at various levels of granularity across individual customers, sub-department customers, organizational customers, etc. AI customer satisfaction can be used to identify an overall level of customer sentiment regarding a company or a particular opportunity or existing contract. Note that while these three functions are described together here, one or two of these functions may be used in any given implementation.

Various types of churn may be identified and managed using the approaches described in this disclosure. The following are examples of the types of churn that may be identified and managed using these approaches. In a fixed recurring revenue “opt out” business model, a customer agrees to receive or use one or more products/services indefinitely at a fixed price, and the customer has to explicitly choose or “opt out” to stop paying for the product(s)/service(s). Here, full churn may occur when the customer cancels the subscription/contract, and partial churn may occur when the customer changes the agreement to a lower tier or smaller offering. In a fixed recurring revenue “opt in” business model, a customer agrees to receive or use one or more products/services for a fixed period of time and at a pre-determined price, and the customer needs to explicitly choose or “opt in” to continue using the product(s)/service(s) at the end of the fixed period of time. Here, full churn may occur when the customer fails to renew the subscription/contract or cancels the subscription/contract early, and partial churn may occur when the customer renews the relationship but at a lower tier or smaller offering. In a usage-based recurring revenue “pay as you go” business model, a customer pays depending on how much the customer utilizes one or more products or services. Here, full churn may occur when the customer terminates the relationship, and partial churn may occur when the customer permanently reduces usage of the product(s)/service(s). In a transactional business model, a customer obtains one or more products or services on a recurring basis, but each purchase or other transaction is discrete. Here, full churn may occur when the customer does not repeat a purchase or other transaction, and partial churn may occur when the customer permanently decreases a transaction frequency or volume. Any or all of these types of churn may be identified and managed using the approaches described here.

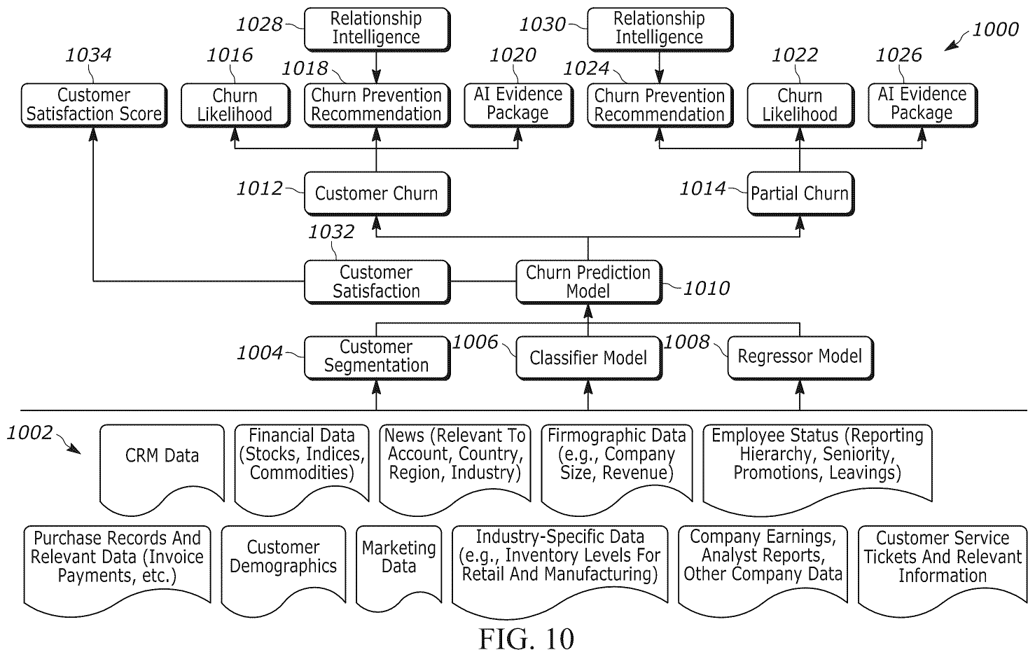

FIG. 10 illustrates an example architecture 1000 supporting churn management, relationship intelligence, and AI customer satisfaction estimation according to this disclosure. The architecture 1000 may, for example, be implemented by the application server 106 shown in the system 100 of FIG. 1 using one or more instances of the device 200 shown in FIG. 2A. The architecture 1000 may also form part of or be used within the architecture 220, modular services component 250, and/or machine learning platform system 260 shown in FIGS. 2B through 2D, such as when the architecture 1000 is used (among other things) to implement at least part of the CRM services function 234 and at least part of the customer satisfaction function 238. However, the architecture 1000 may be implemented using any other suitable device(s) and architecture(s) and in any other suitable system(s).

As shown in FIG. 10, data from a wide variety of data sources 1002 may be obtained and used by the architecture 1000. In this particular example, the data sources 1002 include many of the same data sources described above. The data sources 1002 also include customer service tickets and other related data, which can identify customer service-related interactions of a company with its customers. For example, a customer service ticket may be created for each of the company's interactions with a customer, and these tickets can be used as an indicator of AI-based customer satisfaction. This is useful here since AI-based customer satisfaction feeds into likelihood to churn. A customer service ticket may include information like ticket classification (such as complaint, question, or product feedback), tenor of customer emails or other communications/customer service agent notes (which may be determined via natural language processing), ticket frequency (such as when unhappy customers generate more tickets), time to close a ticket (such as when longer times mean more unhappy customers), number of re-opened tickets or ticket follow-ups (meaning the problem was not resolved right away), and overall ticket count and trends (such as average number of tickets per customer).

This information is processed using an AI-based customer segmentation function 1004, which processes the information in order to segment customers across various criteria as discussed above. This information is also processed using a classifier model 1006 and a regressor model 1008, which may be the same as or similar to the same types of models discussed above. These models 1006 and 1008 may be used to identify probabilities that individual opportunities will be won within a given timeframe.

At least some of the information from the data sources 1002 and the outputs from the AI-based customer segmentation function 1004 and the models 1006 and 1008 are provided to a churn prediction machine learning model 1010, which processes the information to generate a complete (customer) churn prediction 1012 and a partial (product or service) churn prediction 1014. The customer churn prediction 1012 generally identifies a likelihood of a particular customer churning, or leaving a relationship with a company, within a given timeframe. The partial churn prediction 1014 generally identifies a likelihood of a customer churning for at least one particular product or service within a given timeframe.

The churn prediction model 1010 here is therefore used to identify the likelihood of current customers ceasing to be customers of a company, ceasing to be customers for at least one particular product or service that a company offers, or reducing the quantity of product purchases or service consumption. The churn prediction model 1010 may consider various factors when generating its predictions, such as the trend in an AI customer satisfaction score. Using this type of information, the churn prediction model 1010 can generate churn likelihood scores, each of which identifies a probability that a specific customer will churn (cease to be a customer) from a company or a product/service during the given timeframe.

In some cases, the churn prediction model 1010 can be trained based on historical information to identify the likelihood (given past and current conditions) of existing customers ceasing to be customers of a company or a product/service. Features such as duration of relationship, strength of relationship, AI customer satisfaction score, and trends therein may be considered. Suitable training of the churn prediction model 1010 may then occur to train the churn prediction model 1010 to identify whether a current existing customer may cease to be a customer of a company or for a product/service.

In this example, the customer churn prediction 1012 is associated with a churn likelihood 1016, a churn prevention recommendation 1018, and an AI evidence package 1020. The churn likelihood 1016 may represent a numerical value (such as a value from 0 to 100) that identifies how strong the likelihood is of a particular current customer ceasing to be a customer in a given timeframe. The churn prevention recommendation 1018 identifies a proposed course of action that might be used to prevent churn by the particular customer. The AI evidence package 1020 can provide explanation(s) for the churn likelihood 1016 or the churn prevention recommendation 1018. For instance, the AI evidence package 1020 may identify the largest contributors to the churn likelihood 1016 or the churn prevention recommendation 1018 (both positive and negative), such as when the AI evidence package 1020 identifies which features have the largest impact on that churn likelihood 1016 or the churn prevention recommendation 1018. In some cases, the AI evidence package 1020 can be obtained using the AI-based evidence package module function 246.

Similarly, the partial churn prediction 1014 is associated with a churn likelihood 1022, a churn prevention recommendation 1024, and an AI evidence package 1026. The churn likelihood 1022 may represent a numerical value (such as a value from 0 to 100) that identifies how strong the likelihood is of a current customer ceasing to be a customer for at least one particular product or service in a given timeframe. The churn prevention recommendation 1024 identifies a proposed course of action that might be used to prevent churn for the particular product(s) or service(s). The AI evidence package 1026 can provide explanation(s) for the churn likelihood 1022 or the churn prevention recommendation 1024. For instance, the AI evidence package 1026 may identify the largest contributors to the churn likelihood 1022 or the churn prevention recommendation 1024 (both positive and negative), such as when the AI evidence package 1026 identifies which features have the largest impact on that churn likelihood 1022 or the churn prevention recommendation 1024. In some cases, the AI evidence package 1026 can be obtained using the AI-based evidence package module function 246.

As shown in FIG. 10, an AI-based relationship intelligence function 1028 may be used to generate the churn prevention recommendation 1018, and an AI-based relationship intelligence function 1030 may be used to generate the churn prevention recommendation 1024. Note that the same function may be used for both relationship intelligence functions 1028 and 1030, such as when the same function is applied at different times or using different data. The relationship intelligence functions 1028, 1030 are used to identify actual or potential communication pathways between representatives or other personnel of a company and personnel of a customer.

Information from the churn prediction model 1010 may also be provided to an AI customer satisfaction function 1032, which can be used to generate an overall AI customer satisfaction score 1034 for each customer. The overall AI customer satisfaction score 1034 may represent a numerical value (such as a value from 0 to 100) that identifies how satisfied a customer is with the company. In some cases, the AI customer satisfaction score 1034 for a particular customer may be inversely proportional to the likelihood of the customer churning. In other words, satisfied customers are unlikely to churn and become former customers, and dissatisfied customers are more likely to churn.

Although FIG. 10 illustrates one example of an architecture 1000 supporting churn management, relationship intelligence, and AI customer satisfaction, various changes may be made to FIG. 10. For example, any other or additional data may be used as needed or desired. Also, churn management, relationship intelligence, and AI-based customer satisfaction may be used with each other in any combination or separately.

### Relationship Intelligence

Relationship intelligence generally refers to identifying personnel associated with existing or prospective customers and potential contacts, identifying the nature and extent of the interrelationships between and among prospects, customers, suppliers, and other agencies, and communication pathways for reaching or interacting with those people. Relationship intelligence can be used as a component of other functions, such as churn management as discussed above, to map relationships between organizations and individuals and to explore those relationships in order to understand the strength of each connection. This can also involve determining how the strengths of the connections change over time, since negative changes may indicate a higher risk of churn.

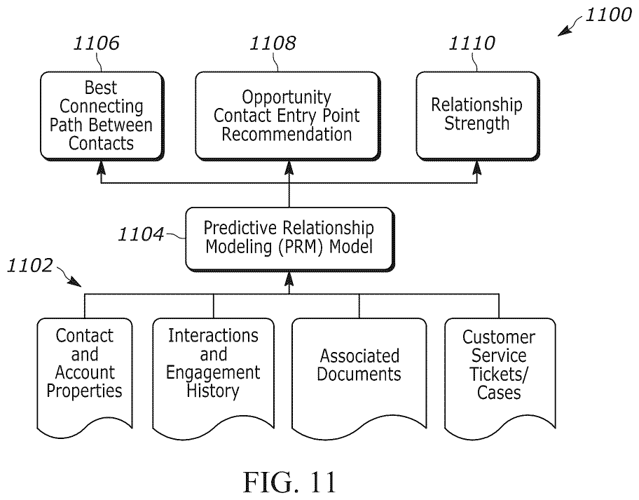

FIG. 11 illustrates an example architecture 1100 supporting relationship intelligence according to this disclosure. The architecture 1100 may, for example, be implemented by the application server 106 shown in the system 100 of FIG. 1 using one or more instances of the device 200 shown in FIG. 2A. The architecture 1100 may also form part of or be used within the architecture 220, modular services component 250, and/or machine learning platform system 260 shown in FIGS. 2B through 2D, such as when the architecture 1100 is used (among other things) to implement at least part of the CRM services function 234. However, the architecture 1100 may be implemented using any other suitable device(s) and architecture(s) and in any other suitable system(s).

As shown in FIG. 11, data from a wide variety of data sources 1102 may be obtained and used by the architecture 1100. In this particular example, the data sources 1102 include contact and account properties, which can identify various personnel of customers. The data sources 1102 also include historical data regarding interactions and customer engagements, which can identify various interactions that have occurred with specific personnel of the customers. The data sources 1102 further include documents associated with customer contacts, such as emails, text messages, or other communications. In addition, the data sources 1102 include customer service tickets and other related data.

This information is processed using a predictive relationship modeling (PRM) model 1104, which processes the information to generate a best connecting path between contacts 1106, an opportunity contact entry point recommendation 1108, and a relationship strength 1110. The best connecting path between contacts 1106 identifies an optimal communication pathway between two contacts, such as a representative of the company and an officer or employee of a customer. The opportunity contact entry point recommendation 1108 represents a recommendation on how the representative of the company may interact with the officer or employee of the customer. The relationship strength 1110 identifies an estimated strength of any relationship between the two contacts.

In this way, the PRM model 1104 may represent a trained machine learning model that can identify connections between a company and its customers, as well as the most likely or successful connections that can be used by the company to contact the customers. The connections here may be direct (such as between the company and a customer) or indirect (such as between the company and at least one third party and between the at least one third party and a customer). The PRM model 1104 may consider various factors when generating its predictions, such as known contacts between the company and the customers, the lengths of the relationships between the contacts, and similar interests of the contacts. This type of machine learning model may be trained using data identifying customers who have and have not churned, along with information identifying contacts of a company with those customers. If desired, an AI evidence package may be provided for these recommendations.

Although FIG. 11 illustrates one example of an architecture 1100 supporting relationship intelligence, various changes may be made to FIG. 11. For example, any other or additional data may be used as needed or desired.

### AI Customer Satisfaction

AI customer satisfaction can be used to identify an overall level of customer sentiment regarding a company or a particular opportunity or existing contract. As noted above, AI customer satisfaction can be related to customer churn, since satisfied customers are less likely to churn and dissatisfied customers are more likely to churn. Depending on the implementation, AI customer satisfaction can be used to determine the satisfaction of individual customers with a company or one or more particular opportunities or existing contracts or an aggregated satisfaction of multiple or all customers with a company or their associated opportunities or existing contracts. Similarly, AI customer satisfaction can be used to determine the satisfaction of individual customers or multiple/all customers with one or more products/services offered by the company, with one or more representatives of the company, or with any other individual or group characteristic(s) of the company.

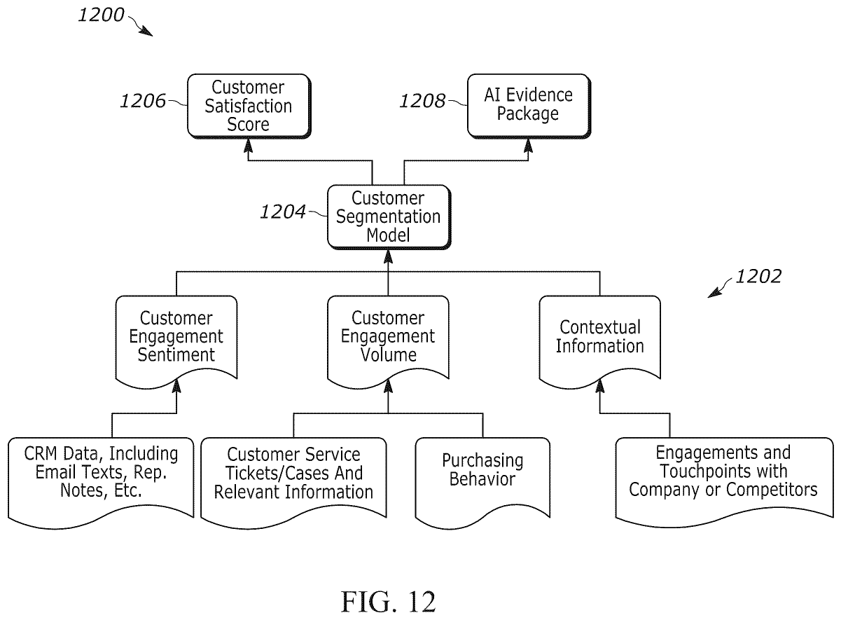

FIG. 12 illustrates an example architecture 1200 supporting AI customer satisfaction estimation according to this disclosure. The architecture 1200 may, for example, be implemented by the application server 106 shown in the system 100 of FIG. 1 using one or more instances of the device 200 shown in FIG. 2A. The architecture 1200 may also form part of or be used within the architecture 220, modular services component 250, and/or machine learning platform system 260 shown in FIGS. 2B through 2D, such as when the architecture 1200 is used (among other things) to implement at least part of the customer satisfaction function 238. However, the architecture 1200 may be implemented using any other suitable device(s) and architecture(s) and in any other suitable system(s).

As shown in FIG. 12, data from a wide variety of data sources 1202 may be obtained and used by the architecture 1200. In this particular example, the data sources 1202 include several of the same data sources described above. The data sources 1202 also include information about known engagements of the company and its competitors with the customers. Here, the information from the data sources 1202 may be generally combined into three sets of data, namely (i) information identifying customer engagement sentiment (the customers' sentiments during customer engagements), (ii) information identifying customer engagement volume (the number of customer engagements), and (iii) contextual information (information related to the customer engagements).

This information is processed using a customer satisfaction machine learning model 1204, which processes the information to generate customer satisfaction scores 1206 and AI evidence packages 1208. Each customer satisfaction score 1206 may represent a numerical value (such as a value from 0 to 100) that identifies how satisfied a customer is with the company. Each AI evidence package 1208 can provide explanation(s) for the associated customer satisfaction score 1206. For instance, the AI evidence package 1208 may identify the largest contributors to a customer satisfaction score 1206 (both positive and negative), such as when the AI evidence package 1208 identifies which features have the largest impact on that customer satisfaction score 1206. In some cases, the AI evidence package 1208 can be obtained using the AI-based evidence package module function 246.

The customer satisfaction model 1204 here is therefore used to estimate customer satisfaction, and the customer satisfaction model 1204 may consider various factors when generating its predictions, such as net promoter scores and known information about customer engagements with customers who have and have not churned. Net promoter scores (NPS) are a metric to measure customer satisfaction that uses a survey with a question asking respondents to rate the likelihood that they would recommend a company, product, or service to a friend or colleague (which allows companies to measure the sentiments of customers towards their offerings). Suitable training of the customer satisfaction model 1204 may then occur to train the customer satisfaction model 1204 to predict customer satisfaction.

Although FIG. 12 illustrates one example of an architecture 1200 supporting AI customer satisfaction estimation, various changes may be made to FIG. 12. For example, any other or additional data may be used as needed or desired.

### Lead Scoring

Lead scoring generally identifies an estimate of the propensity or probability of each prospective customer to buy or otherwise obtain one or more products or services. Among other things, these probabilities allow a company to prioritize outreach and marketing efforts in order to build a high-quality pipeline.

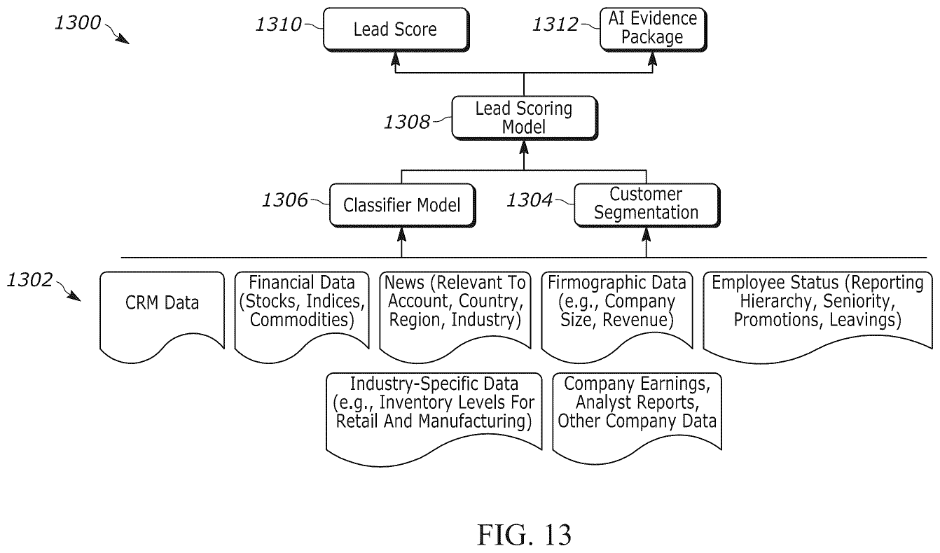

FIG. 13 illustrates an example architecture 1300 supporting lead scoring according to this disclosure. The architecture 1300 may, for example, be implemented by the application server 106 shown in the system 100 of FIG. 1 using one or more instances of the device 200 shown in FIG. 2A. The architecture 1300 may also form part of or be used within the architecture 220, modular services component 250, and/or machine learning platform system 260 shown in FIGS. 2B through 2D, such as when the architecture 1300 is used (among other things) to implement at least part of the CRM services function 234 and/or at least part of the CRM marketing function 236. However, the architecture 1300 may be implemented using any other suitable device(s) and architecture(s) and in any other suitable system(s).

As shown in FIG. 13, data from a wide variety of data sources 1302 may be obtained and used by the architecture 1300. In this particular example, the data sources 1302 include the same data sources described above. This information is processed using an AI-based customer segmentation function 1304, which processes the information in order to segment customers across various criteria as discussed above. This information is also processed using a classifier model 1306, which may be the same as or similar to the same type of model discussed above. The model 1306 may be used to identify probabilities that individual opportunities will be won (without regard to timing).

At least some of the information from the data sources 1302 and the outputs from the AI-based customer segmentation function 1304 and the model 1306 are provided to a lead scoring machine learning model 1308, which processes the information to generate a lead score 1310 and an AI evidence package 1312. The lead score 1310 generally identifies a likelihood of a particular prospective customer purchasing one or more products or services from the company.

The lead scoring model 1308 here is therefore used to identify the likelihood of prospective customers obtaining products or services from a company. The lead scoring model 1308 may consider various factors when generating its predictions, such as the likelihood of an opportunity successfully closing with each prospective customer. Using this type of information, the lead scoring model 1308 can generate the lead scores 1310, each of which identifies a probability that a specific prospective customer will obtain one or more products or services.

In some cases, the lead scoring model 1308 can be trained based on historical sales records or other historical information to identify the likelihood (given past and current conditions) of prospective customers obtaining products or services. For example, historical records that indicate prospective customers obtained products or services may be labeled as positive, and historical records that indicate prospective customers did not obtain products or services may be labeled as negative. Suitable training of the lead scoring model 1308 may then occur to train the lead scoring model 1308 to predict whether a prospective customer will obtain one or more products or services.

The lead score 1310 may represent a numerical value (such as a value from 0 to 100) that identifies how strong the likelihood is of a particular prospective customer obtaining one or more products or services. The AI evidence package 1312 can provide an explanation for the lead score 1310. For instance, the AI evidence package 1312 may identify the largest contributors to the lead score 1310 (both positive and negative), such as when the AI evidence package 1312 identifies which features have the largest impact on that lead score 1310. In some cases, the AI evidence package 1312 can be obtained using the AI-based evidence package module function 246.

Although FIG. 13 illustrates one example of an architecture 1300 supporting lead scoring, various changes may be made to FIG. 13. For example, any other or additional data may be used as needed or desired.

### Opportunity/Pricing Optimization

Opportunity/pricing optimization generally identifies an optimal pricing or other offering for any given opportunity, such as by protecting (from anomalous pricing and recommending) best pricing ranges that maximize expected profitability. These estimates may then be used by representatives to help successfully close opportunities.

In some cases, opportunity/pricing optimization can combine relationship intelligence (such as segmentation, customer satisfaction, loyalty, churn, and feedback loops) with machine learning-based forecasting and predictions to optimize offerings (such as product configurations and bundling, next best offer/product determination, warranty or upgrade replacement, and marketing). Among other things, this can be accomplished by simulating various offerings in view of target opportunities and operational intelligence (such as point of sale data, aisle costs, inventory, margin controls, and relationship potential) to dynamically recommend offerings that optimize opportunities. For example, a compelling price point can be determined with different product configurations and bundlings directed to a customer or retail opportunity. As a particular example, product configuration and bundling techniques may use models to predict/optimize customers' desired product configurations and streamline sales or onboarding processes. Example techniques that may be used here can include unifying product configuration systems, historical orders, sales systems, and external data (such as demographics, news, and social media) and applying machine learning for customer segmentation in order to predict customer preferences for product configurations and bundles. Thus, for instance, assume a goal of opportunity/pricing optimization is to identify a compelling price point for a product that incorporates various discrete components. The opportunity/pricing optimization may use various information, such as retailer point-of-sale data, RFID data, or aisle data, to adjust the price for the product. Machine learning can be used to better predict and manage inventory out in the field by adjusting the price of the product, suggesting packaging for the product, and accounting for surge pricing/fluctuations and demands for the product. Social media information can be considered by the machine learning, and the results of the machine learning processing can be used for additional functions (such as optimization delivery and downstream warehousing).

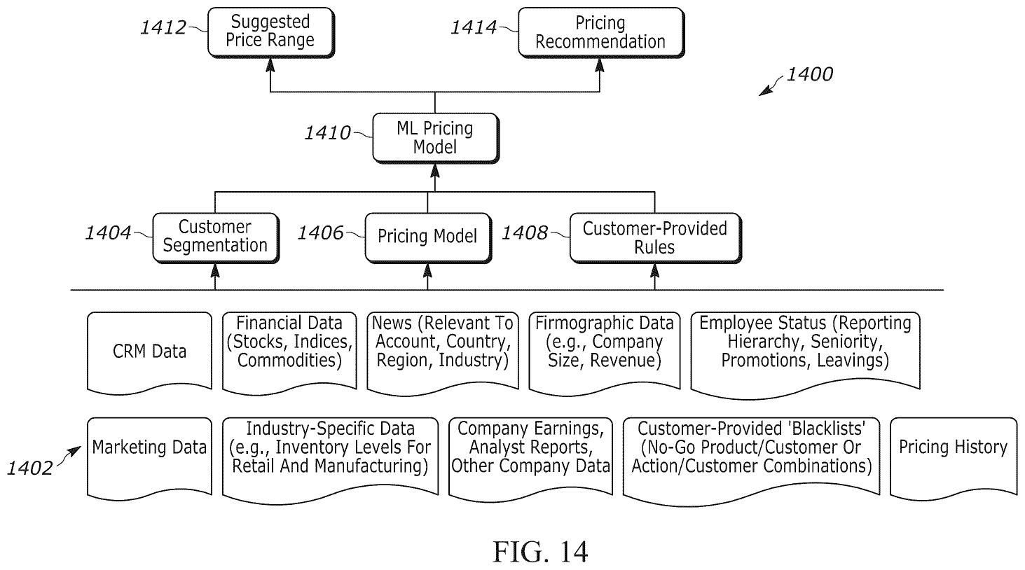

FIG. 14 illustrates an example architecture 1400 supporting opportunity/pricing optimization according to this disclosure. The architecture 1400 may, for example, be implemented by the application server 106 in the system 100 of FIG. 1 using one or more instances of the device 200 shown in FIG. 2A. The architecture 1400 may also form part of or be used within the architecture 220, modular services component 250, and/or machine learning platform system 260 shown in FIGS. 2B through 2D, such as when the architecture 1400 is used (among other things) to implement at least part of the pricing optimization function 228. However, the architecture 1400 may be implemented using any other suitable device(s) and architecture(s) and in any other suitable system(s).

As shown in FIG. 14, data from a wide variety of data sources 1402 may be obtained and used by the architecture 1400. In this particular example, the data sources 1402 include the same data sources described above. This information is processed using an AI-based customer segmentation function 1404, which processes the information in order to segment customers across various criteria as discussed above. This information is also processed using at least one standard pricing model 1406, which may represent at least one conventional, existing, or other tool at a company for estimating prices. This information is further processed using one or more customer-based rules 1408, which may represent logic provided by a customer for calculating prices for that specific customer. Some customers (such as government contractors) may have specific rules on how prices are calculated, and the customer-based rules 1408 can support this.

At least some of the information from the data sources 1402 and the outputs from the AI-based customer segmentation function 1404, the pricing model 1406, and the customer-based rules 1408 are provided to a machine learning pricing model 1410, which processes the information to generate a suggested price range 1412 and a pricing recommendation 1414. The suggested price range 1412 identifies both the lowest price and the highest price that should be offered to at least one particular customer for at least one product or service. The pricing recommendation 1414 identifies a recommended price point that should be offered to the particular customer(s) for the product(s) or service(s), which may be based on a variety of factors such as the price range 1412. An AI recommendation engine, such as the AI-based evidence package module function 246, can provide an explanation behind the individual features driving the outcomes of the pricing model 1410.

The pricing model 1410 here is therefore used to identify the optimal price points or price ranges that might be offered to customers, which can help to improve or maximize revenue. The pricing model 1410 may consider various factors when generating its predictions, such as prior purchases or other actions by the customers. Using this type of information, the pricing model 1410 can generate the suggested price ranges 1412 and the pricing recommendations 1414.

In some cases, the pricing model 1410 can be trained based on historical sales records or other historical information to identify possible or likely prices paid by customers for obtaining products or services. For example, historical records identifying various characteristics of customers specifically or a market more generally (such as macroeconomic conditions in a region, a country, or the world) may be labeled with actual sales. Suitable training of the pricing model 1410 may then occur to train the pricing model 1410 to predict acceptable prices for customers.

Although FIG. 14 illustrates one example of an architecture 1400 supporting opportunity/pricing optimization, various changes may be made to FIG. 14. For example, any other or additional data may be used as needed or desired.

### Warranty and Product Upgrade Replacement

Warranty and product upgrade replacement generally involves estimating the likelihood of customers upgrading or updating their current products or services for additional or newer products or services. This allows a company to prioritize its outreach and sales efforts and focus on customers that are more likely to request upgrades of their products or services.

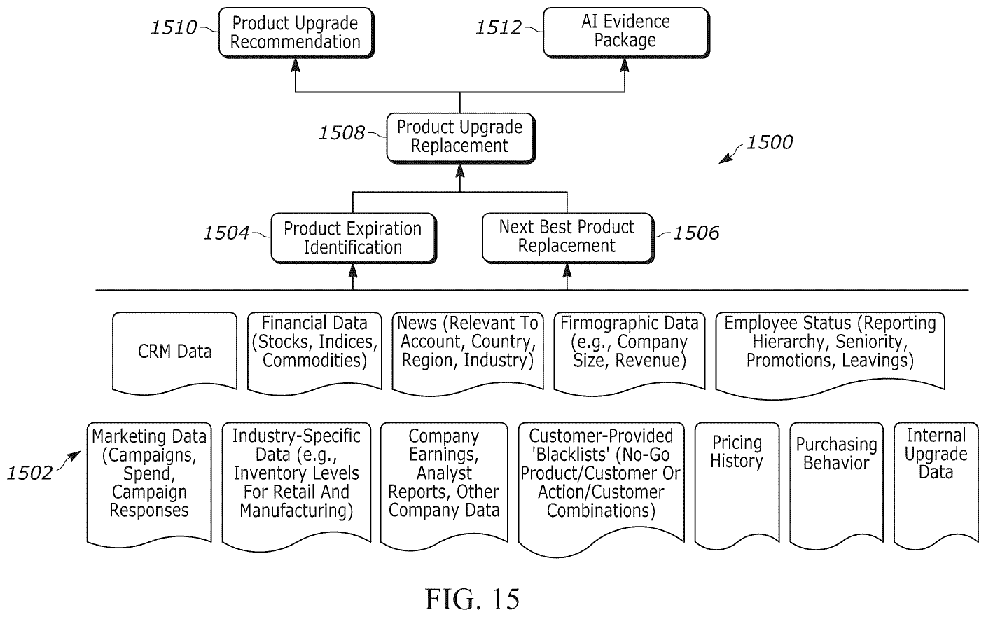

FIG. 15 illustrates an example architecture 1500 supporting warranty and product upgrade replacement according to this disclosure. The architecture 1500 may, for example, be implemented by the application server 106 in the system 100 of FIG. 1 using one or more instances of the device 200 shown in FIG. 2A. The architecture 1500 may also form part of or be used within the architecture 220, modular services component 250, and/or machine learning platform system 260 shown in FIGS. 2B through 2D, such as when the architecture 1500 is used (among other things) to implement at least part of the CRM services function 234 and/or at least part of the NBO/NBP/NBA function 230. However, the architecture 1500 may be implemented using any other suitable device(s) and architecture(s) and in any other suitable system(s).

As shown in FIG. 15, data from a wide variety of data sources 1502 may be obtained and used by the architecture 1500. In this particular example, the data sources 1502 include the same data sources described above. The data sources 1502 also include purchasing behaviors and internal upgrade data. The purchasing behaviors represent prior purchases or other transactions involving customers, such as for specific products or services that might be subject to upgrade or replacement. The internal upgrade data represents known information about upgrades that have been, are being, or will be made to products or services of the company.

This information is processed using a product or service expiration identification function 1504, which can identify customers who have products or services that might be upgraded within a given timeframe. This may be based on, for example, information about products or services previously provided to a customer and knowledge of current or future upgrades to those products or services. This information is also processed using a next best product replacement function 1506, which may implement the “next best” functionality described above (while limiting the potential products or services recommended to upgrades or replacements).

By identifying customers who have products or services that can be upgraded and the next best replacements for those customers, a product upgrade replacement function 1508 can identify one or more specific products or services to be offered as upgrades for one or more specific customers. Here, the product upgrade replacement function 1508 generates product update recommendations 1510 and AI evidence packages 1512. Each product update recommendation 1510 identifies a specific customer and a specific product or service to be offered to the customer as an upgrade. Each AI evidence package 1512 may identify the largest contributors to a product update recommendation 1510 (both positive and negative), such as when the AI evidence package 1512 identifies which features have the largest impact on that product update recommendation 1510. In some cases, the AI evidence package 1512 can be obtained using the AI-based evidence package module function 246.

Note that, in some cases, a predictive maintenance algorithm may be used to process customer-related data in order to predict when at least one product used by one or more customers is likely to need maintenance. For example, the predictive maintenance algorithm may identify the likelihood of failure of a product or degradation in the performance of the product. These predictions may be used as inputs to the product upgrade replacement function 1508 so that the predictions may be factored into the identification of products or services that can be offered to the customers.

Although FIG. 15 illustrates one example of an architecture 1500 supporting product upgrade replacement, various changes may be made to FIG. 15. For example, any other or additional data may be used as needed or desired.

### Marketing Optimization & Trade Promotion Optimization

Marketing optimization generally involves estimating characteristics of marketing activities (such as amounts of money to spend on marketing campaigns) and likely returns for those promotion activities. This allows allow a company to prioritize its promotion activities and focus on promotion activities that are likely to result in increased opportunities.

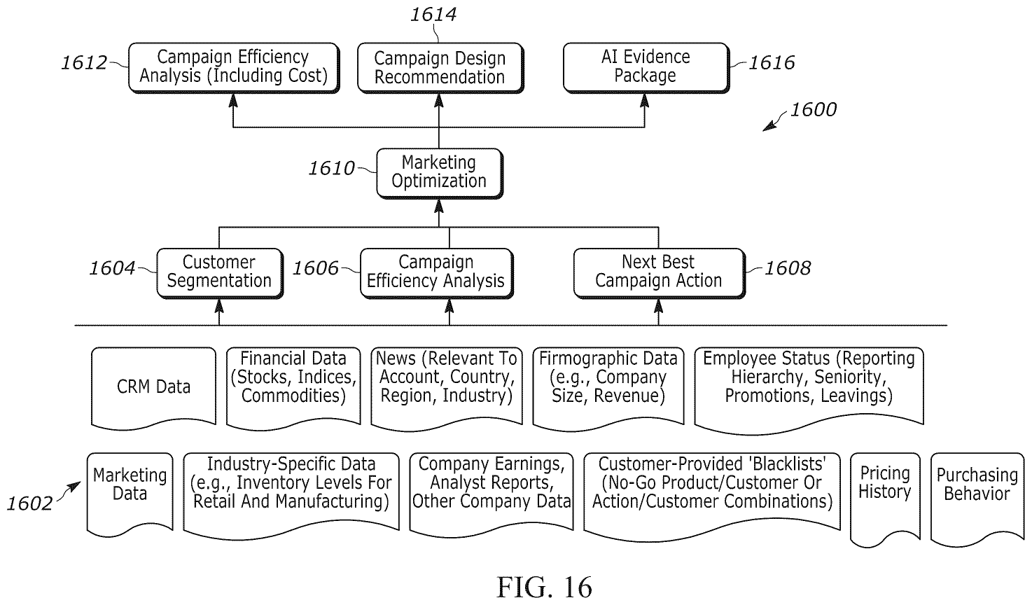

FIG. 16 illustrates an example architecture 1600 supporting marketing optimization and trade promotion optimization according to this disclosure. The architecture 1600 may, for example, be implemented by the application server 106 in the system 100 of FIG. 1 using one or more instances of the device 200 shown in FIG. 2A. The architecture 1600 may also form part of or be used within the architecture 220, modular services component 250, and/or machine learning platform system 260 shown in FIGS. 2B through 2D, such as when the architecture 1600 is used (among other things) to implement at least part of the CRM marketing function 236. However, the architecture 1600 may be implemented using any other suitable device(s) and architecture(s) and in any other suitable system(s).

As shown in FIG. 16, data from a wide variety of data sources 1602 may be obtained and used by the architecture 1600. In this particular example, the data sources 1602 include the same data sources described above. This information is processed using an AI-based customer segmentation function 1604, which processes the information in order to segment customers across various criteria as discussed above. This information is also processed using a campaign efficiency analysis function 1606, which can analyze information about prior marketing campaigns to determine an efficiency of the prior marketing campaigns. This type of analysis may be common in various organizations today. In addition, this information is processed using a next best campaign action function 1608, which is an outcome of the next best action function described above.

At least some of the information from the data sources 1602 and the outputs from the AI-based customer segmentation function 1604, the campaign efficiency analysis function 1606, and the next best campaign action function 1608 are provided to a marketing optimization machine learning model 1610, which processes the information to generate a campaign efficiency analysis report 1612, a campaign design recommendation 1614, and an AI evidence package 1616. The campaign efficiency analysis report 1612 identifies estimated efficiencies of marketing campaigns (such as costs of the campaigns). The campaign design recommendation 1614 identifies a recommended campaign action that may be performed by a company.

The marketing optimization model 1610 here is therefore used to identify the efficiencies of marketing campaigns and recommendations to improve marketing campaigns. The marketing optimization model 1610 may consider various factors when generating its predictions, such as prior campaigns and resulting opportunities (won or lost) associated with those campaigns. Using this type of information, the marketing optimization model 1610 can generate the campaign efficiency analysis reports 1612, campaign design recommendations 1614, and AI evidence packages 1616. Each AI evidence package 1616 can provide an explanation for a campaign efficiency analysis report 1612 or a campaign design recommendation 1614. For instance, the AI evidence package 1616 may identify the largest contributors to the campaign efficiency analysis report 1612 or campaign design recommendation 1614 (both positive and negative), such as when the AI evidence package 1616 identifies which features have the largest impact on that campaign efficiency analysis report 1612 or campaign design recommendation 1614. In some cases, the AI evidence package 1616 can be obtained using the AI-based evidence package module function 246.

In some cases, the marketing optimization model 1610 can be trained based on historical sales records or other historical information to identify possible or likely campaign efforts that may result in opportunities. For example, historical records identifying various characteristics of prior campaigns may be labeled with indicators of resulting sales or the resulting sales. Suitable training of the marketing optimization model 1610 may then occur to train the marketing optimization model 1610 to predict desirable campaign characteristics that can result in sales or other transactions for products or services.

Trade promotion optimization is a form of marketing optimization for retail- and consumer-packaged goods companies. Trade promotion optimization generally involves unifying data across various regions (such as sales and customer data, economic data, pricing data, and marketing data) to optimize which pricing discounts (“trade promotions”) to offer for what products in which geographies or stores. The architecture 1600 shown in FIG. 16 can be configured to use a combination of forecasting, segmentation, and optimization algorithms to identify these optimized strategies.

Although FIG. 16 illustrates one example of an architecture 1600 supporting marketing optimization, various changes may be made to FIG. 16. For example, any other or additional data may be used as needed or desired.

### AI Recommendations

As described above, various machine learning models can learn what representative actions may be performed to help the representatives achieve their objectives (such as closing an opportunity or mitigating churn risk). In some cases, inputs to the machine learning models described above can be grouped into actionable inputs and non-actionable inputs. An example of an actionable model input is the number of phone calls or meetings the representative has had with a customer (since the representative has control over that number). An example of a non-actionable model input is the GDP growth of a country (since the representative has negligible/no control over that value).

A variety of approaches (such as counterfactuals or Bayesian optimization) can be leveraged to identify specific values of actionable inputs that change a machine learning model's output in a desirable direction. For example, the approaches may determine that making five to ten phone calls in a month for a specific customer and a specific product or service can improve the opportunity score for a specific opportunity, while anything less than five phone calls or more than ten phone calls is determined to reduce the opportunity score. Any identified recommendations can be presented to the representative through a user interface, and the representative may choose to act on one or more of the identified recommendations.

### Natural Language Processing

For at least some of the CRM-related functions described above, natural language processing (NLP) can be applied to analyze text, voice, and other data sources. For example, natural language processing can be applied to various representative-customer communications and other information, such as call logs, e-mails, text messages, news, social media content, annual reports, and analyst reports, to identify features used as inputs to machine learning models. As a particular example, customer call and e-mail sentiment computed using natural language processing can inform the potential success of an opportunity. Natural language processing can also be used to estimate sentiment and other relevant indicators from news articles or social media posts related to customers, geographic regions, industry sectors, or other relevant factors. Natural language processing can further be used to estimate sentiment and other relevant indicators from financial reports (such as 10-K and 10-Q reports), analyst reports, or other sources. In particular embodiments, relevant indicators identified using natural language processing may include sentiment and the existence of key words and their variants. For instance, the phrase “strong performance” in an analyst report may indicate that the customer is perceived to be in good financial health, despite a drop in the customer's stock price (which is a separate machine learning model input).

### Time Series Data

Many or all of the enterprise and/or extraprise (exogenous) data signals used by the application server(s) 106 implementing the various architectures described above can be normalized and time-aligned and synchronized with each other for use by one or more machine learning models. For example, to properly understand the impacts of news or social media sentiment, email frequency in the past 30 days, stock price changes in the past 7 days, and number of leadership changes in the past 5 months on the likelihood of success for an opportunity, the system can align and optionally normalize these data signals against each other in a continuous data stream. Interpolations may also be performed to estimate the values of certain data signals, such as at times associated with data values in other data signals. The interpolated, normalized, and time-aligned time-series data signals can be provided to one or more machine learning models to generate predictions, such as predictions for each entity at each point in time. Overall, this allows all of the various data used by the machine learning models to be combined in order to create a single time-series view of the data.

### AI-Based Evidence Package

Various AI-based functions described above have involved the use of evidence packages. The generation of an AI-based evidence package involves identifying contributing factors to a machine learning output, which means that the evidence package identifies reasons why a machine learning algorithm makes a particular prediction and the impact of individual reasons on the prediction. In some embodiments, an AI evidence package can represent intermediate data elements (such as features of a machine learning model's outputs) that are leveraged for multiple CRM-based functions without requiring upstream or downstream processing, platform elements, etc. An AI-based evidence package can be a data element or data structure that can be used to implement various CRM functionality of a platform.

As a particular example of this, an AI-based CRM system can use machine learning to generate scores, forecasts, or segmentations of customers or products. As discussed in this disclosure, scores may represent the likelihood that an opportunity closes, the propensity of a customer to buy a product or service, the likelihood that a customer will churn, etc. Although the AI research community has developed AI model interpretability frameworks, those frameworks are designed primarily for data scientists to understand why machine learning models make certain decisions, and they are not relatable for CRM application end users who may have no expertise with artificial intelligence. Because of this, features used in machine learning models may not be relatable for representatives (users of a CRM application), feature contribution frameworks may not be relatable for representatives, and feature values may not be contextualized to understand why they contribute positively or negatively to an AI-calculated score. AI-based evidence packages can be generated for scores, forecasts, segmentations, or other AI-based outputs to explain the reasoning behind those predictions. As a particular example, extraprise data that is available for use may include news about a company and stock aggregates associated with an opportunity's industry (such as healthcare or mining) or region (such as country or continent). Here, an AI evidence package may contain statements such as “News about account indicates layoffs” or “Stock aggregate of opportunity's region/industry have declined 30% over the past 3 months.” The data that corresponds to those statements can be fed as model inputs directly so that a machine learning model can learn how to predict that an opportunity is unlikely to close successfully if the news about a customer's account is negative or if the customer account is in an industry that (as a whole) has been declining. Some other specific examples of types of AI-based evidence packages that can be presented to users are provided below.

In some examples, features that are used by a machine learning model can be grouped, and the feature contribution of the group can be obtained as the sum of the feature contributions of the individual features. There are a number of ways in which AI features can be grouped and tracked to support the generation of AI-based evidence packages. For example, multiple levels of groupings can be created in a hierarchy, and the contribution of each group in the hierarchy can represent the sum of the contributions of its individual features. In some cases, features can be grouped into “super features,” and the super features can be grouped into feature groups as described above.

Also, in some cases, contextualization of feature scores can be performed by identifying nearest neighbors to the feature scores. As an example, with respect to opportunity scoring, it is possible to identify deals or opportunities that are similar to a deal or opportunity under consideration, and those similar deals or opportunities can be filtered (such as to identify the similar deals or opportunities that succeeded). Feature values for the deal or opportunity under consideration can then be compared with feature values of the similar deals or opportunities in order to determine how the feature values for the deal or opportunity under consideration contribute (positively or negatively) to its opportunity score. As another example, with respect to a bookings forecast, there may be only one business unit within the scope of the bookings forecast, and a bookings forecast model may not have other business units to use for comparison/context. In this situation or in other situations, feature values can be placed into context with historical values for the same business unit, such as by comparing the feature values for a current deal or opportunity with feature values for deals or opportunities during the same time in the prior quarter or during the same time in the prior year (which may be good temporal references for comparison).

In addition to or as an alternative to the example embodiments described above, another example implementation may support a technique for generating an AI evidence package that includes determining one or more machine learning model features that contributed to predicted probabilities determined from one or more machine learning models. The one or more machine learning models are used with at least one CRM function to calculate transaction opportunities, and the machine learning model features can be extracted from outputs of the one or more machine learning models. This example implementation can use at least one AI evidence package as at least one input to the one or more machine learning models or to one or more additional machine learning models, and a library of AI evidence packages associated with the machine learning model outputs can be created.

In some cases, each AI evidence package can be associated with at least one of a recommendation, a score, a pricing, a prediction, a report, a real-time stream, a dynamic graphical reporting interface, a marketing campaign, an adjusted model, and updated data generated using the one or more machine learning models. An AI evidence package may identify (i) a group of multiple machine learning model features and/or (ii) a feature contribution of the group to the associated machine learning model output (where the feature contribution of the group includes a sum of feature contributions of the machine learning model features in the group) and/or (iii) multiple groups of machine learning model features, such as multiple groups associated with a hierarchy (where a feature contribution of each group in the hierarchy represents a sum of feature contributions of the machine learning model features in the group).

In some embodiments, the features can be grouped into super features, the super features can be grouped into feature groups, and an AI evidence package can identify the feature groups. As one specific example of an implementation, at least one AI evidence package may contextualize at least one associated machine learning model output by identifying nearest neighbors of the at least one associated machine learning model output, where (optionally) at least one associated machine learning model output includes an opportunity score capturing a probability that a transaction opportunity will be successfully completed with a specified customer. The nearest neighbors of the at least one associated machine learning model output may include similar transaction opportunities that were successfully completed. As another specific example of an implementation, at least one associated machine learning model output may include a revenue or bookings forecast. The nearest neighbors of the at least one associated machine learning model output may include prior revenue or bookings forecasts generated for the same or similar time in a prior fiscal period.

In various embodiments, one or more machine learning models may be used to perform at least one CRM function by using one or more machine learning models to utilize time-series data that includes internal and external information as time-aligned, normalized, and interpolated. In some cases, one or more machine learning models can be associated with (i) a core machine learning model and one or more additional machine learning models and (ii) a core data model and one or more additional data models. The one or more additional machine learning models and the one or more additional data models can extend the core machine learning model and the core data model to one or more industry-specific functionalities.

### Additional AI-Based Functionality

While the description above has described a number of possible AI-based CRM functions, various other AI-based CRM functions may be supported in the same or similar manner as those described above. For example, a customer loyalty management technique may use suitable data sources and one or more machine learning models to manage customer loyalty. This may involve unifying customer loyalty systems, web and mobile interactions, sales or other transaction systems, and external data (such as demographics, news, and social media content) and applying a machine learning model for customer segmentation in order to predict changes in customer loyalty. This may be done to identify customers at risk of churning and to identify engagement recommendations and offers in order to maintain or increase loyalty. This approach may be used in conjunction with next best offer and customer churn management functionality. This approach may also identify customer loyalty or changes therein for individual customers, groups of customers, or customer as a whole.

As another example, a product configuration and bundling technique may use suitable data sources and one or more machine learning models to predict customers' desired product configurations and streamline sales/other transactions or an onboarding process. This may involve unifying product configuration systems, historical orders, sales or other transaction systems, and external data (such as demographics, news, and social media content) and applying a machine learning model for customer segmentation in order to predict customer preferences for product configurations and bundles. The customers may then be proactively offered the product configurations and bundles, as opposed to going through a full time-consuming configuration process.

As yet another example, an Internet self-service technique may use suitable data sources and one or more machine learning models to manage customers' journey orchestration via Internet self-service. This may involve unifying website traffic and history, sales or other transaction systems, service systems, and external data (such as demographics, news, and social media content) and applying a machine learning model in order to predict the most successful Internet self-service customer journey (navigation) and provide signals to website clients on which journey will achieve a desired customer outcome (such as successful sales or other transactions, rapid delivery of support, or streamlined browsing to find the most relevant data on a website).

Note that in the various figures showing architectures and related functions described above, the functionalities of the various architectures may be implemented in any suitable manner. For example, in some embodiments, various functionalities can be implemented or supported using one or more software applications or other software instructions that are executed by at least one processing device 202 of the application server(s) 106 or other device(s). In other embodiments, at least some of the functionalities can be implemented or supported using dedicated hardware components. In general, the functionalities described above may be performed using any suitable hardware or any suitable combination of hardware and software/firmware instructions.

Also note that while various architectures and related functions are described above with reference to different figures, any combination of these architectures and related functions may be used together in any given implementation. Moreover, various components that are shown in one or some of the figures described above may be used in other figures described above, even if those components are not explicitly shown in the other figures. Thus, for instance, a model orchestrator function 242 may be used in any of the architectures described above in order to control the operations being performed using the architecture(s).

### User Interfaces

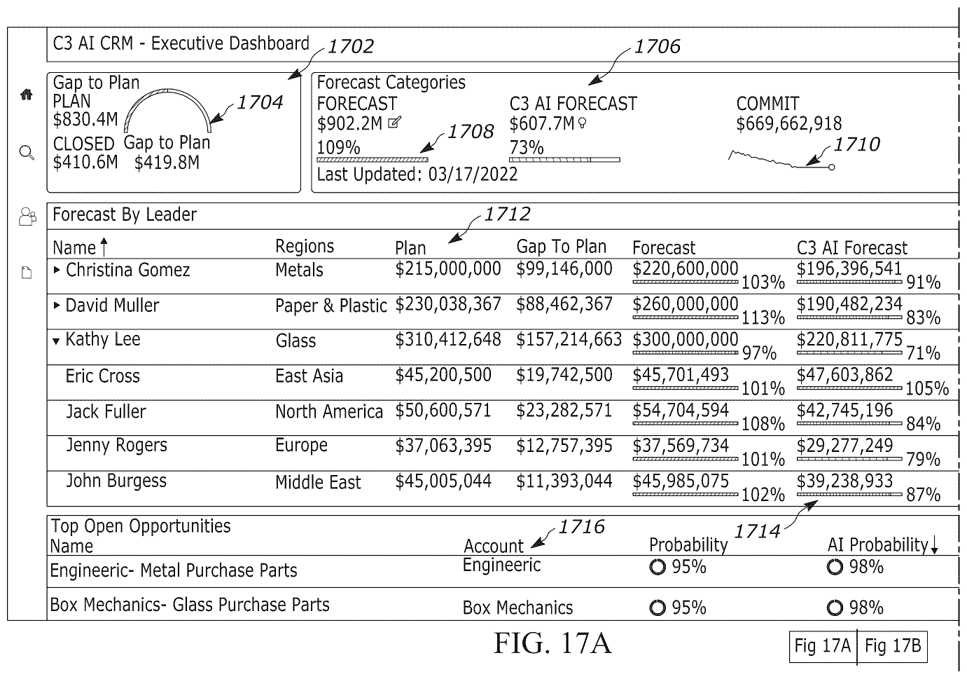

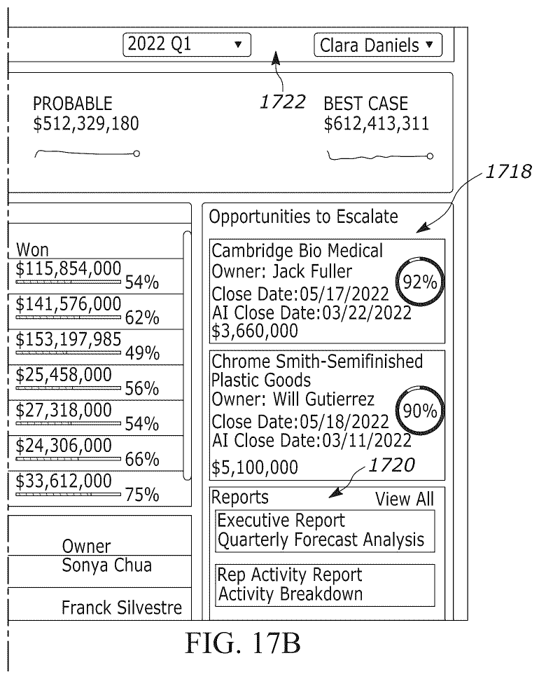

FIGS. 17A through 27 illustrate example user interfaces supporting AI-based CRM according to this disclosure. The user interfaces may, for example, be generated by or for the various architectures described above using one or more devices 200 of FIG. 2A, the architecture 220 of FIG. 2B, the modular services component 250 of FIG. 2C, and/or the machine learning platform system 260 of FIG. 2D. In some cases, the user interfaces may be presented on one or more of the user devices 102a-102n of FIG. 1. However, the architectures may generate or be used with any other suitable user interfaces, and the user interfaces may be presented on any other suitable device(s) in any other suitable system(s). Also, multiple user interfaces are described below, and each user interface may be used individually or in combination with any other user interface(s) described below in any suitable combination. The specific user interfaces used in any given implementation may vary based, among other things, on the CRM-related functions supported in that implementation.

As shown in FIGS. 17A and 17B, a user interface 1700 represents an executive dashboard interface that can be used to summarize information associated with a company or a portion thereof. Here, the user interface 1700 includes a gap-to-plan section 1702, which identifies a desired (planned) amount of sales or other revenue in a given timeframe and a won (closed) amount of sales or other revenue in the given timeframe for the company or the portion thereof. A graphical indicator 1704 illustrates how the closed amount of revenue compares to the planned amount of revenue, such as by illustrating the percentage of closed revenue compared to planned revenue as a colored or shaded arch across a semi-circular indicator. Any difference between the closed and planned amounts of revenue can be identified, such as by identifying the numerical difference between the closed and planned amounts of revenue within the graphical indicator 1704.

The user interface 1700 also includes a forecast categories section 1706, which identifies various overall forecasts for the company or the portion thereof. In this example, the forecast categories section 1706 identifies a total estimated human forecast of the sales or other revenue for the given timeframe and an AI-based estimated forecast of the sales or other revenue for the given timeframe. The AI-based estimated forecast of the sales or other revenue may, for instance, be generated using precision revenue forecasting as described above. The human and AI-based estimates of the sales or other revenue may each be associated with a graphical indicator 1708. Each graphical indicator 1708 can identify the estimated revenue compared to the planned revenue, such as by identifying a percentage of the estimated revenue relative to the planned revenue. Colors or shading may be used with at least one of the graphical indicators 1708, such as when orange and red are used with different levels of predicted shortfalls and green is used with satisfactory performance (although other colors and meanings may be used). The amount of color or shading within a bar of each graphical indicator 1708 can also be used to graphically represent the percentage of the estimated revenue relative to the planned revenue. The forecast categories section 1706 also identifies different categories of sales or other revenue forecasts. In this example, the forecast categories include revenue forecasts related to committed opportunities, probable opportunities to be closed (such as those opportunities with opportunity scores above a threshold), and best case opportunities. These categories may include graphical indicators 1710 that identify how the different categories of revenue forecasts have varied over time.

A forecast summary section 1712 provides information about the AI-based forecast contained in the forecast categories section 1706. In this example, the forecast summary section 1712 shows information by representative, which means the forecast is broken down by representative. The information in the forecast summary section 1712 includes the name of each representative and a region associated with each representative. The information also includes a desired or planned amount of sales or other revenue for each representative in the given timeframe, a won or closed amount of sales or other revenue for each representative in the given timeframe, and a gap-to-plan value identifying the difference between the closed and planned amounts of revenue for each representative in the given timeframe. The information further includes a total estimated human forecast of the sales or other revenue by each representative for the given timeframe and an AI-based estimated forecast of the sales or other revenue by each representative for the given timeframe. The AI-based estimated forecast of the sales or other revenue for each representative may, for instance, be generated using precision revenue forecasting as described above. Each of the closed amount of sales or other revenue, the human-based estimate of the sales or other revenue, and the AI-based estimate of the sales or other revenue may be associated with a graphical indicator 1714. Each graphical indicator 1714 can identify the associated revenue compared to the planned revenue for that representative, such as by identifying a percentage of the associated revenue relative to the planned revenue. Colors or shading may be used with at least one of the graphical indicators 1714, such as when orange and red are used with different levels of predicted shortfalls and green is used with satisfactory performance (although other colors and meanings may be used). The amount of color or shading within a bar of each graphical indicator 1714 can also be used to graphically represent the percentage of the associated revenue relative to the planned revenue. In some embodiments, the name of each representative identified in the forecast summary section 1712 may represent a hyperlink that can be selected in order to view more information about that particular representative. Representatives may also be arranged hierarchically, such as when representatives are grouped by manager, by region, or by some other characteristic(s). Also, each column of the forecast summary section 1712 can be selected to sort the information in that column, such as in increasing or decreasing order numerically or alphabetically.

An open opportunities section 1716 provides information about open opportunities associated with the representatives. In this example, each open opportunity is identified by name and customer account and has an associated owner (such as a representative). Each opportunity is also listed with its human-estimated probability of closing and its AI-based probability of closing, such as the probability 412a-412n that the opportunity will be successfully won by a specified close date. At least some of this information may, for instance, be generated using opportunity scoring as described above. Colors or other indicators may optionally be used with one or more of these fields, such as when different colors are used with the human and AI-based probabilities to identify whether the probabilities are good/bad or in high/medium/low ranges and when different amounts of closure of annular circles represent measures of the probabilities compared to 100% (although other colors and meanings may be used). In some embodiments, the name of each opportunity identified in the open opportunities section 1716 may represent a hyperlink that can be selected in order to view more information about that particular opportunity. Also, each column of the open opportunities section 1716 can be selected to sort the information in that column, such as in increasing or decreasing order numerically or alphabetically.

An accelerated opportunities section 1718 provides information about opportunities that might be completed earlier than their human-based predictions. In this example, each opportunity that might be accelerated is identified by name, owner, and listed value. Each opportunity that might be accelerated also shows the human-based close date prediction and the AI-based close date prediction, along with an AI-based calculated probability that the opportunity can be successfully won by the AI-based close date prediction. At least some of this information may, for instance, be generated using opportunity scoring and next best offer/product/action as described above. Colors or other indicators may optionally be used with one or more of these fields, such as when different colors are used with the AI-based probabilities to identify whether the probabilities are good/bad or in high/medium/low ranges and when different amounts of closure of annular circles represent measures of the probabilities compared to 100% (although other colors and meanings may be used). In some embodiments, each opportunity identified in the accelerated opportunities section 1718 may be associated with a hyperlink that can be selected in order to view more information about that particular opportunity.

A reports section 1720 may be used to identify specific types of reports that can be selected and viewed by a user. The reports in the reports section 1720 may be predefined, defined globally for all users, or defined locally for one or more specific users. Each of the reports when selected may be presented in any suitable format, such as on a webpage or in a portable document format (PDF) or other document.

One or more controls 1722 provided in the user interface 1700 allow the user to view information associated with different periods of time and optionally to view different types of information associated with different periods of time. In this example, the user has selected information for a particular fiscal quarter and a particular person (such as a sales manager or other representative), although other types of controls may be used in order to alter the information presented in the user interface 1700.

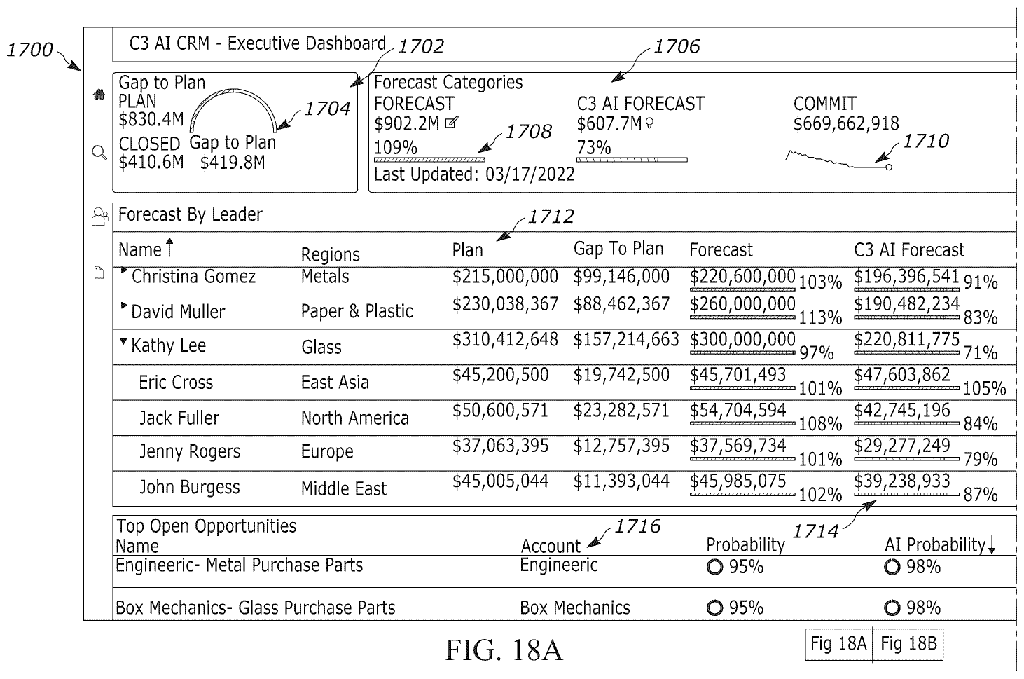

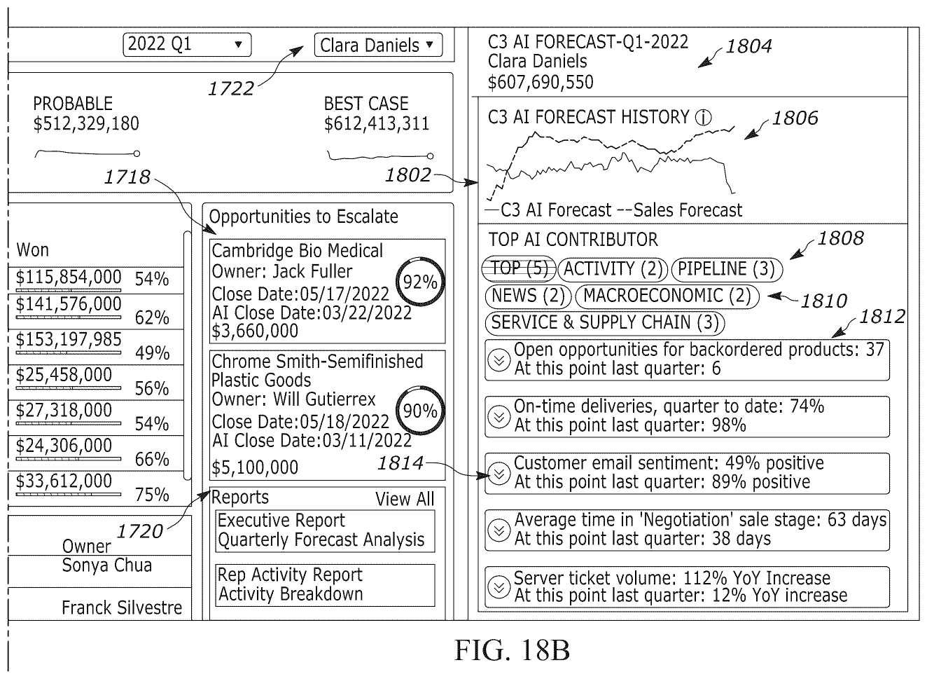

As noted above, various fields shown in the user interface 1700 may be clickable or otherwise selectable to view more specific information about that field. For instance, in some cases, a user may select a particular representative, opportunity, AI-based probability, or other field identified in the user interface 1700 (or select an option in another interface or otherwise request information about the particular representative, opportunity, AI-based probability, or other field). For example, as shown in FIGS. 18A and 18B, a user may select the AI-based forecast in the forecast categories section 1706, which presents the user with a pop-up window 1802 providing additional details for that particular AI-based forecast.

In this example, the pop-up window 1802 presents general information 1804 about the AI-based forecast or other selected field, such as an owner, time period, and value. The pop-up window 1802 also presents a forecast history 1806 over time, where the forecast history 1806 identifies both the human-predicted forecast and the AI-predicted forecast for the selected field over time (although only one of these might be presented depending on the selected field or specific configuration). The pop-up window 1802 further presents an AI-based evidence package 1808 that identifies the top contributors on which the AI-based forecast for the selected field is based. The AI-based evidence package 1808 may be produced using the AI-based evidence package module function 246. Here, the AI-based evidence package 1808 can be filtered using controls 1810, which in this example represent different types of contributors that can be viewed by the user. The AI-based evidence package 1808 also includes a listing of the top contributors or drivers 1812 that impact the AI-based forecast for the selected field. Each driver 1812 can have a textual description as well as an indicator 1814 that indicates whether the driver 1812 contributes positively, negatively, or neutrally (and optionally how strongly) to the AI-based forecast. Using the pop-up window 1802, an explanation for the AI-based revenue forecast may be viewed. At least some of this information may, for instance, be generated using opportunity scoring and AI evidence packaging as described above.

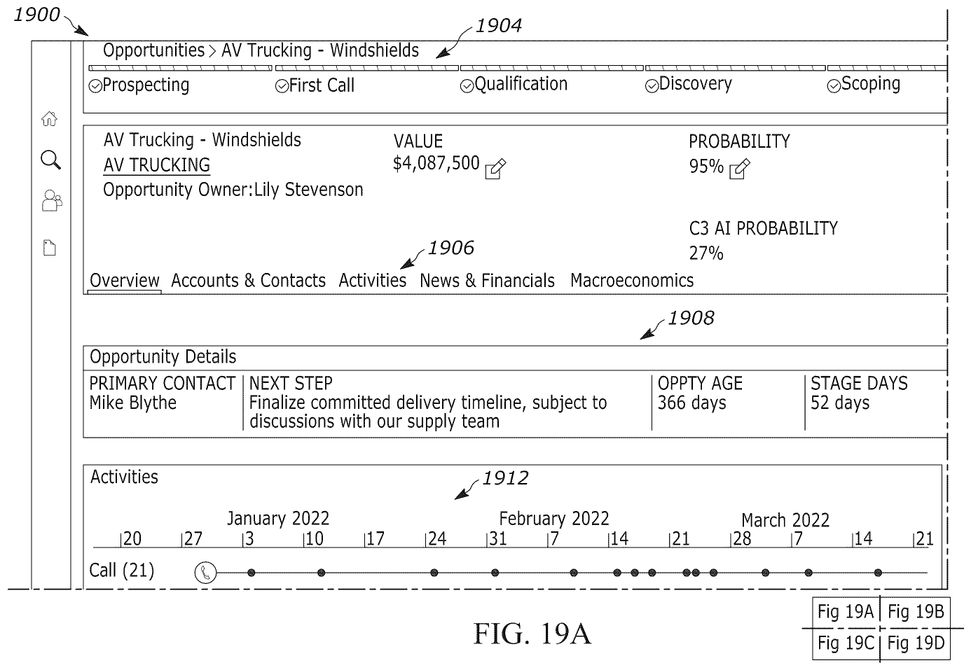

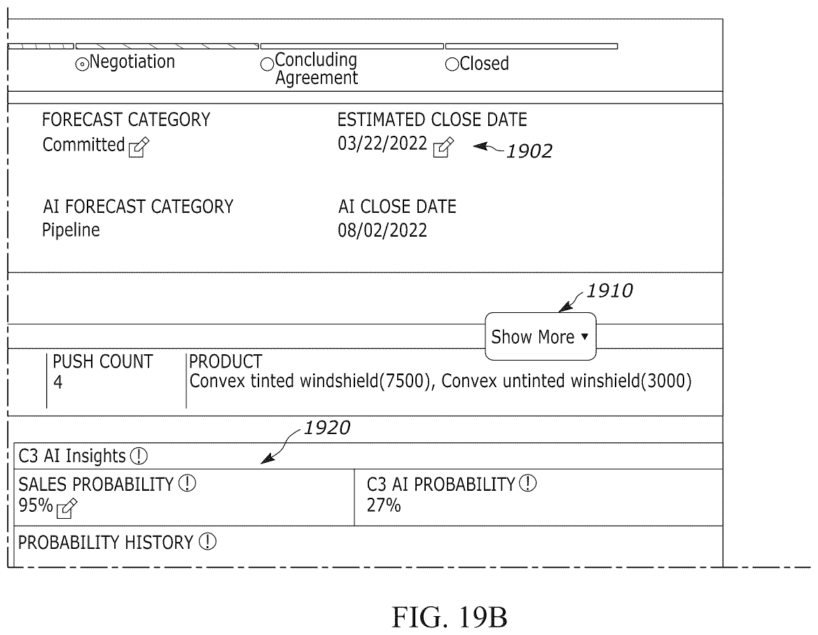

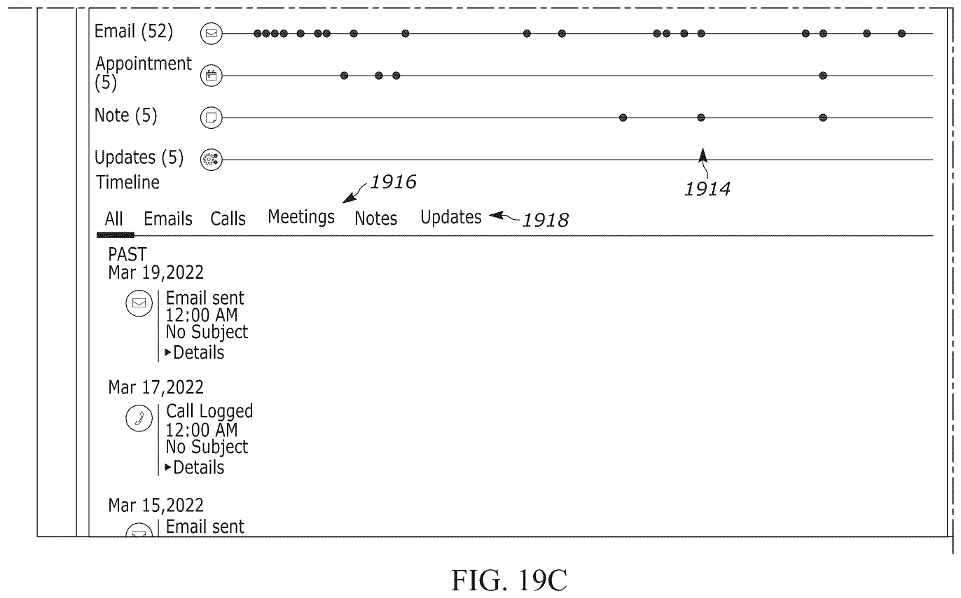

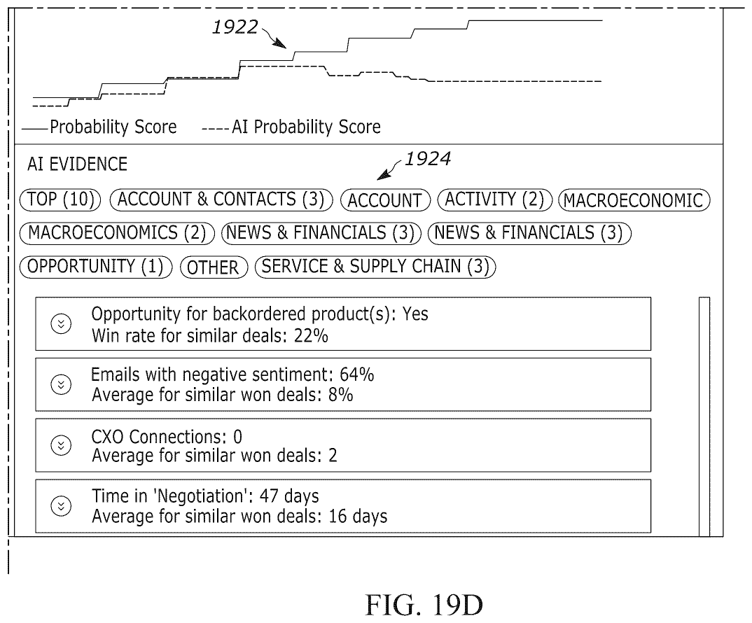

From the open opportunities section 1716, the pop-up window 1802, or other portion of the user interface 1700, 1800 or other interface, a user may select a particular opportunity for review. In that case, a user interface 1900 as shown in FIGS. 19A through 19D may be presented to the user. Here, the user interface 1900 includes an opportunity section 1902, which identifies various overall information related to a specific opportunity. In this example, the opportunity section 1902 identifies a name of the opportunity, an owner of the opportunity, and a listed value of the opportunity. The opportunity section 1902 also identifies a human-estimated probability of winning the opportunity, an AI-based estimated probability of winning the opportunity, and human and AI-estimated closing dates for the opportunity. The opportunity section 1902 further identifies a human-estimated forecast category for the opportunity and an AI-based forecast category for the opportunity. Colors or other indicators may be used with the human-estimated and AI-based estimated probabilities of winning the opportunity, such as when green is used to indicate higher probabilities and orange and red are used to indicate lower probabilities. At least some of this information may, for instance, be generated using opportunity scoring and precision revenue forecasting as described above. A bar or other indicator 1904 identifies a current stage of the opportunity in an overall transaction process. Controls may optionally be provided for updating the current stage of the opportunity and for editing the information about the opportunity.

Controls 1906 are used for toggling between different views associated with the opportunity, such as to view different types of information associated with the opportunity. In this example, an “Overview” option has been selected in the controls 1906, and an opportunity details section 1908 identifies various information about the opportunity. As shown here, this information may include the primary representative associated with the opportunity, a next step that is recommended to be taken for the opportunity, the age of the opportunity, the total number of days (or other time period) in which the opportunity has been in its current pipeline stage, a number of times that the opportunity has been raised with the customer (push count), and the product/service name(s)/volume(s)/price(s) associated with the opportunity. Only a summary or a portion of the opportunity details may be shown in the opportunity details section 1908, and a control 1910 may be used to expand the opportunity details section 1908 to view additional information about the opportunity or to contract the opportunity details section 1908.

An activities section 1912 identifies specific activities that have been performed involving the customer for the opportunity. Here, different types of activities are identified along with a total number of times that each type of activity has occurred. A graph 1914 plots the occurrences of the different types of activities over time. A timeline section 1916 provides additional details regarding the specific activities that have been performed involving the customer for the opportunity. For instance, the timeline section 1916 may identify the type, time, and date of each contact along with related details, such as the name of the person being contacted and that person's role/email address/telephone number. Controls 1918 may be used to limit the display of information in the timeline section 1916 to one or more specific types of activities.

A probability section 1920 identifies current human-based and AI-based estimates of winning the opportunity. Colors or other indicators may be used with the human-estimated and AI-based estimated probabilities of winning the opportunity, such as when green is used to indicate higher probabilities and orange and red are used to indicate lower probabilities. The probability section 1920 also presents a forecast history 1922 over time, where the forecast history 1922 identifies both the human-predicted forecast and the AI-predicted forecast for the opportunity over time (although only one of these might be presented). At least some of this information may, for instance, be generated using opportunity scoring as described above. In addition, an AI-based evidence package 1924 associated with the current AI-based estimate of winning the opportunity can be presented. The AI-based evidence package 1924 may be produced using the AI-based evidence package module function 246. In this example, the AI-based evidence package 1924 has the same or similar form as the AI-based evidence package 1808 shown in FIGS. 18A and 18B. Thus, for instance, the AI-based evidence package 1924 can include a listing of the top contributors or drivers, along with textual descriptions and indicators that indicate whether the drivers contribute positively, negatively, or neutrally (and optionally how strongly) to the opportunity score. Controls can be provided for filtering the identification of the top contributors.

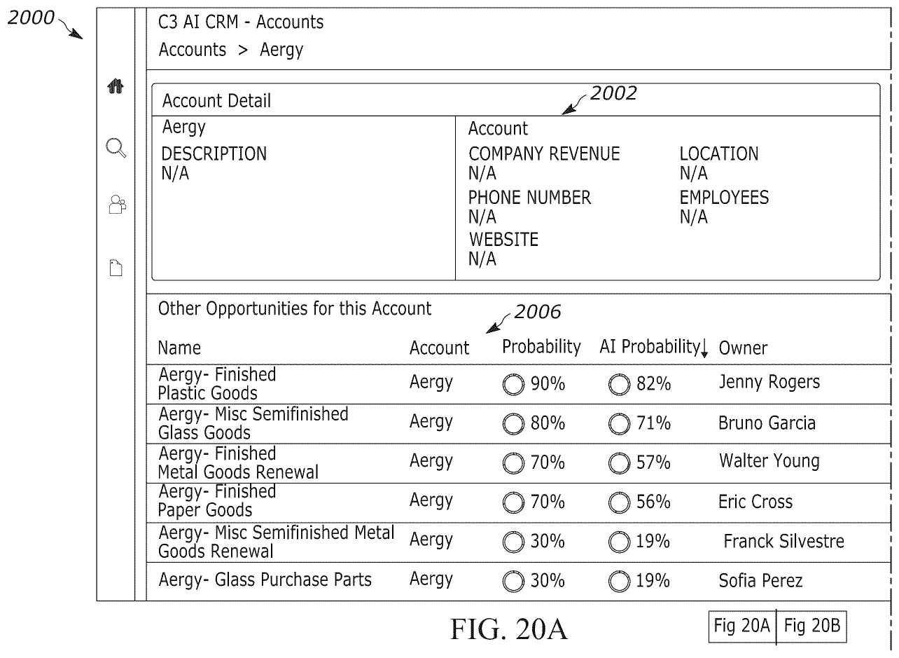

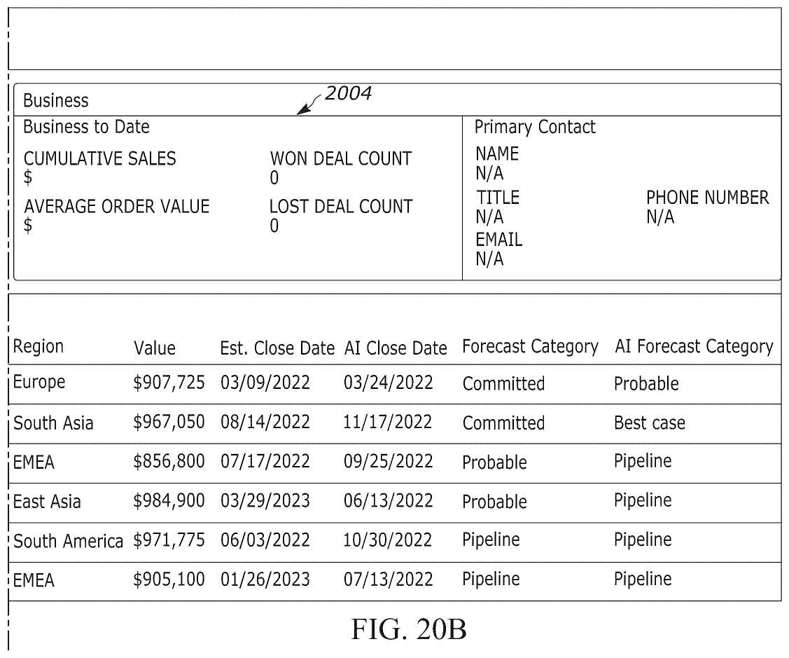

In some cases, a user may select a particular customer within one of the user interfaces described above or in another interface or otherwise request information about the particular customer. If a particular customer is selected, a user interface 2000 as shown in FIGS. 20A and 20B can be presented to provide information about that particular customer. Here, the user interface 2000 includes an account details section 2002, which identifies various information about the customer. In this example, the information about the customer includes a name and description of the customer, revenue and contact information of the customer, a location of the customer, a number of employees for the customer, and a website for the customer. A business section 2004 identifies various financial information about the customer, such as sales or other transactions involving the customer. In this example, the information includes cumulative sales or other transactions, number of won/lost sales or other transactions, and average order value. The information also includes information about a company's primary contact at the customer, such as the primary contact's name, title, email address, and phone number.

A related opportunities section 2006 identifies other opportunities involving the same customer. Here, for each related opportunity, the related opportunities section 2006 identifies a name and account associated with the related opportunity, human-based and AI-based probabilities of winning the related opportunity, an owner and region of the related opportunity, a value of the related opportunity, human-based and AI-based estimated closing dates of the related opportunity, and human-based and AI-based forecast categories of the related opportunity. At least some of this information may, for instance, be generated using opportunity scoring and next best offer/product/action as described above. Colors or other indicators may optionally be used with one or more of these fields, such as when different colors are used with the human and AI-based probabilities to identify whether the probabilities are good/bad or in high/medium/low ranges and when different amounts of closure of annular circles represent measures of the probabilities compared to 100% (although other colors and meanings may be used). In some embodiments, the name of each opportunity identified in the related opportunities section 2006 may represent a hyperlink that can be selected in order to view more information about that particular opportunity. Also, each column of the related opportunities section 2006 can be selected to sort the information in that column, such as in increasing or decreasing order numerically or alphabetically.

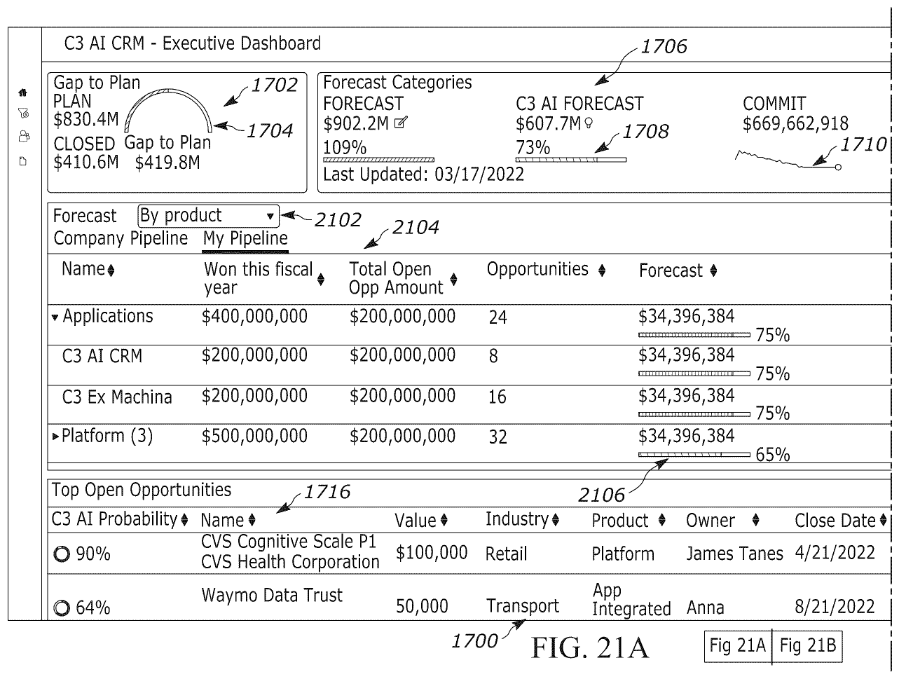

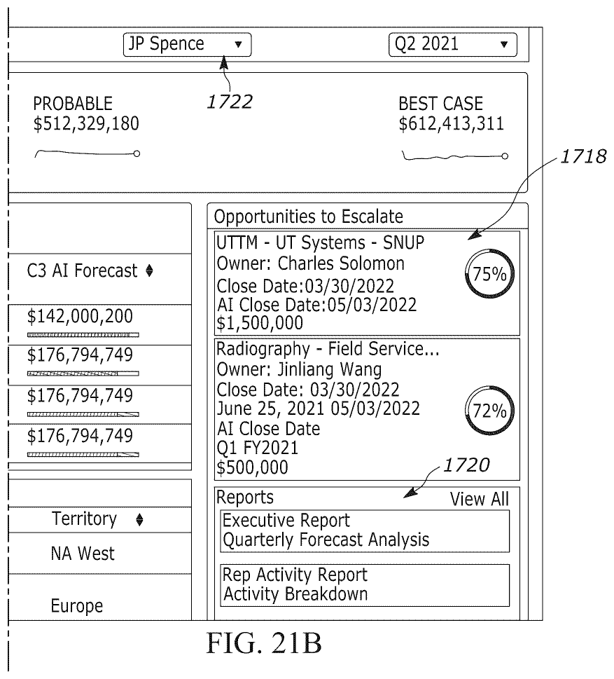

As shown in FIGS. 21A and 21B, the user interface 1700 may also be used to graphically present forecast information based on products/services rather than based on representatives (such as when a “by product” option rather than a “by leader” option is selected using a control 2102 of the user interface 1700). Here, the user interface 1700 shows a different forecast summary section 2104 in place of the forecast summary section 1712. The forecast summary section 2104 here is broken down by product or service. The information includes the name or category of each product/service, the won amount per category or name of product/service during a year or other time period, an amount of all open opportunities per category or name of product/service, a number of open opportunities per category or name of product/service, and human and AI-based forecasts per category or name of product/service.

Each of the human-based and AI-based forecasts may be associated with a graphical indicator 2106. Each graphical indicator 2106 can identify the associated revenue compared to the planned revenue for that product/service, such as by identifying a percentage of the associated revenue relative to the planned revenue. Colors or shading may be used with at least one of the graphical indicators 2106, such as when orange and red are used with different levels of predicted shortfalls and green is used with satisfactory performance (although other colors and meanings may be used). The amount of color or shading within a bar of each graphical indicator 2106 can also be used to graphically represent the percentage of the associated revenue relative to the planned revenue. Each column of the forecast summary section 2104 can be selected to sort the information in that column, such as in increasing or decreasing order numerically or alphabetically.

The user interface 1700 may be useful, for example, in determining performance by representatives or product/service lines over time. The user interface 1700 can also be used to understand representative and product/service behaviors, such as how the representatives and products/services are behaving in terms of won and forecasted business. It may also be possible to identify discrepancies and drill down to understand drivers and inform business planning discussions. If desired, information can be synchronized with order management and supply chain systems to drive production and inventory planning.

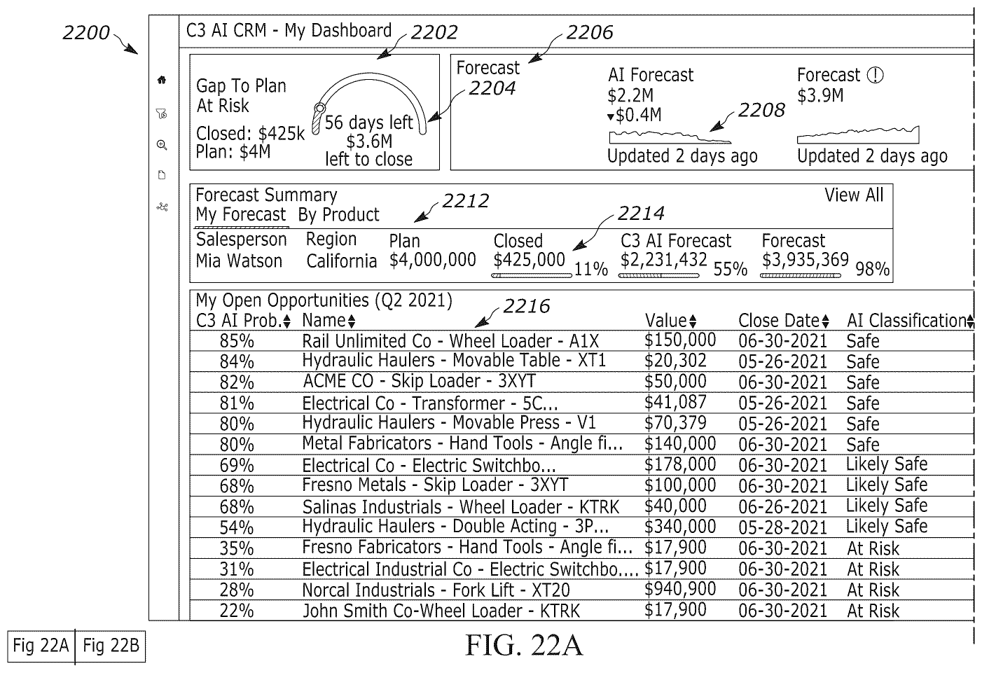

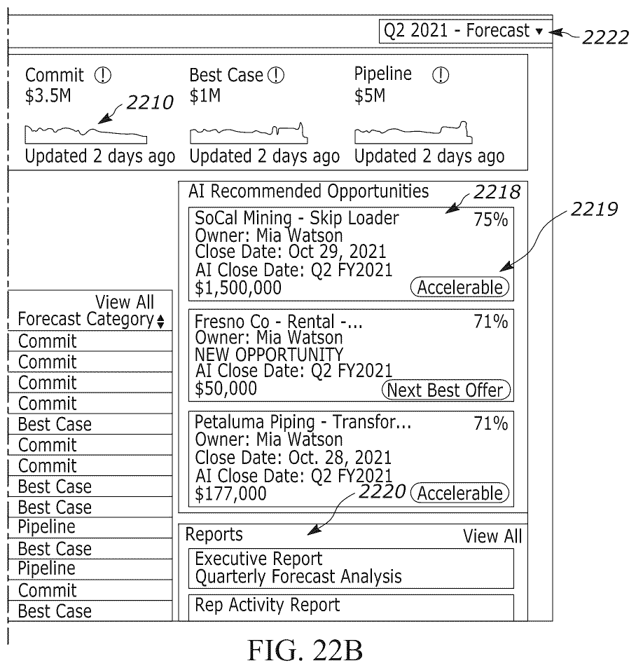

While the user interface 1700 represents an executive dashboard interface that summarizes information associated with a company or a portion thereof, other dashboards may also be used. For example, FIGS. 22A and 22B illustrate a user interface 2200 that represents a dashboard interface for a particular user, such as a particular representative. The types of information presented here may be the same as or similar to what is presented in the user interface 1700, but the user interface 2200 may be limited to a specific representative. Here, the user interface 2200 includes a gap-to-plan section 2202, which identifies a desired (planned) amount of sales or other revenue for the representative in a given timeframe and a won (closed) amount of sales or other revenue for the representative in the given timeframe. A graphical indicator 2204 illustrates how the closed amount of revenue compares to the planned amount of revenue for the representative, such as by illustrating the percentage of closed revenue compared to planned revenue as a colored or shaded arch across a semi-circular indicator. Any difference between the closed and planned amounts of revenue for the representative can be identified, such as by identifying the numerical difference between the closed and planned amounts of revenue within the graphical indicator 2204. The gap-to-plan section 2202 also identifies a time remaining in the given timeframe and an indicator whether the representative is likely to meet the desired revenue amount.

The user interface 2200 also includes a forecast categories section 2206, which identifies various overall forecasts related to the specific representative. In this example, the forecast categories section 2206 identifies a total estimated human forecast of the sales or other revenue for the representative in the given timeframe and an AI-based estimated forecast of the sales or other revenue for the representative in the given timeframe. The AI-based estimated forecast of the sales or other revenue may, for instance, be generated using precision revenue forecasting as described above. The human and AI-based estimates of the sales or other revenue may each be associated with a graphical indicator 2208. Each graphical indicator 2208 can identify how the estimated revenue has varied over time. Colors or shading may be used with at least one of the graphical indicators 2208, such as when orange and red are used with different levels of predicted shortfalls and green is used with satisfactory performance (although other colors and meanings may be used). The forecast categories section 2206 also identifies different categories of sales or other revenue forecasts for the representative. In this example, the forecast categories include revenue forecasts related to committed opportunities, best case opportunities, and all pipeline opportunities involving the representative. These categories may include graphical indicators 2210 that identify how the different categories of revenue forecasts have varied over time.

A forecast summary section 2212 provides information about the AI-based forecast contained in the forecast categories section 2206. Here, the forecast summary section 2212 provides information for the specific representative, although the user may elect to view information by product/service as was done in FIGS. 21A and 21B (note that a different type of control is shown here). The information for the specific representative in the forecast summary section 2212 includes the name of the representative and a region associated with the representative. The information also includes a desired or planned amount of sales or other revenue for the representative in the given timeframe and a won or closed amount of sales or other revenue for the representative in the given timeframe. The information further includes a total estimated human forecast of the sales or other revenue by the representative for the given timeframe and an AI-based estimated forecast of the sales or other revenue by the representative for the given timeframe. The AI-based estimated forecast of the sales or other revenue for the representative may, for instance, be generated using precision revenue forecasting as described above. Each of the closed amount of sales or other revenue, the human-based estimate of the sales or other revenue, and the AI-based estimate of the sales or other revenue may be associated with a graphical indicator 2214. Each graphical indicator 2214 can identify the associated revenue compared to the planned revenue for that representative, such as by identifying a percentage of the associated revenue relative to the planned revenue. Colors or shading may be used with at least one of the graphical indicators 2214, such as when orange and red are used with different levels of predicted shortfalls and green is used with satisfactory performance (although other colors and meanings may be used). The amount of color or shading within a bar of each graphical indicator 2214 can also be used to graphically represent the percentage of the associated revenue relative to the planned revenue. In some embodiments, the name of the representative identified in the forecast summary section 2212 may represent a hyperlink that can be selected in order to view more information about that particular representative.

An open opportunities section 2216 provides information about open opportunities associated with the specific representative. In this example, each open opportunity is identified by name and has a listed value, close date, and forecast category. Each opportunity is also listed with its AI-based calculated probability, such as the probability 412a-412n, that the opportunity will be successfully won by the identified close date and an AI classification that can be based on the calculated probability. At least some of this information may, for instance, be generated using opportunity scoring as described above. Colors or other indicators may optionally be used with one or more of these fields, such as when different colors are used with the AI-based probabilities to identify whether the probabilities are good/bad or in high/medium/low ranges (although other colors and meanings may be used). In some embodiments, the name of each opportunity identified in the open opportunities section 2216 may represent a hyperlink that can be selected in order to view more information about that particular opportunity. Also, each column of the open opportunities section 2216 can be selected to sort the information in that column, such as in increasing or decreasing order numerically or alphabetically.

An accelerated opportunities section 2218 provides information about opportunities that might be completed earlier than their human-based predictions. In this example, each opportunity that might be accelerated is identified by name, owner, and listed value. Some opportunities that might be accelerated show the human-based close date prediction and the AI-based close date prediction, along with an AI-based calculated probability that the opportunity can be successfully won by the AI-based close date prediction. Other opportunities that might be accelerated show the AI-based close date prediction (without a human-based close date prediction since one might not exist), along with an AI-based calculated probability that the opportunity can be successfully won by the AI-based close date prediction. An indicator 2219 can be provided to indicate why the opportunity might be accelerated, such as “accelerable” when the opportunity might be closed sooner than anticipated by the representative or “next best offer” when a new opportunity has been detected. At least some of this information may, for instance, be generated using opportunity scoring and next best offer/product/action as described above. Colors or other indicators may optionally be used with one or more of these fields, such as when different colors are used with the AI-based probabilities to identify whether the probabilities are good/bad or in high/medium/low ranges (although other colors and meanings may be used). In some embodiments, each opportunity identified in the accelerated opportunities section 2218 may be associated with a hyperlink that can be selected in order to view more information about that particular opportunity.

A reports section 2220 may be used to identify specific types of reports that can be selected and viewed by a user. The reports in the reports section 2220 may be predefined, defined globally for all users, or defined locally for one or more specific users. Each of the reports when selected may be presented in any suitable format, such as on a webpage or in a PDF or other document.

One or more controls 2222 provided in the user interface 2200 allow the user to view information associated with different periods of time. In this example, the user has selected information for a particular fiscal quarter, although other types of controls may be used in order to alter the information presented in the user interface 2200.

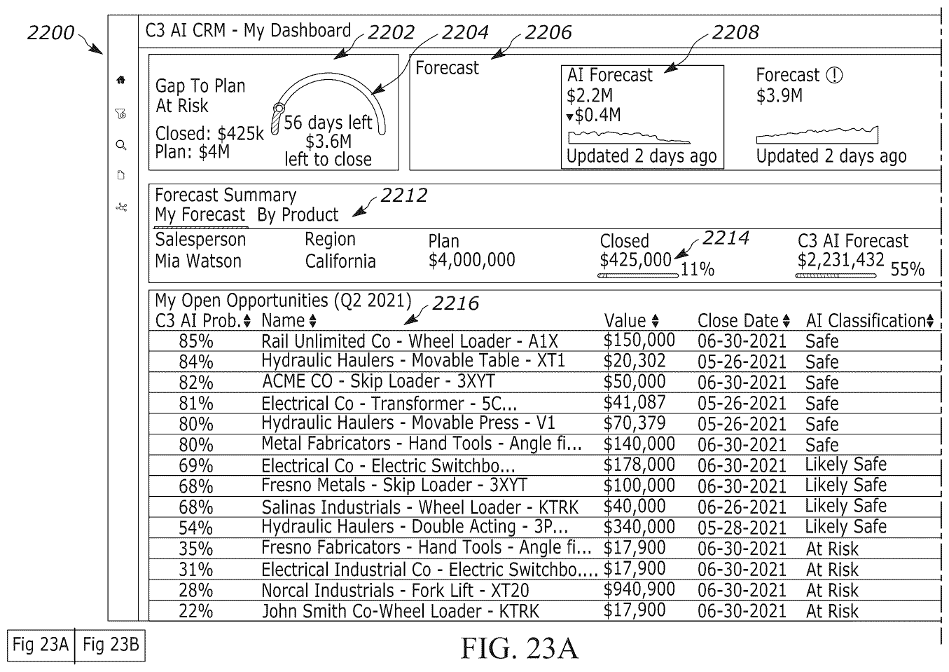

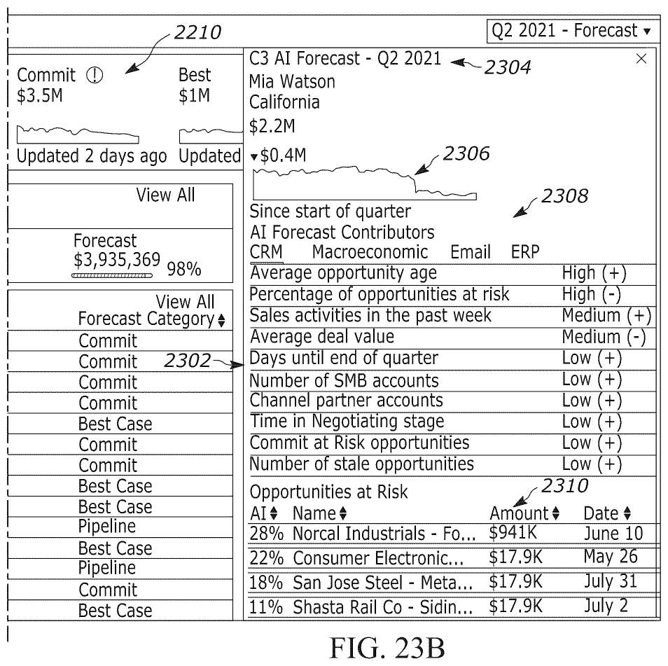

As noted above, various fields shown in the user interface 2200 may be clickable or otherwise selectable to view more specific information about that field. For instance, in some cases, a user may select a particular representative, opportunity, AI-based probability, or other field identified in the user interface 2200 (or select an option in another interface or otherwise request information about the particular representative, opportunity, AI-based probability, or other field). For example, as shown in FIGS. 23A and 23B, a user may select the AI-based forecast in the forecast categories section 2206, which presents the user with a pop-up window 2302 providing additional details for that particular AI-based forecast.

In this example, the pop-up window 2302 presents general information 2304 about the AI-based forecast or other selected field, such as an owner, region, time period, and value. The pop-up window 2302 also presents a forecast history 2306 over time, where the forecast history 2306 identifies the AI-predicted forecast for the selected field over time (the human-predicted forecast may also be included if desired). The pop-up window 2302 further presents an AI-based evidence package 2308 that identifies the top contributors on which the AI-based forecast for the selected field is based. The AI-based evidence package 2308 may be produced using the AI-based evidence package module function 246. Here, the AI-based evidence package 2308 can be filtered using controls, and the AI-based evidence package 2308 includes a listing of the top contributors or drivers that impact the AI-based forecast. Each driver can have a textual description as well as an indicator that indicates whether the driver contributes positively, negatively, or neutrally (and optionally how strongly) to the AI-based forecast. Controls can be provided for filtering the identification of the top contributors.

The pop-up window 2302 further includes an at-risk opportunities section 2310 that identifies opportunities of the specific representative determined to be at risk, such as when their opportunity scores are below a threshold. Each opportunity identified here can be identified by name, amount, and closing date and have an AI-based probability of closing by that date. Colors or other indicators may optionally be used with one or more of these fields, such as when different colors are used with the AI-based probabilities to identify whether the probabilities are good/bad or in high/medium/low ranges. In some embodiments, the name of each opportunity may represent a hyperlink that can be selected in order to view more information about that particular opportunity. Also, each column of the at-risk opportunities section 2310 can be selected to sort the information in that column, such as in increasing or decreasing order numerically or alphabetically. Using the pop-up window 2302, an explanation for the AI-based revenue forecast may be viewed. At least some of this information may, for instance, be generated using opportunity scoring and AI evidence packaging as described above.

The user interface 2200 may be used in the same or similar manner as the user interface 1700. Thus, for example, selecting a specific opportunity in the user interface 2200 or pop-up window 2302 may present the user with a user interface 1900 for that specific opportunity. Similarly, selecting a specific customer in the user interface 2200 or pop-up window 2302 may present the user with a user interface 2000 for that specific customer.

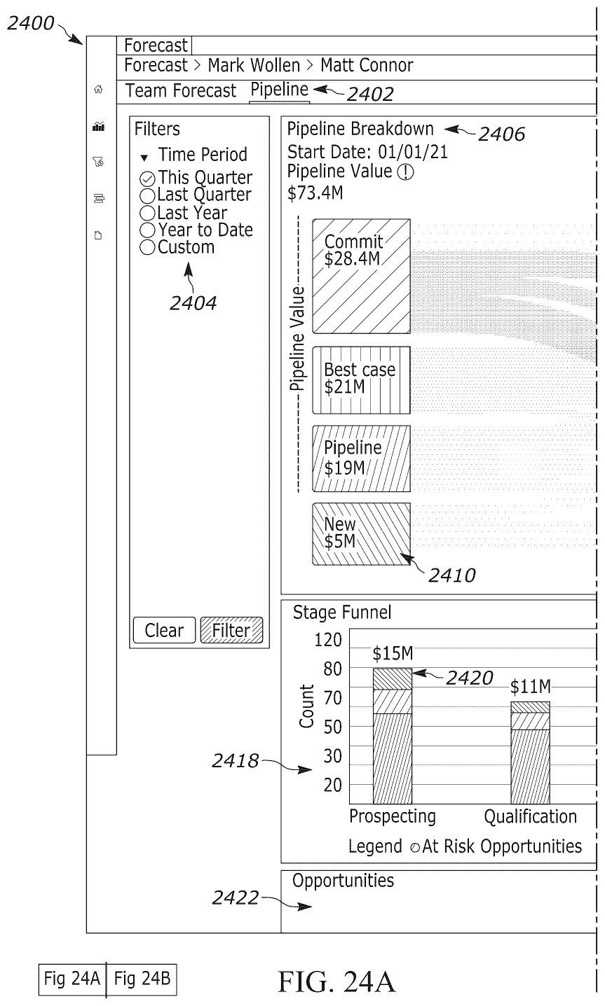

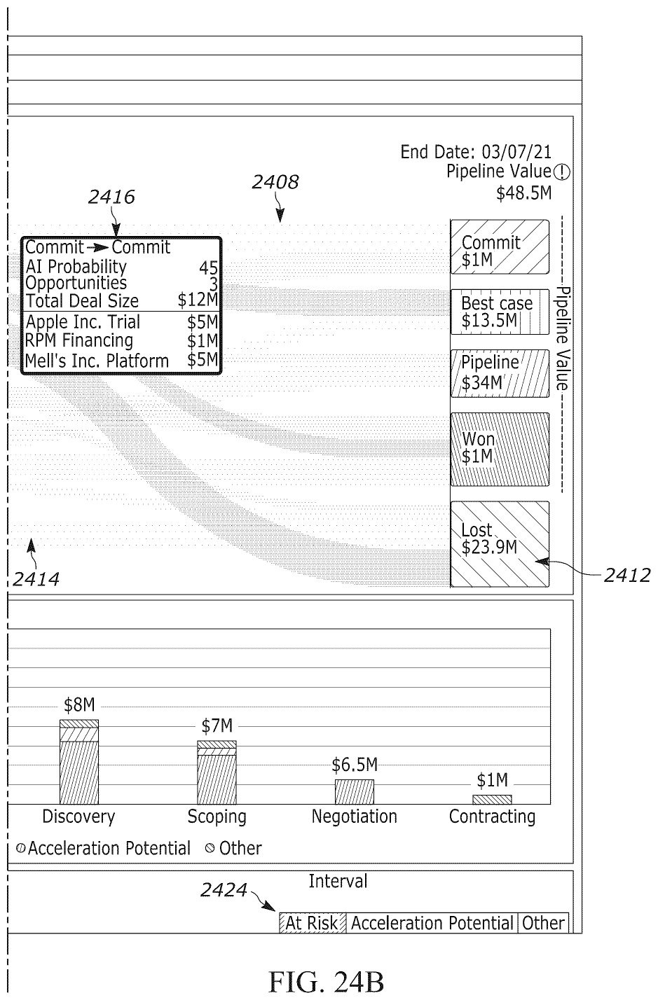

As shown in FIGS. 24A and 24B, a user interface 2400 may be used to graphically illustrate precision revenue forecasting information for one or more representatives. Here, the user interface 2400 includes controls 2402 that allow a user to identify whether the precision revenue forecast being presented relates to a pipeline or to a team of representatives. Controls 2404 allow the user to define a specific timeframe for a precision revenue forecast. In FIGS. 24A and 24B, the “Pipeline” option in the controls 2402 has been selected, so a precision revenue forecast for an entire pipeline is being presented. In that case, the user interface 2400 includes a summary 2406 associated with the precision revenue forecast for the pipeline, such as an identification of the start and end dates for the forecast and estimated values of opportunities in the pipeline for the associated representative(s) at the start and end dates of the forecast.

The user interface 2400 further includes a graphical representation 2408 that illustrates how opportunities in the pipeline (which are collectively represented using different monetary amounts here) are estimated to be resolved at the end of the timeframe. The estimations of how the opportunities are likely to be resolved can be based, for example, on opportunity scoring. Labels 2410 within the graphical representation 2408 identify different categories of opportunities at the start date of the forecast, and labels 2412 within the graphical representation 2408 identify different categories of opportunities at the end date of the forecast. As can be seen here, committed, best case, and pipeline categories are used to produce the estimated value of the opportunities in the pipeline at the start date of the forecast and to produce the estimated value of the opportunities in the pipeline at the end date of the forecast. In this particular example, new and lost opportunities are not included in the estimated values of the pipeline. Paths 2414 are shown traveling between the labels 2410 and 2412 to indicate how opportunities in the categories at the start date of the forecast are estimated to transition into categories at the end date of the forecast. The thickness of each path 2414 can be used to represent a monetary value of the opportunities, a number of the opportunities, or other characteristic(s) of the opportunities transitioning between one of the labels 2410 and one of the labels 2412. If the user selects one of the paths 2414 shown in the graphical representation 2408, a pop-up window 2416 may appear and identify information about the one or more opportunities associated with that path 2414. In this example, the pop-up window 2416 identifies the number of opportunities involved, the overall AI-based probability of winning those opportunities, a total monetary size of those opportunities, and the individual opportunities themselves along with their individual monetary sizes.

The user interface 2400 can also include a graphical representation 2418 of all opportunities for the pipeline in terms of the sales or other transaction stages in which those opportunities are currently positioned. Here, the graphical representation 2418 identifies each stage and, for each stage, includes a bar 2420 identifying the number of opportunities in that stage. Each bar 2420 may itself be subdivided into sections that identify, for example, the numbers of opportunities in the associated stage that are at risk, capable of being accelerated, or otherwise located in that stage. Each bar 2420 may also have an associated monetary value for all opportunities in the stage. The graphical representation 2418 is referred to as a “stage funnel” since the number of opportunities typically decreases (as a general rule) moving left-to-right through the various transaction stages. Each bar 2420 in the graphical representation 2418 may be selectable in order to view information about the specific opportunities in the associated stage.

A listing 2422 (only a portion of which is shown here) can identify the specific opportunity or opportunities associated with a selected path 2414 in the graphical representation 2408 or a selected bar 2420 in the graphical representation 2418. In some cases, the listing 2422 may include information about each opportunity similar to those listings described above for other user interfaces. Controls 2424 may be used to filter the opportunities in the listing 2422, such as by filtering the listing 2422 to include only opportunities that are at risk, capable of being accelerated, or otherwise included.

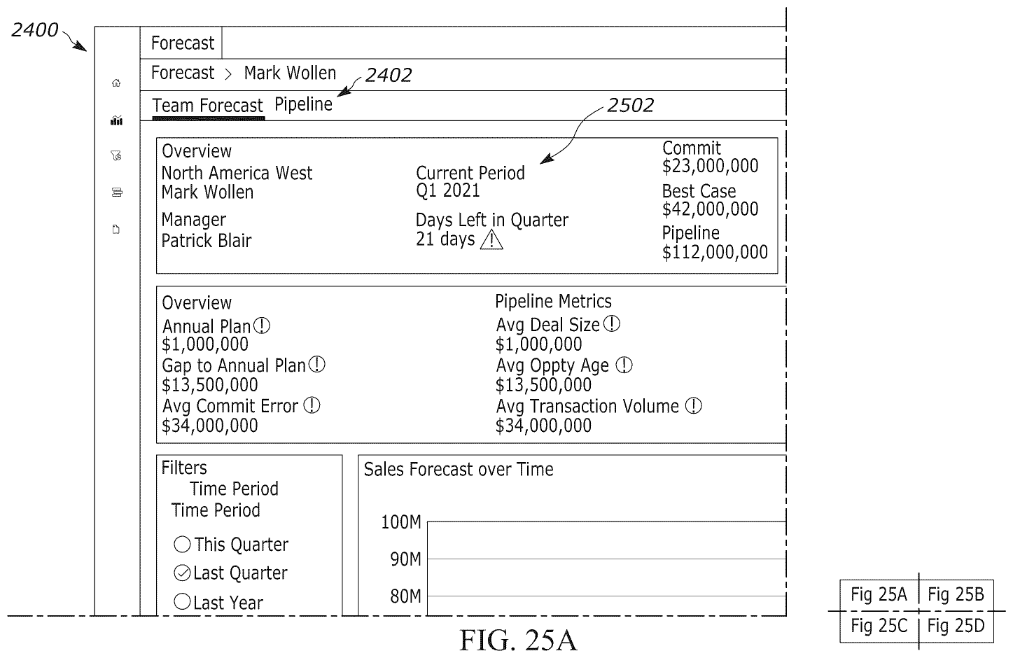

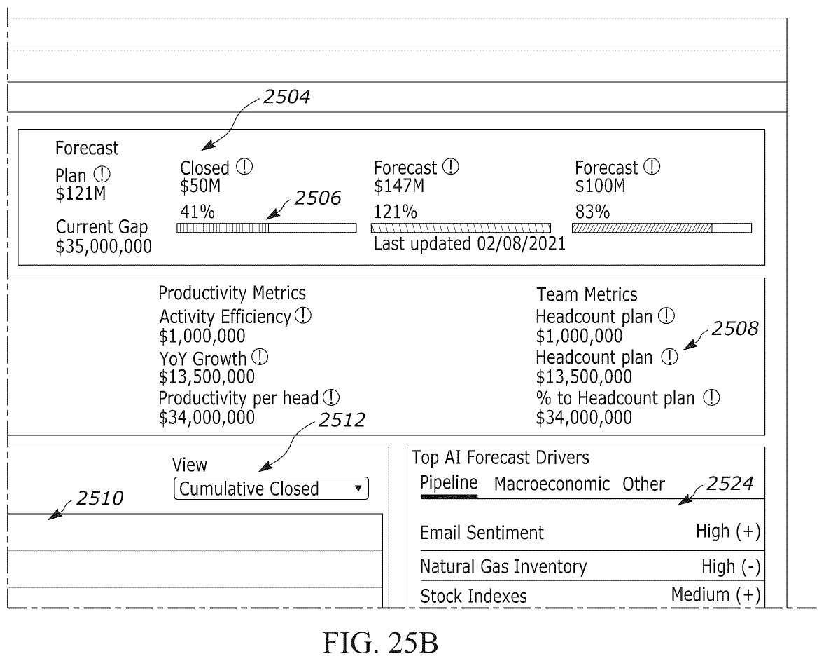

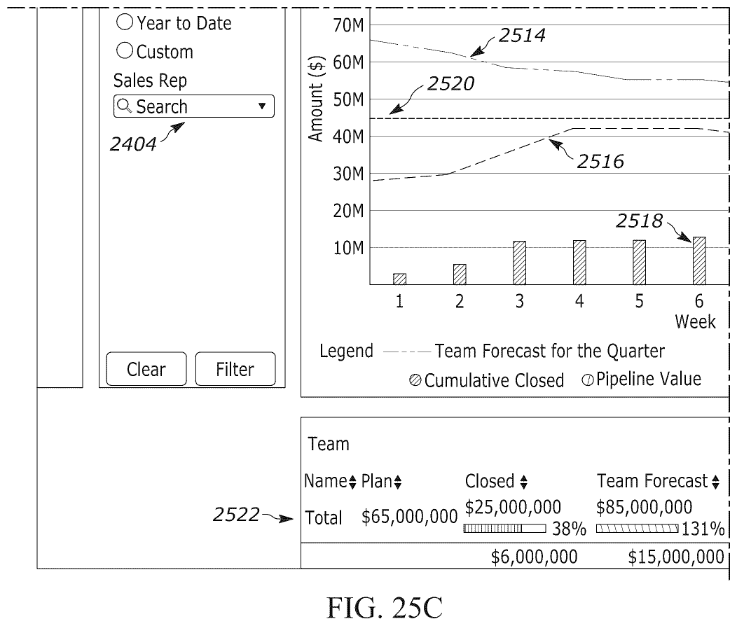

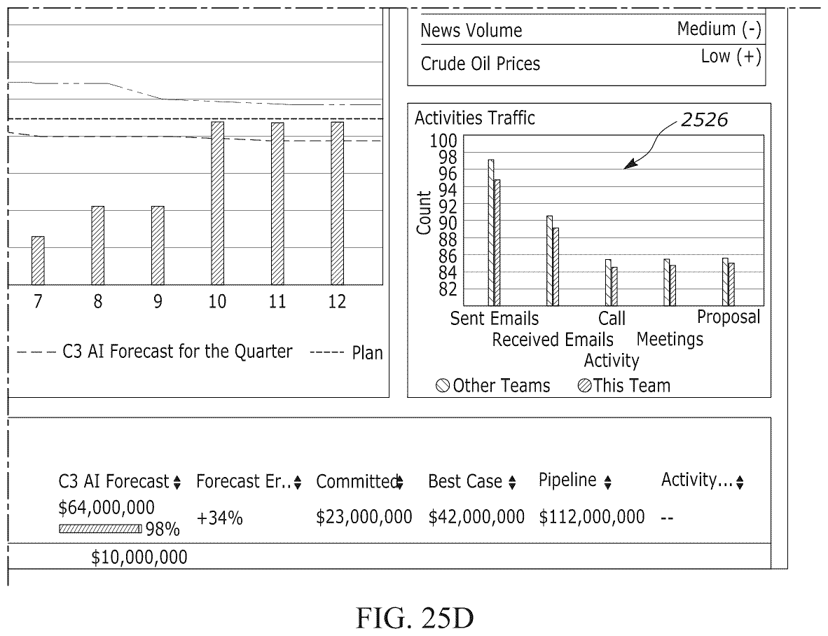

As shown in FIGS. 25A through 25D, the user interface 2400 is now being used to graphically illustrate precision revenue forecasting information for a team of representatives, which is accomplished by selecting the “Team Forecast” option in the controls 2402. In that case, the user interface 2400 now includes expanded controls 2404, which allow the user to define a specific timeframe for a precision revenue forecast and optionally to limit the precision revenue forecast to one or more specific representatives associated with the team. In the absence of an identification of one or more specific representatives via the controls 2404, the precision revenue forecast may be shown for the entire team of representatives.

The user interface 2400 includes an overview section 2502 that identifies various information about the precision revenue forecast for the team of representatives or any selected representative(s). Here, the information includes a location and a manager for the team or selected representative(s) and a current fiscal period for the precision revenue forecast. The information also includes an identification of the remaining time (such as number of days) until the end of the current fiscal period. In addition, the information includes overall values associated with opportunities for the team of representatives or any selected representative(s) in different categories, such as committed, best cast, and pipeline opportunities.

The user interface 2400 also includes a forecast section 2504, which identifies information associated with various human and AI-based predictions for the precision revenue forecast related to the team or selected representative(s). This information includes a planned amount of revenue and a current gap (if any) between estimated and realized revenues. This information also includes a won or closed amount of sales or other revenue, a total estimated human forecast of the sales or other revenue, and an AI-based estimated forecast of the sales or other revenue. The AI-based estimated forecast of the sales or other revenue may, for instance, be generated using precision revenue forecasting as described above. Each of the closed amount of sales or other revenue, the human-based estimate of the sales or other revenue, and the AI-based estimate of the sales or other revenue may be associated with a graphical indicator 2506. Each graphical indicator 2506 can identify the associated revenue compared to the planned revenue, such as by identifying a percentage of the associated revenue relative to the planned revenue. Colors or shading may be used with at least one of the graphical indicators 2506, such as when orange and red are used with different levels of predicted shortfalls and green is used with satisfactory performance (although other colors and meanings may be used). The amount of color or shading within a bar of each graphical indicator 2506 can also be used to graphically represent the percentage of the associated revenue relative to the planned revenue.

The user interface 2400 further includes a metrics section 2508, which identifies various metrics related to the predicted revenue forecast. In this example, the metrics section 2508 includes metrics associated with the forecast, pipeline, productivity, and team of representatives or selected representative(s). The forecast metrics may include the value of an annual plan for one or more representatives, a gap between current revenue and the annual plan, and an average error or difference between committed opportunities and the annual plan. The pipeline metrics may include an average deal size of the opportunities in the pipeline for one or more representatives, an average age (in monetary terms) of the opportunities in the pipeline for one or more representatives, and an average transaction volume (in monetary terms) of the opportunities in the pipeline for one or more representatives. The productivity metrics may include activity efficiency (in monetary terms) of the team or selected representative(s), year-over-year revenue growth (in monetary terms) of the team or selected representative(s), and productivity per team member (in monetary terms) of the team or selected representative(s). The team metrics may include headcount (in monetary terms) for the team, headcount plan (in monetary terms) for the team, and percent for the headcount plan (in monetary terms) for the team.

A graphical representation 2510 plots human and AI-based predictions of revenue over time. A control 2512 can be used to identify the type of revenue predictions that are plotted in the graphical representation 2510. In this example, the graphical representation 2510 includes lines 2514 and 2516 that respectively represent the human and AI-based predictions of revenue over time, and bars 2518 represent cumulative revenue for closed opportunities over the same time. A line 2520 represents the desired or planned amount of revenue for the representative(s) during the given timeframe. Note that while actual revenue is plotted cumulatively here, the revenue may be presented in other ways based on the control 2512. Individual performances of team members are broken out in a table 2522 and shown along with a total performance for the entire team. In this example, for each representative, the table 2522 identifies planned revenue, closed revenue, a human-based forecasted revenue, an AI-based forecasted revenue, an error between the human-based and AI-based forecasted revenues, committed/best case/pipeline values of opportunities, and activities of the representative. The AI-based forecasted revenue may, for instance, be generated using precision revenue forecasting as described above.

An AI-based evidence package 2524 identifies the top contributors on which the predicted revenue forecast for the team or selected representative(s) is based. The AI-based evidence package 2524 may be produced using the AI-based evidence package module function 246. In this example, the AI-based evidence package 2524 has the same or similar form as the AI-based evidence packages described above. The AI-based evidence package 2524 can include a listing of the top contributors or drivers along with textual descriptions and indicators that indicate whether the drivers contribute positively, negatively, or neutrally (and optionally how strongly) to the predicted revenue forecast. Controls can be provided for filtering the identification of the top contributors.

A comparison 2526 of various types of activities of the current team or selected representative(s) relative to other teams or representatives is also provided. Here, the comparison 2526 plots the numbers of different types of activities performed by the current team or selected representative(s) compared to the averages or other numbers of the same types of activities performed by other teams or representatives. In this particular example, the specific activities used here include the number of emails sent, the number of emails received, the numbers of calls placed, the number of meetings conducted, and the number of proposals submitted.

The user interface 2400 here may be used to perform various functions, such as to drill down into the performance of any team of representatives and understand how a pipeline has changed over time for those representatives. For each opportunity contributing to the change in the pipeline, the user interface 2400 allows a user to understand the AI drivers by opportunity. The user interface 2400 further allows a user to analyze forecast and sales performance over time and compare different teams and different representatives. Among other things, the user interface 2400 can be used to understand individual or team performance and key metrics for a given timeframe. It is also possible to review representative history and performance in order to inform coaching decisions or make other personnel decisions. Historical performance and forecasting performance/accuracy over time can also be reviewed, and a user can view key drivers of the AI forecast and activity metrics as needed or desired.

FIGS. 26A-1 through 26E-2 illustrate an example user interface 2600 that may be used to provide relationship intelligence, such as when connections to a customer are being displayed for churn mitigation. In this example, as shown in FIGS. 26A-1 and 26A-2, the user interface 2600 includes controls 2602 that are used for toggling between different views of relationship intelligence information. In this particular example, the controls 2602 support views of an overview of the relationship intelligence information, account/contact-specific relationship intelligence information, and sales or other transactional-centric relationship intelligence information. The “sales view” option is selected here, and additional controls 2604 related to at least this view are presented. These controls 2604 enable a user to search the relationship intelligence information (such as based on keyword, connections, or ideal contacts) and create new relationship intelligence information (such as new people or nodes, events, or relationships). These controls 2604 also enable the user to configure the display of relationship intelligence information (such as based on a geographic map, data map, or AI model) and to control the display of certain types of information (such as for a specific opportunity or across all opportunities). These controls 2604 further enable the user to view relationship intelligence information in different ways (such as a standard view with a particular node in the center, a hierarchical view with a particular node at the top, a group view with a particular node in one level of a triangular or other arrangement, or a geospatial view with a particular node on a map). In addition, these controls 2604 enable the user to share relationship intelligence information, such as via an export operation. In this example, the user is viewing information for a particular opportunity, and a bar or other indicator 2606 identifies a current stage of the particular opportunity in an overall transaction process and the last time the current stage was updated.

Here, the user has selected to view the relationship intelligence information for the particular opportunity using a hierarchical display, which leads to the presentation of a graphical display 2608. The graphical display 2608 here includes nodes 2610 that identify specific individuals associated with a company, a customer, and optionally one or more third parties. The company, customer, and third party personnel may optionally be distinguished from one another in any suitable manner, such as via color or shading. Each node 2610 here includes a name of a person and that person's role in the company, customer, or third party. The top node 2610 in the graphical display 2608 represents an opportunity owner (representative) for the particular opportunity.

The graphical display 2608 also includes links 2612 that identify relationships between people represented by the nodes 2610. At least one of the links 2612 involves the top node 2610 for the opportunity owner and goes to at least one other node 2610 representing a person having a relationship with the opportunity owner. One or more other links 2612 may optionally involve other people unknown or poorly known to the opportunity owner. The thickness of each link 2612, or at least the links 2612 connected to the node 2610 of the opportunity owner, can have a thickness representing the strength of the relationship between the personnel represented by the nodes 2610 connected by that link 2612. Thus, for example, thicker lines may represent stronger relationships, and thinner lines may represent weaker relationships.

Each of one or more nodes 2610 (such as those nodes 2610 having direct links to the opportunity owner) can have an indicator 2614 identifying whether the person represented by that node 2610 has a positive, negative, or neutral attitude towards the opportunity owner. Controls 2616 can be used to zoom in, zoom out, or navigate within the graphical display 2608. In some cases, a node 2610 or link 2612 may be selected by the user in order to view specific information about the associated person or relationship. For example, if a particular node 2610 in the graphical display 2608 is selected, information about the selected contact can be provided, such as name, position, related parties (like the person who previously held the contact's position), email address, and phone number.

A timeline 2618 may be used to represent the number of interactions between the opportunity owner and one or more people (referred to as contacts) identified in the graphical display 2608. A control 2620 can be used to control whether the number of interactions in the timeline 2618 occurs for all contacts or just for one or more selected contacts, and a control 2622 can be used to adjust the amount of time represented within the timeline 2618. The timeline 2618 may be provided so that changes in the interactions between the company and customer can be viewed over time or can be viewed at a specific time.

If the user elects to identify an ideal contact (such as via the controls 2604) for the particular opportunity being viewed, a pop-up window 2630 as shown in FIGS. 26B-1 and 26B-2 may be presented to the user. Here, the CRM system can perform the relationship intelligence functions described above to identify possible connections between the opportunity owner and another person associated with the particular opportunity (whether or not that person is currently shown in the graphical display 2608). For example, the CRM system can look for strong connections between people having relationships with the opportunity owner and people associated with the customer involved in the opportunity. Both direct and indirect relationships may be identified here.

The results of this process can be used to populate a contacts list 2632 contained in the pop-up window 2630. Each contact in the contacts list 2632 can be identified by name and title, and an AI-based relevance score identifying the strength of the opportunity owner's relationship strength with that contact can be provided. Colors or other indicators may be used with the AI-based relevance scores, such as when green is used to indicate higher scores and orange and red are used to indicate lower scores. Each contact in the contacts list 2632 can also be associated with a number of connections that are shared by the opportunity owner and the contact and a number of marketing engagements involving the opportunity owner (or the company generally) and the contact. Checkboxes can be used by the user to select which of the contacts in the contacts list 2632 (if any) might be associated with an opportunity. Controls 2634 can be used to control whether one or more selected contacts from the contacts list 2632 are included in a list only or actually associated with the opportunity.

In this specific example, the user selects three contacts from the contacts list 2632 and adds those three contacts to the opportunity. This updates the user interface 2600 as shown in FIGS. 26C-1 and 26C-2. Here, the user has elected to view the results for all opportunities and to use a geospatial view. This updates the graphical display 2608 so that the nodes 2610 are arranged geographically. The graphical display 2608 has also been updated to now include additional nodes 2610 associated with the contact(s) added via the contacts list 2632. The user interface 2600 also now includes a summary 2642 of the possible contacts identified previously as discussed above and a listing 2644 of those possible contacts. Here, the listing 2644 is divided into sections identifying top possible contacts and all possible contacts, where the top possible contacts may be selected as having higher relevance scores. For each contact identified in the listing 2644, the listing 2644 identifies the name, position, number of shared contacts, number of marketing engagements, and relevance score (along with its related color or other indicator) for that contact.

Each contact identified in the listing 2644 can be selected by the user in order to view that contact's node 2610 within the graphical display 2608 or to view additional information about that contact. An example of this is shown in FIGS. 26D-1 and 26D-2, where the user has selected the first contact contained in the listing 2644. This updates the graphical display 2608 to highlight that particular contact's node 2610. This also updates the user interface 2600 with a pop-up window 2650, which contains additional information about this particular contact. Here, the pop-up window 2650 includes an identification 2652 of the contact, such as the contact's name and position. The pop-up window 2650 also includes a details section 2654 containing detailed information about the contact, such as the type of contact (like person or business), the contact's relevance score (along with its related color or other indicator), and the contact's phone number, email address, location, and LINKEDIN profile webpage. A control 2656 may be used to add the identified contact as an opportunity contact, meaning the identified contact can be added as someone associated with the opportunity.

In addition, the pop-up window 2650 includes an AI-based evidence package 2658 that identifies an explanation for why the selected contact was identified as possibly being an ideal contact for the opportunity. The AI-based evidence package 2658 may be produced using the AI-based evidence package module function 246. Here, the AI-based evidence package 2658 includes the relevance score and an indication of the range or quality of the relevance score (such as an indication that the relevance score is low/medium/high), along with a graphical indication of the relevance score plotted over time. The AI-based evidence package 2658 also indicates that the relevance score is better than a specified percentage of other possible contacts and identifies the number of shared connections between that contact and the opportunity owner.

As shown in FIGS. 26E-1 and 26E-2, the listing 2644 may include, for each contact, a section 2660 identifying certain shared connections involving the opportunity owner and the associated contact in the listing 2644. Each one of these shared connections can be selected by the user in order to perform one or more actions involving that connection. In this example, the user has selected the first shared connection, and the user interface 2600 presents a messaging box 2662 to the user. The messaging box 2662 allows the user to enter a message to one or more of the shared connections, such as a message requesting assistance with the opportunity. A control 2664 may allow the user to add one or more additional shared connections as recipients of the message, and a control 2666 may allow the user to add one or more shared connections as a team member for the opportunity.

The user interface 2600 may allow a user to understand the connection activity and strength of connection between a company and a customer and to identify the best path through a network to a given contact. The user interface 2600 may also provide (such as through related parties) next best contact recommendations to help opportunities progress. This may be useful, for example, if the selected contact does not have a strong (or any) connection with personnel of the company. The user interface 2600 may further allow users to understand organizational charts or other hierarchies of potential or actual customers.

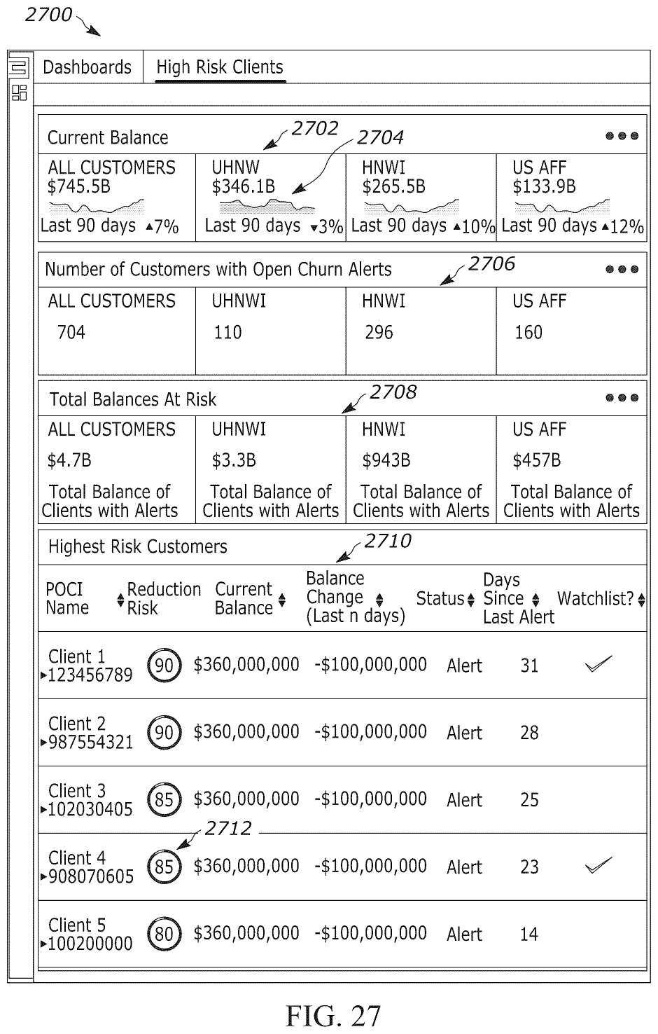

As shown in FIG. 27, a user interface 2700 may provide a dashboard view for customer churn (complete churn) predictions. Here, the user interface 2700 includes an overview section 2702 identifying information about all customers collectively and information about multiple groups of customers. This particular example is for a financial institution that has accounts with a number of customers, and the customers can be grouped as ultra-high net worth individuals (UHNWI), high net worth individuals (HNWI), and other individuals. A graphical indicator 2704 may be used with each group of customers and can identify the overall value associated with each group of customers, along with recent changes in that overall value. The user interface 2700 also includes a churn overview section 2706, which identifies numbers of customers (overall and in groups) having open churn alerts, meaning these customers have been identified as being more likely to churn based on the churn management as described above. The user interface 2700 further includes a churn risk overview section 2708, which identifies monetary values associated with the accounts of the customers (overall and in groups) having open churn alerts.

In addition, the user interface 2700 includes a churn alert section 2710, which can identify the open churn alerts for customers. Each churn alert here can be identified by the customer having the churn alert, a churn risk (churn probability) associated with the customer, a current balance associated with the customer, and a recent change in the balance associated with the customer (which may form at least part of the basis for the churn alert). Each churn alert also has an associated status and length of time (such as number of days or other length of time) since the churn alert was issued. Each churn alert may further have an indicator identifying whether any type of remediating action or other action has been undertaken. Colors or other indicators may optionally be used with one or more of these fields, such as when different colors are used with the AI-based churn probabilities to identify whether the probabilities are good/bad or in high/medium/low ranges and when different amounts of closure of annular circles represent measures of the probabilities compared to 100% (although other colors and meanings may be used). In some cases, a user may select a particular churn alert (such as by clicking on the customer name or other portion of the churn alert) in order to view more information about a particular churn alert, such as one or more churn prevention recommendations or relationship intelligence graphics.

Although FIGS. 17A through 27 illustrate examples of user interfaces supporting AI-based CRM, various changes may be made to FIGS. 17A through 27. For example, the contents and arrangements of the information shown in FIGS. 17A through 27 are for illustration only and can vary widely based on the implementation. For instance, the specific data shown in each user interface and in each section of the user interfaces may vary or have other forms from what is shown here. Also, the architectures described above may support the use of any other suitable user interfaces with any other suitable contents. In addition, while certain I/O mechanisms (such as checkboxes, various graphs, lists, etc.) are shown here, data may be input or output using the user interfaces in any other suitable manner using a variety of user interface mechanisms. In general, the format, content, and arrangement of user interfaces can vary widely, and FIGS. 17A through 27 do not limit the scope of this disclosure to any particular implementations of the user interfaces.

The AI-based CRM functions described above may find use in a number of applications. For example, one or more AI-based CRM functions may be extended to a specific industry. Example industries may include telecommunications, manufacturing, automotive, aerospace, healthcare, energy, financial services, and utility industries. In some cases, one or more machine learning models may be trained using information specific to an industry in order to allow one or more AI-based CRM functions to be performed for that industry. In other cases, one or more generic AI-based CRM functions may be performed using one or more generic machine learning models, and customization may be added to allow for use of the one or more AI-based CRM functions in specific industries.

FIG. 28 illustrates an example approach 2800 for extending AI-based CRM to a specific industry or other use case according to this disclosure. In this approach 2800, a core machine learning model 2802 represents a machine learning model used to perform a CRM function. For example, the core machine learning model 2802 may represent any of the machine learning models discussed above with reference to FIGS. 3 through 16. An industry-specific machine learning model 2804 is used to process inputs or outputs of the core machine learning model 2802. The industry-specific machine learning model 2804 can be trained to convert inputs or outputs of the core machine learning model 2802 into inputs or outputs tailored for use specifically with a particular industry. In this way, the core machine learning model 2802 may be trained to accurately perform one or more desired functions, and the industry-specific machine learning model 2804 may enable customization of the one or more desired functions without modification of the core machine learning model 2802.

Furthermore, a CRM function can be extended using an industry-specific data model 2808 that extends a core CRM data model 2806. The core CRM data model 2806 represents a collection of CRM entities and relationships between those CRM entities, and the core CRM data model 2806 is used by the core machine learning model 2802. The industry-specific data model 2808 represents a collection of industry-specific entities and relationships between those industry-specific entities, and the industry-specific data model 2808 is used by the industry-specific machine learning model 2804. Various industry-specific data models 2808 can connect to the core CRM data model 2806 to enable industry-specific capabilities (such as when a utilities-specific data model provides capabilities to process customers' utilities bills and energy consumption patterns for use as inputs into the core machine learning model 2802).

Although FIG. 28 illustrates one example of an approach 2800 for extending AI-based CRM to a specific industry or other use case, various changes may be made to FIG. 28. For example, multiple industry-specific machine learning models 2804 may be used to tailor the same core machine learning model 2802 for use with different industries.

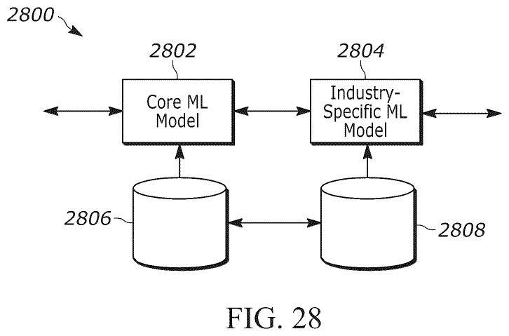

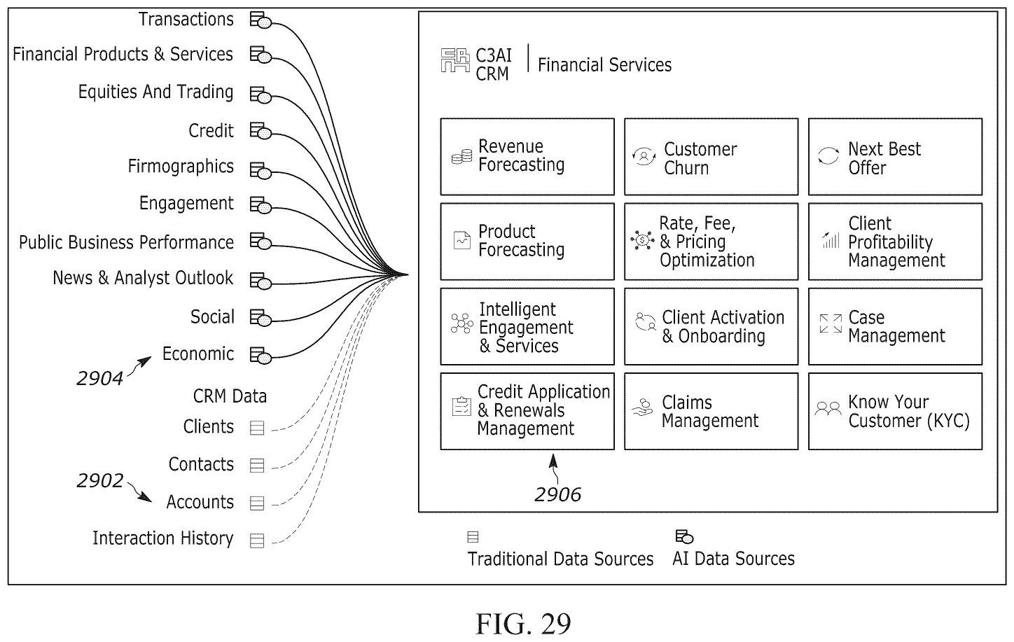

FIGS. 29 through 39 illustrate example use cases for AI-based CRM according to this disclosure. For example, the use cases shown here may be supported using the approach 2800 of FIG. 28, although other approaches (such as those that specifically train machine learning models for specific use cases) may be performed here. In the following discussion, it is assumed that each use case involves the use of various AI-based CRM functions described above. However, each use case may involve one, some, or all of the AI-based CRM functions described above.

Each use case is shown here using a figure that illustrates the data sources used in that use case and the possible AI-based functions available for selection in that use case. The description below describes what each of the possible functions for that use case may entail. As can be seen here, similar types of functions may be performed in the various use cases, but these functions may often be used for different purposes or to produce different results in the various use cases.

In FIG. 29, the use case here involves financial services, meaning the services provided to customers are financial in nature (such as banking or investment services). Data sources 2902 that can be used here include traditional data sources, such as sources of client (customer) data, client contacts, client accounts, and interaction histories. Additional data sources 2904 that can be used with AI-based CRM functions may include sources providing information such as client financial transactions, financial products and services that are available to clients, equities and trading behaviors of clients, credit available to clients, and firmographics data associated with the clients. The additional data sources 2904 that can be used with AI-based CRM functions may also include sources providing information such as client engagement data, public business performance data for clients, news and analyst outlooks for clients, social media data associated with clients, and economic data associated with clients.

These various data sources 2902-2904 can provide data used by a number of AI-based CRM functions 2906. Note that while many of these functions are described in detail above, some of these AI-based CRM functions 2906 may provide additional functionality while being implemented in the same or similar ways as discussed above. Revenue forecasting can be used to accurately forecast revenue, balances, and assets under management (AUM) with machine learning to identify risks and opportunities, explain drivers, and coach users how to address them. Customer churn prediction can be used to build complete and unified views of customers and leverage customer sentiments, such as through natural language processing and machine learning algorithms, to detect mismatches between client offerings and client needs, rate client sensitivities and identify other churn risk drivers, and identify effective intervention strategies to retain and grow wallet share with each profitable client. Next best offer prediction can be used to identify emerging client needs for financial services, such as based on transactions, business performances, and more, and to offer personalized up-sell and cross-sell opportunities by accurately predicting client needs, values, and eligibilities. Product forecasting can be used to better forecast product demands and plan needed risks and treasury activities to manage financial reserves for risk and regulatory objectives. Rate, fee, and other pricing optimizations and client profitability management can be used to improve portfolio profitability by detecting unprofitable clients and recommending effective strategies to achieve profitability or offboarding of clients. Case management can be used to manage customer service requests with end-to-end case management workflows for financial services that support complex product and service catalogues across multiple different customer segments and to use machine learning to proactively recommend actions to resolve the cases. Client activation and onboarding can be used to onboard and activate new clients in line with regulatory and internal compliance requirements in a single system that communicates with all necessary enterprise and extraprise tools while using machine learning to identify risks and recommend next steps. Intelligent engagement and services can be used to maximize the likelihood of successful client interactions by using machine learning to understand customer sentiments and recommend the highest-value engagement activities, including person, message, channel, and timing. Credit application and renewal management can be used to manage an entire credit approval pipeline across prospects, where machine learning models can be used to pre-qualify low-risk candidates in order to expedite their approvals and provide front line and credit teams with a shared view of credit risks and evidence packages of risk drivers. Claims management can be used to triage and resolve claims with end-to-end workflows for insurance that can contextualize claims against all other client data and apply machine learning to detect fraudulent activities or recommend next steps. Know your customer functionality can be used to leverage a unified view of clients and accounts and all their activities in order to perform detailed customer diligence and use machine learning to identify anomalous and potentially concerning behaviors to manage future risks.

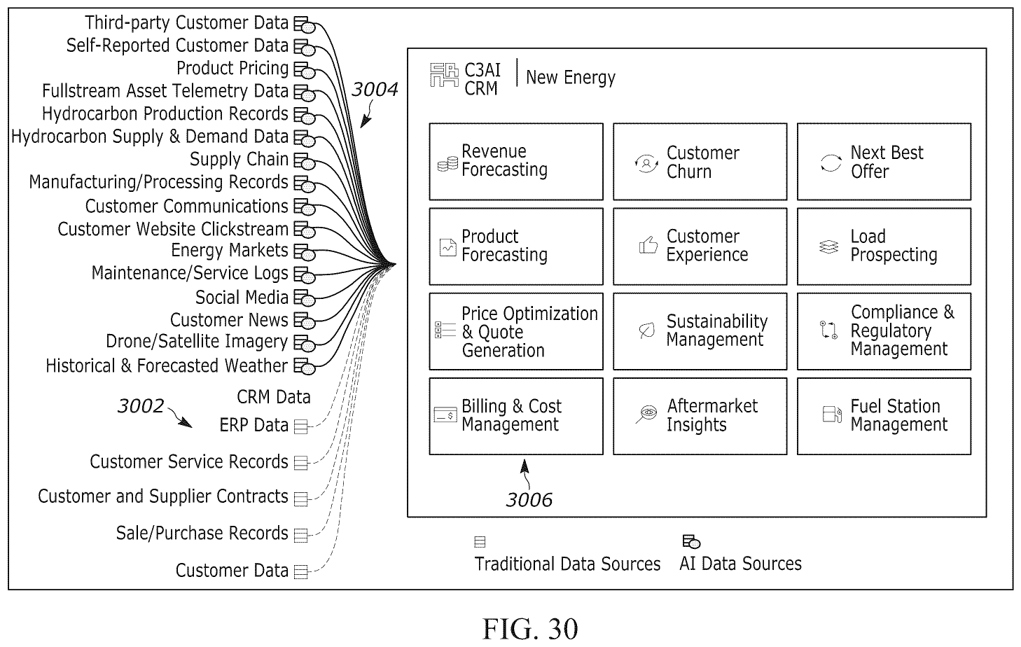

In FIG. 30, the use case here involves new energy, meaning the services provided to customers relate to energy exploration or delivery. Data sources 3002 that can be used here include traditional data sources, such as sources of enterprise resource planning (ERP) data, customer service records, customer and supplier contracts, marketing campaign records, sales/purchase records, and other customer data. Additional data sources 3004 that can be used with AI-based CRM functions may include sources providing information such as self-reported customer data, product pricing, asset telemetry data, hydrocarbon production records, hydrocarbon supply and demand information, supply chain information, and manufacturing or processing records. The additional data sources 3004 that can be used with AI-based CRM functions may also include sources providing information such as customer communications, customer website interactions, energy market data, maintenance or service logs, social media content, customer news, drone or satellite imagery, and historical or forecasted weather.

These various data sources 3002-3004 can provide data used by a number of AI-based CRM functions 3006. Note that while many of these functions are described in detail above, some of these AI-based CRM functions 3006 may provide additional functionality while being implemented in the same or similar ways as discussed above. Revenue forecasting can be used to accurately forecast revenue with machine learning to identify risks and opportunities, explain drivers, coach users how to address them, and help with financial planning. Customer churn prediction can be used to identify and prioritize customers at risk of churn, understand the churn risk drivers, and enact effective intervention strategies to retain each profitable customer. Next best offer prediction can be used to analyze past customer behaviors, predict customer needs, predict customers' propensities to buy available products, and provide actionable recommendations for timing, channel, and marketing contents to build sales strategies. Product forecasting can be used to integrate market data, retail forecasting capabilities, sales forecasting, and other AI functionalities in order to provide forward-looking views of the company's supply and demand in order to plan operations and ensure that customer needs are met. Customer experience functionality can be used throughout each customer touchpoint with a company in a fuel station experience, and machine learning capabilities can streamline end-to-end experiences and automatically generate relevant recommendations (such as identifying customers by vehicle and offering discounted and bundled items like car washes). Lead prospecting can use machine learning to prioritize the highest-quality leads by examining internal and external data (such as news, social media, and weather data) to determine customer propensities to buy and the right sales strategies to convert leads into customers. Pricing optimization and quote generation can be used to generate relevant and timely quotes, provide negotiation-guiding price ranges, and maximize likelihood to win and profits (where knowledge of required margins, pricing histories, competitor pricing, customers' calculated willingness to pay, and deal sizes can be leveraged). Sustainability management can be used to leverage AI-driven insights from integrated data across an energy value chain in order to quantify a company's carbon footprint across all operations. Compliance and regulatory management can be used to leverage integrated data and automated workflows to support regulatory compliance with AI-driven insights to catch errors, identify red flags, and remind users of next steps to minimize non-compliance costs. Billing and cost management can be used to streamline billing and cost control processes with AI-driven insights to forecast project costs and customer bills, identify anomalous patterns, and proactively mitigate billing errors and project cost overruns. Aftermarket insights and fuel station management can be used to monitor fuel station portfolio performances and predict consumer demand growth in order to determine expansion areas, station designs (such as car washes, groceries, restaurants) and franchise incentives to maximize profitable station footprints.

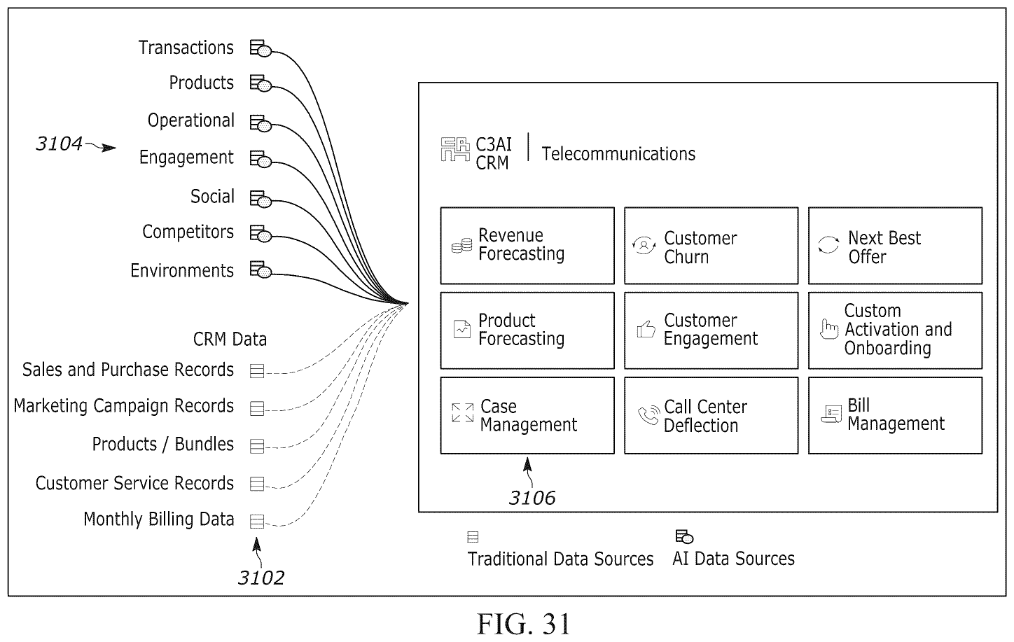

In FIG. 31, the use case here involves telecommunications, meaning the services provided to customers relate to communications equipment and services. Data sources 3102 that can be used here include traditional data sources, such as sales and purchase records, marketing campaign records, products/bundles available to customers, customer service records, and monthly or other billing data. Additional data sources 3104 that can be used with AI-based CRM functions may include sources providing information such as customer transactions, products available to customers, operational data associated with customers, engagement data involving customers, social media content, competitor information, and communication environment data.

These various data sources 3102-3104 can provide data used by a number of AI-based CRM functions 3106. Note that while many of these functions are described in detail above, some of these AI-based CRM functions 3106 may provide additional functionality while being implemented in the same or similar ways as discussed above. Revenue forecasting can be used to accurately forecast revenues in order to better prioritize sales efforts and improve financial planning by using machine learning to look at all enterprise and extraprise data in order to predict which sales will close, where risks and opportunities are and why, and what can be done to address them. Customer churn prediction can be used to detect customer churn risks (such as up to 90 days in advance) with a 360° customer view, identify drivers of churn risks, and use machine learning recommendations to prevent customer churn with custom offers and discounts. Next best offer prediction can be used to identify high-potential customers for up-sell and cross-sell opportunities, pair customers with optimal products/services/pricing offers, and guide customer service representatives to maximize customer lifetime values. Product forecasting can be used to accurately forecast demands using machine learning in order to improve capacity and supply chain planning, thereby minimizing inventory levels while ensuring customer needs are met. Case management can be used to manage customer service requests with end-to-end case management workflows and to use machine learning to proactively recommend actions to resolve cases. Customer engagement functionality can be used to unify customer service experiences across all channels (such as call centers, websites, direct mailings, and emails) and leverage machine learning to deliver personalized messaging at the right time through the right channel. Customer activation and onboarding can be used to track customer activations from sales to installations in order to ensure efficient deliveries of products and services and can use machine learning to optimize operations and detect delays in delivery. Call center detection can be used to detect customer needs and complaints using machine learning and to proactively reach out with content and assistance in order to reduce call center activity and increase customer satisfaction. Bill management can use machine learning to predict high or anomalous bills and proactively engage customers with cost management suggestions.

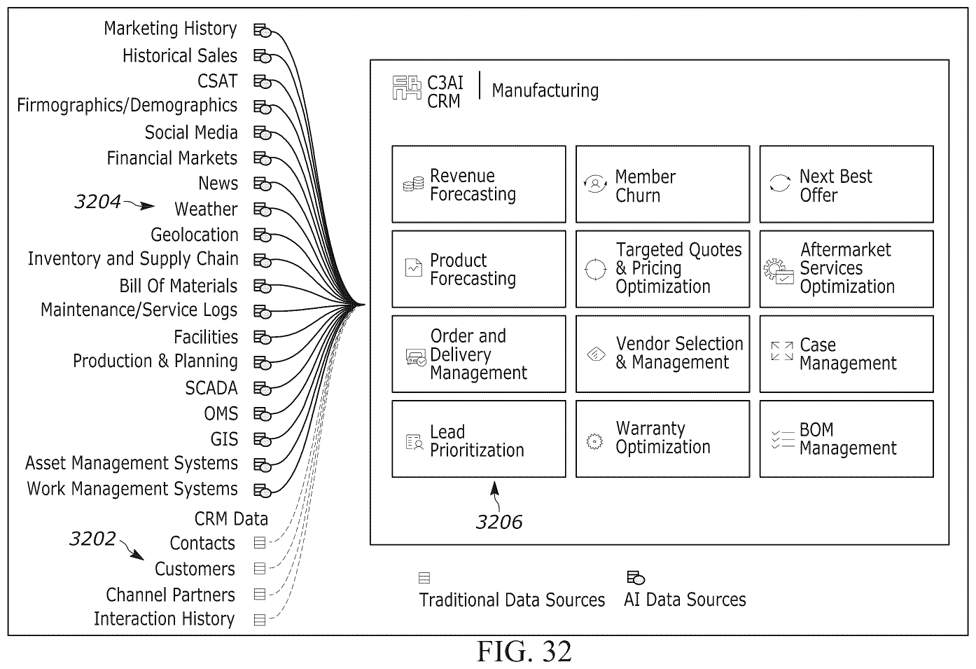

In FIG. 32, the use case here involves manufacturing, meaning the services provided to customers relate to the manufacture of one or more products. Data sources 3202 that can be used here include traditional data sources, such as client contacts, customers of the clients, channel partners of the clients, and interaction histories with the clients. Additional data sources 3204 that can be used with AI-based CRM functions may include sources providing information such as historical sales of manufacturers, customer satisfaction information for the manufacturers, firmographic or demographic information of manufacturers, social media content related to manufacturers, financial market information for the manufacturers, and news related to manufacturers. Additional data sources 3204 that can be used with AI-based CRM functions may also include sources providing information such as geolocation information for manufacturers, inventory and supply chain information for manufacturer, bills of materials for manufacturers, maintenance and service logs for manufacturers, and facilities information for manufacturers. Additional data sources 3204 that can be used with AI-based CRM functions may further include sources providing information such as production and planning information for manufacturers, supervisory control and data acquisition (SCADA) information for manufacturers, open manufacturing system (OMS) information for manufacturers, geographic information system (GIS) information for manufacturers, asset management system information for manufacturers, and work management system information for manufacturers.

These various data sources 3202-3204 can provide data used by a number of AI-based CRM functions 3206. Note that while many of these functions are described in detail above, some of these AI-based CRM functions 3206 may provide additional functionality while being implemented in the same or similar ways as discussed above. Revenue forecasting can be used to accurately forecast revenue with machine learning to identify risks and opportunities, explain drivers, coach users how to address them, and help with financial planning. Next best offer prediction can be used to identify what products or services to offer customers by using machine learning to calculate their propensities for buying for each eligible product or service, understand the underlying drivers of the predictions, and receive recommendations on how to offer and convert the opportunities. Product forecasting can be used to accurately predict demand, production needs, and order stability for each SKU and enable proactive and lower cost production and inventory planning. Member churn can be used to identify and prioritize customers at risk of churn, understand the churn risk drivers, and enact effective intervention strategies to retain each profitable customer. Lead prioritization can use machine learning to assess lead quality and determine predispositions to buy for leads using all available data across internal data sources (such as historical sales and marketing campaign results) and external data sources (such as news and financial markets) to prioritize highest value leads, increasing win rates and team productivity. Targeted quotes and pricing optimization can be used to offer personalized and optimized quotes with recommended product configurations, pricing, and time of delivery based on an integrated view of the supply chain, bill of materials data, customer needs, channel sales, competitive dynamics, and more. Aftermarket services optimization can be used to predict customer servicing needs and product failures to up-sell maintenance services, optimize replacement sales, and ultimately procure parts and deploy technicians to remedy problems before they appear. Order and delivery management can be used to predict delays and change orders, detect anomalous orders and errors, and recommend actions to remediate any delivery risks, thereby providing full and transparent delivery visibility to manufacturers and their customers. Warranty optimization can be used to proactively identify components at risk and alert customers to potential issues, which can increase customer satisfaction and manage warranty costs by prioritizing higher-cost cases and maintaining inventory visibility. Vendor selection and management can be used to understand all supply chain and vendor operations and use machine learning to guide procurement managers to select and manage vendors, mitigate emerging risks, and proactively manage pricing with each supplier. Case management can be used to manage customer service requests with end-to-end case management workflows, provide a unified view of customer operations, and provide AI-driven proactive recommendations to enable faster resolution and higher customer satisfaction. Bill of material (BOM) management can be used to maintain accurate bills of materials for complex products at each stage of engineering, delivery, and aftermarket usage and to calculate profitability for design, as-built, and added components for aftermarket stages.

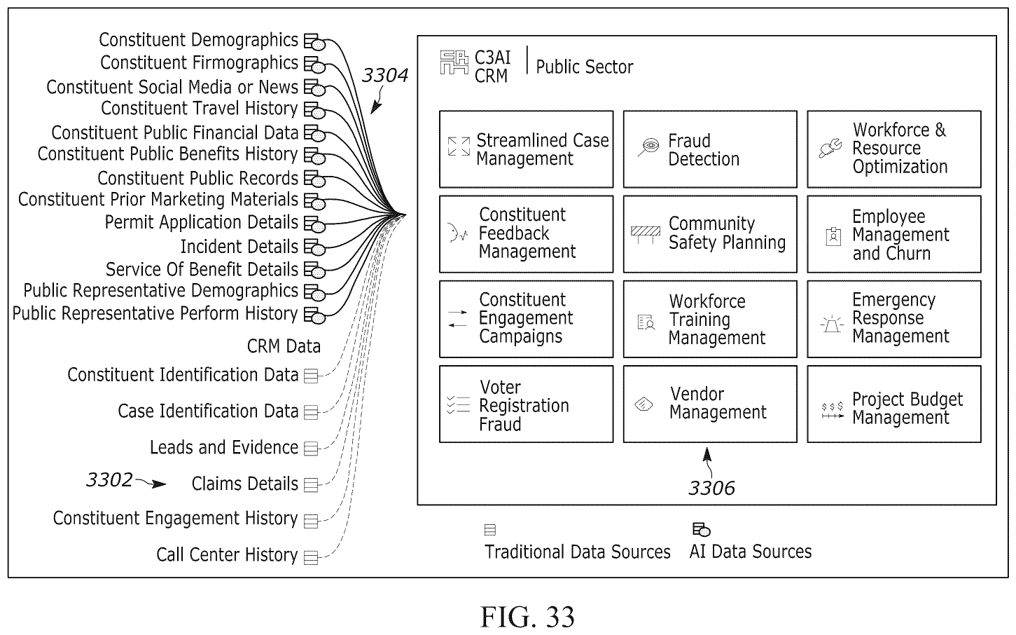

In FIG. 33, the use case here involves public utilities, meaning the services provided to customers relate to public services (such as fire, police, and emergency response services, election services, and other government-run services). Data sources 3302 that can be used here include traditional data sources, such as constituent (service customer) identification data, case identification data, leads and evidence data, claims details, constituent engagement histories, and call center histories. Additional data sources 3304 that can be used with AI-based CRM functions may include sources providing information such as constituent demographic data, constituent firmographic data, constituent social media or news data, constituent travel histories, constituent public financial data, and constituent public benefits data. Additional data sources 3304 that can be used with AI-based CRM functions may also include sources providing information such as constituent public records, prior constituent marketing materials, permit application data, incident details, service of benefit details, public representative demographics for the public sector service provider, and public representative performance histories for the public sector service provider.

These various data sources 3302-3304 can provide data used by a number of AI-based CRM functions 3306. Note that while many of these functions are described in detail above, some of these AI-based CRM functions 3306 may provide additional functionality while being implemented in the same or similar ways as discussed above. Revenue forecasting can be used to consolidate all permit, complaint, license, regulatory, and other processes into a single system and resolve cases at lower costs and faster speeds using machine learning to direct steps. Fraud detection can be used to identify malicious transactions or anomalous cases to save investigators time and prioritize investigations to eliminate fraudulent use of public funds with automated AI-based anomaly detection algorithms. Workforce and resource optimization can be used to optimize human and public resources to improve employee productivity, operational efficiency, and constituent satisfaction. Employee management and churn can be used to monitor employee productivity and sentiment in order to ensure employees are both productive and satisfied with their current standing and jobs and to predict potential churn in order to reduce costly recruiting and retraining activities. Constituent feedback management can be used to easily keep up with many channels of stakeholder inputs with a unified stream and communication, thereby enabling automatic routing, AI-based responses, and streamlined reporting. Community safety planning can be used to minimize public health threats and increase public safety with AI-based scenario modeling on rich and unified clinical, economic, financial, hospital, law enforcement, and crime data. Constituent engagement campaign functionality can be used to generate, manage, and personalize engagement content for constituents through multiple channels (such as email, print, social, and text) based on machine learning models that analyze constituent sentiment across news, social media, and direct feedback and to predict the message(s) most likely to resonate with each individual. Workforce training management can be used to manage instructors, content, and operations for an entire employee training process and proactively plan training capacity to streamline onboarding at lowest taxpayer costs. Emergency response management can be used to monitor all emergency response activities from a single system and ensure proper resource allocation and resolution by using machine learning to predict and prioritize response actions. Voter registration fraud functionality can be used to analyze voter registration data across all constituents, cross-referenced with available housing or license data, in order to identify potential registrations for out-of-state individuals who may be registered in multiple locations. Vendor management can be used to manage all vendor and request for proposal/bid/quote/information (RFx) activities through a single system to streamline evaluation, selection, and implementation activities and to use machine learning to proactively identify issues in responses or vendor activities to reduce manual efforts and errors. Project budget management can be used to monitor ongoing costs of public projects and control budgets with AI-driven insights to forecast expected costs, identify anomalous patterns, and proactively mitigate budget overruns.

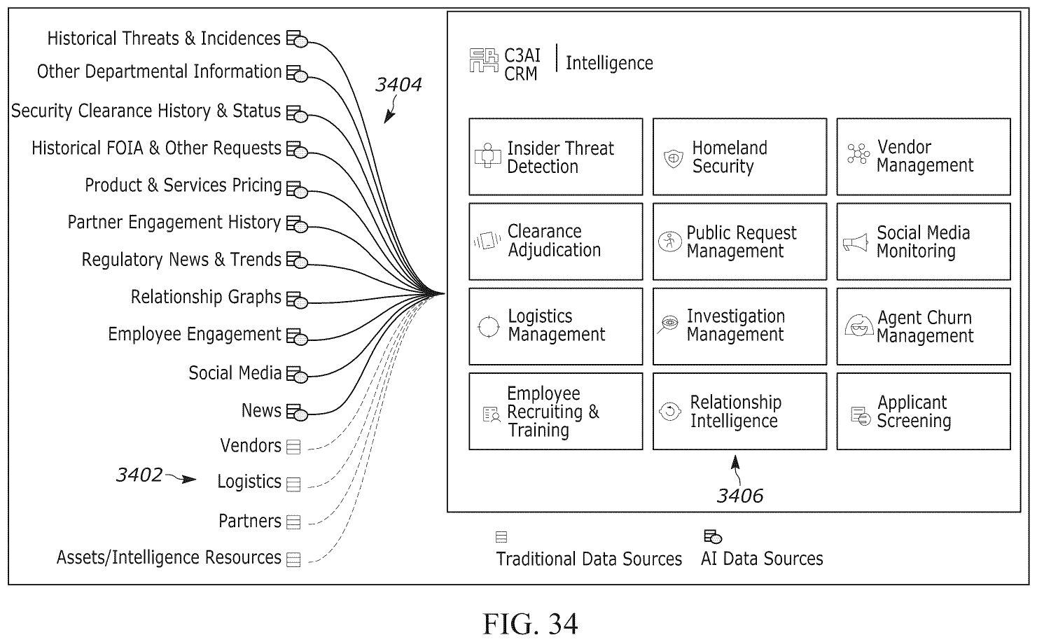

In FIG. 34, the use case here involves intelligence, meaning the services provided to customers relate to the collection or use of intelligence information. Data sources 3402 that can be used here include traditional data sources, such as vendor information, logistics information, partner information, and asset or other intelligence resource information. Additional data sources 3404 that can be used with AI-based CRM functions may include sources providing information such as historical threat and incidence information, other departmental information, security clearance history and status information, historical freedom of information act (FOIA) request and other request information, and partner engagement history information. Additional data sources 3404 that can be used with AI-based CRM functions may also include sources providing information such as regulatory news and trend information, relationship graphs, employee engagement information, social media content, and news information.

These various data sources 3402-3404 can provide data used by a number of AI-based CRM functions 3406. Note that while many of these functions are described in detail above, some of these AI-based CRM functions 3406 may provide additional functionality while being implemented in the same or similar ways as discussed above. Insider threat detection can be used to unify all employee activity data and apply machine learning to flag anomalous and potentially-risky behaviors to initiate diligence procedures for insider threats. Homeland security functionality can be used to track and monitor all known threats, use machine learning to predict events based on activities, and uncover new individual cells using relationship graph analysis. Vendor management can be used to manage performance of all vendors providing products and services, proactively flag service issues, delays, and deteriorating relationships, and engage vendors to remediate so that critical operations remain uninterrupted. Clearance adjudication can be streamlined by programmatically using machine learning models on unified individual data and activity to assess security risks. Public request management can be used to manage public FOIA or other requests and streamline responses by intelligent grouping of similar records and AI-driven redaction. Social media monitoring can be used to scan social media sites like FACEBOOK, TWITTER, and LINKEDIN for key assets and contacts of interest and flag anomalous user behaviors using natural language processing and image detection. Logistics management can be used to integrate data sources across planning and asset lifecycles in order to improve logistics transparency and collaboration and leverage machine learning to proactively identify blockers or unexpected events of covert operations. Investigation management can be used to perform streamlined investigations with all data across all systems, including other agencies, and use machine learning to pre-identify anomalous activities in order to better prioritize where time is spent. Agent churn management can be used to monitor agent activities and use machine learning to identify potential churn risk due to dissatisfaction and proactively intervene to improve chances of retention. Employee recruiting and training functionality can be used to proactively target new recruiting leads from the general population based on machine learning that predicts likelihood to enroll and match them up with the right roles and training programs. Relationship intelligence can be used to model all relationships across employees, citizens, and persons of interest and identify connections that could pose as risks or opportunities. Applicant screening functionality can be used to streamline applicant screening by programmatically using machine learning on unified individual data and activities to assess likelihood to join, security risk, and future potential.

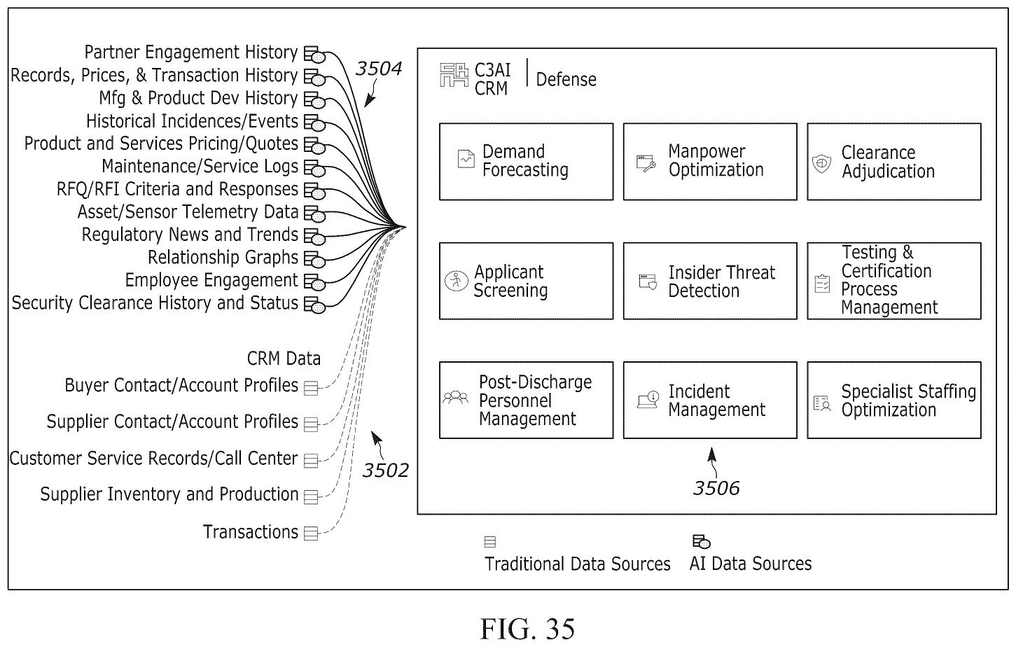

In FIG. 35, the use case here involves defense, meaning the services provided to customers relate to the protection of a country or its interests (such as the procurement of offensive and defensive weapons systems or other systems). Data sources 3502 that can be used here include traditional data sources, such as buyer contact or account profiles, supplier contact or account profiles, customer service records or call center records, supplier inventory and production information, and transactions. Additional data sources 3504 that can be used with AI-based CRM functions may include sources providing information such as partner engagement history information, records/prices/transaction histories, manufacturing and product development histories, historical incidence and event information, product and service pricing or quotes, and maintenance or service logs. Additional data sources 3504 that can be used with AI-based CRM functions may also include sources providing information such as RFx criteria and responses, asset or sensor telemetry data, regulatory news and trend information, relationship graphs, employee engagement information, and security clearance history and status information.

These various data sources 3502-3504 can provide data used by a number of AI-based CRM functions 3506. Note that while many of these functions are described in detail above, some of these AI-based CRM functions 3506 may provide additional functionality while being implemented in the same or similar ways as discussed above. Demand forecasting can use machine learning to accurately and dynamically predict demand for products and services and improve supply and capacity planning. Manpower optimization can be used to predict service member churn, re-enlistment, or enrollment in order to proactively organize recruiting resources, downstream training, incentive programs, and funding allocations. Clearance adjudication can be streamlined by programmatically using machine learning models on unified individual data and activity to assess security risks. Applicant screening functionality can be used to streamline applicant screening by programmatically using machine learning on unified individual data and activities. Insider threat detection can be used to unify all military and related civilian personnel and activity data and apply machine learning to flag anomalous and potentially risky behaviors. Process management can use AI-driven workflows to manage all testing and certification processes that ensure full compliance with internal and external standards. Post-discharge personnel management can be used to monitor adequate care and support for ex-military personnel and identify individuals that need early intervention or additional support. Incident management can be used to unify all first responder activities and incident reports to arm incident commanders (IC) with relevant, real-time data to aid in intelligent decision making and resource management. Specialist staffing optimization can be used to optimize staffing of high-skilled specialists across global sites and across branches to ensure optimal utilization.

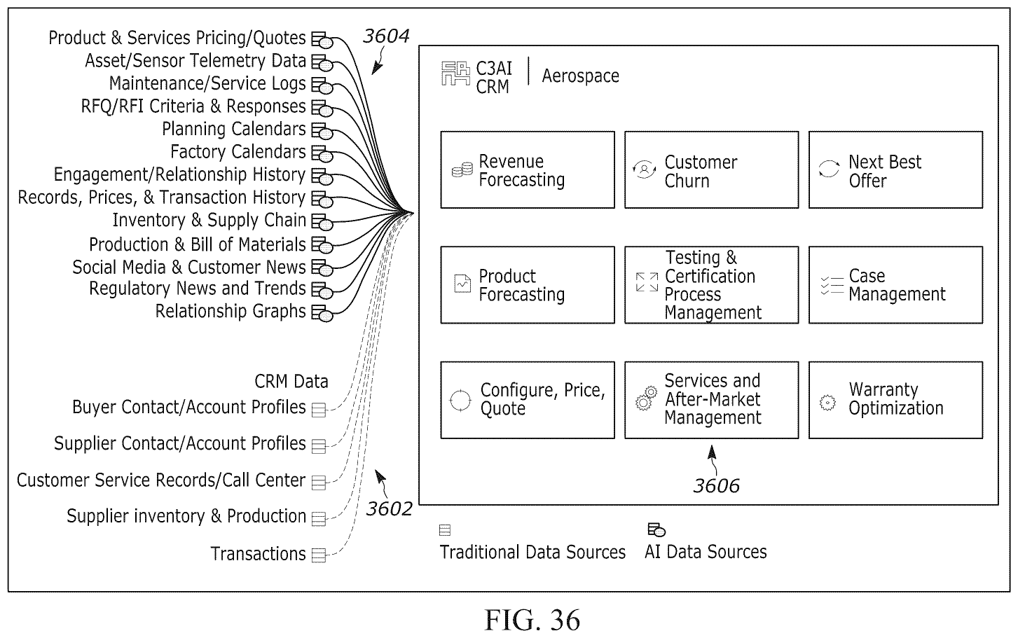

In FIG. 36, the use case here involves aerospace, meaning the services provided to customers relate to airborne and space-based products and operations (civilian or defense-related). Data sources 3602 that can be used here include traditional data sources, such as buyer contact or account profiles, supplier contact or account profiles, customer service records or call center records, supplier inventory and production information, and transactions. Additional data sources 3604 that can be used with AI-based CRM functions may include sources providing information such as product and service pricing or quotes, asset or sensor telemetry data, maintenance or service logs, RFx criteria and responses, and planning and factory calendars. Additional data sources 3604 that can be used with AI-based CRM functions may also include sources providing information such as engagement or relationship histories, records/prices/transaction histories, inventory and supply chain information, production and bills of materials information, social media and customer news, regulatory news and trend information, and relationship graphs.

These various data sources 3602-3604 can provide data used by a number of AI-based CRM functions 3606. Note that while many of these functions are described in detail above, some of these AI-based CRM functions 3606 may provide additional functionality while being implemented in the same or similar ways as discussed above. Revenue forecasting can be used to accurately forecast revenue with machine learning to identify risks and opportunities, explain drivers, coach users on how to address them, and help with financial planning. Customer churn management can be used to identify and prioritize customers at risk of churn, understand the churn risk drivers, and proactively engage the customers with offers to increase loyalty and drive retention. Next best offer functionality can be used to leverage machine learning to segment and target customers for up-sell and cross-sell opportunities (such as add-ons or additional services) and new products (such as new product lines) and identify potential opportunities for investment or retrenchment across models, carriers, fleets, and geographies. Product forecasting can use machine learning to accurately and dynamically predict product demand across all points of the supply chain in order to improve supply planning, minimize inventory, reduce ongoing working capital needs, and enable targeted sales activities. Testing and certification process management can use AI-driven workflows that flag anomalous activities and enable support testing and certification processes that ensure full compliance with internal and external standards. Case management can be used to manage customer service requests with end-to-end case management workflows for aerospace supply or manufacturing with a unified view of customer operations and AI-driven recommendations to enable faster resolution and higher customer satisfaction. Configure, price and quote (CPQ) functionality can ensure access to available inventory by managing end-to-end CPQ processes in a single automated system that is standardized across sites and vendors/suppliers. Services and after-market management can be used to integrate all available part, usage, telemetry, sensor, and other airplane and customer data to streamline customer service operations and use machine learning to predict needed service and opportunities for predictive service and maintenance. Warranty optimization can be used to identify componentry at risk and proactively alert customers to potential issues to increase satisfaction, proactively manage warranty operations and costs by prioritizing higher potential cost cases, and maintain visibility of components at factory, distribution, or customer locations.

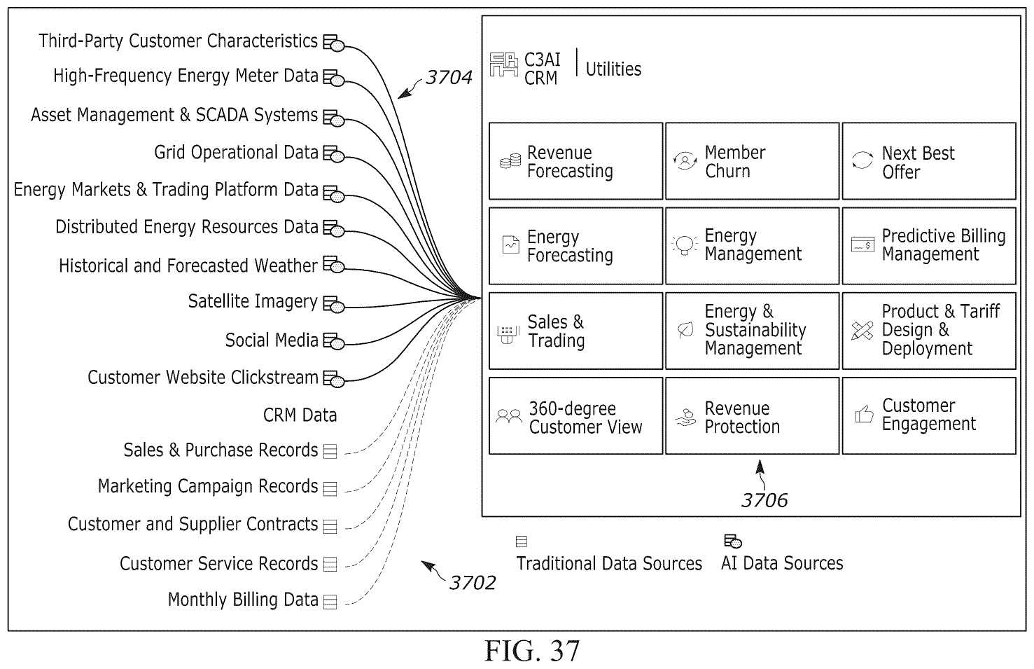

In FIG. 37, the use case here involves public utilities, meaning the services provided to customers relate to public services (such as electricity or gas services). Data sources 3702 that can be used here include traditional data sources, such as sales and purchase records, marketing campaign records, customer and supplier contracts, customer service records, and monthly or other billing data. Additional data sources 3704 that can be used with AI-based CRM functions may include sources providing information such as third-party customer characteristics, high-frequency energy meter data, asset management and SCADA system data, grid operational data, and energy markets and trading platform data. Additional data sources 3704 that can be used with AI-based CRM functions may also include sources providing information such as distributed energy resource data, historical and forecasted weather data, satellite imagery, social media content, and customer website interactions.

These various data sources 3702-3704 can provide data used by a number of AI-based CRM functions 3706. Note that while many of these functions are described in detail above, some of these AI-based CRM functions 3706 may provide additional functionality while being implemented in the same or similar ways as discussed above. Revenue forecasting can be used to accurately forecast revenue with machine learning in order to support regulatory and capital planning that supports meeting customer needs, optimizing rates, and operating at the lowest cost to serve. Member churn management can be used to identify and prioritize customers at risk of churn, understand the churn risk drivers, and enact effective intervention strategies to retain each profitable customer. Next best offer functionality can be used to analyze past customer behaviors, predict customer needs, predict customers' propensity to buy available products, and provide actionable recommendations to build marketing strategies. Energy forecasting functionality can be used to generate accurate demand/load and price forecasts while supporting end-to-end operations, balancing generation, validating production plans, and planning expansion projects. Customer fulfillment functionality can be used to track customer fulfillment from sale to installation to activation in order to ensure efficient delivery of products and services and use machine learning to optimize operations and detect delays in deliveries and activations. Predictive billing management can be used to integrate historical meter data, billing records, and customer service records to identify when bills are likely to trigger customer concerns and proactively contact customers with information and recommendations to reduce unexpected bills in the future. Sales and tracking functionality can be used to provide an accessible overview of a company's supply, demand, and outlook with integrated price curves and machine learning capabilities to identify opportunities and help sales and trading staff make informed decisions. Energy and sustainability management can be used to monitor customer energy usage and carbon emissions and provide AI-based recommendations on opportunities to reduce costs and carbon footprints in order to expand services and deepen customer relationships. Product and tariff design and deployment functionality can be used to design and optimize new energy rates and products, automatically assess customer value and revenue impact, and target customers most likely to buy and benefit based on AI-based targeting models. 360° customer view functionality can be used to develop a single view of customers and operations across a whole energy grid by unifying all available enterprise and extraprise data in order to drive machine learning insights across all customer-facing operations. Revenue protection functionality can be used to analyze energy meter data and customer characteristics to identify signals of non-technical losses, determine cases of fraud, and proactively engage customers to increase revenue recovery. Customer engagement functionality can be used to unify utility customer service experiences across all channels (such as call centers, websites, direct mailings, and emails) and leverage machine learning to deliver personalized messaging at the right time through the right channel.

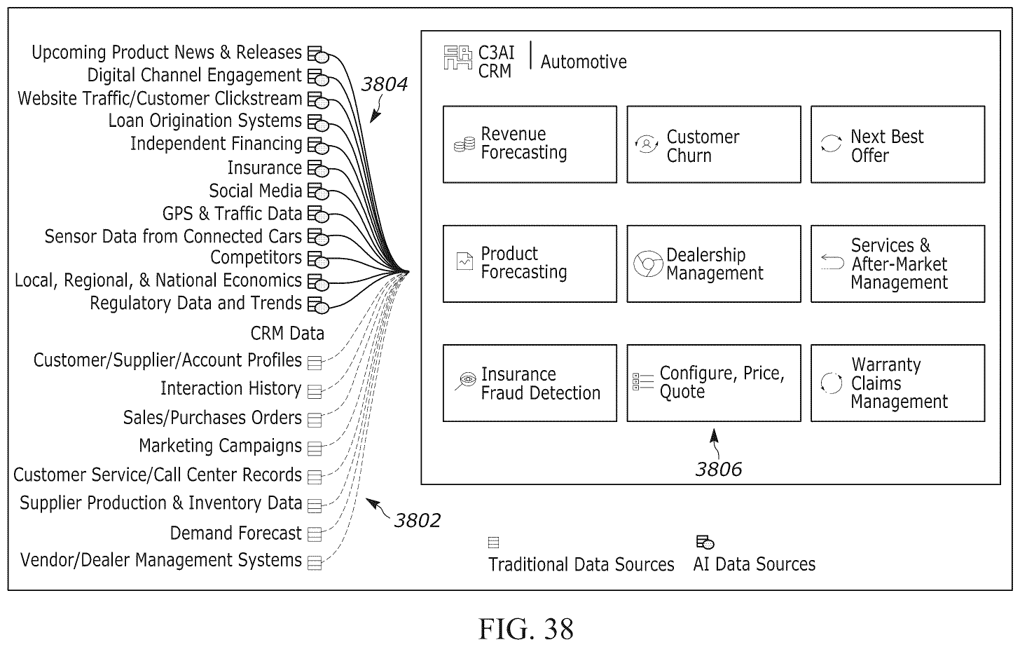

In FIG. 38, the use case here involves the automotive industry, meaning the services provided to customers relate to vehicle-based products and operations (civilian or defense-related). Data sources 3802 that can be used here include traditional data sources, such as customer, supplier, or account profiles, interaction histories, sales or purchase orders, marketing campaigns, customer service records or call center records, supplier inventory and production information, demand forecasts, and vendor or dealer management system information. Additional data sources 3804 that can be used with AI-based CRM functions may include sources providing information such as upcoming product news or upcoming product release information, digital channel engagements, customer website interactions, loan origination system information, independent financing information, and insurance information. Additional data sources 3804 that can be used with AI-based CRM functions may also include sources providing information such as social media content, global positioning system (GPS) and traffic data, sensor data from connected vehicles, competitor information, local, regional, or national economic information, and regulatory news and trend information.

These various data sources 3802-3804 can provide data used by a number of AI-based CRM functions 3806. Note that while many of these functions are described in detail above, some of these AI-based CRM functions 3806 may provide additional functionality while being implemented in the same or similar ways as discussed above. Revenue forecasting can be used to accurately forecast revenue with machine learning to identify risks and opportunities, explain drivers, coach users on how to address them, and help with financial planning. Customer churn management can be used to identify and prioritize customers at risk of churn, understand the churn risk drivers, and proactively engage the customers with offers to increase brand and dealer loyalty. Next best offer functionality can be used to leverage machine learning to segment and target customers for up-sell and cross-sell opportunities (such as add-ons or additional services). Product forecasting can use machine learning to accurately and dynamically predict demand, production needs, and order stability for each product and enable proactive and lower cost production and inventory planning. Dealership management can be used to integrate more data sources, from marketing leads to after-market services, to build a 360° view of all dealership and cross-dealership customers in order to track customers across multiple sites. Services and after-market management can be used to integrate all available vehicle usage, sensor, and vehicle service data to create a seamless, integrated customer experience across all service channels and use machine learning to predict service needs and recommend maintenance events with customized offers. Insurance fraud detection functionality can use real-time data from connected cars and extraprise data to enable data-driven fraud detection, leveraging machine learning models that are able to detect fraudulent insurance claims with evidence packages on the underlying drivers. Configure, price and quote functionality can be used to manage the end-to-end CPQ processes in a single automated system that is standardized across sites and connected with original equipment manufacturers (OEMs) and use machine learning to match and recommend vehicle configurations while providing smooth customer experiences and reducing time to sale. Warranty claims management can be used to streamline end-to-end warranty claims management with unified data across dealers, OEMs, and external systems and use machine learning to identify anomalies and potential fraud.

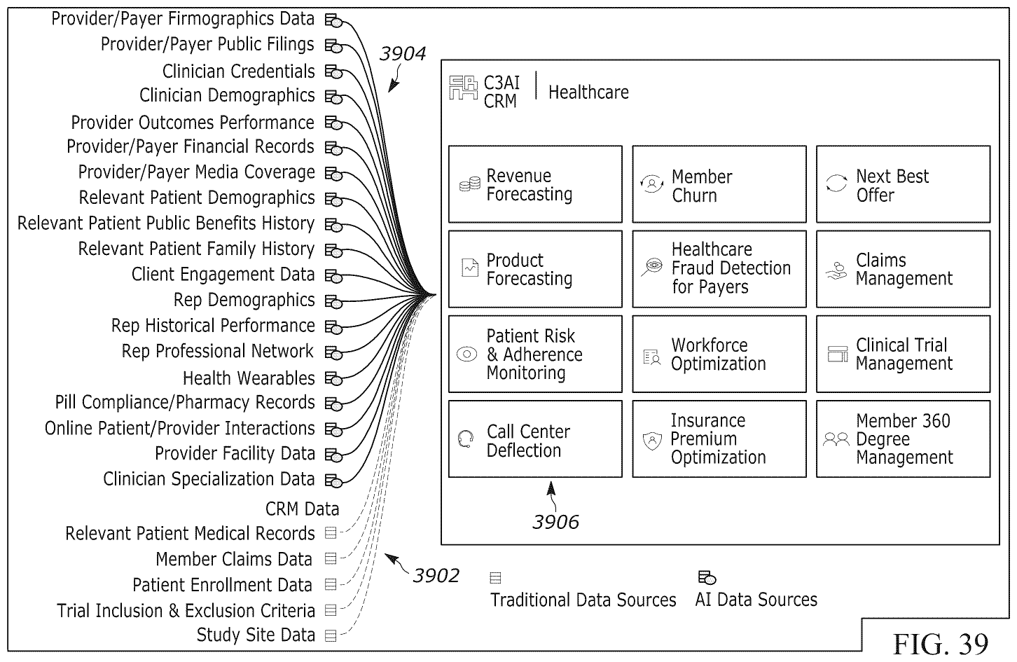

In FIG. 39, the use case here involves the healthcare industry, meaning the services provided to customers relate to medical care, health insurance, and related aspects. Data sources 3902 that can be used here include traditional data sources, such as relevant patient medical records, insurance member claims data, patient enrollment data, trial inclusion and exclusion criteria, and study site data. Additional data sources 3904 that can be used with AI-based CRM functions may include sources providing information such as provider or payer firmographic data, provider or payer public filings, clinician credentials, clinician demographics, provider outcomes performance, provider or payer financial records, and provider or payer media coverage. Additional data sources 3904 that can be used with AI-based CRM functions may also include sources providing information such as relevant patient demographics, relevant patient public benefits histories, relevant patient family histories, client engagement data, representative demographics, representative historical performances, and representative professional networks. Additional data sources 3904 that can be used with AI-based CRM functions may further include sources providing information such as health wearable data, pill compliance or pharmacy records, online patient/provider interactions, provider facility data, and clinician specialization data.

These various data sources 3902-3904 can provide data used by a number of AI-based CRM functions 3906. Note that while many of these functions are described in detail above, some of these AI-based CRM functions 3906 may provide additional functionality while being implemented in the same or similar ways as discussed above. Revenue forecasting can be used to accurately forecast revenue with machine learning to identify risks and opportunities, explain drivers, coach users on how to address them, and help with financial planning. Member churn management can be used to identify and prioritize customers at risk of churn, understand the churn risk drivers, and receive recommended best offers and optimized plans to maximize member renewal during open enrollment periods. Next best offer functionality can be used to identify what products or services to offer customers by using machine learning to calculate their propensity to buy for each eligible product or service, understand the underlying drivers of the predictions, and receive recommendations on how to offer and convert the opportunities. Product forecasting can be used to accurately predict demand, production needs, and order stability for each SKU and enable proactive and lower cost production and inventory planning. Healthcare fraud detection can be used to identify anomalous insurance claims, mismatches between diagnoses and provided care, and clinical decisions outside of guidelines to detect fraud and enable investigators to prioritize the highest priority cases. Claims management can be used to facilitate medical claims management by enabling insurers to automatically identify missing information, route claims, customize explanation of benefits, and predict expected volumes of claims and patient inquiries. Patient risk and adherence monitoring functionality can be used to improve patient outcomes and avoid re-admission fines, leveraging machine learning to identify and monitor patients at risk of developing serious clinical concerns, non-adherence, or preventable clinical emergencies. Workforce optimization functionality can be used to optimize staff schedules based on real data from past patient loads and capacity requirements to ensure engaged, utilized, and satisfied care teams. Clinical trial management can be used to accelerate availability of new life-saving therapies on the market by using machine learning to streamline designs and management of clinical trials from study site selection to patient enrollment and regulatory submissions. Call center deflection functionality can leverage machine learning to provide accurate predictions of the types and frequencies of member inquiries, helping payers reduce call center costs. Insurance premium optimization functionality can be used to integrate historical claims data, medical records, and financial and employment histories, powering machine learning to optimize premium and service offerings via each member's personalized health insurance plan. Member 360° management functionality can be used to enable service managers to engage with members through personalized and targeted preventive care recommendations while helping to prevent costly medical treatments in the future and improve member satisfaction.

As can be seen here, the types of CRM-related functions and the results of those functions can be common or vary widely depending on the particular use case. Overall, CRM “actionability” refers to the various ways that a CRM platform can be implemented with real-world implementations, such as standard or customized user interfaces and standard or customized automated communications. This can enable use of the CRM platform is various applications ranging from the simple (such as within sales organizations) to the complex (such as national or multi-national organizations) and for any suitable purposes ranging from the simple (such as sales management) to the complex (such as industrial process control systems, supply chain management, or cashier-less stores).

Although FIGS. 29 through 39 illustrate examples of use cases for AI-based CRM, various changes may be made to FIGS. 29 through 39. For example, the AI-based CRM functions described above may be used in any other suitable manner. Also, the AI-based CRM functions described above may be used in different ways even in the same industries or use cases shown in FIGS. 29 through 39.

An example method for pricing optimization may include obtaining information associated with transaction opportunities involving customers; and using one or more trained machine learning models to perform at least one CRM function related to the transaction opportunities. The at least one CRM function may include an identification of one or more offerings, and the one or more offerings may be identified as increasing or optimizing a likelihood of one or more of the transaction opportunities being successfully completed with one or more of the customers.

The at least one CRM function may enable at least one of: a segmentation of the customers into groups with shared characteristics; an identification of customer satisfaction individually or in one or more groups; an identification of customer loyalty individually or in one or more groups; and an identification of a likelihood of customer churn individually or in one or more groups. The one or more offerings may be identified based on at least one of: the segmentation, the customer satisfaction, the customer loyalty, and the likelihood of customer churn.

In some examples, at least one machine learning model may be used to at least one of: predict one or more additional products or services that a particular customer is likely to obtain if offered; predict customer preferences associated with a product in order to optimize product configurations or product bundles; predict whether one or more customers are likely to upgrade a product or service and prioritize the one or more customers for service actions or sales efforts; and predict which marketing activities are likely to increase revenue, analyze drivers of previous successful and unsuccessful marketing campaigns, and recommend marketing investments across potential campaigns.

The example method may further include generating one or more evidence packages. Each evidence package may identify features that contributed to one of the one or more offerings identified using the one or more machine learning models. The one or more offerings may include a price point determined based on different product configurations and bundlings. Example offerings may include at least one of: an adjusted price of a product, suggesting packaging for the product, and an accounting for surge pricing, fluctuation, or demand for the product. In some examples, the one or more machine learning models may be configured to generate the one or more offerings using at least one of: internal information of a company seeking to provide one or more products or services to the customers and external information from outside the company. Example external information may include at least one of: streaming data, batch data, social media data, financial data, relationship data, demographics data, news data, and customer data. The example method may further include generating a graphical user interface identifying at least one of the one or more offerings.

The example pricing optimization method may be implemented using at least one processor configured to perform the method of any of the examples described above. Also, the example pricing optimization method may be implemented via a non-transitory computer readable medium storing computer readable program code that, when executed by one or more processors, causes the one or more processors to perform the example pricing optimization method including any of the examples described above.

An example CRM forecasting method may include obtaining information associated with transaction opportunities involving customers and using one or more trained machine learning models to perform opportunity scoring. The opportunity scoring may include identifying, for each transaction opportunity, an opportunity score capturing a probability that the transaction opportunity will be successfully completed by a target date or within a target date range. The method may also include generating a graphical user interface containing at least one of: (i) one or more of the opportunity scores and (ii) one or more forecasts based on the opportunity scores. The target date may include an arbitrary date, or the target date range may include an arbitrary date range.

The example CRM forecasting method may use the one or more machine learning models to perform opportunity scoring. For each transaction opportunity, the method may include using a first machine learning model to predict a first probability that the transaction opportunity will be successfully completed; using a second machine learning model to predict a probable closing date for the transaction opportunity, where the probable closing date may represent the target date or be within the target date range; and determining a second probability that the transaction opportunity will be successfully completed by the probable closing date using the first probability and the probable closing date.

In some examples, the second probability may include a probability that the transaction opportunity will be successfully completed by a beginning of the target date range. Using the one or more machine learning models to perform opportunity scoring may further include, for each transaction opportunity, determining a third probability that the transaction opportunity will be successfully completed by an end of the target date range; and determining a difference between the second and third probabilities to identify a probability that the transaction opportunity will be successfully completed within the target date range.

The example CRM forecasting method may use the one or more machine learning models to perform opportunity scoring. For each transaction opportunity, the method may include using a single machine learning model to predict a probability that the transaction opportunity will be successfully completed by the target date or within the target date range.

In some examples, the one or more machine learning models can be trained to generate the opportunity scores using at least one of: internal information of a company seeking to provide one or more products or services to the customers and external information from outside the company. Also, in some examples, one or more of the opportunity scores may be calibrated so that the one or more opportunity scores are expressed on a human-relatable scale.

The example CRM forecasting method may generate the one or more forecasts, and the one or more forecasts may include a revenue or bookings forecast that may identify revenue or bookings for a specified time period. The revenue or bookings forecast may be based on at least some of the opportunity scores and corresponding monetary values of the transaction opportunities that are associated with the at least some of the opportunity scores. Generating the one or more forecasts may include reconciling the at least some of the opportunity scores with an aggregate-level forecast such that revenue or bookings roll up to produce the aggregate-level forecast. In some examples, an optimization formulation associated with the aggregate-level forecast may (i) account for ranges within which the probabilities are adjustable and (ii) use a range between zero and one when a range for a specified probability is not identified. In some examples, at least one of the one or more forecasts is associated with a hierarchy-agnostic aggregation of the at least some of the opportunity scores and the corresponding monetary values of the associated transaction opportunities such that changing the hierarchy-agnostic aggregation may not change the at least one of the one or more forecasts. The hierarchy-agnostic aggregation may, for example, be associated with a buffer model that estimates additional revenue or bookings between a current time and an end of the specified time period.

The graphical user interface may contain an evidence package, and the evidence package may identify features that contribute to one or more predictions generated by the one or more machine learning models.

In some examples, the one or more machine learning models may be associated with (i) a core machine learning model and one or more additional machine learning models and (ii) a core data model and one or more additional data models. The one or more additional machine learning models and the one or more additional data models may extend the core machine learning model and the core data model to one or more industry-specific functionalities.

In some examples, the one or more machine learning models may be managed by an orchestrator. The orchestrator may be configured to at least one of: identify machine learning model templates for different use cases; train and retrain the one or more machine learning models; perform inferencing on data using the one or more machine learning models; trigger computations of feature contributions and aggregate feature contributions into virtual-features; and create actionable recommendations for representatives to achieve specified objectives.

The example CRM forecasting method may use the one or more machine learning models to at least one of: provide actionable recommendations for representatives to improve machine learning scores and help the representatives achieve specified objectives; utilize inputs created through natural language processing; and utilize time-series data that includes internal and external information as time-aligned, normalized, and interpolated.

The example CRM forecasting method may be implemented using at least one processor configured to perform the method of any of the examples described above. Also, the example CRM forecasting method may be implemented via a non-transitory computer readable medium storing computer readable program code that, when executed by one or more processors, causes the one or more processors to perform the example CRM forecasting method including any of the examples described above.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
executing at least one of multiple customer relationship management (CRM) functions using one or more processors, each CRM function associated with and configured to use one or more trained machine learning models and one or more data models;
administering, using a model orchestrator, usage of the machine learning models and the data models based on (i) the at least one CRM function of the multiple CRM functions being executed and (ii) a specified use case associated with the at least one CRM function being executed;
generating evidence packages associated with predictions produced by the machine learning models, each evidence package identifying features that contribute to the associated prediction generated by the associated machine learning model; and
providing one or more of the evidence packages as one or more inputs to at least one of the machine learning models.

2. The method of claim 1, wherein:
each of one or more of the CRM functions is associated with (i) a core machine learning model and one or more additional machine learning models and (ii) a core data model and one or more additional data models, the one or more additional machine learning models and the one or more additional data models extending the core machine learning model and the core data model to one or more industry-specific functionalities; and
the model orchestrator administers usage of the core machine learning model, the one or more additional machine learning models, the core data model, and the one or more additional data models for each of the one or more CRM functions.

3. The method of claim 1, wherein one or more of the machine learning models are configured to generate the predictions using (i) internal information of a company seeking to provide one or more products or services to customers and (ii) external information from outside the company.

4. The method of claim 1, wherein administering the usage of the machine learning models and the data models comprises at least one of:
identifying machine learning model templates for different use cases;
training and retraining at least some of the machine learning models associated with the CRM functions;
performing inferencing on data using the machine learning models;
triggering computations of feature contributions and aggregate feature contributions into virtual-features; and
creating actionable recommendations for representatives to achieve specified objectives.

5. The method of claim 1, wherein:
administering the usage of the machine learning models and the data models comprises:
identifying machine learning model templates for different use cases; and
applying the one or more machine learning models associated with at least one of the CRM functions based on one of the model templates; and
each model template includes a specification defining one or more specified machine learning models to be used, one or more inputs to be provided to the one or more specified machine learning models, at least one algorithm to be performed, and a scope of data to be processed using the one or more specified machine learning models.

6. The method of claim 1, wherein executing the at least one CRM function comprises performing an opportunity scoring function by:
using a first machine learning model to predict a probability that a transaction opportunity involving a customer will be successfully completed;
using a second machine learning model to predict a probable closing date for the transaction opportunity; and
determining a probability that the transaction opportunity will be successfully completed by the closing date.

7. The method of claim 1, wherein executing the at least one CRM function comprises performing a precision revenue forecasting function by:
using a machine learning model to predict a probability that each of multiple transaction opportunities involving customers will be successfully completed within a given timeframe, the probabilities predicted using information associated with individual transaction opportunities; and
using the probabilities and deal sizes to generate a revenue forecast.

8. The method of claim 1, wherein executing the at least one CRM function comprises at least one of:
using a machine learning model to predict transaction volumes for specified products or services within a given timeframe;
providing a demand forecast for likely products that are to be sold to customers in order to optimize product inventory to produce and deliver the products within the given timeframe;
performing a next best offer or next best product determination function by using a machine learning model to predict one or more additional products or services that a particular customer is likely to obtain if offered;
performing a churn management function by using a machine learning model to predict whether an existing customer is likely to cease being a customer completely or partially within a given timeframe;
performing a churn management function by using a machine learning model to predict an aggregate likelihood of a group of existing customers ceasing to be customers completely or partially within a given timeframe;
performing a relationship intelligence function by using a machine learning model to identify one or more direct or indirect relationships between a company and its customers and to evaluate connection strengths; and
performing a lead scoring function by using a machine learning model to identify a probability of a prospective customer purchasing at least one product or service if offered.

9. The method of claim 1, wherein executing the at least one CRM function comprises at least one of:
performing a price optimization function by using a machine learning model to predict a price range that is acceptable to at least one customer and identify a most likely price point in the price range that the at least one customer will accept;
performing a warranty or upgrade replacement function by using a machine learning model to predict whether one or more customers are likely to upgrade a product or service and prioritize the one or more customers for service actions or sales efforts;
performing a marketing optimization function by using one or more machine learning models to predict which marketing activities are likely to increase revenue, analyze drivers of previous successful and unsuccessful marketing campaigns, and recommend marketing investments across potential campaigns;
performing a customer satisfaction analysis function by using a machine learning model to analyze customers' sentiments about at least one of: a company, one or more products or services of the company, transaction opportunities involving the customers, and the customers' relationships with the company; and
performing a customer segmentation analysis function by using a machine learning model to segment or divide customers into groups with shared characteristics.

10. The method of claim 1, wherein executing the at least one CRM function comprises at least one of:
performing a recommendation function by identifying sales or service actions in order to achieve one or more specified objectives;
performing a recommendation function by predicting at least one of: a customer satisfaction level for each of multiple customers and customer satisfaction levels in aggregate;
utilizing one or more of the machine learning models associated with one or more of the CRM functions to provide actionable recommendations for representatives to improve a likelihood that the representatives achieve specified objectives;
using one or more of the machine learning models associated with one or more of the CRM functions to optimize pricing discounts for different products in different geographic areas or stores;
using one or more of the machine learning models associated with one or more of the CRM functions to predict changes in customer loyalty;
using one or more of the machine learning models associated with one or more of the CRM functions to optimize product configurations or product bundles based on predicted customer preferences associated with the product;
using one or more of the machine learning models associated with one or more of the CRM functions to provide information to website clients regarding an Internet self-service navigation of a website;
performing predictive relationship modeling by using a machine learning model to identify at least one of: (i) a best connecting path between a company and a customer, (ii) a recommendation regarding interaction with the customer using the best connecting path, and (iii) an estimated strength of a relationship between the company and the customer based on the best connecting path; and
performing predictive relationship modeling by using a machine learning model to identify and provide an interactive graphical representation of at least one of: (i) a hierarchy and structure of relationships between customers, representatives of a company, and external agents; (ii) a best connecting path between the company and one of the customers, (iii) a recommendation regarding interaction with the customer using the best connecting path, and (iv) an estimated strength of a relationship between the company and the customer based on the best connecting path.

11. An apparatus comprising:
at least one processing device configured to:
execute at least one of multiple customer relationship management (CRM) functions, each CRM function associated with and configured to use one or more trained machine learning models and one or more data models;
administer, using a model orchestrator, usage of the machine learning models and the data models based on (i) the at least one CRM function of the multiple CRM functions being executed and (ii) a specified use case associated with the at least one CRM function being executed;
generate evidence packages associated with predictions produced by the machine learning models, each evidence package identifying features that contribute to the associated prediction generated by the associated machine learning model; and
provide one or more of the evidence packages as one or more inputs to at least one of the machine learning models.

12. The apparatus of claim 11, wherein:
each of one or more of the CRM functions is associated with (i) a core machine learning model and one or more additional machine learning models and (ii) a core data model and one or more additional data models, the one or more additional machine learning models and the one or more additional data models extending the core machine learning model and the core data model to one or more industry-specific functionalities; and
the model orchestrator is configured to administer usage of the core machine learning model, the one or more additional machine learning models, the core data model, and the one or more additional data models for each of the one or more CRM functions.

13. The apparatus of claim 11, wherein one or more of the machine learning models are configured to generate the predictions using (i) internal information of a company seeking to provide one or more products or services to customers and (ii) external information from outside the company.

14. The apparatus of claim 11, wherein, to administer the usage of the machine learning models and the data models, the at least one processing device is configured to at least one of:
identify machine learning model templates for different use cases;
train and retrain at least some of the machine learning models associated with the CRM functions;
perform inferencing on data using the machine learning models;
trigger computations of feature contributions and aggregate feature contributions into virtual-features; and
create actionable recommendations for representatives to achieve specified objectives.

15. The apparatus of claim 11, wherein:
to administer the usage of the machine learning models and the data models, the at least one processing device is configured to:
identify machine learning model templates for different use cases; and
apply the one or more machine learning models associated with at least one of the CRM functions based on one of the model templates; and
each model template includes a specification defining one or more specified machine learning models to be used, one or more inputs to be provided to the one or more specified machine learning models, at least one algorithm to be performed, and a scope of data to be processed using the one or more specified machine learning models.

16. The apparatus of claim 11, wherein:
to execute the at least one CRM function, the at least one processing device is configured to perform an opportunity scoring function; and
to perform the opportunity scoring function, the at least one processing device is configured to:
use a first machine learning model to predict a probability that a transaction opportunity involving a customer will be successfully completed;
use a second machine learning model to predict a probable closing date for the transaction opportunity; and
determine a probability that the transaction opportunity will be successfully completed by the closing date.

17. The apparatus of claim 11, wherein:
to execute the at least one CRM function, the at least one processing device is configured to performing a precision revenue forecasting function; and
to perform the precision revenue forecasting function, the at least one processing device is configured to:
use a machine learning model to predict a probability that each of multiple transaction opportunities involving customers will be successfully completed within a given timeframe, the probabilities predicted using information associated with individual transaction opportunities; and
use the probabilities and deal sizes to generate a revenue forecast.

18. The apparatus of claim 11, wherein, to execute the at least one CRM function, the at least one processing device is configured to at least one of:
use a machine learning model to predict transaction volumes for specified products or services within a given timeframe;
provide a demand forecast for likely products that are to be sold to customers in order to optimize product inventory to produce and deliver the products within the given timeframe;
perform a next best offer or next best product determination function by using a machine learning model to predict one or more additional products or services that a particular customer is likely to obtain if offered;
perform a churn management function by using a machine learning model to predict whether an existing customer is likely to cease being a customer completely or partially within a given timeframe;
perform a churn management function by using a machine learning model to predict an aggregate likelihood of a group of existing customers ceasing to be customers completely or partially within a given timeframe;
perform a relationship intelligence function by using a machine learning model to identify one or more direct or indirect relationships between a company and its customers and to evaluate connection strengths; and
perform a lead scoring function by using a machine learning model to identify a probability of a prospective customer purchasing at least one product or service if offered.

19. The apparatus of claim 11, wherein, to execute the at least one CRM function, the at least one processing device is configured to at least one of:
perform a price optimization function by using a machine learning model to predict a price range that is acceptable to at least one customer and identify a most likely price point in the price range that the at least one customer will accept;
perform a warranty or upgrade replacement function by using a machine learning model to predict whether one or more customers are likely to upgrade a product or service and prioritize the one or more customers for service actions or sales efforts;
perform a marketing optimization function by using one or more machine learning models to predict which marketing activities are likely to increase revenue, analyze drivers of previous successful and unsuccessful marketing campaigns, and recommend marketing investments across potential campaigns;
perform a customer satisfaction analysis function by using a machine learning model to analyze customers' sentiments about at least one of: a company, one or more products or services of the company, transaction opportunities involving the customers, and the customers' relationships with the company; and
perform a customer segmentation analysis function by using a machine learning model to segment or divide customers into groups with shared characteristics.

20. The apparatus of claim 11, wherein, to execute the at least one CRM function, the at least one processing device is configured to at least one of:
perform a recommendation function by identifying sales or service actions in order to achieve one or more specified objectives;
perform a recommendation function by predicting at least one of: a customer satisfaction level for each of multiple customers and customer satisfaction levels in aggregate;
utilize one or more of the machine learning models associated with one or more of the CRM functions to provide actionable recommendations for representatives to improve a likelihood that the representatives achieve specified objectives;
use one or more of the machine learning models associated with one or more of the CRM functions to optimize pricing discounts for different products in different geographic areas or stores;
use one or more of the machine learning models associated with one or more of the CRM functions to predict changes in customer loyalty;
use one or more of the machine learning models associated with one or more of the CRM functions to optimize product configurations or product bundles based on predicted customer preferences associated with the product;
use one or more of the machine learning models associated with one or more of the CRM functions to provide information to website clients regarding an Internet self-service navigation of a website;
perform predictive relationship modeling by using a machine learning model to identify at least one of: (i) a best connecting path between a company and a customer, (ii) a recommendation regarding interaction with the customer using the best connecting path, and (iii) an estimated strength of a relationship between the company and the customer based on the best connecting path; and
perform predictive relationship modeling by using a machine learning model to identify and provide an interactive graphical representation of at least one of: (i) a hierarchy and structure of relationships between customers, representatives of a company, and external agents; (ii) a best connecting path between the company and one of the customers, (iii) a recommendation regarding interaction with the customer using the best connecting path, and (iv) an estimated strength of a relationship between the company and the customer based on the best connecting path.

21. A non-transitory computer readable medium storing computer readable program code that, when executed by one or more processors, causes the one or more processors to:
execute at least one of multiple customer relationship management (CRM) functions, each CRM function associated with and configured to use one or more trained machine learning models and one or more data models;
administer, using a model orchestrator, usage of the machine learning models and the data models based on (i) the at least one CRM function of the multiple CRM functions being executed and (ii) a specified use case associated with the at least one CRM function being executed;
generate evidence packages associated with predictions produced by the machine learning models, each evidence package identifying features that contribute to the associated prediction generated by the associated machine learning model; and
provide one or more of the evidence packages as one or more inputs to at least one of the machine learning models.

22. The non-transitory computer readable medium of claim 21, wherein:
each of one or more of the CRM functions is associated with (i) a core machine learning model and one or more additional machine learning models and (ii) a core data model and one or more additional data models, the one or more additional machine learning models and the one or more additional data models extending the core machine learning model and the core data model to one or more industry-specific functionalities; and
the model orchestrator is configured to administer usage of the core machine learning model, the one or more additional machine learning models, the core data model, and the one or more additional data models for each of the one or more CRM functions.

23. The non-transitory computer readable medium of claim 21, wherein one or more of the machine learning models are configured to generate the predictions using (i) internal information of a company seeking to provide one or more products or services to customers and (ii) external information from outside the company.

24. The non-transitory computer readable medium of claim 21, wherein, to administer the usage of the machine learning models and the data models, the at least one processing device is configured to at least one of:
identify machine learning model templates for different use cases;
train and retrain at least some of the machine learning models associated with the CRM functions;
perform inferencing on data using the machine learning models;
trigger computations of feature contributions and aggregate feature contributions into virtual-features; and
create actionable recommendations for representatives to achieve specified objectives.

25. The non-transitory computer readable medium of claim 21, wherein:
to administer the usage of the machine learning models and the data models, the at least one processing device is configured to:
identify machine learning model templates for different use cases; and
apply the one or more machine learning models associated with at least one of the CRM functions based on one of the model templates; and
each model template includes a specification defining one or more specified machine learning models to be used, one or more inputs to be provided to the one or more specified machine learning models, at least one algorithm to be performed, and a scope of data to be processed using the one or more specified machine learning models.

26. The non-transitory computer readable medium of claim 21, wherein:
to execute the at least one CRM function, the at least one processing device is configured to perform an opportunity scoring function; and
to perform the opportunity scoring function, the at least one processing device is configured to:
use a first machine learning model to predict a probability that a transaction opportunity involving a customer will be successfully completed;
use a second machine learning model to predict a probable closing date for the transaction opportunity; and
determine a probability that the transaction opportunity will be successfully completed by the closing date.

27. The non-transitory computer readable medium of claim 21, wherein:
to execute the at least one CRM function, the at least one processing device is configured to performing a precision revenue forecasting function; and
to perform the precision revenue forecasting function, the at least one processing device is configured to:
use a machine learning model to predict a probability that each of multiple transaction opportunities involving customers will be successfully completed within a given timeframe, the probabilities predicted using information associated with individual transaction opportunities; and
use the probabilities and deal sizes to generate a revenue forecast.

28. The non-transitory computer readable medium of claim 21, wherein, to execute the at least one CRM function, the at least one processing device is configured to at least one of:
use a machine learning model to predict transaction volumes for specified products or services within a given timeframe;
provide a demand forecast for likely products that are to be sold to customers in order to optimize product inventory to produce and deliver the products within the given timeframe;
perform a next best offer or next best product determination function by using a machine learning model to predict one or more additional products or services that a particular customer is likely to obtain if offered;
perform a churn management function by using a machine learning model to predict whether an existing customer is likely to cease being a customer completely or partially within a given timeframe;
perform a churn management function by using a machine learning model to predict an aggregate likelihood of a group of existing customers ceasing to be customers completely or partially within a given timeframe;
perform a relationship intelligence function by using a machine learning model to identify one or more direct or indirect relationships between a company and its customers and to evaluate connection strengths; and
perform a lead scoring function by using a machine learning model to identify a probability of a prospective customer purchasing at least one product or service if offered.

29. The non-transitory computer readable medium of claim 21, wherein, to execute the at least one CRM function, the at least one processing device is configured to at least one of:
perform a price optimization function by using a machine learning model to predict a price range that is acceptable to at least one customer and identify a most likely price point in the price range that the at least one customer will accept;
perform a warranty or upgrade replacement function by using a machine learning model to predict whether one or more customers are likely to upgrade a product or service and prioritize the one or more customers for service actions or sales efforts;
perform a marketing optimization function by using one or more machine learning models to predict which marketing activities are likely to increase revenue, analyze drivers of previous successful and unsuccessful marketing campaigns, and recommend marketing investments across potential campaigns;
perform a customer satisfaction analysis function by using a machine learning model to analyze customers' sentiments about at least one of: a company, one or more products or services of the company, transaction opportunities involving the customers, and the customers' relationships with the company; and
perform a customer segmentation analysis function by using a machine learning model to segment or divide customers into groups with shared characteristics.

30. The non-transitory computer readable medium of claim 21, wherein, to execute the at least one CRM function, the at least one processing device is configured to at least one of:
perform a recommendation function by identifying sales or service actions in order to achieve one or more specified objectives;
perform a recommendation function by predicting at least one of: a customer satisfaction level for each of multiple customers and customer satisfaction levels in aggregate;
utilize one or more of the machine learning models associated with one or more of the CRM functions to provide actionable recommendations for representatives to improve a likelihood that the representatives achieve specified objectives;
use one or more of the machine learning models associated with one or more of the CRM functions to optimize pricing discounts for different products in different geographic areas or stores;
use one or more of the machine learning models associated with one or more of the CRM functions to predict changes in customer loyalty;
use one or more of the machine learning models associated with one or more of the CRM functions to optimize product configurations or product bundles based on predicted customer preferences associated with the product;
use one or more of the machine learning models associated with one or more of the CRM functions to provide information to website clients regarding an Internet self-service navigation of a website;
perform predictive relationship modeling by using a machine learning model to identify at least one of: (i) a best connecting path between a company and a customer, (ii) a recommendation regarding interaction with the customer using the best connecting path, and (iii) an estimated strength of a relationship between the company and the customer based on the best connecting path; and
perform predictive relationship modeling by using a machine learning model to identify and provide an interactive graphical representation of at least one of: (i) a hierarchy and structure of relationships between customers, representatives of a company, and external agents; (ii) a best connecting path between the company and one of the customers, (iii) a recommendation regarding interaction with the customer using the best connecting path, and (iv) an estimated strength of a relationship between the company and the customer based on the best connecting path.
